(19) United States
(12) Patent Application Publication
(10) Pub. No.: US 2020/0163342 A1
(43) Pub. Date: May 28, 2020

(54) MIXTURES COMPRISING A BIOPESTICIDE AND A NITRIFICATION INHIBITOR

(71) Applicant: BASF SE, Ludwigshafen am Rhein (DE)

(72) Inventors: Barbara Nave, Limburgerhof (DE); Gregor Pasda, Limburgerhof (DE); Alexander Wissemeier, Limburgerhof (DE); Maarten Staal, Limburgerhof (DE); Karl-Heinrich Schneider, Limburgerhof (DE); Markus Schmid, Limburgerhof (DE); Wolfram Zerulla, Limburgerhof (DE); Daniella Lohe, Limburgerhof (DE); Sascha Shuxia Zhu, Ludwigshafen (DE)

(21) Appl. No.: 16/630,092

(22) PCT Filed: Jul. 5, 2018
(86) PCT No.: PCT/IB2018/054949

§ 371 Date: Jan. 10, 2020

(30) Foreign Application Priority Data
Jul. 10, 2017 (EP) 17180510.4

(51) Int. Cl. A01N 63/20; C05G 3/60; C05G 3/90

(52) U.S. Cl. CPC A01N 63/20; C05G 3/90; C05G 3/60

(57) ABSTRACT

Described herein are pesticidal mixtures including as active components at least one specific nitrification inhibitor (compound I) and at least one biopesticide (compound II). Also described herein are a method for controlling phytopathogenic harmful fungi, or for improving the nitrification-inhibiting effect, or for increasing the health of a plant using mixtures of at least one compound I and at least one compound II and a method of using the mixtures comprising compounds I and compounds II for controlling phytopathogenic harmful fungi or to increasing the health of a plant. Also described herein are agrochemical compositions including these mixtures. Also described herein is plant propagation material including these mixtures or agrochemical compositions.

The present invention relates to the mixture comprising nitrification inhibitors (compound I) and biopesticides (compound II). Moreover, the invention relates to the use of this combination comprising nitrification inhibitors (compound I) and biopesticides (compound II) for increasing the health of a plant, and/or for providing better crop yields and/or a better quality of the plants or crops, and/or for contributing to a better resistance to stress, and/or for reducing of the quantity of pesticides used, and/or for avoiding the development of resistances against the respective pesticides. Furthermore, the present invention relates to methods for increasing the health of a plant comprising the treatment of plants, soil and/or loci with said mixture comprising the nitrification inhibitor (compound I) and a biopesticide (compound II).

Nitrogen is an essential element for plant growth, plant health and reproduction. About 25% of the plant available nitrogen in soils (ammonium and nitrate) originate from decomposition processes (mineralization) of organic nitrogen compounds such as humus, plant and animal residues and organic fertilizers. Approximately 5% derive from rainfall. On a global basis, the biggest part (70%), however, are supplied to the plant by inorganic nitrogen fertilizers. The mainly used nitrogen fertilizers comprise ammonium compounds or derivatives thereof, i.e. nearly 90% of the nitrogen fertilizers applied worldwide is in the NH₄⁺ form (Subbarao et al., 2012, Advances in Agronomy, 114, 249-302) or are based on neem-extract, including various compounds such as neemoil-coated fertilizers, neem-coated fertilizers, nimin-coated fertilizers and fertilizers with neem cake from the Indian neem tree (Azadirachta indica). This is, inter alia, due to the fact that NH₄⁺ assimilation is energetically more efficient than assimilation of other nitrogen sources such as NO₃⁻.

Moreover, being a cation, NH₄⁺ is held electrostatically by the negatively charged clay surfaces and functional groups of soil organic matter. This binding is strong enough to limit NH₄⁺-loss by leaching to groundwater. By contrast, NO₃⁻, being negatively charged, does not bind to the soil and is liable to be leached out of the plants' root zone. In addition, nitrate may be lost by denitrification which is the microbiological conversion of nitrate and nitrite (NO₂⁻) to gaseous forms of nitrogen such as nitrous oxide (N₂O) and molecular nitrogen (N₂).

However, ammonium (NH₄⁺) compounds are converted by soil microorganisms to nitrates (NO₃⁻) in a relatively short time in a process known as nitrification. The nitrification is carried out primarily by two groups of chemolithotrophic bacteria, ammonia-oxidizing bacteria (AOB) of the genus Nitrosomonas and Nitrobacter, which are ubiquitous component of soil bacteria populations. The enzyme, which is essentially responsible for nitrification is ammonia monooxygenase (AMO), which was also found in ammonia-oxidizing archaea (Subbarao et al., 2012, Advances in Agronomy, 114, 249-302).

The nitrification process typically leads to nitrogen losses and environmental pollution. As a result of the various losses, approximately 50% of the applied nitrogen fertilizers is lost during the year following fertilizer addition (see Nelson and Huber; Nitrification inhibitors for corn production (2001), National Corn Handbook, Iowa State University).

As countermeasures, the use of nitrification inhibitors, mostly together with fertilizers, was suggested. Suitable nitrification inhibitors include biological nitrification inhibitors (BNIs) such as linoleic acid, alpha-linolenic acid, methyl p-coumarate, methyl ferulate, MHPP, Karanjin, brachialacton or the p-benzoquinone sorgoleone (Subbarao et al., 2012, Advances in Agronomy, 114, 249-302). Further suitable nitrification inhibitors are synthetic chemical inhibitors such as Nitrapyrin, dicyandiamide (DCD), 3,4-dimethyl pyrazole phosphate (DMPP), 4-amino-1,2,4-triazole hydrochloride (ATC), 1-amido-2-thiourea (ASU), 2-amino-4-chloro-6-methylpyrimidine (AM), 5-ethoxy-3-trichloromethyl-1,2,4-thiodiazole (terrazole), or 2-sulfanilamidothiazole (ST) (Slangen and Kerkhoff, 1984, Fertilizer research, 5(1), 1-76).

EP 0 917 526 further mentions the use of polyacids to treat mineral fertilizers containing a nitrification inhibitor in order to improve the fixation of the nitrification inhibitors in the inorganic fertilizer. Moreover, the volatility of the nitrification inhibitor can be reduced.

However, many of these inhibitors only work sub-optimal or have undesirable side effects.

In view of this situation there is a continuous need for compositions or mixtures that increase the health of plants. Healthier plants are desirable since they result among other in better crop yields and/or a better quality of the plants or crops. Healthier plants also better resist to biotic and abiotic stress. A better resistance to stress in turn allows reducing the quantity of pesticides, which also helps avoiding the development of resistances against the respective pesticides.

One object of the present invention is to provide a composition or mixture containing a nitrification inhibitor and/or a biopesticide which increases the health of plants, and/or provides better crop yields and/or a better quality of the plants or crops, and/or shows a better resistance to stress, and/or allows the reduction of the quantity of pesticides used, and/or helps avoiding the development of resistances against the respective pesticides.

Another object of the present invention is to provide a composition or mixture containing the nitrification inhibitor (compound I) and/or a biopesticide (compound II) which—each preferably through a synergistic action—
(i) enhances the stability of compound I, and/or
(ii) enhances the nitrification-inhibiting effect of compound I, and/or
(iii) enhances the yield increase effect of the compound I, and/or
(iv) has a relatively long storage life, particularly before being applied to or coated on nitrogen-containing fertilizers, and/or
(v) reduces the emission of nitrous oxide from soils, and/or
(vi) reduces the ammonia emission from soils, and/or
(vii) reduces nitrate leaching, and/or
(viii) does not adversely affect the nitrification-inhibiting effect and/or the nitrification-inhibiting activity of the compound I, and/or
(ix) can be easily and safely packaged, transported and shipped, even in large quantities, and/or
(x) can be easily and safely handled and applied for soil treatment, even in large quantities, and/or
(xi) improves the nutrient use efficiency, and/or
(xii) improves the delivery of the biopesticide (compound II) to the plant, and/or
(xiii) improves the plant growth (e.g. biomass, yield, root branching and length; compact growth in case of ornamental plants), and/or
(xiv) enables a better developed root system, a larger leaf area, greener leaves, stronger shoots and/or
(xv) improves the plant defense of the plants, and/or
(xvi) improves the plant health of the plants, and/or
(xvii) improves the quality of the plants, and/or
(xviii) improves the storage or survivability of the biopesticide (compound II) and/or prolongs the availability of biopesticides (compound II) to the plants, and/or
(xix) enhances the biopesticidal effect of the biopesticide (compound II), and/or
(xx) allows the reduction of the quantity of biopesticides (compound II) used, and/or
(xxi) increase the survivability rate of seedlings, for example transplanted seedlings, and/or
(xxii) reduce or avoid unfavorable environmental or toxicological effects whilst still allowing effective pest control, and/or
(xxiii) enable earlier seed germination and/or blooming, and/or
(xxiv) is toxicologically unobjectionable, and/or
(xxv) enables simple handling and application of compound I and compound II.

The objects (xiii), (xiv), (xv), (xvi), (xvii) and (xxi) particularly pertains to such plants or seedlings wherein such plants or seedlings were treated with the mixture or composition, or the soil in which the plants or seedlings were placed, was subject to the application of the mixture or composition of the present invention.

The preferred objects of the present invention are (i), (ii), (v), (vi), (vii), (xi), (xii), (xiii), (xiv), (xv), (xvi), (xvii), (xviii), (xix), (xx), (xxii), (xxiv), (xxv), the more preferred objects of the present invention are (i), (ii), (v), (vi), (vii), (xii), (xiii), (xv), (xvi), (xix), (xx), and/or (xxii), the most preferred objects of the present invention are (i), (ii), (v), (vii), (xvi), (xix), and/or (xxii), the particularly preferred objects of the present invention are (ii), (v), (vii), (xvi) and/or (xix).

The term “in a synergistic way” means that the composition or mixture comprising the nitrification inhibitor (compound I) and the biopesticide (compound II) can fulfil one or more of the objects (i) to (xxiv) significantly better than the individual compounds—i.e. compound I or compound II—alone can do, and preferably, this better fulfillment of the objects by said composition or mixture compared to the individual compounds is evidenced by calculations according to Colby's formula, see Colby, S. R. (Calculating synergistic and antagonistic responses of herbicide Combinations”, Weeds, 15, pp. 20-22, 1967).

The present invention relates to a mixture comprising as active components
1) at least one active compound I (nitrification inhibitor) selected from the group consisting of:
   a) 2-(3,4-dimethyl-1H-pyrazol-1-yl)succinic acid (referred to as “DMPSA1” in the following) and/or 2-(4,5-dimethyl-1H-pyrazol-1-yl)succinic acid (referred to as “DMPSA2” in the following), and/or a derivative thereof, and/or a salt thereof,
   b) glycolic acid addition salt of 3,4-dimethyl pyrazole (3,4-dimethyl pyrazolium glycolate, referred to as “DMPG” in the following), and/or an isomer thereof, and/or a derivative thereof,
   c) citric acid addition salt of 3,4-dimethyl pyrazole (3,4-dimethyl pyrazolium citrate, referred to as “DMPC” in the following), and/or an isomer thereof, and/or a derivative thereof,
   d) lactic acid addition salt of 3,4-dimethyl pyrazole (3,4-dimethyl pyrazolium lactate, referred to as “DMPL” in the following), and/or an isomer thereof, and/or a derivative thereof,
   e) mandelic acid addition salt of 3,4-dimethyl pyrazole (3,4-dimethyl pyrazolium mandelate, referred to as “DMPM” in the following), and/or an isomer thereof, and/or a derivative thereof,
   f) 1,2,4-triazole (referred to as “TZ” in the following), and/or a derivative thereof, and/or a salt thereof,
   g) 4-Chloro-3-methylpyrazole (referred to as “CIMP” in the following), and/or an isomer thereof, and/or a derivative thereof, and/or a salt thereof,
   h) N-((3(5)-methyl-1H-pyrazole-1-yl)methyl)acetamide, and/or an isomer thereof, and/or a derivative thereof, and/or a salt thereof,
   i) N-((3(5)-methyl-1H-pyrazole-1-yl)methyl)formamide, and/or an isomer thereof, and/or a derivative thereof, and/or a salt thereof,
   j) N-((3(5),4-dimethyl pyrazole-1-yl)methyl)formamide, and/or an isomer thereof, and/or a derivative thereof, and/or a salt thereof,
   k) N-((4-chloro-3(5)-methyl-pyrazole-1-yl)methyl)formamide, and/or an isomer thereof, and/or a derivative thereof, and/or a salt thereof,
   l) a reaction adduct of dicyandiamide, urea and formaldehyde, or a triazonyl-formaldehyde-dicyandiamide adduct,
   m) 2-cyano-1-((4-oxo-1,3,5-triazinan-1-yl)methyl)guanidine,
   n) 1-((2-cyanoguanidino)methyl)urea,
   o) 2-cyano-1-((2-cyanoguanidino)methyl)guanidine,
   p) 2-chloro-6-(trichloromethyl)-pyridine (nitrapyrin or N-serve),
   q) dicyandiamide (DCD, DIDIN),
   r) 3,4-dimethyl pyrazole phosphate, and/or 4,5-dimethyl pyrazole phosphate (DMPP, ENTEC), and/or an isomer thereof, and/or a derivative thereof,
   s) 3,4-dimethylpyrazole, and/or 4,5-dimethylpyrazole (DMP), and/or an isomer thereof, and/or a derivative thereof, and/or a salt thereof, and/or an acid addition salt thereof,
   t) ammoniumthiosulfate (ATU),
   u) neem, and/or products based on ingredients of neem,
   v) linoleic acid,
   w) alpha-linolenic acid,
   x) methyl p-coumarate,
   y) methyl ferulate,
   z) methyl 3-(4-hydroxyphenyl) propionate (MHPP),
   aa) Karanjin,
   bb) brachialacton,
   cc) p-benzoquinone sorgoleone,
   dd) 4-amino-1,2,4-triazole hydrochloride (ATC),
   ee) 1-amido-2-thiourea (ASU),
   ff) 2-amino-4-chloro-6-methylpyrimidine (AM),
   gg) 2-mercapto-benzothiazole (MBT),
   hh) 5-ethoxy-3-trichloromethyl-1,2,4-thiodiazole (terrazole, etridiazole),
   ii) 2-sulfanilamidothiazole (ST),
   jj) 3-methylpyrazol (3-MP),
   kk) 1,2,4-triazol thiourea (TU),
   ll) cyan amide,
   mm) melamine,
   nn)zeolite powder,
   oo) catechol,
   pp) benzoquinone,
   qq)sodium tetra borate,
   rr) allylthiourea,
   ss) chlorate salts, and
   tt) zinc sulfate;
      and
2) at least one active compound II (biopesticide) selected from groups L1) to L6):
   L1) Microbial pesticides with fungicidal, bactericidal, viricidal and/or plant defense activator activity: Ampelomyces quisqualis, Aspergillus flavus, Aureobasidium pullulans, Bacillus altitudinis, Bacillus amyloliquefaciens, Bacillus licheniformis, Bacillus megaterium, Bacillus mojavensis, Bacillus mycoides, Bacillus pumilus, Bacillus simplex, Bacillus solisalsi, Bacillus subtilis, Bacillus subtilis var. amyloliquefaciens, Candida oleophila, Candida saitoana, Clavibacter michiganensis (bacteriophages), Coniothyrium minitans, Cryphonectria parasitica, Cryptococcus albidus, Dllophosphora alopecuri, Fusarium oxysporum, Clonostachys rosea f. catenulata (also named Gliocladium catenulatum), Gliocladium roseum, Lysobacter antibioticus, Lysobacter enzymogenes, Metschnikowia fructicola, Microdochium dimerum, Microsphaeropsis ochracea, Muscodor albus, Paenibacillus alvei, Paenibacillus epiphyticus, Paenibacillus polymyxa, Paenibacillus agglomerans, Pantoea vagans, Penicillium bilaiae, Phlebiopsis gigantea, Pseudomonas chlororaphis, Pseudomonas fluorescens, Pseudomonas putida, Pseudozyma flocculosa, Pichia anomala, Pythium oligandrum, Sphaerodes mycoparasitica, Streptomyces griseoviridis, Streptomyces lydicus, Streptomyces violaceusniger, Talaromyces flavus, Trichoderma asperellum, Trichoderma atroviride, Trichoderma asperelloides, Trichoderma fertile, Trichoderma gamsii, Trichoderma harmatum, Trichoderma harzianum, Trichoderma polysporum, Trichoderma stromaticum, Trichoderma virens, Trichoderma viride, Typhula phacorrhiza, Ulocladium oudemansii, Verticillium dahlia, zucchini yellow mosaic virus (avirulent strain);
   L2) Biochemical pesticides with fungicidal, bactericidal, viricidal and/or plant defense activator activity: chitosan (hydrolysate), fusaricidins, paeniserines, paeniprolixines, harpin protein, laminarin, Menhaden fish oil, natamycin, Plum pox virus coat protein, potassium or sodium bicarbonate, Reynoutria sachalinensis extract, salicylic acid, tea tree oil (Melaleuca alternifolla extract);
   L3) Microbial pesticides with insecticidal, acaricidal, molluscidal and/or nematicidal activity: Agrobacterium radiobacter, Bacillus cereus, Bacillus firmus, Bacillus subtilis, Bacillus licheniformis, Bacillus thuringiensis, Bacillus thuringiensis ssp. aizawai, Bacillus thuringiensis ssp. israelensis, Bacillus thuringiensis ssp. galleriae, Bacillus thuringiensis ssp. kurstaki, Bacillus thuringiensis ssp. tenebrionis, Beauveria bassiana, Beauveria brongniartil, Burkhoideria rinojensis, Chromobacterium subtsugae, Cydia pomonella granulovirus (CpGV), Cryptophlebia leucotreta granulovirus (CrleGV), Flavobacterium spp., Helicoverpa armigera nucleopolyhedrovirus (HearNPV), Heterorhabditis bacteriophora, Isaria fumosorosea, Lecanicillium longisporum, Lecanicillium muscarium, Metarhizium anisopliae, Metarhizium anisopliae var. anisopliae, Metarhizium anisopliae var. acridum, Nomuraea rileyi, Paecilomyces lilacinus, Paenibacillus popilliae, Pasteuria nishizawae, Pasteuria penetrans, Pasteuria ramosa, Pasteuria thornea, Pasteuria usgae, Phasmarhabditis hermaphrodita, Pseudomonas fluorescens, Spodoptera littoralis nucleopolyhedrovirus (SpliNPV), Steinernema carpocapsae, Steinernema feltiae, Stelnemema kraussei, Stelnemema riobrave, Streptomyces galbus, Streptomyces microflavus, Paecilomyces lilacinus,
   L4) Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl butyrate, isopropyl myristate, lavanulyl senecioate, cis-jasmone, 2-methyl 1-butanol, methyl eugenol, methyl jasmonate, (E,Z)-2,13-octadecadien-1-ol, (E,Z)-2,13-octadecadien-1-ol acetate, (E,Z)-3,13-octadecadien-1-ol, R-1-octen-3-ol, pentatermanone, potassium silicate, sorbitol actanoate, (E,Z,Z)-3,8,11-tetradecatrienyl acetate, (Z,E)-9,12-tetradecadien-1-yl acetate, Z-7-tetradecen-2-one, Z-9-tetradecen-1-yl acetate, Z-11-tetradecenal, Z-11-tetradecen-1-ol, Acacia negra extract, extract of grapefruit seeds and pulp, Chenopodium ambrosioides extract, Catnip oil, Neem oil, Quillay extract, Tagetes oil;
   L5) Microbial pesticides with plant stress reducing, plant growth regulator, plant growth promoting and/or yield enhancing activity: Azospirillum amazonense, Azospialum brasilense, Azospirillum lipoferum, Azospirillum irakense, Azospirillum halopraeferens, Bradyrhizobium elkanii; Bradyrhizobium japonicum, Bradyrhizobium spp., Bradyrhizobium liaoningense, Bradyrhizobium Delftia acidovorans, Glomus intraradices, Mesorhizobium spp., Mesorhizobium ciceri, Rhizobium leguminosarum bv. phaseoli, Rhizobium leguminosarum bv. trifolii, Rhizobium leguminosarum bv. viciae, Rhizobium Sinorhizobium meliloti, Sinorhizobium medicae;
   L6) Biochemical pesticides with plant stress reducing, plant growth regulator and/or plant yield enhancing activity: abscisic acid, aluminium silicate (kaolin), 3-decen-2-one, formononectin, genistein, hesperetin, homobrassinolide, humates, methyl jasmonate, cis-jasmone, lysophosphatidyl ethanlamine, naringenin, polymeric polyhydroxy acid, salicylic acid, Ascophyllum nodosum (Norwegian kelp, Brown kelp) extract and Ecklonia maxima (kelp) extract, zeolite (aluminosilicate), grape seed extract.

The above mixture of the present invention also includes kit-of-parts comprising a nitrification inhibitor (compound I) and a biopesticide (compound II). Here, the term “kit-of-parts” is to be understood to denote a kit comprising at least two separate parts wherein each of the parts can be independently removed from the kit. A kit includes a box, a tool, a vessel, a container, a bag or any kit-like equipment. Also a kit whose separate parts are only together in this one kit for a extremely short period of time are regarded as kit-of-parts. Kit-of-parts are useful for the combined application (of the contents) of the separate parts of the kit.

The present invention also relates to an agrochemical composition, comprising an auxiliary and a mixture comprising as active components at least one compound I and at least one compound II.

The present invention also relates to the use of a mixture or an agrochemical composition according to the invention for nitrification inhibition and/or for increasing the health of a plant and/or for plant growth regulation.

The present invention also relates to a method for controlling phytopathogenic harmful fungi, comprising treating the fungi, their habitat or the seed, the soil or the plants to be protected against fungal attack with an effective amount of a mixture or of an agrochemical composition according to the invention.

The present invention also relates to a method for controlling phytopathogenic harmful insects, comprising treating the insects, their habitat or the seed, the soil or the plants to be protected against insect attack with an effective amount of a mixture or of an agrochemical composition according to the invention.

The present invention also relates to a method for increasing the health of a plant, comprising treating the plant or the plant propagation material or the soil where the plants are to grow with an effective amount of the mixture or of an agrochemical composition according to the invention.

The present invention also relates to plant propagation material, comprising a mixture or an agrochemical composition according to the invention in an amount of from 0.1 to 10 kg active substances per 100 kg of seed.

A “pesticide” is generally a chemical or biological agent (such as a virus, bacterium, antimicrobial or disinfectant) that through its effect deters, incapacitates, kills or otherwise discourages pests. Target pests can include insects, plant pathogens, weeds, mollusks, birds, mammals, fish, nematodes (roundworms), and microbes that destroy property, cause nuisance, spread disease or are vectors for disease. The term “pesticide” includes also plant growth regulators that alter the expected growth, flowering, or reproduction rate of plants; defoliants that cause leaves or other foliage to drop from a plant, usually to facilitate harvest; desiccants that promote drying of living tissues, such as unwanted plant tops; plant activators that activate plant physiology for defense of against certain pests; safeners that reduce unwanted herbicidal action of pesticides on crop plants; and plant growth promoters that affect plant physiology e.g. to increase plant growth, biomass, yield or any other quality parameter of the harvestable goods of a crop plant.

Biopesticides have been defined as a form of pesticides based on micro-organisms (bacteria, fungi, viruses, nematodes, etc.) or natural products (compounds, such as metabolites, proteins, or extracts from biological or other natural sources) (U.S. Environmental Protection Agency: http://www.epa.gov/pesticides/biopesticides/). Biopesticides fall into two major classes, microbial and biochemical pesticides:

(1) Microbial pesticides consist of bacteria, fungi or viruses (and often include the metabolites that bacteria and fungi produce). Entomopathogenic nematodes are also classified as microbial pesticides, even though they are multi-cellular.
(2) Biochemical pesticides are naturally occurring substances or structurally-similar and functionally identical to a naturally-occurring substance and extracts from biological sources that control pests or provide other crop protection uses as defined below, but have non-toxic mode of actions (such as growth or developmental regulation, attractants, repellents or defence activators (e.g. induced resistance) and are relatively non-toxic to mammals.

Biopesticides for use against crop diseases have already established themselves on a variety of crops. For example, biopesticides already play an important role in controlling downy mildew diseases. Their benefits include: a 0-Day Pre-Harvest Interval, the ability to use under moderate to severe disease pressure, and the ability to use in mixture or in a rotational program with other registered pesticides.

A major growth area for biopesticides is in the area of seed treatments and soil amendments. Biopesticidal seed treatments are e.g. used to control soil borne fungal pathogens that cause seed rots, damping-off, root rot and seedling blights. They can also be used to control internal seed borne fungal pathogens as well as fungal pathogens that are on the surface of the seed. Many biopesticidal products also show capacities to stimulate plant host defenses and other physiological processes that can make treated crops more resistant to a variety of biotic and abiotic stresses or can regulate plant growth. Many biopesticidal products also show capacities to stimulate plant health, plant growth and/or yield enhancing activity.

The term “plant health” or “health of a plant” as used herein is intended to mean a condition of the plant which is determined by several aspects alone or in combination with each other. One indicator (indicator 1) for the condition of the plant is the crop yield. “Crop” and “fruit” are to be understood as any plant product which is further utilized after harvesting, e.g. fruits in the proper sense, vegetables, nuts, grains, seeds, wood (e.g. in the case of silviculture plants), flowers (e.g. in the case of gardening plants, ornamentals) etc., that is anything of economic value that is produced by the plant. Another indicator (indicator 2) for the condition of the plant is the plant vigor. The plant vigor becomes manifest in several aspects, too, some of which are visual appearance, e.g. leaf color, fruit color and aspect, amount of dead basal leaves and/or extent of leaf blades, plant weight, plant height, extent of plant verse (lodging), number, strong ness and productivity of tillers, panicles' length, extent of root system, strongness of roots, extent of nodulation, in particular of rhizobial nodulation, point of time of germination, emergence, flowering, grain maturity and/or senescence, protein content, sugar content and the like. Another indicator (indicator 3) for an increase of a plant's health is the reduction of biotic or abiotic stress factors. The three above mentioned indicators for the health condition of a plant may be interdependent and may result from each other. For example, a reduction of biotic or abiotic stress may lead to a better plant vigor, e.g. to better and bigger crops, and thus to an increased yield. Biotic stress, especially over longer terms, can have harmful effects on plants. The term “biotic stress” as used in the context of the present invention refers in particular to stress caused by living organisms. As a result, the quantity and the quality of the stressed plants, their crops and fruits decrease. As far as quality is concerned, reproductive development is usually severely affected with consequences on the crops which are important for fruits or seeds. Growth may be slowed by the stresses; polysaccharide synthesis, both structural and storage, may be reduced or modified: these effects may lead to a decrease in biomass and to changes in the nutritional value of the product. Abiotic stress includes drought, cold, increased UV, increased heat, or other changes in the environment of the plant, that leads to sub-optimal growth conditions. The term “increased yield” of a plant as used herein means that the yield of a product of the respective plant is increased by a measurable amount over the yield of the same product of the plant produced under the same conditions, but without the application of the composition of the invention. According to the present invention, it is preferred that the yield is increased by at least 2%, more preferably by at least 4%, most preferably at least 7%, particularly preferably at least 10%, more particularly preferably by at least 15%, most particularly preferably by at least 20%, particularly more preferably by at least 25%, particularly most preferably by at least 30%, particularly by at least 35%, especially more preferably by at least 40%, especially most preferably by at least 45%, especially by at least 50%, in particular preferably by at least 55%, in particular more preferably by at least 60%, in particular most preferably by at least 65%, in particular by at least 70%, for example by at least 75%. According to the present invention, it is preferred that the yield is increased—compared to the situation in which only the individual compound I or the individual compound II is used—by at least 1%, more preferably by at least 2%, most preferably at least 3%, particularly preferably at least 4%, more particularly preferably by at least 5%, most particularly preferably by at least 6%, particularly more preferably by at least 7%, particularly most preferably by at least 8%, particularly by at least 10%, especially more preferably by at least 12%, especially most preferably by at least 14%, especially by at least 16%, in particular preferably by at least 18%. An increased yield may, for example, be due to a reduction of nitrification and a corresponding improvement of uptake of nitrogen nutrients. The term “improved plant vigor” as used herein means that certain crop characteristics are increased or improved by a measurable or noticeable amount over the same factor of the plant produced under the same conditions, but without the application of the composition of the present invention. Improved plant vigor can be characterized, among others, by following improved properties of a plant:
(a) improved vitality of the plant,
(b) improved quality of the plant and/or of the plant products, e.g.
(b) enhanced protein content,
(c) improved visual appearance,
(d) delay of senescence,
(e) enhanced root growth and/or more developed root system (e.g. determined by the dry mass of the root),
(f) enhanced nodulation, in particular rhizobial nodulation,
(g) longer panicles,
(h) bigger leaf blade,
(i) less dead basal leaves,
(j) increased chlorophyll content
(k) prolonged photosynthetically active period
(l) improved nitrogen-supply within the plant
(m) improved water use efficiency

The improvement of the plant vigor according to the present invention particularly means that the improvement of anyone or several or all of the above mentioned plant characteristics are improved. It further means that if not all of the above characteristics are improved, those which are not improved are not worsened as compared to plants which were not treated according to the invention or are at least not worsened to such an extent that the negative effect exceeds the positive effect of the improved characteristic (i.e. there is always an overall positive effect which preferably results in an improved crop yield). An improved plant vigor may, for example, be due to a reduction of nitrification and, e.g. a regulation of plant growth.

However, biopesticides under certain conditions can also have disadvantages such as high specificity: which may require an exact identification of the pest/pathogen and the use of multiple products to be used, slow speed of action (thus making them unsuitable if a pest outbreak is an immediate threat to a crop), variable efficacy due to the influences of various biotic and abiotic factors (since biopesticides are usually living organisms, which bring about pest/pathogen control by multiplying within the target insect pest/pathogen) and resistance development.

Practical agricultural experience has shown that the repeated and exclusive application of an individual active component in the control of harmful fungi, insects or other pests leads in many cases to a rapid selection of those fungus strains or pest isolates which have developed natural or adapted resistance against the active component in question. Effective control of these fungi, insects or other pests with the active component in question is then no longer possible.

Another typical problem arising in the field of pest control lies in the need to reduce the dosage rates of the active ingredient to reduce or avoid unfavorable environmental or toxicological effects whilst still allowing effective pest control.

It is an object of the present invention to overcome the abovementioned disadvantages and to provide, with a view to effective resistance management and effective control of phytopathogenic harmful fungi, insects or other pests or to effective plant growth regulation, at application rates which are as low as possible, compositions which, at a reduced total amount of active compounds applied, have improved activity against the harmful fungi, insects or other pests or improved plant growth regulating activity (synergistic mixtures) and a broadened activity spectrum, in particular for certain indications.

This is particularly visible if application rates for the beforementioned mixtures of pesticides are used where the individual components show no or virtually no activity. The invention can also result in an advantageous behavior during formulation or during use, for example during grinding, sieving, emulsifying, dissolving or dispensing; improved storage stability and light stability, advantageous residue formation, improved toxicological or ecotoxicological behaviour, improved properties of the plant, for example better growth, increased harvest yields, a better developed root system, a larger leaf area, greener leaves, stronger shoots, less seed required, lower phytotoxicity, mobilization of the defense system of the plant, good compatibility with plants. Moreover, even an enhanced systemic action of the pesticides as defined herein and/or a persistency of the fungicidal, insecticidal, acaricidal, nematicidal action and/or plant growth regulating activity are expected.

It was therefore also an object of the present invention to provide mixtures which solve the problems of reducing the dosage rate, and/or enhancing the spectrum of activity, and/or combining knock-down activity with prolonged control, and/or improving resistance management and/or promoting (increasing) the health of plants, and/or facilitating application on the plants or on the soil.

We have accordingly found that this object is achieved by the mixtures and compositions defined herein.

Any reference to “compound I” refers to compound I as such, or an agriculturally useful salt thereof.

Any reference to “compound III” refers to compound III as such, or an agriculturally useful salt thereof.

Agriculturally useful salts of the active compounds I, II and III encompass especially the salts of those cations or the acid addition salts of those acids whose cations and anions, respectively, have no adverse effect on the fungicidal action of the active compounds. Suitable cations are thus in particular the ions of the alkali metals, preferably sodium and potassium, of the alkaline earth metals, preferably calcium, magnesium and barium, of the transition metals, preferably manganese, copper, zinc and iron, and also the ammonium ion which, if desired, may carry 1 to 4 C₁-C₄-alkyl substituents and/or one phenyl or benzyl substituent, preferably di isopropylammonium, tetramethylammonium, tetrabutylammonium, trimethylbenzylammonium, furthermore phosphonium ions, sulfonium ions, preferably tri(C₁-C₄-alkyl)sulfonium, and sulfoxonium ions, preferably tri(C₁-C₄-alkyl)sulfoxonium. Anions of useful acid addition salts are primarily chloride, bromide, fluoride, hydrogensulfate, sulfate, dihydrogenphosphate, hydrogenphosphate, phosphate, nitrate, bicarbonate, carbonate, hexafluorosilicate, hexafluorophosphate, benzoate, and the anions of C₁-C₄-alkanoic acids, preferably formate, acetate, propionate and butyrate. They can be formed by reacting a compound I with an acid of the corresponding anion, preferably of hydrochloric acid, hydrobromic acid, sulfuric acid, phosphoric acid or nitric acid.

The scope of the present invention includes mixtures of the (R)- and (S)-isomers and the racemates of compounds I and/or II and/or III having one or more chiral centers. As a result of hindered rotation of asymmetrically substituted groups, atrope isomers of active compounds I and/or II and/or III may be present. They also form part of the subject matter of the invention.

Within compound II, the microbial pesticides of the groups L1, L3 and L5 embrace not only the isolated, pure cultures as defined herein, but also their cell-free extract having pesticidal activity, preferably a ketone-based extract, their suspension in a whole broth culture or as a metabolite-containing supernatant or a purified metabolite obtained from a whole broth culture of the microorganism or microorganism strain.

As used herein, “whole culture broth” refers to a liquid culture of a microorganism containing vegetative cells and/or spores suspended in the culture medium and optionally metabolites produced by the respective microorganism.

As used herein, “culture medium”, refers to a medium obtainable by culturing the microorganism in said medium, preferably a liquid broth, and remaining when cells grown in the medium are removed, e.g. the supernatant remaining when cells grown in a liquid broth are removed by centrifugation, filtration, sedimentation, or other means well known in the art; comprising e.g. metabolites produced by the respective microorganism and secreted into the culture medium. The “culture medium” sometimes also referred to as “supernatant” can be obtained e.g. by centrifugation at temperatures of about 2 to 30° C. (more preferably at temperatures of 4 to 20° C.) for about 10 to 60 min (more preferably about 15 to 30 min) at about 5,000 to 20,000×g (more preferably at about 15,000×g).

As used herein, “cell-free extract” refers to an extract of the vegetative cells, spores and/or the whole culture broth of a microorganism comprising cellular metabolites produced by the respective microorganism obtainable by cell disruption methods known in the art such as solvent-based (e.g. organic solvents such as alcohols sometimes in combination with suitable salts), temperature-based, application of shear forces, cell disruption with an ultrasonicator. The desired extract may be concentrated by conventional concentration techniques such as drying, evaporation, and centrifugation or alike. Certain washing steps using organic solvents and/or water-based media may also be applied to the crude extract preferably prior to use.

As used herein, the term “metabolite” refers to any component, compound, substance or byproduct (including but not limited to small molecule secondary metabolites, polyketides, fatty acid synthase products, non-ribosomal peptides, ribosomal peptides, proteins and enzymes) produced by a microorganism (such as fungi and bacteria, in particular the strains of the invention) that has any beneficial effect as described herein such as pesticidal activity or improvement of plant growth, water use efficiency of the plant, plant health, plant appearance, or the population of beneficial microorganisms in the soil around the plant activity herein.

As used herein, “isolate” refers to a pure microbial culture separated from its natural origin, such an isolate obtained by culturing a single microbial colony. An isolate is a pure culture derived from a heterogeneous, wild population of microorganisms.

As used herein, “strain” refers to isolate or a group of isolates exhibiting phenotypic and/or genotypic traits belonging to the same lineage, distinct from those of other isolates or strains of the same species.

The term “mutant” refers a microorganism obtained by direct mutant selection but also includes microorganisms that have been further mutagenized or otherwise manipulated (e.g. via the introduction of a plasmid). Accordingly, embodiments include mutants, variants, and or derivatives of the respective microorganism, both naturally occurring and artificially induced mutants. For example, mutants may be induced by subjecting the microorganism to known mutagens, such as X-ray, UV radiation or N-methyl-nitrosoguanidine, using conventional methods. Subsequent to said treatments a screening for mutant strains showing the desired characteristics may be performed.

Mutant strains may be obtained by any methods known in the art such as direct mutant selection, chemical mutagenesis or genetic manipulation (e.g., via the introduction of a plasmid). For example, such mutants are obtainable by applying a known mutagen, such as X-ray, UV radiation or N-methyl-nitrosoguanidine. Subsequent to said treatments a screening for mutant strains showing the desired characteristics may be performed.

In general, the term “nematode” comprises eggs, larvae, juvenile and mature forms of said organism. Thus, in one embodiment, said organisms are comprised in form of eggs, larvae, juvenile or mature form in a formulation, e.g., a solo- or combined-formulation.

According to one embodiment, compound II is a cell-free extract of a microbial pesticide. According to a further embodiment, compound II is a mutant of a microbial pesticide having pesticidal activity and producing at least one pesticidal metabolite. According to a further embodiment, the mutant of the microbial pesticide is obtained by direct mutant selection optionally after being subjected to mutagens. According to a further embodiment, the microbial pesticide is in a whole browth. According to a further embodiment, the microbial pesticide is in a dormant form. According to a further embodiment, the microbial pesticide is in the form of spores. According to a further embodiment, the microbial pesticide is in the form of condiospores or chlamydospores.

“Chlamydospores” are thick-walled big resting spore of several kinds of fungi. It is the life-stage which survives in unfavourable conditions, such as dry or hot seasons, which makes them being a stable and storable dormant life stage an especially suitable use form of a biopesticide. “Conidiospores” (also called conidia) are asexual spores that are generated through mitosis.

The microbial pesticides may be cultivated using media and fermentation techniques known in the art. In liquid culture, condiospores and chlamydospores can be produced. In large liquid cultures, aeriation may be necessary. The bacterial cells (vegatitive cells and spores) can be washed and concentrated (e.g. by centrifugation at room temperature for about 15 min at 7000× g). To produce a dry formulation, bacterial cells, preferably spores were suspended in a suitable dry carrier (e.g. clay). To produce a liquid formulation, cells, preferably spores, can be re-suspended in a suitable liquid carrier (e.g. water-based) to the desired spore density. The spore density number of spores per mL can be determined by identifying the number of colony-forming units (CFU) on agar medium e.g. potato dextrose agar after incubation for several days.

Regarding the Compounds I, the compound and preparation of DMPSA1 or DMPSA2 have been described for example in WO 2015/086823 A2. DMPSA1 is described in the formula I below, and DMPSA2 is described in formula II below. The compound and preparation of DMPG, DMPC, DMPL, and DMPM have been described for example in AU 2015/227487 B1. The compound and preparation of N-((3(5)-methyl-1H-pyrazole-1-yl)methyl)acetamide have been described for example in DE 102013022031 B3, The compound and preparation of N-((3(5)-methyl-1H-pyrazole-1-yl)methyl)formamide, N-((4-chloro-3(5)-methyl-pyrazole-1-yl)methyl)formamide, and N-((3(5),4-dimethylpyrazole-1-yl)methyl)formamide have been described for example in EP 2785697 B1. A reaction adduct of dicyandiamide, urea and formaldehyde, a triazonyl-formaldehyde-dicyandiamide adduct, 2-cyano-1-((4-oxo-1,3,5-triazinan-1-yl)methyl)guanidine, 1-((2-cyanoguanidino)methyl)urea, and 2-cyano-1-((2-cyanoguanidino)methyl)guanidine have been described in US 2016/0060184 A1. 2-cyano-1-((4-oxo-1,3,5-triazinan-1-yl)methyl)guanidine has the structure as described in formula III below, and 1-((2-cyanoguanidino)methyl)urea has the structure as described in formula IV below, and 2-cyano-1-((2-cyanoguanidino)methyl)guanidine has the structure as described in formula V below.

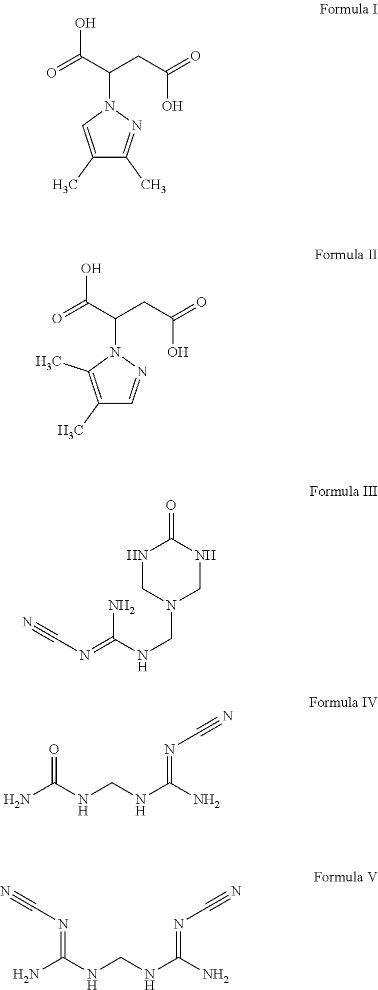

Compounds II (biopesticides from group L)), their preparation and their pesticidal activity e.g. against harmful fungi or insects are known (e-Pesticide Manual V 5.2 (ISBN 978 1 901396 85 0) (2008-2011); http://www.epa.gov/opp00001/biopesticides/, see product lists therein; http://www.omri.org/omri-lists, see lists therein; Bio-Pesticides Database BPDB http://sitem.herts.ac.uk/aeru/bpdb/, see A to Z link therein).

Compounds II, their preparation and their activity e. g. against harmful fungi is known (cf.: http://www.alanwood.net/pesticides/); these substances are commercially available. The compounds described by IUPAC nomenclature, their preparation and their pesticidal activity are also known (cf. Can. J. Plant Sci. 48(6), 587-94, 1968; EP-A 141 317; EP-A 152 031; EP-A 226 917; EP-A 243 970; EP-A 256 503; EP-A 428 941; EP-A 532 022; EP-A 1 028 125; EP-A 1 035 122; EP-A 1 201 648; EP-A 1 122 244, JP 2002316902; DE 19650197; DE 10021412; DE 102005009458; U.S. Pat. Nos. 3,296,272; 3,325,503; WO 98/46608; WO 99/14187; WO 99/24413; WO 99/27783; WO 00/29404; WO 00/46148; WO 00/65913; WO 01/54501; WO 01/56358; WO 02/22583; WO 02/40431; WO 03/10149; WO 03/11853; WO 03/14103; WO 03/16286; WO 03/53145; WO 03/61388; WO 03/66609; WO 03/74491; WO 04/49804; WO 04/83193; WO 05/120234; WO 05/123689; WO 05/123690; WO 05/63721; WO 05/87772; WO 05/87773; WO 06/15866; WO 06/87325; WO 06/87343; WO 07/82098; WO 07/90624, WO 10/139271, WO 11/028657, WO 12/168188, WO 07/006670, WO 11/77514; WO 13/047749, WO 10/069882, WO 13/047441, WO 03/16303, WO 09/90181, WO 13/007767, WO 13/010862, WO 13/127704, WO 13/024009, WO 13/24010, WO 13/047441, WO 13/162072, WO 13/092224, WO 11/135833, CN 1907024, CN 1456054, CN 103387541, CN 1309897, WO 12/84812, CN 1907024, WO 09094442, WO 14/60177, WO 13/116251, WO 08/013622, WO 15/65922, WO 94/01546, EP 2865265, WO 07/129454, WO 12/165511, WO 11/081174, WO 13/47441).

In one preferred embodiment, the present invention relates to mixtures comprising at least one active compound I, wherein the active compound I is 2-(3,4-dimethyl-1H-pyrazol-1-yl)succinic acid (DMPSA1) and/or 2-(4,5-dimethyl-1H-pyrazol-1-yl)succinic acid (DMPSA2), and/or a derivative thereof, and/or a salt thereof, more preferably DMPSA1 and/or DMPSA2, most preferably DMPSA1.

In another preferred embodiment, the present invention relates to mixtures comprising at least one active compound I, wherein the active compound I is a salt of DMPSA1 and/or DMPSA2, more preferably an alkali salt, an earth alkali salt, or an ammonium salt of DMPSA1 and/or DMPSA2, most preferably a potassium salt, sodium salt, magnesium salt, or an ammonium salt of DMPSA1 and/or DMPSA2, particularly a potassium salt of DMPSA1 and/or DMPSA2.

In another preferred embodiment, the present invention relates to mixtures comprising at least one active compound I, wherein the active compound I is an alkali salt of DMPSA1 and/or DMPSA2.

In another preferred embodiment, the present invention relates to mixtures comprising at least one active compound I, wherein the active compound I is an earth alkali salt of DMPSA1 and/or DMPSA2.

In another preferred embodiment, the present invention relates to mixtures comprising at least one active compound I, wherein the active compound I is an ammonium salt of DMPSA1 and/or DMPSA2.

In another preferred embodiment, the present invention relates to mixtures comprising at least one active compound I, wherein the active compound I is a sodium salt of DMPSA1 and/or DMPSA2.

In another preferred embodiment, the present invention relates to mixtures comprising at least one active compound I, wherein the active compound I is a magnesium salt of DMPSA1 and/or DMPSA2.

In another preferred embodiment, the present invention relates to mixtures comprising at least one active compound I, wherein the active compound I is the glycolic acid addition salt of 3,4-dimethyl pyrazole (3,4-dimethyl pyrazolium glycolate, referred to as “DMPG” in the following), and/or an isomer thereof, and/or a derivative thereof, most preferably DMPG.

In another preferred embodiment, the present invention relates to mixtures comprising at least one active compound I, wherein the active compound I is the citric acid addition salt of 3,4-dimethyl pyrazole (3,4-dimethyl pyrazolium citrate, referred to as “DMPC” in the following), and/or an isomer thereof, and/or a derivative thereof, most preferably DMPC.

In another preferred embodiment, the present invention relates to mixtures comprising at least one active compound I, wherein the active compound I is the lactic acid addition salt of 3,4-dimethyl pyrazole (3,4-dimethyl pyrazolium lactate, referred to as “DMPL” in the following), and/or an isomer thereof, and/or a derivative thereof, most preferably DMPL.

In another preferred embodiment, the present invention relates to mixtures comprising at least one active compound I, wherein the active compound I is the mandelic acid addition salt of 3,4-dimethyl pyrazole (3,4-dimethyl pyrazolium mandelate, referred to as “DMPM” in the following), and/or an isomer thereof, and/or a derivative thereof, most preferably DMPM.

In another preferred embodiment, the present invention relates to mixtures comprising at least one active compound I, wherein the active compound I is 1,2,4-triazole (referred to as “TZ” in the following), and/or a derivative thereof, and/or a salt thereof, most preferably TZ.

In another preferred embodiment, the present invention relates to mixtures comprising at least one active compound I, wherein the active compound I is 4-Chloro-3-methylpyrazole (referred to as “CIMP” in the following), and/or an isomer thereof, and/or a derivative thereof, and/or a salt thereof, most preferably CIMP.

In another preferred embodiment, the present invention relates to mixtures comprising at least one active compound I, wherein the active compound I is N-((3(5)-methyl-1H-pyrazole-1-yl)methyl)acetamide, and/or an isomer thereof, and/or a derivative thereof, and/or a salt thereof, most preferably N-((3-methyl-1H-pyrazole-1-yl)methyl)acetamide, and/or N-((5-methyl-1H-pyrazole-1-yl)methyl)acetamide.

In another preferred embodiment, the present invention relates to mixtures comprising at least one active compound I, wherein the active compound I is N-((3(5)-methyl-1H-pyrazole-1-yl)methyl)formamide, and/or an isomer thereof, and/or a derivative thereof, and/or a salt thereof, most preferably N-((3-methyl-1H-pyrazole-1-yl)methyl)formamide, and/or N-((5-methyl-1H-pyrazole-1-yl)methyl)formamide.

In another preferred embodiment, the present invention relates to mixtures comprising at least one active compound I, wherein the active compound I is N-((3(5),4-dimethylpyrazole-1-yl)methyl)formamide, and/or an isomer thereof, and/or a derivative thereof, and/or a salt thereof, most preferably N-((3,4-dimethyl-1H-pyrazole-1-yl)methyl)formamide, and/or N-((4,5-dimethyl-1H-pyrazole-1-yl)methyl)formamide.

In another preferred embodiment, the present invention relates to mixtures comprising at least one active compound I, wherein the active compound I is N-((4-chloro-3(5)-methyl-pyrazole-1-yl)methyl)formamide, and/or an isomer thereof, and/or a derivative thereof, and/or a salt thereof, most preferably N-((4-chloro-3-methyl-pyrazole-1-yl)methyl)formamide, and/or N-((4-chloro-5-methyl-pyrazole-1-yl)methyl)formamide.

In another preferred embodiment, the present invention relates to mixtures comprising at least one active compound I, wherein the active compound I is a reaction adduct of dicyandiamide, urea and formaldehyde, preferably a reaction adduct of dicyandiamide, urea and formaldehyde as described in US 2016/0060184 A1.

In another preferred embodiment, the present invention relates to mixtures comprising at least one active compound I, wherein the active compound I is a triazonyl-formaldehyde-dicyandiamide adducte, preferably a triazonyl-formaldehyde-dicyandiamide adduct as described in US 2016/0060184 A1.

In another preferred embodiment, the present invention relates to mixtures comprising at least one active compound I, wherein the active compound I is 2-cyano-1-((4-oxo-1,3,5-triazinan-1-yl)methyl)guanidine.

In another preferred embodiment, the present invention relates to mixtures comprising at least one active compound I, wherein the active compound I is 1-((2-cyanoguanidino)methyl)urea.

Particularly preferred are mixtures wherein compound I is selected from the group consisting of compounds I.A to I.AU:
I.A: 2-(3,4-dimethyl-1H-pyrazol-1-yl)succinic acid (DMPSA1) and/or 2-(4,5-dimethyl-1H-pyrazol-1-yl)succinic acid (DMPSA2),
I.B: a salt of DMPSA1 and/or DMPSA2,
I.C: a potassium salt of DMPSA1 and/or DMPSA2,
I.D: an ammonium salt of DMPSA1 and/or DMPSA2,
I.E a sodium salt of DMPSA1 and/or DMPSA2,
I.F: 3,4-dimethyl pyrazolium glycolate (DMPG),
I.G: 3,4-dimethyl pyrazolium citrate (DMPC),
I.H: 3,4-dimethyl pyrazolium lactate (DMPL),
I.J: 3,4-dimethyl pyrazolium lactate (DMPM),
I.K: 1,2,4-triazole (TZ),
I.L: 4-Chloro-3-methylpyrazole (CIMP),
I.M N-((3(5)-methyl-1H-pyrazole-1-yl)methyl)acetamide,
I.N N-((3(5)-methyl-1H-pyrazole-1-yl)methyl)formamide,
I.O N-((3(5),4-dimethyl pyrazole-1-yl)methyl)formamide,
I.P N-((4-chloro-3(5)-methyl-pyrazole-1-yl)methyl)formamide,
I.Q reaction adduct of dicyandiamide, urea and formaldehyde, or a triazonyl-formaldehyde-dicyandiamide adduct
I.R 2-cyano-14(4-oxo-1,3,5-triazinan-1-yl)methyl)guanidine,
I.S 1-((2-cyanoguanidino)methyl)urea,
I.T 2-cyano-1-((2-cyanoguanidino)methyl)guanidine,
I.U 2-chloro-6-(trichloromethyl)-pyridine (nitrapyrin or N-serve),
I.V dicyandiamide (DCD, DIDIN),
I.W 3,4-dimethyl pyrazole phosphate, and/or 4,5-dimethyl pyrazole phosphate (DMPP, ENTEC), and/or an isomer thereof, and/or a derivative thereof,
I.X 3,4-dimethylpyrazole, and/or 4,5-dimethylpyrazole (DMP), and/or an isomer thereof, and/or a derivative thereof, and/or a salt thereof, and/or an acid addition salt thereof,
I.Y ammoniumthiosulfate (ATU),
I.Z neem,
I.AA linoleic acid,
I.AB alpha-linolenic acid,
I.AC methyl p-coumarate,
I.AD methyl ferulate,
I.AE methyl 3-(4-hydroxyphenyl) propionate (MHPP),
I.AF brachialacton,
I.AG p-benzoquinone sorgoleone,
I.AH 4-amino-1,2,4-triazole hydrochloride (ATC),
I.AI 1-amido-2-thiourea (ASU),
I.AJ 2-amino-4-chloro-6-methylpyrimidine (AM),
I.AK 2-mercapto-benzothiazole (MBT),
I.AL 5-ethoxy-3-trichloromethyl-1,2,4-thiodiazole (terrazole, etridiazole),
I.AM 2-sulfanilamidothiazole (ST),
I.AN 3-methylpyrazol (3-MP),
I.AO 1,2,4-triazol thiourea (TU),
I.AP cyan amide,
I.AQ melamine,
I.AR zeolite powder,
I.AS catechol,
I.AT benzoquinone,
I.AU sodium tetra borate,
I.AV allylthiourea,
I.AW chlorate salts, or
I.AX zinc sulfate.

In one aspect of the invention, compound I is selected from the group of compounds consisting of I.A, I.B, I.C, I.D, I.E, I.L, I.M, I.N, I.O, I.P, I.Q, I.R, I.S., I.T, I.U, I.V, I.W, I.X, I.Y, I.Z, I.AA, I.AB, I.AC, I.AD, I.AE, I.AF, I.AG, I.AH, I.AI, I.AJ, I.AK, I.AL, I.AM, I.AN, I.AO, I.AP, I.AQ, I.AR, I.AS, I.AT, I.AU, I.AV, I.AW, or I.AX, more preferably selected from the group of compounds consisting of I.A, I.B, I.C, I.D, I.E, I.L, I.M, I.N, I.O, I.P, I.Q, I.R, I.S., I.T, I.U, I.V, I.W, I.X, I.Y, I.AX, most preferably selected from the group of compounds consisting of I.A, I.B, I.C, I.D, I.E, I.L, I.M, I.N, I.O, I.P, I.Q, I.R, I.S.

With respect to their intended use in the methods of the present invention, the following binary mixtures (A) listed in tables 1 to 49 comprising one compound (I) and one compound (II) are a preferred embodiment of the present invention.

TABLE 1

| A | I | II |
|---|---|---|
| A1 | (I.A) | Ampelomyces quisqualis |
| A2 | (I.A) | Aspergillus flavus |
| A3 | (I.A) | Aureobasidium pullulans |
| A4 | (I.A) | Bacillus altitudinis |
| A5 | (I.A) | Bacillus amyloliquefaciens |
| A6 | (I.A) | Bacillus licheniformis |
| A7 | (I.A) | Bacillus megaterium |
| A8 | (I.A) | Bacillus mojavensis |
| A9 | (I.A) | Bacillus mycoides |
| A10 | (I.A) | Bacillus pumilus |
| A11 | (I.A) | Bacillus simplex |
| A12 | (I.A) | Bacillus solisalsi |
| A13 | (I.A) | Bacillus subtitis |
| A14 | (I.A) | Bacillus subtitis var. amyloliquefaciens |
| A15 | (I.A) | Candida oleophila |
| A16 | (I.A) | Candida saitoana |
| A17 | (I.A) | Clavibacter michiganensis |
| A18 | (I.A) | Coniothyrium minitans |
| A19 | (I.A) | Cryphonectria parasitica |
| A20 | (I.A) | Cryptococcus albidus |
| A21 | (I.A) | Dilophosphora alopecuri |
| A22 | (I.A) | Fusarium oxysporum |
| A23 | (I.A) | Clonostachys rosea f. catenulata |
| A24 | (I.A) | Gliocladium roseum |
| A25 | (I.A) | Lysobacter antibioticus |
| A26 | (I.A) | Lysobacter enzymogenes |
| A27 | (I.A) | Metschnikowia fructicola |
| A28 | (I.A) | Microdochium dimerum |
| A29 | (I.A) | Microsphaeropsis ochracea |
| A30 | (I.A) | Muscodor albus |
| A31 | (I.A) | Paenibacillus alvei |
| A32 | (I.A) | Paenibacillus epiphyticus |
| A33 | (I.A) | Paenibacillus polymyxa |
| A34 | (I.A) | Paenibacillus agglomerans |
| A35 | (I.A) | Pantoea vagans |
| A36 | (I.A) | Penicillium bilaiae |
| A37 | (I.A) | Phlebiopsis gigantea |
| A38 | (I.A) | Pseudomonas chlororaphis |
| A39 | (I.A) | Pseudomonas fluorescens |
| A40 | (I.A) | Pseudomonas putida |
| A41 | (I.A) | Pseudozyma flocculosa |
| A42 | (I.A) | Pichia anomala |
| A43 | (I.A) | Pythium oligandrum |
| A44 | (I.A) | Sphaerodes mycoparasitica |
| A45 | (I.A) | Streptomyces griseoviridis |
| A46 | (I.A) | Streptomyces lydicus |
| A47 | (I.A) | Streptomyces violaceusniger |
| A48 | (I.A) | Talaromyces flavus |
| A49 | (I.A) | Trichoderma asperellum |
| A50 | (I.A) | Trichoderma asperelloides |
| A51 | (I.A) | Trichoderma atroviride |
| A52 | (I.A) | Trichoderma fertile |
| A53 | (I.A) | Trichoderma gamsii |
| A54 | (I.A) | Trichoderma harmatum |
| A55 | (I.A) | Trichoderma harzianum |
| A56 | (I.A) | Trichoderma polysporum |
| A57 | (I.A) | Trichoderma stromaticum |
| A58 | (I.A) | Trichoderma virens (=Gliocladium virens) |
| A59 | (I.A) | Trichoderma viride |
| A60 | (I.A) | Typhula phacorrhiza |
| A61 | (I.A) | Ulocladium oudemansii |
| A62 | (I.A) | Verticillium dahlia |
| A63 | (I.A) | zucchini yellow mosaic virus (avirulent strain) |
| A64 | (I.A) | chitosan (hydrolysate) |
| A65 | (I.A) | fusaricidins |
| A66 | (I.A) | paeniserines |
| A67 | (I.A) | paeniprolixines |
| A68 | (I.A) | harpin protein |
| A69 | (I.A) | laminarin |
| A70 | (I.A) | Menhaden fish oil |
| A71 | (I.A) | natamycin |
| A72 | (I.A) | Plum pox virus coat protein |
| A73 | (I.A) | potassium or sodium bicarbonate |
| A74 | (I.A) | Reynoutria sachalinensis extract |
| A75 | (I.A) | salicylic acid |
| A76 | (I.A) | tea tree oil (Melaleuca alternifolia extract) |
| A77 | (I.A) | Agrobacterium radiobacter |
| A78 | (I.A) | Bacillus cereus |
| A79 | (I.A) | Bacillus firmus |
| A80 | (I.A) | Bacillus subtilis |
| A81 | (I.A) | Bacillus licheniformis |
| A82 | (I.A) | Bacillus thuringiensis |
| A83 | (I.A) | Bacillus thuringiensis ssp. aizawai |
| A84 | (I.A) | Bacillus thuringiensis ssp. israelensis |
| A85 | (I.A) | Bacillus thuringiensis ssp. galleriae |
| A86 | (I.A) | Bacillus thuringiensis ssp. kurstaki |
| A87 | (I.A) | Bacillus thuringiensis ssp. tenebrionis |
| A88 | (I.A) | Beauveria bassiana |
| A89 | (I.A) | Beauveria brongniartii |
| A90 | (I.A) | Burkholderia rinojensis |
| A91 | (I.A) | Chromobacterium subtsugae |
| A92 | (I.A) | Cydia pomonella granulovirus (CpGV) |
| A93 | (I.A) | Cryptophlebia leucotreta granulovirus (CrleGV) |
| A94 | (I.A) | Flavobacterium spp. |
| A95 | (I.A) | Helicoverpa armigera nucleopolyhedrovirus (HearNPV) |
| A96 | (I.A) | Heterorhabditis bacteriophora |
| A97 | (I.A) | Isaria fumosorosea |
| A98 | (I.A) | Lecanicillium longisporum |
| A99 | (I.A) | Lecanicillium muscarium |
| A100 | (I.A) | Metarhizium anisopliae |
| A101 | (I.A) | Metarhizium anisopliae var. anisopliae |
| A102 | (I.A) | Metarhizium anisopliae var. acridum |
| A103 | (I.A) | Nomuraea rileyi |
| A104 | (I.A) | Paecilomyces lilacinus |
| A105 | (I.A) | Paenibacillus popilliae |
| A106 | (I.A) | Pasteuria nishizawae |
| A107 | (I.A) | Pasteuria penetrans |
| A108 | (I.A) | Pasteuria ramosa |
| A109 | (I.A) | Pasteuria thornea |
| A110 | (I.A) | Pasteuria usgae |
| A111 | (I.A) | Pseudomonas fluorescens |
| A112 | (I.A) | Spodoptera littoralis nucleopolyhedrovirus (SpliNPV) |
| A113 | (I.A) | Steinernema carpocapsae |
| A114 | (I.A) | Steinernema feltiae |
| A115 | (I.A) | Steinernema kraussei |
| A116 | (I.A) | Steinernema riobrave |
| A117 | (I.A) | Streptomyces galbus |
| A118 | (I.A) | Streptomyces microflavus |
| A119 | (I.A) | L-carvone |
| A120 | (I.A) | citral |
| A121 | (I.A) | (E,Z)-7,9-dodecadien-1-yl acetate |
| A122 | (I.A) | ethyl formate |
| A123 | (I.A) | (E,Z)-2,4-ethyl decadienoate (pear ester) |
| A124 | (I.A) | (Z,Z,E)-7,11,13-hexadecatrienal |
| A125 | (I.A) | heptyl butyrate |
| A126 | (I.A) | isopropyl myristate |
| A127 | (I.A) | lavanulyl senecioate |
| A128 | (I.A) | cis-jasmone |
| A129 | (I.A) | 2-methyl 1-butanol |
| A130 | (I.A) | methyl eugenol |
| A131 | (I.A) | methyl jasmonate |
| A132 | (I.A) | (E,Z)-2,13-octadecadien-1-ol |
| A133 | (I.A) | (E,Z)-2,13-octadecadien-1-ol acetate |
| A134 | (I.A) | (E,Z)-3,13-octadecadien-1-ol |
| A135 | (I.A) | R-1-octen-3-ol |
| A136 | (I.A) | pentatermanone |
| A137 | (I.A) | potassium silicate |
| A138 | (I.A) | sorbitol actanoate |
| A139 | (I.A) | (E,Z,Z)-3,8,11-tetradecatrienyl acetate |
| A140 | (I.A) | (Z,E)-9,12-tetradecadien-1-yl acetate |
| A141 | (I.A) | Z-7-tetradecen-2-one |
| A142 | (I.A) | Z-9-tetradecen-1-yl acetate |
| A143 | (I.A) | Z-11-tetradecenal |
| A144 | (I.A) | Z-11-tetradecen-1-ol |
| A145 | (I.A) | Acacia negra extract |
| A146 | (I.A) | extract of grapefruit seeds and pulp |
| A147 | (I.A) | Chenopodium ambrosioides extract |
| A148 | (I.A) | Catnip oil |
| A149 | (I.A) | Neem oil |
| A150 | (I.A) | Quillay extract |
| A151 | (I.A) | Tagetes oil |
| A152 | (I.A) | Azospirilium amazonense |
| A153 | (I.A) | Azospirillum brasilense |
| A154 | (I.A) | Azospirilium lipoferum |
| A155 | (I.A) | Azospirillum irakense |
| A156 | (I.A) | Azospirilium halopraeferens |
| A157 | (I.A) | Bradyrhizobium elkanii |
| A158 | (I.A) | Bradyrhizobium japonicum |
| A159 | (I.A) | Bradyrhizobium liaoningense |
| A160 | (I.A) | Bradyrhizobium lupini |
| A161 | (I.A) | Bradyrhizobium arachis |
| A162 | (I.A) | Delftia acidovorans |
| A163 | (I.A) | Glomus intraradices |
| A164 | (I.A) | Mesorhizobium spp. |
| A165 | (I.A) | Rhizobium leguminosarum bv. phaseoli |
| A166 | (I.A) | Rhizobium leguminosarum bv. trifolii |
| A167 | (I.A) | Rhizobium leguminosarum bv. viciae |
| A168 | (I.A) | Rhizobium tropici |
| A169 | (I.A) | Sinorhizobium meliloti |
| A170 | (I.A) | Sinorhizobium medicae |
| A171 | (I.A) | abscisic acid |
| A172 | (I.A) | aluminium silicate (kaolin) |
| A173 | (I.A) | 3-decen-2-one |
| A174 | (I.A) | formononectin |
| A175 | (I.A) | genistein |
| A176 | (I.A) | hesperetin |
| A177 | (I.A) | homobrassinolide |
| A178 | (I.A) | humates |
| A179 | (I.A) | lysophosphatidyl ethanlamine |
| A180 | (I.A) | naringenin |
| A181 | (I.A) | polymeric polyhydroxy acid |
| A182 | (I.A) | salicylic acid |
| A183 | (I.A) | Ascophyllum nodosum (Norwegian kelp, Brown kelp) |
| | | extract and Ecklonia maxima (kelp) extract |
| A184 | (I.A) | zeolite (aluminosilicate) |
| A185 | (I.A) | Paecilomyces lilacinus |
| A186 | (I.A) | Phasmarhabditis hermaphrodita |
| A187 | (I.A) | Mesorhizobium ciceri |
| A188 | (I.A) | Grape seed extract |

A = Mixture;
I = compound I;
II = compound II

Table 2: The binary mixtures A189 to A376 correspond to the mixtures A1 to A188, wherein compound I.A is replaced by compound I.B.

Table 3: The binary mixtures A 377 to A 564 correspond to the mixtures A1 to A188, wherein compound I.A is replaced by compound I.C.

Table 4: The binary mixtures A565 to A752 correspond to the mixtures A1 to A188, wherein compound I.A is replaced by compound I.D.

Table 5: The binary mixtures A753 to A940 correspond to the mixtures A1 to A188, wherein compound I.A is replaced by compound I.E.

Table 6: The binary mixtures A941 to A1128 correspond to the mixtures A1 to A188, compound I.A is replaced by compound I.F.

Table 7: The binary mixtures A1129 to A1316 correspond to the mixtures A1 to A188, wherein compound I.A is replaced by compound I.G.

Table 8: The binary mixtures A1317 to A1504 correspond to the mixtures A1 to A188, wherein compound I.A is replaced by compound I.H.

Table 9: The binary mixtures A1505 to A1692 correspond to the mixtures A1 to A188, wherein compound I.A is replaced by compound I.J.

Table 10: The binary mixtures A1693 to A1880 correspond to the mixtures A1 to A188, wherein compound I.A is replaced by compound I.K.

Table 11: The binary mixtures A1881 to A2068 correspond to the mixtures A1 to A188, wherein compound I.A is replaced by compound I.L.

Table 12: The binary mixtures A2069 to A2256 correspond to the mixtures A1 to A188, wherein compound I.A is replaced by compound I.M.

Table 13: The binary mixtures A2257 to A2444 correspond to the mixtures A1 to A188, wherein compound I.A is replaced by compound I.N.

Table 14: The binary mixtures A2445 to A2632 correspond to the mixtures A1 to A188, wherein compound I.A is replaced by compound I.O.

Table 15: The binary mixtures A2633 to A2820 correspond to the mixtures A1 to A188, wherein compound I.A is replaced by compound I.P.

Table 16: The binary mixtures A2821 to A3008 correspond to the mixtures A1 to A188, wherein compound I.A is replaced by compound I.Q.

Table 17: The binary mixtures A3009 to A3196 correspond to the mixtures A1 to A188, wherein compound I.A is replaced by compound I.R.

Table 18: The binary mixtures A3197 to A3384 correspond to the mixtures A1 to A188, wherein compound I.A is replaced by compound I.S.

Table 19: The binary mixtures A3385 to A3572 correspond to the mixtures A1 to A188, wherein compound I.A is replaced by compound I.T.

Table 20: The binary mixtures A3573 to A3760 correspond to the mixtures A1 to A188, wherein compound I.A is replaced by compound I.U.

Table 21: The binary mixtures A3761 to A3948 correspond to the mixtures A1 to A188, wherein compound I.A is replaced by compound I.V.

Table 22: The binary mixtures A3949 to A4136 correspond to the mixtures A1 to A188, wherein compound I.A is replaced by compound I.W.

Table 23: The binary mixtures A4137 to A4324 correspond to the mixtures A1 to A188, wherein compound I.A is replaced by compound I.X.

Table 24: The binary mixtures A4325 to A4512 correspond to the mixtures A1 to A188, wherein compound I.A is replaced by compound I.Y.

Table 25: The binary mixtures A4513 to A4700 correspond to the mixtures A1 to A188, wherein compound I.A is replaced by compound I.Z.

Table 26: The binary mixtures A4701 to A4888 correspond to the mixtures A1 to A188, wherein compound I.A is replaced by compound I.AA.

Table 27: The binary mixtures A4889 to A5076 correspond to the mixtures A1 to A188, wherein compound I.A is replaced by compound I.AB.

Table 28: The binary mixtures A5077 to A5264 correspond to the mixtures A1 to A188, wherein compound I.A is replaced by compound I.AC.

Table 29: The binary mixtures A5265 to A5452 correspond to the mixtures A1 to A188, wherein compound I.A is replaced by compound I.AD.

Table 30: The binary mixtures A5453 to A5640 correspond to the mixtures A1 to A188, wherein compound I.A is replaced by compound I.AE.

Table 31: The binary mixtures A5641 to A5828 correspond to the mixtures A1 to A188, wherein compound I.A is replaced by compound I.AF.

Table 32: The binary mixtures A5829 to A6016 correspond to the mixtures A1 to A188, wherein compound I.A is replaced by compound I.AG.

Table 33: The binary mixtures A6017 to A6204 correspond to the mixtures A1 to A188, wherein compound I.A is replaced by compound I.AH.

Table 34: The binary mixtures A6205 to A6392 correspond to the mixtures A1 to A188, wherein compound I.A is replaced by compound I.AI.

Table 35: The binary mixtures A6393 to A6580 correspond to the mixtures A1 to A188, wherein compound I.A is replaced by compound I.AJ.

Table 36: The binary mixtures A6581 to A6768 correspond to the mixtures A1 to A188, wherein compound I.A is replaced by compound I.AK.

Table 37: The binary mixtures A6769 to A6956 correspond to the mixtures A1 to A188, wherein compound I.A is replaced by compound I.AL.

Table 38: The binary mixtures A6957 to A7144 correspond to the mixtures A1 to A188, wherein compound I.A is replaced by compound I.AM.

Table 39: The binary mixtures A7145 to A7332 correspond to the mixtures A1 to A188, wherein compound I.A is replaced by compound I.AN.

Table 40: The binary mixtures A7333 to A7520 correspond to the mixtures A1 to A188, wherein compound I.A is replaced by compound I.AO.

Table 41: The binary mixtures A7521 to A7708 correspond to the mixtures A1 to A188, wherein compound I.A is replaced by compound I.AP.

Table 42: The binary mixtures A7709 to A7896 correspond to the mixtures A1 to A188, wherein compound I.A is replaced by compound I.AQ.

Table 43: The binary mixtures A7897 to A8084 correspond to the mixtures A1 to A188, wherein compound I.A is replaced by compound I.AR.

Table 44: The binary mixtures A8085 to A8272 correspond to the mixtures A1 to A188, wherein compound I.A is replaced by compound I.AS.

Table 45: The binary mixtures A8273 to A8460 correspond to the mixtures A1 to A188, wherein compound I.A is replaced by compound I.AT.

Table 46: The binary mixtures A8461 to A8648 correspond to the mixtures A1 to A188, wherein compound I.A is replaced by compound I.AU.

Table 47: The binary mixtures A8649 to A8836 correspond to the mixtures A1 to A188, wherein compound I.A is replaced by compound I.AV.

Table 48: The binary mixtures A8837 to A9024 correspond to the mixtures A1 to A188, wherein compound I.A is replaced by compound I.AW.

Table 49: The binary mixtures A9025 to A9212 correspond to the mixtures A1 to A188, wherein compound I.A is replaced by compound I.AX.

Within the mixtures of tables 1 to 49 the mixtures comprising Ampelomyces quisqualis, Aspergillus flavus, Azospirillum brasilense, Bacillus subtilis, Bacillus subtilis var. amyloliquefaciens, Bacillus amyloliquefaciens, Bacillus pumilus, Bacillus simplex, Beauveria bassiana, Bradyrhizobium lupini, Bradyrhizobium arachis, Burkholderia rinojensis, Candida oleophila, Candida saitoana, Chenopodium ambrosioides extract, chitosan (hydrolysate), Chromobacterium subtsugae, Clonostachys rosea f. catenulata, Coniothyrium minitans, Cryptococcus albidus, a fusaricidin, a paeniserine, a paeniprolixine, Fusarium oxysporum, Heterorhabditis bacteriophora, Mesorhizobium ciceri, Metschnikowia fructicola, Microdochium dimerum, Penicillium bilaiae, Phasmarhabditis hermaphrodita, Phlebiopsis gigantea, Pseudozyma flocculosa, Pseudomonas chlororaphis, Pythium oligandrum, Reynoutria sachalinensis extract, Rhizobium leguminosarum, Rhizobium tropici, Sinorhizobium meliloti, Sinorhizobium medicae, Steinernema carpocapsae, Steinernema kraussei, Steinernema feltiae, Steinernema riobrave, Streptomyces lydicus, Talaromyces flavus, Trichoderma asperellum, Trichoderma asperelloides, Trichoderma atroviride, Trichoderma harzianum, Trichoderma polysporum, Trichoderma vixens, Trichoderma viride, Trichoderma stromaticum, Ulocladium oudemansii, zeolite (aluminosilicate), grape seed extract, Bacillus firmus, Harpin protein, Neem oil, cis-jasmone, methyl jasmonate, Bradyrhizobium japonicum, Bradyrhizobium elkanii; Paecilomyces lilacinus, Pasteuria nishizawae, Metarhizium anisopliae, Paenibacillus alvei, Paenibacillus polymyxa or Paenibacillus epiphyticus are especially preferred mixtures according to the invention.

In one embodiment, the mixture according to the invention comprises at least one compound II (biopesticide) selected from the group consisting of Bacillus amyloliquefaciens, Bacillus firmus, Bacillus pumilus, Bacillus subtilis, Bacillus licheniformis, Paenibacillus polymyxa, Paenibacillus epiphyticus, Pasteuria nishizawae, Penicillium bilaiae fusaricidins and cis-jasmone.

In one embodiment, the mixture according to the invention comprises a strain of Bacillus amyloliquefaciens as compound II.

In one embodiment, the mixture according to the invention comprises a strain of Bacillus firmus as compound II.

In one embodiment, the mixture according to the invention comprises a strain of Bacillus pumilus as compound II.

In one embodiment, the mixture according to the invention comprises a strain of Bacillus subtilis as compound II.

In one embodiment, the mixture according to the invention comprises a strain of Bacillus licheniformis as compound II.

In one embodiment, the mixture according to the invention comprises a strain of Paenibacillus polymyxa as compound II.

In one embodiment, the mixture according to the invention comprises a strain of Paenibacillus epiphyticus as compound II.

In one embodiment, the mixture according to the invention comprises a strain of Pasteuria nishizawae as compound II.

In one embodiment, the mixture according to the invention comprises a strain of Penicillium bilaiae as compound II.

In one embodiment, the mixture according to the invention comprises a fusaricidin as compound II.

In one embodiment, the mixture according to the invention comprises cis-jasmone as compound II.

In one embodiment, the mixture according to the invention comprises at least one compound II (biopesticide) selected from the groups L1) to L6):

L1) Microbial pesticides with fungicidal, bactericidal, viricidal and/or plant defense activator activity: Ampelomyces quisqualis M-10 (L.1.1), Aspergillus flavus NRRL 21882 (L.1.2), Aureobasidium pullulans DSM 14940 (L1.3), Aureobasidium pullulans DSM 14941 (L.1.4), Bacillus altitudinis 41 KF2b (L.1.5), Bacillus amyloliquefaciens AP-136 (L.1.6), Bacillus amyloliquefaciens AP-188 (L.1.7), Bacillus amyloliquefaciens AP-218 (L.1.8), Bacillus amyloliquefaciens AP-219 (L.1.9), Bacillus amyloliquefaciens AP-295 (L.1.10), Bacillus amyloliquefaciensIN937a (L.1.11), Bacillus amyloliquefaciens IT-45 (L.1.12), Bacillus amyloliquefaciens ssp. plantarum D747 (L.1.13), Bacillus amyloliquefaciens ssp. plantarum FZB24 (L.1.14), Bacillus amyloliquefaciens ssp. plantarum FZB42 (L.1.15), Bacillus amyloliquefaciens ssp. plantarum GB03 (=Bacillus subtilis GB03) (L.1.16), Bacillus amyloliquefaciens ssp. plantarum MBI600 (NRRL B-50595) (L.1.17), Bacillus amyloliquefaciens ssp. plantarum QST-713 (L.1.18), Bacillus amyloliquefaciens ssp. plantarum TJ 1000 (L.1.19), Bacillus mojavensis AP-209 (L.1.20), Bacillus mycoides AQ726 (L.1.21), Bacillus mycoides strain J (L.1.22), Bacillus pumilus INR-7 (L.1.23), B. pumilus KFP9F (L.1.24), Bacillus pumilus QST 2808 (L.1.25), Bacillus pumilus GHA 180 (L.1.26), Bacillus solisalsi AP-217 (L.1.28), Bacillus subtilis CX-9060 (L.1.29), Bacillus subtilis FB17 (L.1.30), Bacillus subtilis GB07 (L.1.31), Candida oleophila I-82 (L.1.32), Candida oleophila O (L.1.33), Candida saitoana (L.1.34), Clavibacter michiganensis (bacteriophages) (L.1.35), Coniothyrium minitans CON/M/91-08 (L.1.36), Cryphonectria parasitica (L.1.37), Cryptococcus albidus (L.1.38), Dilophosphora alopecuri (L.1.39), Fusarium oxysporum (L.1.40), Clonostachys rosea f. catenulata J1446 (L.1.41), Gliocladium roseum 321U (L.1.42), Metschnikowia fructicola NRRL Y-30752 (L.1.43), Microdochium dimerum (L.1.44), Microsphaeropsis ochracea P130A (L.1.45), Muscodor albus QST 20799 (L.1.46), Muscodor albus SA-13 (L.1.47), Paenibacillus alvei NAS6G6 (L.1.48), Paenibacillus polymyxa PKB1 (L.1.49), Pantoea agglomerans E325 (L.1.90), Pantoea vagans C9-1 (L.1.50), Penicillium bilaiae ATCC 22348 (L.1.51), P. bilaiae ATCC 20851 (L.1.52), Penicillium bilaiae ATCC 18309 (L.1.53), Phlebiopsis gigantea (L.1.54), Pichia anomala WRL-76 (L.1.55), Pseudomonas sp. Proradix (L.1.56), Pseudomonas chlororaphis MA 342 (L.1.57), P. fluorescens A506 (L.1.58), P. fluorescens CL 145A (L.1.91), P. fluorescens NCIB 12089 (L.1.92), P. fluorescens Pf-5 (L.1.93), P. fluorescens WCS 374 (L.1.94), P. fluorescens ATCC 13525 (L.1.95), P. fluorescens CHAO (L.1.96), P. putida ATCC 202153 (L.1.97), Pseudozyma flocculosa PF-A22 UL (L.1.59), Pythium oligandrum DV 74 (L.1.60), Sphaerodes mycoparasitica SMCD2220 (L.1.61), Streptomyces griseoviridis K61 (L.1.62), Streptomyces lydicus WYEC 108 (L.1.63), Streptomyces violaceusniger XL-2 (L.1.64), Streptomyces violaceusniger YCED-9 (L.1.65), Talaromyces flavus V117b (L.1.66), Trichoderma asperellum T34 (L.1.67), Trichoderma asperellum SKT-1 (L.1.68), Trichoderma asperellum ICC 012 (L.1.69), Trichoderma atroviride LC52 (L.1.70), Trichoderma atroviride CNCM I-1237 (L.1.71), Trichoderma asperelloides JM41R (=Trichoderma fertile) (L.1.72), Trichoderma gamsii ICC 080 (L.1.73), Trichoderma harmatum TH 382 (L.1.74), Trichoderma harzianum T-35 (L.1.75), Trichoderma harzianum T-22 (L.1.76), Trichoderma harzianum T-39 (L.1.77); mixture of Trichoderma harzianum ICC012 and Trichoderma viride ICC080 (L.1.78); Trichoderma polysporum (L.1.79); Trichoderma stromaticum (L.1.80), Trichoderma virens GI-3 (L.1.81), Trichoderma virens G-41 (L.1.82), Trichoderma virens GL-21 (=Gliocladium virens GL-21) (L.1.83), Trichoderma virens G-41 (L.1.84), Trichoderma viride TV1 (L.1.85), Typhula phacorrhiza 94671 (L.1.86), Ulocladium oudemansii HRU3 (L.1.87), Verticillium dahlia (L.1.88), zucchini yellow mosaic virus (avirulent strain) (L.1.89), Bacillus licheniformis SB3086 (L.1.90), Paenibacillus polymyxa Lu16774 (L.1.91), Paenibacillus polymyxa Lu17007 (L.1.92), Paenibacillus epiphyticus Lu17015 (L.1.93), Paenibacillus sp. NRRL B-50972 (L.1.94), Paenibacillus sp. strain NRRL B-67129 (L.1.95), Bacillus pumilus strain GB34 (L.1.96);

L2) Biochemical pesticides with fungicidal, bactericidal, viricidal and/or plant defense activator activity: chitosan (hydrolysate) (L.2.1), harpin protein (L.2.2), laminarin (L.2.3), Menhaden fish oil (L.2.4), natamycin (L.2.5), Plum pox virus coat protein (L.2.6), potassium bicarbonate (L.2.7), Reynoutria sachalinensis extract (L.2.8), salicylic acid (L.2.9), potassium or sodium bicarbonate (L.2.10), tea tree oil (Melaleuca alternifolia extract) (L.2.11), fusaricidin A (L.2.12), fusaricidin B (L.2.13), fusaricidin C (L.2.14), fusaricidin D (L.2.15), fusaricidin LI F03 (L.2.16), fusaricidin LI F04 (L.2.17), fusaricidin LI-F05 (L.2.18), fusaricidin LI-F06 (L.2.18), fusaricidin LI-F07 (L.2.19), fusaricidin LI-F08 (L.2.20), fusaricidin 1A (L.2.21), fusaricidin 1B (L.2.22), paeniserine A (L.2.23), paeniserine B (L.2.24) paeniserine C (L.2.25), paeniserine D (L.2.26) paeniprolixine A (L.2.27), paeniprolixine B (L.2.28), paeniprolixine C (L.2.29), paeniprolixine D (L.2.30), paeniprolixine E (L.2.31), paeniprolixine F (L.2.32), paeniprolixine G (L.2.33);
L3) Microbial pesticides with insecticidal, acaricidal, molluscidal and/or nematicidal activity: Agrobacterium radiobacter K1026 (L.3.1), A. radiobacterK84 (L.3.2), Bacillus firmus I-1582 (L.3.3); B. thuringiensis ssp. aizawai strains: ABTS-1857 (L.3.4), SAN 4011 (L.3.5), ABG-6305 (L.3.6) and ABG-6346 (L.3.7); B. t. ssp. israelensis AM65-52 (L.3.8), B. t. ssp. Israelensis SUM-6218 (L.3.9), B. t. ssp. galleriae SDS-502 (L.3.10), B. t. ssp. kurstaki EG2348 (L.3.11), B. t. ssp. kurstaki SB4 (L.3.12), B. t. ssp. kurstaki ABTS-351 (HD-1) (L.3.13), Beauveria bassiana ATCC 74040 (L.3.14), Beauveria bassiana GHA (L.3.15), Beauveria bassiana H123 (L.3.16), Beauveria bassiana DSM 12256 (L.3.17), Beauveria bassiana PPRI 5339 (L.3.18), B. brongniartii (L.3.19), Burkholderia rinojensis A396 (L.3.20), Chromobacterium subtsugae PRAA4-1^{T} (L.3.21), Cydia pomonella granulosis virus V22 (L.3.22), Cydia pomonella granulosis virus V1 (L.3.23), Cryptophlebia leucotreta granulovirus (CrleGV) (L.3.57), Flavobacterium sp. H492 (L.3.60), Helicoverpa armigera nucleopolyhedrovirus (HearNPV) (L.3.58), Isaria fumosorosea Apopka-97 (L.3.24), Lecanicillium longisporum KV42 (L.3.25), Lecanicillium longisporum KV71 (L.3.26), Lecanicillium muscarium KV01 (L.3.27), Metarhizium anisopliae FI-985 (L.3.28), Metarhizium anisopliae FI-1045 (L.3.29), Metarhizium anisopliae F52 (L.3.30), Metarhizium anisopliae ICIPE 69 (L.3.31), Metarhizium anisopliae var. acridum IMI 330189 (L.3.32); Nomuraea rileyi strains: SA86101 (L.3.33), GU87401 (L.3.34), SR 86151 (L.3.35), CG128 (L.3.36) and VA9101 (L.3.37); Paecilomyces fumosoroseus FE 9901 (L.3.38), Paecilomyces lilacinus 251 (L.3.39), Paecilomyces DSM 15169 (L.3.40), Paecilomyces lilacinus BCP2 (L.3.41), Paenibacillus popilliae Dutky-1940 (NRRL B-2309=ATCC 14706) (L.3.42), Paenibacillus popilliae Dutky 1 (L.3.43), Paenibacillus popilliae KLN 3 (L.3.56), Pasteuria sp. Ph3 (L.3.44), Pasteuria sp. ATCC PTA-9643 (L.3.45), Pasteuria sp. ATCC SD-5832 (L.3.46), P. nishizawae Pn1 (L.3.46), P. penetrans (L.3.47), P. ramosa (L.3.48), P. sp. Pr-3 (L.3.49), P. thornea (L.3.50), P. usgae (L.3.51), Pseudomonas fluorescens CL 145A (L.3.52), Spodoptera littoralis nucleopolyhedrovirus (SpliNPV) (L.3.59), Steinernema carpocapsae (L.3.53), Steinernema feltiae UK76 (L.3.54), Steinernema kraussei L137 (L.3.55), Beauveria bassiana 147 (L.3.56), Beauveria bassiana NPP111B005 (L.3.57); Bacillus subtilis linhagem QST 713 (L.3.58), Bacillus licheniformis RT1184 (L.3.59), Paecilomyces lilacinus (L.3.60), Steinernema riobrave 355 (L.3.61), Phasmarhabditis hermaphrodita DMG 0001 (L.3.62), Heterorhabditis bacteriophora GPS11 (L.3.63);
L4) Biochemical pesticides with insecticidal, acaricidal, molluscidal, pheromone and/or nematicidal activity: L-carvone (L.4.1), citral (L.4.2), (E,Z)-7,9-dodecadien-1-yl acetate (L.4.3), ethyl formate (L.4.4), (E,Z)-2,4-ethyl decadienoate (pear ester) (L.4.5), (Z,Z,E)-7,11,13-hexadecatrienal (L.4.6), heptyl butyrate (L.4.7), isopropyl myristate (L.4.8), cis-jasmone (L.4.9), lavanulyl senecioate (L.4.10), 2-methyl 1-butanol (L.4.11), methyl eugenol (L.4.12), methyl jasmonate (L.4.13), (E,Z)-2,13-octadecadien-1-ol (L.4.14), (E,Z)-2,13-octadecadien-1-ol acetate (L.4.15), (E,Z)-3,13-octadecadien-1-ol (L.4.16), R-1-octen-3-ol (L.4.17), pentatermanone (L.4.18), potassium silicate (L.4.19), sorbitol actanoate (L.4.20), (E,Z,Z)-3,8,11-tetradecatrienyl acetate (L.4.21), (Z,E)-9,12-tetradecadien-1-yl acetate (L.4.22), Z-7-tetradecen-2-one (L.4.23), Z-9-tetradecen-1-yl acetate (L.4.24), Z-11-tetradecenal (L.4.25), Z-11-tetradecen-1-ol (L.4.26), Acacia negra extract (L.4.27), extract of grapefruit seeds and pulp (L.4.28), Chenopodium ambrosioides extract (L.4.29), Catnip oil (L.4.30), Neem oil (L.4.31), Quillay extract (L.4.32), Tagetes oil (L.4.33);
L5) Microbial pesticides with plant stress reducing, plant growth regulator, plant growth promoting and/or yield enhancing activity: Azospirillum amazonense BR 11140 (SpY2) (L.5.1), A. brasilense Ab-V5 (L.5.74), A. brasilense Ab-V6 (L.5.75), A. brasilense AZ39 (L.5.2), A. brasilense XOH (L.5.3), A. brasilense Sp245 (BR 11005) (L.5.4), A. brasilense BR 11002 (L.5.5), A. lipoferum BR 11646 (Sp31) (L.5.6), A. irakense (L.5.7), A. halopraeferens (L.5.8), Bradyrhizobium sp. PNL01 (L.5.9), Bradyrhizobium sp. (Arachis) CB1015 (L.5.10), Bradyrhizobiumsp. (Arachis) USDA 3446 (L.5.11), Bradyrhizobiumsp. (Arachis) SEMIA 6144 (L.5.12), Bradyrhizobium sp. (Arachis) SEMIA 6462 (L.5.13), Bradyrhizobium sp. (Arachis) SEMIA 6464 (L.5.14), Bradyrhizobium sp. (Vigna) (L.5.15), Bradyrhizobium elkanii SEMIA 587 (L.5.16), Bradyrhizobium elkanii SEMIA 5019 (L.5.17), Bradyrhizobium elkanii U-1301 (L.5.18), Bradyrhizobium elkanii U-1302 (L.5.19), Bradyrhizobium USDA 74 (L.5.20), Bradyrhizobium elkanii USDA 76 (L.5.21), Bradyrhizobium elkanii USDA 94 (L.5.22), B. elkanii USDA 3254 (L.5.23), Bradyrhizobium japonicum 532c (L.5.24), Bradyrhizobium japonicum CPAC 15 (L.5.25), Bradyrhizobium japonicum E-109 (L.5.26), Bradyrhizobium japonicum G49 (L.5.27), Bradyrhizobium japonicum TA-11 (L.5.28), Bradyrhizobium japonicum USDA 3 (L.5.29), Bradyrhizobium japonicum USDA 31 (L.5.30), Bradyrhizobium japonicum USDA 76 (L.5.31), Bradyrhizobium japonicum USDA 110 (L.5.32), Bradyrhizobium japonicum USDA 121 (L.5.33), Bradyrhizobium japonicum USDA 123 (L.5.34), Bradyrhizobium japonicum USDA 136 (L.5.35), Bradyrhizobium japonicum SEMIA 566 (L.5.36), Bradyrhizobium japonicum SEMIA 5079 (L.5.37), Bradyrhizobium japonicum SEMIA 5080 (L.5.38), Bradyrhizobium japonicum WB74 (L.5.39), Bradyrhizobium liaoningense (L.5.40), Bradyrhizobium lupini LL13 (L.5.41), Bradyrhizobium lupini WU425 (L.5.42), Bradyrhizobium lupini WSM471 (L.5.43), Bradyrhizobium lupini WSM4024 (L.5.44), Glomus intraradices RTI-801 (L.5.45), Mesorhizobium sp. WSM1271 (L.5.46), Mesorhizobium sp. WSM1497 (L.5.47), Mesorhizobium ciceri CC1192 (L.5.48), Mesorhizobium huakii (L.5.49), Mesorhizobium loti CC829 (L.5.50), Mesorhizobium loti SU 343 (L.5.51), Rhizobium leguminosarum bv. phaseoli RG-B10 (L.5.52), R. I. bv. trifolii RP113-7 (L.5.53), R. I. bv. trifolii 095 (L.5.57), R. I. bv. trifolii TA1 (L.5.58), R. I. bv. trifolii CC283b (L.5.59), R. I. bv. trifolii CC275e (L.5.60), R. I. bv. trifolii CB782 (L.5.61), R. I. bv. trifolii CC1099 (L.5.62), R. I. bv. trifolii WSM1325 (L.5.63), R. I. bv. viciae SU303 (L.5.64), R. I. bv. viciae WSM1455 (L.5.65), R. I. bv. viciae P1NP3Cst (=1435) (L.5.66), R. I. bv. viciae RG-P2 (L.5.67), R. tropici PRF81 (L.5.68), R. tropici SEMIA 4077 (L.5.69), R. tropici CC511(L.5.70), Sinorhizobium meliloti RCR2011 (L.5.71), S. meliloti NRG185 (L.5.72), S. meliloti RR1128 (L.5.73), Bacillus licheniformis RTI184 (L.5.74), Bacillus licheniformis CH200 (L.5.75), Bacillus simplex ABU 288 (L.5.76), Bradyrhizobium lupini LL13 (L.5.77), Mesorhizobium ciceri CC1653 (L.5.78), Sinorhizobium medicae WSM1115 (L.5.79), Bradyrhizobium japonicum CB1809 (L.5.80), Bradyrhizobium japonicum 3407 (L.5.81), Rhizobium tropici SEMIA 4088 (L.5.82), Bradyrhizobium NC92 (L.5.83), Bradyrhizobium CB1024 (L.5.84);
L6) Biochemical pesticides with plant stress reducing, plant growth regulator and/or plant yield enhancing activity: abscisic acid (L.6.1), aluminium silicate (kaolin) (L.6.2), 3-decen-2-one (L.6.3), formononectin (L.6.4), genistein (L.6.5), hesperetin (L.6.6), homobrassinolide (L.6.7), humates (L.6.8), methyl jasmonate (L.6.9), cis-jasmone (L.6.10), lysophosphatidyl ethanlamine (L.6.11), naringenin (L.6.12), polymeric polyhydroxy acid (L.6.13), salicylic acid (L.6.14), Ascophyllum nodosum (Norwegian kelp, Brown kelp) extract (L.6.15) and Ecklonia maxima (kelp) extract (L.6.16), zeolite (aluminosilicate) (L.6.17), grape seed extract (L.6.18).

In one embodiment, the mixture according to the invention comprises a compound II selected from the group consisting of Bacillus firmus CNCM I-1582 (L.3.3), Bacillus amyloliquefaciens ssp. plantarum M B1600 (NRRL B-50595) (L.1.17), Bacillus subtilis linhagem QST 713 (L.3.58), Bacillus licheniformis RTI184 (L.3.59), Paenibacillus polymyxa Lu16774 (L.1.91), Paenibacillus polymyxa Lu17007 (L.1.92), Paenibacillus epiphyticus Lu17015 (L.1.93), Pasteuria nishizawae Pn1 (L.3.46), Penicillium ATCC 22348 (L.1.51), Penicillium bilaiae ATCC 20851 (L.1.52) and Penicillium bilaiae ATCC 18309 (L.1.53).

In one preferred embodiment, the mixture according to the invention comprises Bradyrhizobium japonicum 532c (L.5.24) as compound II.

In one preferred embodiment, the mixture according to the invention comprises grape seed extract (L.6.18) as compound II.

In another preferred embodiment, the mixture according to the invention comprises

a) DMPSA1 and/or DMPSA2, and/or a derivative thereof, and/or a salt thereof, as compound I (nitrication inhibitor),
b) Bradyrhizobium japonicum as compound II.

In another preferred embodiment, the mixture according to the invention comprises

a) DMPSA1 and/or DMPSA2, and/or a derivative thereof, and/or a salt thereof, as compound I (nitrication inhibitor),
b) Bradyrhizobium japonicum 532c (L.5.24) as compound II.

In another preferred embodiment, the mixture according to the invention comprises

a) DMPSA1 and/or DMPSA2, and/or a derivative thereof, and/or a salt thereof, as compound I (nitrication inhibitor),
b) grape seed extract (L.6.18) as compound II.

In one preferred embodiment, the mixture according to the invention comprises Bacillus firmus CNCM I-1582 (L.3.3) as compound II.

In one preferred embodiment, the mixture according to the invention comprises Bacillus amyloliquefaciens ssp. plantarum MB1600 (NRRL B-50595) (L.1.17) as compound II.

In one preferred embodiment, the mixture according to the invention comprises Bacillus subtilis linhagem QST 713 (L.3.58) as compound II.

In one preferred embodiment, the mixture according to the invention comprises Bacillus licheniformis RTI184 (L.3.59) as compound II.

In one preferred embodiment, the mixture according to the invention comprises Paenibacillus polymyxa Lu16774 (L.1.91) as compound II.

In one preferred embodiment, the mixture according to the invention comprises Paenibacillus polymyxa Lu17007 (L.1.92) as compound II.

In one preferred embodiment, the mixture according to the invention comprises Paenibacillus epiphyticus Lu17015 (L.1.93) as compound II.

In one preferred embodiment, the mixture according to the invention comprises Pasteuria nishizawae Pn1 (L.3.46) as compound II.

In one preferred embodiment, the mixture according to the invention comprises Penicillium bilaiae ATCC 22348 (L.1.51) as compound II.

In one preferred embodiment, the mixture according to the invention comprises Penicillium bilaiae ATCC 20851 (L.1.52) as compound II.

In one preferred embodiment, the mixture according to the invention comprises Penicillium bilaiae ATCC 18309 (L.1.53) as compound II.

Preference is also given to mixtures comprising as compound II a biopesticide from group L1), preferably selected from Bacillus amyloliquefaciens herein even more preferably from strains AP-136, AP-188, AP-218, AP-219, AP-295, IN937a, IT-45; B. amyloliquefaciens ssp. plantarum (formerly called B. subtilis or B. subtilis spp. amyloliquefaciens) herein even more preferably from strains M B1600, D747, FZB254, FZB42, GB03, QST-713 and TJ1000; B. mojavensis AP-209; B. pumilus herein even more preferably from strains GHA 180, INR-7, KFP9F and QST 2808; B. solisalsi herein more preferably strain AP-217; B. subtilis herein even more preferably selected from strains CX-9060, FB17 and GB07; Muscodor albus herein more preferably strains QST 20799 and SA-13; Paenibacillus alvei herein more preferably strain NAS6G6, Paenibacillus polymyxa herein more preferably strain PKB1, Penicillium bilaiae herein more preferably strains ATCC 22348, ATCC 20581 and ATCC 18309; Pseudomonas fluorescens herein more preferably strain A506; Sphaerodes mycoparasitica herein more preferably strain SMCD2220; Trichoderma fertile herein more preferably strain JM41R; Trichoderma harzianum herein more preferably strain T-22; Trichoderma virens herein more preferably strains GI-3 and G-41.

Preference is also given to mixtures comprising as compound II a biopesticide from group L1), even more preferably selected from B. amyloliquefaciens AP-188, B. amyloliquefaciens ssp. plantarum MBI600, B. amyloliquefaciens ssp. plantarum QST-713, B. pumilus INR-7, B. pumilus QST 2808, B. subtilis FB17, Paenibacillus alvei NAS6G6 and Trichoderma fertile JM41R.

According to one embodiment of the inventive mixtures, the at least one compound II is Bacillus amyloliquefaciens ssp. plantarum MBI 600. These mixtures are particularly suitable in soybean.

According to another embodiment of the inventive mixtures, the at least one compound II is B. pumilus INR-7. These mixtures are particularly suitable in soybean and corn.

According to a further embodiment, the at least one compound II is Bacillus subtilis, preferably B. subtilis strain FB 17.

According to one embodiment of the inventive mixtures, the at least one compound II is selected from Bacillus amyloliquefaciens AP-136, B. amyloliquefaciens AP-188, B. amyloliquefaciens AP-218, B. amyloliquefaciens AP-219, B. amyloliquefaciens AP-295, B. amyloliquefaciens spp. plantarum FZB24, B. amyloliquefaciens ssp. plantarum FZB42, B. amyloliquefaciens ssp. plantarum TJ1000, B. amyloliquefaciens ssp. plantarum D747, B. amyloliquefaciens ssp. plantarum MBI600, B. amyloliquefaciens spp. plantarum G B03, B. amyloliquefaciens spp. plantarum QST-713, B. mojavensis AP-209, B. pumilus GB34, B. pumilus INR-7, B. pumilus KFP9F, a pumilus QST 2808, B. pumilus GHA 180, B. solisalsi AP-217, B. subtilis CX-9060, B. subtilis FB17 and B. subtilis GB07. These mixtures are particularly suitable in soybean and corn, in particular for seed treatment.

According to a further embodiment, the at least one compound 11 is selected from Streptomyces spp., preferably from S. griseoviridis, S. lydicus and S. violaceusniger, in particular from strains S. griseoviridis K61, S. lydicus WYEC 108, S. violaceusniger XL-2 and S. violaceusniger YCED-9.

According to one embodiment of the inventive mixtures, the at least one compound II is selected from the following fungi Coniothyrium minitans CON/M/91-08, Trichoderma fertile JM41R, T. harzianum T-22, T. virens G1-3, T. virens GL-21, T. virens G-41. These mixtures are particularly suitable for seed and/or soil treatment.

The present invention also relates to mixtures wherein the at least one compound II is selected from the following yeasts and fungi: Ampelomyces quisqualis, in particular strain M-10; Aureobasidium pullulans, in particular blastospores of strain DSM14940 or blastospores of strain DSM 14941 or mixtures thereof; Candida oleophila, in particular strains 1-182 and O; Coniothyrium minitans, in particular strain CON/M/91-8; Dilophosphora alopecuri which reduces annual ryegrass toxicity (ARGT), a disease of livestock resulting from the ingestion of annual ryegrass seed-heads that have been infected by the toxin producing bacterium Rathayibacter toxicus, Clonostachys rosea f. catenulata, in particular strain J1446; Metschnikovia fructicola, in particular strain 277, Microsphaeropsis ochracea, in particular strain P130A for control of apple scab; Muscodor albus, in particular strain QST 20799, Pichia anomala, in particular strain WRL-076, Pseudozyma flocculosa, in particular strain PF-A22 UL; Pythium oligandrum, in particular strain DV74.

According to a further embodiment, the at least one compound II is selected from Pseudomonas spp., preferably selected from P. chlororaphis herein more preferably strain MA 342 and Pseudomonas sp. DSM 13134; P. fluorescens herein more preferably selected from strains A506, WCS 374 and Pf-5; and P. putida herein more preferably strain ATCC 202153.

The present invention also relates to mixtures wherein the at least one compound II is selected from the fungal genus Trichoderma, preferably from the strains T. asperellum T34, T. asperellum SKT-1, T. asperellum ICC 012, T. asperellum TV1, T. atroviride LC52, T. atroviride CNCM I-1237, T. fertile JM41R, T. gamsii ICC 080, T. harmatum TH 382, T. harzianum T-22, T. harzianum T-35, T. harzianum T-39, T. harzianum T-315; mixture of T. harzianum ICC012 and T. gamsi ICC080; mixture of T. polysporum and T. harzianum; T. stromaticum, T. virens GI-3, T. virens GL-21, T. virens G-41 and; in particular T. fertile JM41R.

The present invention also relates to mixtures wherein the at least one compound II is selected from the fungal species Muscodor albus preferably from the strains SA-13 and QST 20799, which are particularly suitable for soil and seed treatment against soil-borne pathogens and/or nematodes.

Preference is also given to mixtures comprising as compound II a biopesticide from group L2), preferably selected from chitosan (hydrolysate), methyl-jasmonate, cis-jasmone, laminarin, Reynoutria sachalinensis extract and tea tree oil; even more preferable from methyl jasmonate, cis-jasmone and laminarin.

Preference is also given to mixtures comprising as compound II a biopesticide from group L2), preferably selected from fusaricidins, paeniserines and paeniprolixines.

Especially preferred are mixtures comprising as compound 11 at least one fusaricidin.

Preference is also given to mixtures comprising as compound II a biopesticide from group L3), preferably selected from Agrobacterium radiobacter herein preferably strain K1026, Bacillus firmus herein preferably strain 1-1582, Bacillus thuringiensis ssp. kurstaki herein preferably strain SB4, Beauveria bassiana herein preferably selected from strains GHA, H123, DSM 12256 and PPRI 5339; Burkholderia sp. and herein preferably strain A396, Metarhizium anisopliae var. acridum herein preferably strain IM1330189, M. anisopliae herein preferably selected from strains FI-985, FI-1045, F52 and ICIPE 69; Paecilomyces lilacinus herein preferably selected from strains 251, DSM 15169 and BCP2, Paenibacillus popilliae herein preferably selected from strains Dutky-1940, KLN 3 and Dutky 1; Pasteuria nishazawa and herein preferably strain Pn1.

Preference is also given to mixtures comprising as compound II a biopesticide from group L3), even more preferably from Bacillus thuringiensis ssp. kurstaki SB4, B. bassiana DSM 12256, B. bassiana PPRI 5339, Metarhizium anisopliae var. acridum IMI 330189, M. anisopliae FI-985, M. anisopliae FI-1045, Paecilomyces lilacinus DSM 15169, P. lilacinus BCP2, P. lilacinus 251, Paenibacillus Dutky-1940, P. popilliae KLN 3 and P. popilliae Dutky 1.

According to a further embodiment, the at least one compound 11 is Beauveria brongniartii.

According to a further embodiment, the at least one compound 11 is Metarhizium anisopliae or anisopliae var. acridium, preferably selected from M. anisopliae F1-1045, M. anisopliae F52, anisopliae var. acridum strains FI-985 and IMI 330189; in particular strain IMI 330189. These mixtures are particularly suitable for control of arthropod pests in soybean and corn.

According to a further embodiment, the at least one compound II is Lecanicillium sp., preferably selected from Lecanicillium longisporum KV42, L. longisporum KV71 and L. muscarium KV01.

According to a further embodiment, the at least one compound 11 is Paecilomyces fumosoroseus, preferably strain FE 9901 especially for white fly control.

According to a further embodiment, the at least one compound II is selected from Nomuraea rileyi, preferably strains SA86101, GU87401, SR86151, CG128 and VA9101; and P. lilacinus, preferably strains 251, DSM 15169 or BCP2, in particular BCP2, which strains especially control the growth of plant-pathogenic nematodes.

According to a further embodiment, the at least one compound II is Bacillus firmus, preferably spores of strain CNCM I-1582, preferably useful for seed treatment of soybean and corn against nematodes and insects.

According to a further embodiment, the at least one compound II is Bacillus cereus, preferably spores of CNCM I-1562, preferably useful for seed treatment of soybean and corn against nematodes and insects.

According to a further embodiment, the at least one compound II is a mixture of spores of B. firmus and B. cereus, preferably mixtures spores of above mentioned strains CNCM I-1582 and CNCM I-1562, preferably useful for seed treatment of soybean and corn against nematodes and insects.

According to a further embodiment, the at least one compound II is selected from Bacillus t. ssp. kurstaki preferably from strains EG 2348, SB4 and ABTS-351 (HD-1), in particular B. t. ssp. kurstaki SB4. These strains are used for control of lepidopteran larvae, but without noctuidae.

According to one embodiment of the inventive mixtures, the at least one compound II is selected from Bacillus firmus CNCM I-1582, Paecilomyces lilcinus 251, Pasteuria nishizawa Pn1 and Burkholderia sp. A396 having nematicidal, acaricidal and/or insecticidal activity. These mixtures are particularly suitable in soybean and corn, in particular for seed treatment.

Preference is also given to mixtures comprising as compound 11 a biopesticide from group L4), preferably selected from methyl jasmonate, Acacia negra extract, extract of grapefruit seeds and pulp, Catnip oil, Neem oil, Quillay extract and Tagetes oil, in particular methyl jasmonate or water-based Quillay extract.

Preference is also given to mixtures comprising as compound 11 a biopesticide from group L5), preferably selected from Azospirillum amazonense, A. brasilense, A. lipoferum, A. irakense, A. halopraeferens, Bradyrhizobium sp. (Arachis), Bradyrhizobium sp. (Vigna), B. elkanii, B. japonicum; Paenibacillus alvei, Penicillium bilaiae, Rhizobium leguminosarum bv. phaseoli, R. I. bv. trifolii, R. I. bv. viciae, and Sinorhizobium meliloti.

Preference is also given to mixtures comprising as compound II a biopesticide from group L5) selected from Azospirillum amazonense SpY2, A. brasilense XOH, A. brasilense Sp245, A. brasilense Cd, A. brasilense Ab-V5, A. brasilense Ab-V6, A. lipoferum Sp31, Bradyrhizobium sp. (Vigna) PNL1, B. elkanii SEMIA 587, B. elkanii SEMIA 5019, B. japonicum SEMIA 5079, B. japonicum SEMIA 5080, B. japonicum TA-11, B. japonicum 532c, B. simplex herein more preferably strain ABU 288, Paenibacillus alvei NAS6G6, Penicillium bilaiae strains ATCC 18309, ATCC 20851 and ATCC 22348; Rhizobium leguminosarum bv. phaseoli RG-B10, R. I. bv. viciae P1NP3Cst, R. I. bv. viciae RG-P2, R. I. bv. trifolii RP113-7, R. I. bv. viciae SU303, R. I. bv. viciae WSM1455, R. tropici SEMIA 4077, R. tropici PRF 81 and Sinorhizobium meliloti; even more preferably selected from Azospirillum brasilense Sp245, Bradyrhizobium sp. (Vigna) PNL1, B B. elkanii SEMIA 587, B. elkanii SEMIA 5019, B. japonicum SEMIA 5079, B. japonicum SEMIA 5080, B. japonicum TA-11 and B. japonicum 532c.

According to a further embodiment, the at least one compound II is Bacillus simplex, preferably B. simplex ABU 288. These mixtures are particularly suitable in soybean and corn.

The present invention also relates to mixtures, wherein the at least one compound II is selected from Azospirillum amazonense, A. brasilense, A. lipoferum, A. irakense and A. halopraeferens, more preferably from A. brasilense, in particular selected from A. brasilense strains Sp245 and

AZ39 which are both commercially used in Brazil and are obtainable from EMBRAPA-Agribiologia, Brazil, and strains Ab-V5 and Ab-V6; in particular mixtures of these strains Ab-V5 and Ab-V6. These mixtures are particularly suitable in soybean, especially as seed treatment.

The present invention also relates to mixtures wherein the at least one pesticide II is selected from A. amazonense, A. brasilense, A. lipoferum, A. irakense and A. halopraeferens, more preferably A. brasilense, and further comprises a compound III, wherein compound III is selected from jasmonic acid, its salts and derivatives thereof, preferably methyl-jasmonate or cis-jasmone.

According to another embodiment of the inventive mixtures, Bradyrhizobium spp. (meaning any Bradyrhizobium species and/or strain) as compound II is B. japonicum. These mixtures are particularly suitable in soybean. Certain B. japonicum strains have been re-classified as a novel species B. elkanii; e.g. strain USDA 76 (Can. J. Microbiol. 38, 501-505, 1992). Bradyrhizobium spp. are cultivated using media and fermentation techniques known in the art, e.g. in yeast extract-mannitol broth (YEM) at 27° C. for about 5 days.

The present invention also relates to mixtures, wherein the at least one compound II is selected from Bradyrhizobium spp., even more preferably from B. sp. (Arachis), B. elkanii, B. japonicum, liaoningense and B. lupini, and further comprises a compound III (compound III, wherein compound III is selected from jasmonic acid, its salts and derivatives thereof, preferably methyl-jasmonate or cis-jasmone.

Preferably, B. japonicum is selected from strains E-109, SEMIA 5079, SEMIA 5080, TA-11 and 532c. According to a further embodiment, mixtures of B. japonicum strains TA-11 and 532c or B. japonicum strains SEMIA 5079 and 5080 are used. The strains having a prefix SEMIA are especially suitable for soybean grown in Australia or South America, in particular in Brazil. More preferably, mixtures of B. japonicum SEMIA 5079 and SEMIA 5080 are used. B. japonicum WB74 is especially suitable for soybean grown in South America and Africa, in particular in South Africa. Strain E-109 is especially suitable for soybean grown in South America, in particular in Argentina.

The present invention also relates to mixtures, wherein the at least one compound II is selected from B. japonicum and further comprises a compound III, wherein compound III is selected from jasmonic acid, its salts and derivatives thereof, preferably methyl-jasmonate or cis-jasmone.

The present invention also relates to mixtures, wherein the at least one pesticide II is selected from Bradyrhizobium elkanii and Bradyrhizobium liaoningense, more preferably from B. elkanii even more preferably B. elkanii strains SEMIA 587 and SEMIA 5019; in particular mixtures of both. These mixtures are particularly suitable in soybean in Australia or South America, in particular in Brazil.

The present invention also relates to mixtures, wherein compound II is selected from Bradyrhizobium sp. (Arachis) and B. sp. (Vigna) which shall describe the cowpea miscellany cross-inoculation group which includes inter alia indigenous cowpea bradyrhizobia on cowpea (Vigna unguiculata), siratro (Macroptilium atropurpureum), lima bean (Phaseolus lunatus), and peanut (Arachis hypogaea), in particular in particular B. sp. (Vigna) strain PNL1. This mixture comprising as compound II B. sp. (Arachis) or B. sp. (Vigna) is especially suitable for use in peanut, cowpea, Mung bean, Moth bean, Dune bean, Rice bean, Snake bean and Creeping vigna, in particular peanut.

The present invention also relates to mixtures, wherein the at least one compound II is selected from Bradyrhizobium lupini (also called B. sp. (Lupine), B. lupines or Rhizobium lupini). These mixtures are especially suitable for use in dry beans and lupins. Preferably, B. lupini is strain LL13. This strain is especially suitable for lupins grown in Australia, North America or Europe, in particular in Europe.

The present invention also relates to mixtures wherein the at least one compound II is selected from Rhizobium leguminosarum bv. phaseoli especially for the legume common bean (Phaseolus vulgaris), but also for other for various legumes such as alfalfa, clover, peas, beans, lentils, soybeans, peanuts and other crops such as corn and lettuce, even more preferably strain RG-B10 thereof; R. I. bv. trifolii, especially strain RP113-7 thereof, R. I. bv. viciae, in particular strains RG-P2, SU303, WSM1455 and P1NP3Cst thereof, in particular P1NP3Cst; R. tropici, especially strains CC511, CIAT 899 and PRF81 thereof; and Sinorhizobium meliloti especially strain RCR2011 thereof. Further R. I. bv. phaseoli or R. etli strains are e.g. known from the above mentioned references and Appl. Environ. Microbiol. 45(3), 737-742, 1983; ibida 54(5), 1280-1283, 1988.

According to a further embodiment, in the inventive mixtures compound II is selected from Sinorhizobium meliloti more preferably from RCR2011, S. meliloti NRG185, S. meliloti RRI128, S. meliloti SU277,

R. tropici is useful for a range of legume crops especially all kind of clovers e.g. in tropical regions such as Brazil. Preferably, mixtures comprise as R. tropici at least one strain selected from CC511, CIAT899, H12 and PRF 81.

The present invention also relates to mixtures wherein the at least one compound II is selected from R. leguminosarum bv. phaseoli, R. I. bv. trifolii, R. I. bv. viciae, R. tropici and Sinorhizobium meliloti, and further comprises a compound III, wherein compound III is selected from jasmonic acid, its salts and derivatives thereof, preferably methyl-jasmonate or cis-jasmone.

According to a further embodiment, the at least one compound II is selected from Delftia acidovorans, in particular strain RAY209, especially in soybean and canola.

With respect to their intended use in the methods of the present invention, the following binary mixtures (B) listed in tables 50 to 98 comprising one compound (I) and one compound (II) are a preferred embodiment of the present invention.

TABLE 50

| B | I | II |
|---|---|---|
| B1 | (I.A) | L.1.1 |
| B2 | (I.A) | L.1.2 |
| B3 | (I.A) | L.1.3 |
| B4 | (I.A) | L.1.4 |
| B5 | (I.A) | L.1.5 |
| B6 | (I.A) | L.1.6 |
| B7 | (I.A) | L.1.7 |
| B8 | (I.A) | L.1.8 |
| B9 | (I.A) | L.1.9 |
| B10 | (I.A) | L.1.10 |
| B11 | (I.A) | L.1.11 |
| B12 | (I.A) | L.1.12 |
| B13 | (I.A) | L.1.13 |
| B14 | (I.A) | L.1.14 |
| B15 | (I.A) | L.1.15 |
| B16 | (I.A) | L.1.16 |
| B17 | (I.A) | L.1.17 |
| B18 | (I.A) | L.1.18 |
| B19 | (I.A) | L.1.19 |
| B20 | (I.A) | L.1.20 |
| B21 | (I.A) | L.1.21 |
| B22 | (I.A) | L.1.22 |
| B23 | (I.A) | L.1.23 |
| B24 | (I.A) | L.1.24 |
| B25 | (I.A) | L.1.25 |
| B26 | (I.A) | L.1.26 |
| B27 | (I.A) | L.1.27 |
| B28 | (I.A) | L.1.28 |
| B29 | (I.A) | L.1.29 |
| B30 | (I.A) | L.1.30 |
| B31 | (I.A) | L.1.31 |
| B32 | (I.A) | L.1.32 |
| B33 | (I.A) | L.1.33 |
| B34 | (I.A) | L.1.34 |
| B35 | (I.A) | L.1.35 |
| B36 | (I.A) | L.1.36 |
| B37 | (I.A) | L.1.37 |
| B38 | (I.A) | L.1.38 |
| B39 | (I.A) | L.1.39 |
| B40 | (I.A) | L.1.40 |
| B41 | (I.A) | L.1.41 |
| B42 | (I.A) | L.1.42 |
| B43 | (I.A) | L.1.43 |
| B44 | (I.A) | L.1.44 |
| B45 | (I.A) | L.1.45 |
| B46 | (I.A) | L.1.46 |
| B47 | (I.A) | L.1.47 |
| B48 | (I.A) | L.1.48 |
| B49 | (I.A) | L.1.49 |
| B50 | (I.A) | L.1.50 |
| B51 | (I.A) | L.1.51 |
| B52 | (I.A) | L.1.52 |
| B53 | (I.A) | L.1.53 |
| B54 | (I.A) | L.1.54 |
| B55 | (I.A) | L.1.55 |
| B56 | (I.A) | L.1.56 |
| B57 | (I.A) | L.1.57 |
| B58 | (I.A) | L.1.58 |
| B59 | (I.A) | L.1.59 |
| B60 | (I.A) | L.1.60 |
| B61 | (I.A) | L.1.61 |
| B62 | (I.A) | L.1.62 |
| B63 | (I.A) | L.1.63 |
| B64 | (I.A) | L.1.64 |
| B65 | (I.A) | L.1.65 |
| B66 | (I.A) | L.1.66 |
| B67 | (I.A) | L.1.67 |
| B68 | (I.A) | L.1.68 |
| B69 | (I.A) | L.1.69 |
| B70 | (I.A) | L.1.70 |
| B71 | (I.A) | L.1.71 |
| B72 | (I.A) | L.1.72 |
| B73 | (I.A) | L.1.73 |
| B74 | (I.A) | L.1.74 |
| B75 | (I.A) | L.1.75 |
| B76 | (I.A) | L.1.76 |
| B77 | (I.A) | L.1.77 |
| B78 | (I.A) | L.1.78 |
| B79 | (I.A) | L.1.79 |
| B80 | (I.A) | L.1.80 |
| B81 | (I.A) | L.1.81 |
| B82 | (I.A) | L.1.82 |
| B83 | (I.A) | L.1.83 |
| B84 | (I.A) | L.1.84 |
| B85 | (I.A) | L.1.85 |
| B86 | (I.A) | L.1.86 |
| B87 | (I.A) | L.1.87 |
| B88 | (I.A) | L.1.88 |
| B89 | (I.A) | L.1.89 |
| B90 | (I.A) | L.1.90 |
| B91 | (I.A) | L.1.91 |
| B92 | (I.A) | L.1.92 |
| B93 | (I.A) | L.1.93 |
| B94 | (I.A) | L.1.94 |
| B95 | (I.A) | L.1.95 |
| B96 | (I.A) | L.1.96 |
| B97 | (I.A) | L.2.1 |
| B98 | (I.A) | L.2.2 |
| B99 | (I.A) | L.2.3 |
| B100 | (I.A) | L.2.4 |
| B101 | (I.A) | L.2.5 |
| B102 | (I.A) | L.2.6 |
| B103 | (I.A) | L.2.7 |
| B104 | (I.A) | L.2.8 |
| B105 | (I.A) | L.2.9 |
| B106 | (I.A) | L.2.10 |
| B107 | (I.A) | L.2.11 |
| B108 | (I.A) | L.2.12 |
| B109 | (I.A) | L.2.13 |
| B110 | (I.A) | L.2.14 |
| B111 | (I.A) | L.2.15 |
| B112 | (I.A) | L.2.16 |
| B113 | (I.A) | L.2.17 |
| B114 | (I.A) | L.2.18 |
| B115 | (I.A) | L.2.19 |
| B116 | (I.A) | L.2.20 |
| B117 | (I.A) | L.2.21 |
| B118 | (I.A) | L.2.22 |
| B119 | (I.A) | L.2.23 |
| B120 | (I.A) | L.2.24 |
| B121 | (I.A) | L.2.25 |
| B122 | (I.A) | L.2.26 |
| B123 | (I.A) | L.2.27 |
| B124 | (I.A) | L.2.28 |
| B125 | (I.A) | L.2.29 |
| B126 | (I.A) | L.2.30 |
| B127 | (I.A) | L.2.31 |
| B128 | (I.A) | L.2.32 |
| B129 | (I.A) | L.2.33 |
| B130 | (I.A) | L.3.1 |
| B131 | (I.A) | L.3.2 |
| B132 | (I.A) | L.3.3 |
| B133 | (I.A) | L.3.4 |
| B134 | (I.A) | L.3.5 |
| B135 | (I.A) | L.3.6 |
| B136 | (I.A) | L.3.7 |
| B137 | (I.A) | L.3.8 |
| B138 | (I.A) | L.3.9 |
| B139 | (I.A) | L.3.10 |
| B140 | (I.A) | L.3.11 |
| B141 | (I.A) | L.3.12 |
| B142 | (I.A) | L.3.13 |
| B143 | (I.A) | L.3.14 |
| B144 | (I.A) | L.3.15 |
| B145 | (I.A) | L.3.16 |
| B146 | (I.A) | L.3.17 |
| B147 | (I.A) | L.3.18 |
| B148 | (I.A) | L.3.19 |
| B149 | (I.A) | L.3.20 |
| B150 | (I.A) | L.3.21 |
| B151 | (I.A) | L.3.22 |
| B152 | (I.A) | L.3.23 |
| B153 | (I.A) | L.3.24 |
| B154 | (I.A) | L.3.25 |
| B155 | (I.A) | L.3.26 |
| B156 | (I.A) | L.3.27 |
| B157 | (I.A) | L.3.28 |
| B158 | (I.A) | L.3.29 |
| B159 | (I.A) | L.3.30 |
| B160 | (I.A) | L.3.31 |
| B161 | (I.A) | L.3.32 |
| B162 | (I.A) | L.3.33 |
| B163 | (I.A) | L.3.34 |
| B164 | (I.A) | L.3.35 |
| B165 | (I.A) | L.3.36 |
| B166 | (I.A) | L.3.37 |
| B167 | (I.A) | L.3.38 |
| B168 | (I.A) | L.3.39 |
| B169 | (I.A) | L.3.40 |
| B170 | (I.A) | L.3.41 |
| B171 | (I.A) | L.3.42 |
| B172 | (I.A) | L.3.43 |
| B173 | (I.A) | L.3.44 |
| B174 | (I.A) | L.3.45 |
| B175 | (I.A) | L.3.46 |
| B176 | (I.A) | L.3.47 |
| B177 | (I.A) | L.3.48 |
| B178 | (I.A) | L.3.49 |
| B179 | (I.A) | L.3.50 |
| B180 | (I.A) | L.3.51 |
| B181 | (I.A) | L.3.52 |
| B182 | (I.A) | L.3.53 |
| B183 | (I.A) | L.3.54 |
| B184 | (I.A) | L.3.55 |
| B185 | (I.A) | L.3.56 |
| B186 | (I.A) | L.3.57 |
| B187 | (I.A) | L.3.58 |
| B188 | (I.A) | L.3.59 |
| B189 | (I.A) | L.3.60 |
| B190 | (I.A) | L.3.61 |
| B191 | (I.A) | L.3.62 |
| B192 | (I.A) | L.3.63 |
| B193 | (I.A) | L.3.1 |
| B194 | (I.A) | L.3.2 |
| B195 | (I.A) | L.4.1 |
| B196 | (I.A) | L.4.2 |
| B197 | (I.A) | L.4.3 |
| B198 | (I.A) | L.4.4 |
| B199 | (I.A) | L.4.5 |
| B200 | (I.A) | L.4.6 |
| B201 | (I.A) | L.4.7 |
| B202 | (I.A) | L.4.8 |
| B203 | (I.A) | L.4.9 |
| B204 | (I.A) | L.4.10 |
| B205 | (I.A) | L.4.11 |
| B206 | (I.A) | L.4.12 |
| B207 | (I.A) | L.4.13 |
| B208 | (I.A) | L.4.14 |
| B209 | (I.A) | L.4.15 |
| B210 | (I.A) | L.4.16 |
| B211 | (I.A) | L.4.17 |
| B212 | (I.A) | L.4.18 |
| B213 | (I.A) | L.4.19 |
| B214 | (I.A) | L.4.20 |
| B215 | (I.A) | L.4.21 |
| B216 | (I.A) | L.4.22 |
| B217 | (I.A) | L.4.23 |
| B218 | (I.A) | L.4.24 |
| B219 | (I.A) | L.4.25 |
| B220 | (I.A) | L.4.26 |
| B221 | (I.A) | L.4.27 |
| B222 | (I.A) | L.4.28 |
| B223 | (I.A) | L.4.29 |
| B224 | (I.A) | L.4.30 |
| B225 | (I.A) | L.4.31 |
| B226 | (I.A) | L.4.32 |
| B227 | (I.A) | L.4.33 |
| B228 | (I.A) | L.5.1 |
| B229 | (I.A) | L.5.2 |
| B230 | (I.A) | L.5.3 |
| B231 | (I.A) | L.5.4 |
| B232 | (I.A) | L.5.5 |
| B233 | (I.A) | L.5.6 |
| B234 | (I.A) | L.5.7 |
| B235 | (I.A) | L.5.8 |
| B236 | (I.A) | L.5.9 |
| B237 | (I.A) | L.5.10 |
| B238 | (I.A) | L.5.11 |
| B239 | (I.A) | L.5.12 |
| B240 | (I.A) | L.5.13 |
| B241 | (I.A) | L.5.14 |
| B242 | (I.A) | L.5.15 |
| B243 | (I.A) | L.5.16 |
| B244 | (I.A) | L.5.17 |
| B245 | (I.A) | L.5.18 |
| B246 | (I.A) | L.5.19 |
| B247 | (I.A) | L.5.20 |
| B248 | (I.A) | L.5.21 |
| B249 | (I.A) | L.5.22 |
| B250 | (I.A) | L.5.23 |
| B251 | (I.A) | L.5.24 |
| B252 | (I.A) | L.5.25 |
| B253 | (I.A) | L.5.26 |
| B254 | (I.A) | L.5.27 |
| B255 | (I.A) | L.5.28 |
| B256 | (I.A) | L.5.29 |
| B257 | (I.A) | L.5.30 |
| B258 | (I.A) | L.5.31 |
| B259 | (I.A) | L.5.32 |
| B260 | (I.A) | L.5.33 |
| B261 | (I.A) | L.5.34 |
| B262 | (I.A) | L.5.35 |
| B263 | (I.A) | L.5.36 |
| B264 | (I.A) | L.5.37 |
| B265 | (I.A) | L.5.38 |
| B266 | (I.A) | L.5.39 |
| B267 | (I.A) | L.5.40 |
| B268 | (I.A) | L.5.41 |
| B269 | (I.A) | L.5.42 |
| B270 | (I.A) | L.5.43 |
| B271 | (I.A) | L.5.44 |
| B272 | (I.A) | L.5.45 |
| B273 | (I.A) | L.5.46 |
| B274 | (I.A) | L.5.47 |
| B275 | (I.A) | L.5.48 |
| B276 | (I.A) | L.5.49 |
| B277 | (I.A) | L.5.50 |
| B278 | (I.A) | L.5.51 |
| B279 | (I.A) | L.5.52 |
| B280 | (I.A) | L.5.53 |
| B281 | (I.A) | L.5.54 |
| B282 | (I.A) | L.5.55 |
| B283 | (I.A) | L.5.56 |
| B284 | (I.A) | L.5.57 |
| B285 | (I.A) | L.5.58 |
| B286 | (I.A) | L.5.59 |
| B287 | (I.A) | L.5.60 |
| B288 | (I.A) | L.5.61 |
| B289 | (I.A) | L.5.62 |
| B290 | (I.A) | L.5.63 |
| B291 | (I.A) | L.5.64 |
| B292 | (I.A) | L.5.65 |
| B293 | (I.A) | L.5.66 |
| B294 | (I.A) | L.5.67 |
| B295 | (I.A) | L.5.68 |
| B296 | (I.A) | L.5.69 |
| B297 | (I.A) | L.5.70 |
| B298 | (I.A) | L.5.71 |
| B299 | (I.A) | L.5.72 |
| B300 | (I.A) | L.5.73 |
| B301 | (I.A) | L.5.74 |
| B302 | (I.A) | L.5.75 |
| B301 | (I.A) | L.5.76 |
| B304 | (I.A) | L.5.77 |
| B305 | (I.A) | L.5.78 |
| B306 | (I.A) | L.5.79 |
| B307 | (I.A) | L.5.80 |
| B308 | (I.A) | L.5.81 |
| B309 | (I.A) | L.5.82 |
| B310 | (I.A) | L.5.83 |
| B311 | (I.A) | L.5.84 |
| B312 | (I.A) | L.6.1 |
| B313 | (I.A) | L.6.2 |
| B314 | (I.A) | L.6.3 |
| B315 | (I.A) | L.6.4 |
| B316 | (I.A) | L.6.5 |
| B317 | (I.A) | L.6.6 |
| B318 | (I.A) | L.6.7 |
| B319 | (I.A) | L.6.8 |
| B320 | (I.A) | L.6.9 |
| B321 | (I.A) | L.6.10 |
| B322 | (I.A) | L.6.11 |
| B323 | (I.A) | L.6.12 |
| B324 | (I.A) | L.6.13 |
| B325 | (I.A) | L.6.14 |
| B326 | (I.A) | L.6.15 |
| B327 | (I.A) | L.6.16 |
| B328 | (I.A) | L.6.17 |
| B329 | (I.A) | L.6.18 |

B = Mixture;
I = compound I;
II = compound II

TABLE 51

| B | I | II |
|---|---|---|
| B330 | (I.B) | L.1.1 |
| B331 | (I.B) | L.1.2 |
| B332 | (I.B) | L.1.3 |
| B333 | (I.B) | L.1.4 |
| B334 | (I.B) | L.1.5 |
| B335 | (I.B) | L.1.6 |
| B336 | (I.B) | L.1.7 |
| B337 | (I.B) | L.1.8 |
| B338 | (I.B) | L.1.9 |
| B339 | (I.B) | L.1.10 |
| B340 | (I.B) | L.1.11 |
| B341 | (I.B) | L.1.12 |
| B342 | (I.B) | L.1.13 |
| B343 | (I.B) | L.1.14 |
| B344 | (I.B) | L.1.15 |
| B345 | (I.B) | L.1.16 |
| B346 | (I.B) | L.1.17 |
| B347 | (I.B) | L.1.18 |
| B348 | (I.B) | L.1.19 |
| B349 | (I.B) | L.1.20 |
| B350 | (I.B) | L.1.21 |
| B351 | (I.B) | L.1.22 |
| B352 | (I.B) | L.1.23 |
| B353 | (I.B) | L.1.24 |
| B354 | (I.B) | L.1.25 |
| B355 | (I.B) | L.1.26 |
| B356 | (I.B) | L.1.27 |
| B357 | (I.B) | L.1.28 |
| B358 | (I.B) | L.1.29 |
| B359 | (I.B) | L.1.30 |
| B360 | (I.B) | L.1.31 |
| B361 | (I.B) | L.1.32 |
| B362 | (I.B) | L.1.33 |
| B363 | (I.B) | L.1.34 |
| B364 | (I.B) | L.1.35 |
| B365 | (I.B) | L.1.36 |
| B366 | (I.B) | L.1.37 |
| B367 | (I.B) | L.1.38 |
| B368 | (I.B) | L.1.39 |
| B369 | (I.B) | L.1.40 |
| B370 | (I.B) | L.1.41 |
| B371 | (I.B) | L.1.42 |
| B372 | (I.B) | L.1.43 |
| B373 | (I.B) | L.1.44 |
| B374 | (I.B) | L.1.45 |
| B375 | (I.B) | L.1.46 |
| B376 | (I.B) | L.1.47 |
| B377 | (I.B) | L.1.48 |
| B378 | (I.B) | L.1.49 |
| B379 | (I.B) | L.1.50 |
| B380 | (I.B) | L.1.51 |
| B381 | (I.B) | L.1.52 |
| B382 | (I.B) | L.1.53 |
| B383 | (I.B) | L.1.54 |
| B384 | (I.B) | L.1.55 |
| B385 | (I.B) | L.1.56 |
| B386 | (I.B) | L.1.57 |
| B387 | (I.B) | L.1.58 |
| B388 | (I.B) | L.1.59 |
| B389 | (I.B) | L.1.60 |
| B390 | (I.B) | L.1.61 |
| B391 | (I.B) | L.1.62 |
| B392 | (I.B) | L.1.63 |
| B393 | (I.B) | L.1.64 |
| B394 | (I.B) | L.1.65 |
| B395 | (I.B) | L.1.66 |
| B396 | (I.B) | L.1.67 |
| B397 | (I.B) | L.1.68 |
| B398 | (I.B) | L.1.69 |
| B399 | (I.B) | L.1.70 |
| B400 | (I.B) | L.1.71 |
| B401 | (I.B) | L.1.72 |
| B402 | (I.B) | L.1.73 |
| B403 | (I.B) | L.1.74 |
| B404 | (I.B) | L.1.75 |
| B405 | (I.B) | L.1.76 |
| B406 | (I.B) | L.1.77 |
| B407 | (I.B) | L.1.78 |
| B408 | (I.B) | L.1.79 |
| B409 | (I.B) | L.1.80 |
| B410 | (I.B) | L.1.81 |
| B411 | (I.B) | L.1.82 |
| B412 | (I.B) | L.1.83 |
| B413 | (I.B) | L.1.84 |
| B414 | (I.B) | L.1.85 |
| B415 | (I.B) | L.1.86 |
| B416 | (I.B) | L.1.87 |
| B417 | (I.B) | L.1.88 |
| B418 | (I.B) | L.1.89 |
| B419 | (I.B) | L.1.90 |
| B420 | (I.B) | L.1.91 |
| B421 | (I.B) | L.1.92 |
| B422 | (I.B) | L.1.93 |
| B423 | (I.B) | L.1.94 |
| B424 | (I.B) | L.1.95 |
| B425 | (I.B) | L.1.96 |
| B426 | (I.B) | L.2.1 |
| B427 | (I.B) | L.2.2 |
| B428 | (I.B) | L.2.3 |
| B429 | (I.B) | L.2.4 |
| B430 | (I.B) | L.2.5 |
| B431 | (I.B) | L.2.6 |
| B432 | (I.B) | L.2.7 |
| B433 | (I.B) | L.2.8 |
| B434 | (I.B) | L.2.9 |
| B435 | (I.B) | L.2.10 |
| B436 | (I.B) | L.2.11 |
| B437 | (I.B) | L.2.12 |
| B438 | (I.B) | L.2.13 |
| B439 | (I.B) | L.2.14 |
| B440 | (I.B) | L.2.15 |
| B441 | (I.B) | L.2.16 |
| B442 | (I.B) | L.2.17 |
| B443 | (I.B) | L.2.18 |
| B444 | (I.B) | L.2.19 |
| B445 | (I.B) | L.2.20 |
| B446 | (I.B) | L.2.21 |
| B447 | (I.B) | L.2.22 |
| B448 | (I.B) | L.2.23 |
| B449 | (I.B) | L.2.24 |
| B450 | (I.B) | L.2.25 |
| B451 | (I.B) | L.2.26 |
| B452 | (I.B) | L.2.27 |
| B453 | (I.B) | L.2.28 |
| B454 | (I.B) | L.2.29 |
| B455 | (I.B) | L.2.30 |
| B456 | (I.B) | L.2.31 |
| B457 | (I.B) | L.2.32 |
| B458 | (I.B) | L.2.33 |
| B459 | (I.B) | L.3.1 |
| B460 | (I.B) | L.3.2 |
| B461 | (I.B) | L.3.3 |
| B462 | (I.B) | L.3.4 |
| B463 | (I.B) | L.3.5 |
| B464 | (I.B) | L.3.6 |
| B465 | (I.B) | L.3.7 |
| B466 | (I.B) | L.3.8 |
| B467 | (I.B) | L.3.9 |
| B468 | (I.B) | L.3.10 |
| B469 | (I.B) | L.3.11 |
| B470 | (I.B) | L.3.12 |
| B471 | (I.B) | L.3.13 |
| B472 | (I.B) | L.3.14 |
| B473 | (I.B) | L.3.15 |
| B474 | (I.B) | L.3.16 |
| B475 | (I.B) | L.3.17 |
| B476 | (I.B) | L.3.18 |
| B477 | (I.B) | L.3.19 |
| B478 | (I.B) | L.3.20 |
| B479 | (I.B) | L.3.21 |
| B480 | (I.B) | L.3.22 |
| B481 | (I.B) | L.3.23 |
| B482 | (I.B) | L.3.24 |
| B483 | (I.B) | L.3.25 |
| B484 | (I.B) | L.3.26 |
| B485 | (I.B) | L.3.27 |
| B486 | (I.B) | L.3.28 |
| B487 | (I.B) | L.3.29 |
| B488 | (I.B) | L.3.30 |
| B489 | (I.B) | L.3.31 |
| B490 | (I.B) | L.3.32 |
| B491 | (I.B) | L.3.33 |
| B492 | (I.B) | L.3.34 |
| B493 | (I.B) | L.3.35 |
| B494 | (I.B) | L.3.36 |
| B495 | (I.B) | L.3.37 |
| B496 | (I.B) | L.3.38 |
| B497 | (I.B) | L.3.39 |
| B498 | (I.B) | L.3.40 |
| B499 | (I.B) | L.3.41 |
| B500 | (I.B) | L.3.42 |
| B501 | (I.B) | L.3.43 |
| B502 | (I.B) | L.3.44 |
| B503 | (I.B) | L.3.45 |
| B504 | (I.B) | L.3.46 |
| B505 | (I.B) | L.3.47 |
| B506 | (I.B) | L.3.48 |
| B507 | (I.B) | L.3.49 |
| B508 | (I.B) | L.3.50 |
| B509 | (I.B) | L.3.51 |
| B510 | (I.B) | L.3.52 |
| B511 | (I.B) | L.3.53 |
| B512 | (I.B) | L.3.54 |
| B513 | (I.B) | L.3.55 |
| B514 | (I.B) | L.3.56 |
| B515 | (I.B) | L.3.57 |
| B516 | (I.B) | L.3.58 |
| B517 | (I.B) | L.3.59 |
| B518 | (I.B) | L.3.60 |
| B519 | (I.B) | L.3.61 |
| B520 | (I.B) | L.3.62 |
| B521 | (I.B) | L.3.63 |
| B522 | (I.B) | L.3.1 |
| B523 | (I.B) | L.3.2 |
| B524 | (I.B) | L.4.1 |
| B525 | (I.B) | L.4.2 |
| B526 | (I.B) | L.4.3 |
| B527 | (I.B) | L.4.4 |
| B528 | (I.B) | L.4.5 |
| B529 | (I.B) | L.4.6 |
| B530 | (I.B) | L.4.7 |
| B531 | (I.B) | L.4.8 |
| B532 | (I.B) | L.4.9 |
| B533 | (I.B) | L.4.10 |
| B534 | (I.B) | L.4.11 |
| B535 | (I.B) | L.4.12 |
| B536 | (I.B) | L.4.13 |
| B537 | (I.B) | L.4.14 |
| B538 | (I.B) | L.4.15 |
| B539 | (I.B) | L.4.16 |
| B540 | (I.B) | L.4.17 |
| B541 | (I.B) | L.4.18 |
| B542 | (I.B) | L.4.19 |
| B543 | (I.B) | L.4.20 |
| B544 | (I.B) | L.4.21 |
| B545 | (I.B) | L.4.22 |
| B546 | (I.B) | L.4.23 |
| B547 | (I.B) | L.4.24 |
| B548 | (I.B) | L.4.25 |
| B549 | (I.B) | L.4.26 |
| B550 | (I.B) | L.4.27 |
| B551 | (I.B) | L.4.28 |
| B552 | (I.B) | L.4.29 |
| B553 | (I.B) | L.4.30 |
| B554 | (I.B) | L.4.31 |
| B555 | (I.B) | L.4.32 |
| B556 | (I.B) | L.4.33 |
| B557 | (I.B) | L.5.1 |
| B558 | (I.B) | L.5.2 |
| B559 | (I.B) | L.5.3 |
| B560 | (I.B) | L.5.4 |
| B561 | (I.B) | L.5.5 |
| B562 | (I.B) | L.5.6 |
| B563 | (I.B) | L.5.7 |
| B564 | (I.B) | L.5.8 |
| B565 | (I.B) | L.5.9 |
| B566 | (I.B) | L.5.10 |
| B567 | (I.B) | L.5.11 |
| B568 | (I.B) | L.5.12 |
| B569 | (I.B) | L.5.13 |
| B570 | (I.B) | L.5.14 |
| B571 | (I.B) | L.5.15 |
| B572 | (I.B) | L.5.16 |
| B573 | (I.B) | L.5.17 |
| B574 | (I.B) | L.5.18 |
| B575 | (I.B) | L.5.19 |
| B576 | (I.B) | L.5.20 |
| B577 | (I.B) | L.5.21 |
| B578 | (I.B) | L.5.22 |
| B579 | (I.B) | L.5.23 |
| B580 | (I.B) | L.5.24 |
| B581 | (I.B) | L.5.25 |
| B582 | (I.B) | L.5.26 |
| B583 | (I.B) | L.5.27 |
| B584 | (I.B) | L.5.28 |
| B585 | (I.B) | L.5.29 |
| B586 | (I.B) | L.5.30 |
| B587 | (I.B) | L.5.31 |
| B588 | (I.B) | L.5.32 |
| B589 | (I.B) | L.5.33 |
| B590 | (I.B) | L.5.34 |
| B591 | (I.B) | L.5.35 |
| B592 | (I.B) | L.5.36 |
| B593 | (I.B) | L.5.37 |
| B594 | (I.B) | L.5.38 |
| B595 | (I.B) | L.5.39 |
| B596 | (I.B) | L.5.40 |
| B597 | (I.B) | L.5.41 |
| B598 | (I.B) | L.5.42 |
| B599 | (I.B) | L.5.43 |
| B600 | (I.B) | L.5.44 |
| B601 | (I.B) | L.5.45 |
| B602 | (I.B) | L.5.46 |
| B603 | (I.B) | L.5.47 |
| B604 | (I.B) | L.5.48 |
| B605 | (I.B) | L.5.49 |
| B606 | (I.B) | L.5.50 |
| B607 | (I.B) | L.5.51 |
| B608 | (I.B) | L.5.52 |
| B609 | (I.B) | L.5.53 |
| B610 | (I.B) | L.5.54 |
| B611 | (I.B) | L.5.55 |
| B612 | (I.B) | L.5.56 |
| B613 | (I.B) | L.5.57 |
| B614 | (I.B) | L.5.58 |
| B615 | (I.B) | L.5.59 |
| B616 | (I.B) | L.5.60 |
| B617 | (I.B) | L.5.61 |
| B618 | (I.B) | L.5.62 |
| B619 | (I.B) | L.5.63 |
| B620 | (I.B) | L.5.64 |
| B621 | (I.B) | L.5.65 |
| B622 | (I.B) | L.5.66 |
| B623 | (I.B) | L.5.67 |
| B624 | (I.B) | L.5.68 |
| B625 | (I.B) | L.5.69 |
| B626 | (I.B) | L.5.70 |
| B627 | (I.B) | L.5.71 |
| B628 | (I.B) | L.5.72 |
| B629 | (I.B) | L.5.73 |
| B630 | (I.B) | L.5.74 |
| B631 | (I.B) | L.5.75 |
| B632 | (I.B) | L.5.76 |
| B633 | (I.B) | L.5.77 |
| B634 | (I.B) | L.5.78 |
| B635 | (I.B) | L.5.79 |
| B636 | (I.B) | L.5.80 |
| B637 | (I.B) | L.5.81 |
| B638 | (I.B) | L.5.82 |
| B639 | (I.B) | L.5.83 |
| B640 | (I.B) | L.5.84 |
| B641 | (I.B) | L.6.1 |
| B642 | (I.B) | L.6.2 |
| B643 | (I.B) | L.6.3 |
| B644 | (I.B) | L.6.4 |
| B645 | (I.B) | L.6.5 |
| B646 | (I.B) | L.6.6 |
| B647 | (I.B) | L.6.7 |
| B648 | (I.B) | L.6.8 |
| B649 | (I.B) | L.6.9 |
| B850 | (I.B) | L.6.10 |
| B651 | (I.B) | L.6.11 |
| B652 | (I.B) | L.6.12 |
| B653 | (I.B) | L.6.13 |
| B654 | (I.B) | L.6.14 |
| B655 | (I.B) | L.6.15 |
| B656 | (I.B) | L.6.16 |
| B657 | (I.B) | L.6.17 |
| B658 | (I.B) | L.6.18 |

B = Mixture;
I = compound I;
II = compound II

TABLE 52

| B | I | II |
|---|---|---|
| B659 | (I.C) | L.1.1 |
| B660 | (I.C) | L.1.2 |
| B661 | (I.C) | L.1.3 |
| B662 | (I.C) | L.1.4 |
| B663 | (I.C) | L.1.5 |
| B664 | (I.C) | L.1.6 |
| B665 | (I.C) | L.1.7 |
| B666 | (I.C) | L.1.8 |
| B667 | (I.C) | L.1.9 |
| B668 | (I.C) | L.1.10 |
| B669 | (I.C) | L.1.11 |
| B670 | (I.C) | L.1.12 |
| B671 | (I.C) | L.1.13 |
| B672 | (I.C) | L.1.14 |
| B673 | (I.C) | L.1.15 |
| B674 | (I.C) | L.1.16 |
| B675 | (I.C) | L.1.17 |
| B676 | (I.C) | L.1.18 |
| B677 | (I.C) | L.1.19 |
| B678 | (I.C) | L.1.20 |
| B679 | (I.C) | L.1.21 |
| B680 | (I.C) | L.1.22 |
| B681 | (I.C) | L.1.23 |
| B682 | (I.C) | L.1.24 |
| B683 | (I.C) | L.1.25 |
| B684 | (I.C) | L.1.26 |
| B685 | (I.C) | L.1.27 |
| B686 | (I.C) | L.1.28 |
| B687 | (I.C) | L.1.29 |
| B688 | (I.C) | L.1.30 |
| B689 | (I.C) | L.1.31 |
| B690 | (I.C) | L.1.32 |
| B691 | (I.C) | L.1.33 |
| B692 | (I.C) | L.1.34 |
| B693 | (I.C) | L.1.35 |
| B694 | (I.C) | L.1.36 |
| B695 | (I.C) | L.1.37 |
| B696 | (I.C) | L.1.38 |
| B697 | (I.C) | L.1.39 |
| B698 | (I.C) | L.1.40 |
| B699 | (I.C) | L.1.41 |
| B700 | (I.C) | L.1.42 |
| B701 | (I.C) | L.1.43 |
| B702 | (I.C) | L.1.44 |
| B703 | (I.C) | L.1.45 |
| B704 | (I.C) | L.1.46 |
| B705 | (I.C) | L.1.47 |
| B706 | (I.C) | L.1.48 |
| B707 | (I.C) | L.1.49 |
| B708 | (I.C) | L.1.50 |
| B709 | (I.C) | L.1.51 |
| B710 | (I.C) | L.1.52 |
| B711 | (I.C) | L.1.53 |
| B712 | (I.C) | L.1.54 |
| B713 | (I.C) | L.1.55 |
| B714 | (I.C) | L.1.56 |
| B715 | (I.C) | L.1.57 |
| B716 | (I.C) | L.1.58 |
| B717 | (I.C) | L.1.59 |
| B718 | (I.C) | L.1.60 |
| B719 | (I.C) | L.1.61 |
| B720 | (I.C) | L.1.62 |
| B721 | (I.C) | L.1.63 |
| B722 | (I.C) | L.1.64 |
| B723 | (I.C) | L.1.65 |
| B724 | (I.C) | L.1.66 |
| B725 | (I.C) | L.1.67 |
| B726 | (I.C) | L.1.68 |
| B727 | (I.C) | L.1.69 |
| B728 | (I.C) | L.1.70 |
| B729 | (I.C) | L.1.71 |
| B730 | (I.C) | L.1.72 |
| B731 | (I.C) | L.1.73 |
| B732 | (I.C) | L.1.74 |
| B733 | (I.C) | L.1.75 |
| B734 | (I.C) | L.1.76 |
| B735 | (I.C) | L.1.77 |
| B736 | (I.C) | L.1.78 |
| B737 | (I.C) | L.1.79 |
| B738 | (I.C) | L.1.80 |
| B739 | (I.C) | L.1.81 |
| B740 | (I.C) | L.1.82 |
| B741 | (I.C) | L.1.83 |
| B742 | (I.C) | L.1.84 |
| B743 | (I.C) | L.1.85 |
| B744 | (I.C) | L.1.86 |
| B745 | (I.C) | L.1.87 |
| B746 | (I.C) | L.1.88 |
| B747 | (I.C) | L.1.89 |
| B748 | (I.C) | L.1.90 |
| B749 | (I.C) | L.1.91 |
| B750 | (I.C) | L.1.92 |
| B751 | (I.C) | L.1.93 |
| B752 | (I.C) | L.1.94 |
| B753 | (I.C) | L.1.95 |
| B754 | (I.C) | L.1.96 |
| B755 | (I.C) | L.2.1 |
| B756 | (I.C) | L.2.2 |
| B757 | (I.C) | L.2.3 |
| B758 | (I.C) | L.2.4 |
| B759 | (I.C) | L.2.5 |
| B760 | (I.C) | L.2.6 |
| B761 | (I.C) | L.2.7 |
| B762 | (I.C) | L.2.8 |
| B763 | (I.C) | L.2.9 |
| B764 | (I.C) | L.2.10 |
| B765 | (I.C) | L.2.11 |
| B766 | (I.C) | L.2.12 |
| B767 | (I.C) | L.2.13 |
| B768 | (I.C) | L.2.14 |
| B769 | (I.C) | L.2.15 |
| B770 | (I.C) | L.2.16 |
| B771 | (I.C) | L.2.17 |
| B772 | (I.C) | L.2.18 |
| B773 | (I.C) | L.2.19 |
| B774 | (I.C) | L.2.20 |
| B775 | (I.C) | L.2.21 |
| B776 | (I.C) | L.2.22 |
| B777 | (I.C) | L.2.23 |
| B778 | (I.C) | L.2.24 |
| B779 | (I.C) | L.2.25 |
| B780 | (I.C) | L.2.26 |
| B781 | (I.C) | L.2.27 |
| B782 | (I.C) | L.2.28 |
| B783 | (I.C) | L.2.29 |
| B784 | (I.C) | L.2.30 |
| B785 | (I.C) | L.2.31 |
| B786 | (I.C) | L.2.32 |
| B787 | (I.C) | L.2.33 |
| B788 | (I.C) | L.3.1 |
| B789 | (I.C) | L.3.2 |
| B790 | (I.C) | L.3.3 |
| B791 | (I.C) | L.3.4 |
| B792 | (I.C) | L.3.5 |
| B793 | (I.C) | L.3.6 |
| B794 | (I.C) | L.3.7 |
| B795 | (I.C) | L.3.8 |
| B796 | (I.C) | L.3.9 |
| B797 | (I.C) | L.3.10 |
| B798 | (I.C) | L.3.11 |
| B799 | (I.C) | L.3.12 |
| B800 | (I.C) | L.3.13 |
| B801 | (I.C) | L.3.14 |
| B802 | (I.C) | L.3.15 |
| B803 | (I.C) | L.3.16 |
| B804 | (I.C) | L.3.17 |
| B805 | (I.C) | L.3.18 |
| B806 | (I.C) | L.3.19 |
| B807 | (I.C) | L.3.20 |
| B808 | (I.C) | L.3.21 |
| B809 | (I.C) | L.3.22 |
| B810 | (I.C) | L.3.23 |
| B811 | (I.C) | L.3.24 |
| B812 | (I.C) | L.3.25 |
| B813 | (I.C) | L.3.26 |
| B814 | (I.C) | L.3.27 |
| B815 | (I.C) | L.3.28 |
| B816 | (I.C) | L.3.29 |
| B817 | (I.C) | L.3.30 |
| B818 | (I.C) | L.3.31 |
| B819 | (I.C) | L.3.32 |
| B820 | (I.C) | L.3.33 |
| B821 | (I.C) | L.3.34 |
| B822 | (I.C) | L.3.35 |
| B823 | (I.C) | L.3.36 |
| B824 | (I.C) | L.3.37 |
| B825 | (I.C) | L.3.38 |
| B826 | (I.C) | L.3.39 |
| B827 | (I.C) | L.3.40 |
| B828 | (I.C) | L.3.41 |
| B829 | (I.C) | L.3.42 |
| B830 | (I.C) | L.3.43 |
| B831 | (I.C) | L.3.44 |
| B832 | (I.C) | L.3.45 |
| B833 | (I.C) | L.3.46 |
| B834 | (I.C) | L.3.47 |
| B835 | (I.C) | L.3.48 |
| B836 | (I.C) | L.3.49 |
| B837 | (I.C) | L.3.50 |
| B838 | (I.C) | L.3.51 |
| B839 | (I.C) | L.3.52 |
| B840 | (I.C) | L.3.53 |
| B841 | (I.C) | L.3.54 |
| B842 | (I.C) | L.3.55 |
| B843 | (I.C) | L.3.56 |
| B844 | (I.C) | L.3.57 |
| B845 | (I.C) | L.3.58 |
| B846 | (I.C) | L.3.59 |
| B847 | (I.C) | L.3.60 |
| B848 | (I.C) | L.3.61 |
| B849 | (I.C) | L.3.62 |
| B850 | (I.C) | L.3.63 |
| B851 | (I.C) | L.3.1 |
| B852 | (I.C) | L.3.2 |
| B853 | (I.C) | L.4.1 |
| B854 | (I.C) | L.4.2 |
| B855 | (I.C) | L.4.3 |
| B856 | (I.C) | L.4.4 |
| B857 | (I.C) | L.4.5 |
| B858 | (I.C) | L.4.6 |
| B859 | (I.C) | L.4.7 |
| B860 | (I.C) | L.4.8 |
| B861 | (I.C) | L.4.9 |
| B862 | (I.C) | L.4.10 |
| B863 | (I.C) | L.4.11 |
| B864 | (I.C) | L.4.12 |
| B865 | (I.C) | L.4.13 |
| B866 | (I.C) | L.4.14 |
| B867 | (I.C) | L.4.15 |
| B868 | (I.C) | L.4.16 |
| B869 | (I.C) | L.4.17 |
| B870 | (I.C) | L.4.18 |
| B871 | (I.C) | L.4.19 |
| B872 | (I.C) | L.4.20 |
| B873 | (I.C) | L.4.21 |
| B874 | (I.C) | L.4.22 |
| B875 | (I.C) | L.4.23 |
| B876 | (I.C) | L.4.24 |
| B877 | (I.C) | L.4.25 |
| B878 | (I.C) | L.4.26 |
| B879 | (I.C) | L.4.27 |
| B880 | (I.C) | L.4.28 |
| B881 | (I.C) | L.4.29 |
| B882 | (I.C) | L.4.30 |
| B883 | (I.C) | L.4.31 |
| B884 | (I.C) | L.4.32 |
| B885 | (I.C) | L.4.33 |
| B886 | (I.C) | L.5.1 |
| B887 | (I.C) | L.5.2 |
| B888 | (I.C) | L.5.3 |
| B889 | (I.C) | L.5.4 |
| B890 | (I.C) | L.5.5 |
| B891 | (I.C) | L.5.6 |
| B892 | (I.C) | L.5.7 |
| B893 | (I.C) | L.5.8 |
| B894 | (I.C) | L.5.9 |
| B895 | (I.C) | L.5.10 |
| B896 | (I.C) | L.5.11 |
| B897 | (I.C) | L.5.12 |
| B898 | (I.C) | L.5.13 |
| B899 | (I.C) | L.5.14 |
| B900 | (I.C) | L.5.15 |
| B901 | (I.C) | L.5.16 |
| B902 | (I.C) | L.5.17 |
| B903 | (I.C) | L.5.18 |
| B904 | (I.C) | L.5.19 |
| B905 | (I.C) | L.5.20 |
| B906 | (I.C) | L.5.21 |
| B907 | (I.C) | L.5.22 |
| B908 | (I.C) | L.5.23 |
| B909 | (I.C) | L.5.24 |
| B910 | (I.C) | L.5.25 |
| B911 | (I.C) | L.5.26 |
| B912 | (I.C) | L.5.27 |
| B913 | (I.C) | L.5.28 |
| B914 | (I.C) | L.5.29 |
| B915 | (I.C) | L.5.30 |
| B916 | (I.C) | L.5.31 |
| B917 | (I.C) | L.5.32 |
| B918 | (I.C) | L.5.33 |
| B919 | (I.C) | L.5.34 |
| B920 | (I.C) | L.5.35 |
| B921 | (I.C) | L.5.36 |
| B922 | (I.C) | L.5.37 |
| B923 | (I.C) | L.5.38 |
| B924 | (I.C) | L.5.39 |
| B925 | (I.C) | L.5.40 |
| B926 | (I.C) | L.5.41 |
| B927 | (I.C) | L.5.42 |
| B928 | (I.C) | L.5.43 |
| B929 | (I.C) | L.5.44 |
| B930 | (I.C) | L.5.45 |
| B931 | (I.C) | L.5.46 |
| B932 | (I.C) | L.5.47 |
| B933 | (I.C) | L.5.48 |
| B934 | (I.C) | L.5.49 |
| B935 | (I.C) | L.5.50 |
| B936 | (I.C) | L.5.51 |
| B937 | (I.C) | L.5.52 |
| B938 | (I.C) | L.5.53 |
| B939 | (I.C) | L.5.54 |
| B940 | (I.C) | L.5.55 |
| B941 | (I.C) | L.5.56 |
| B942 | (I.C) | L.5.57 |
| B943 | (I.C) | L.5.58 |
| B944 | (I.C) | L.5.59 |
| B945 | (I.C) | L.5.60 |
| B946 | (I.C) | L.5.61 |
| B947 | (I.C) | L.5.62 |
| B948 | (I.C) | L.5.63 |
| B949 | (I.C) | L.5.64 |
| B950 | (I.C) | L.5.65 |
| B951 | (I.C) | L.5.66 |
| B952 | (I.C) | L.5.67 |
| B953 | (I.C) | L.5.68 |
| B954 | (I.C) | L.5.69 |
| B955 | (I.C) | L.5.70 |
| B956 | (I.C) | L.5.71 |
| B957 | (I.C) | L.5.72 |
| B958 | (I.C) | L.5.73 |
| B959 | (I.C) | L.5.74 |
| B960 | (I.C) | L.5.75 |
| B961 | (I.C) | L.5.76 |
| B962 | (I.C) | L.5.77 |
| B963 | (I.C) | L.5.78 |
| B964 | (I.C) | L.5.79 |
| B965 | (I.C) | L.5.80 |
| B966 | (I.C) | L.5.81 |
| B967 | (I.C) | L.5.82 |
| B968 | (I.C) | L.5.83 |
| B969 | (I.C) | L.5.84 |
| B970 | (I.C) | L.6.1 |
| B971 | (I.C) | L.6.2 |
| B972 | (I.C) | L.6.3 |
| B973 | (I.C) | L.6.4 |
| B974 | (I.C) | L.6.5 |
| B975 | (I.C) | L.6.6 |
| B976 | (I.C) | L.6.7 |
| B977 | (I.C) | L.6.8 |
| B978 | (I.C) | L.6.9 |
| B979 | (I.C) | L.6.10 |
| B980 | (I.C) | L.6.11 |
| B981 | (I.C) | L.6.12 |
| B982 | (I.C) | L.6.13 |
| B983 | (I.C) | L.6.14 |
| B984 | (I.C) | L.6.15 |
| B985 | (I.C) | L.6.16 |
| B986 | (I.C) | L.6.17 |
| B987 | (I.C) | L.6.18 |

B = Mixture;
I = compound I;
II = compound II

TABLE 53

| B | I | II |
|---|---|---|
| B988 | (I.D) | L.1.1 |
| B989 | (I.D) | L.1.2 |
| B990 | (I.D) | L.1.3 |
| B991 | (I.D) | L.1.4 |
| B992 | (I.D) | L.1.5 |
| B993 | (I.D) | L.1.6 |
| B994 | (I.D) | L.1.7 |
| B995 | (I.D) | L.1.8 |
| B996 | (I.D) | L.1.9 |
| B997 | (I.D) | L.1.10 |
| B998 | (I.D) | L.1.11 |
| B999 | (I.D) | L.1.12 |
| B1000 | (I.D) | L.1.13 |
| B1001 | (I.D) | L.1.14 |
| B1002 | (I.D) | L.1.15 |
| B1003 | (I.D) | L.1.16 |
| B1004 | (I.D) | L.1.17 |
| B1005 | (I.D) | L.1.18 |
| B1006 | (I.D) | L.1.19 |
| B1007 | (I.D) | L.1.20 |
| B1008 | (I.D) | L.1.21 |
| B1009 | (I.D) | L.1.22 |
| B1010 | (I.D) | L.1.23 |
| B1011 | (I.D) | L.1.24 |
| B1012 | (I.D) | L.1.25 |
| B1013 | (I.D) | L.1.26 |
| B1014 | (I.D) | L.1.27 |
| B1015 | (I.D) | L.1.28 |
| B1016 | (I.D) | L.1.29 |
| B1017 | (I.D) | L.1.30 |
| B1018 | (I.D) | L.1.31 |
| B1019 | (I.D) | L.1.32 |
| B1020 | (I.D) | L.1.33 |
| B1021 | (I.D) | L.1.34 |
| B1022 | (I.D) | L.1.35 |
| B1023 | (I.D) | L.1.36 |
| B1024 | (I.D) | L.1.37 |
| B1025 | (I.D) | L.1.38 |
| B1026 | (I.D) | L.1.39 |
| B1027 | (I.D) | L.1.40 |
| B1028 | (I.D) | L.1.41 |
| B1029 | (I.D) | L.1.42 |
| B1030 | (I.D) | L.1.43 |
| B1031 | (I.D) | L.1.44 |
| B1032 | (I.D) | L.1.45 |
| B1033 | (I.D) | L.1.46 |
| B1034 | (I.D) | L.1.47 |
| B1035 | (I.D) | L.1.48 |
| B1036 | (I.D) | L.1.49 |
| B1037 | (I.D) | L.1.50 |
| B1038 | (I.D) | L.1.51 |
| B1039 | (I.D) | L.1.52 |
| B1040 | (I.D) | L.1.53 |
| B1041 | (I.D) | L.1.54 |
| B1042 | (I.D) | L.1.55 |
| B1043 | (I.D) | L.1.56 |
| B1044 | (I.D) | L.1.57 |
| B1045 | (I.D) | L.1.58 |
| B1046 | (I.D) | L.1.69 |
| B1047 | (I.D) | L.1.60 |
| B1048 | (I.D) | L.1.61 |
| B1049 | (I.D) | L.1.62 |
| B1050 | (I.D) | L.1.63 |
| B1051 | (I.D) | L.1.64 |
| B1052 | (I.D) | L.1.65 |
| B1053 | (I.D) | L.1.66 |
| B1054 | (I.D) | L.1.67 |
| B1055 | (I.D) | L.1.68 |
| B1056 | (I.D) | L.1.69 |
| B1057 | (I.D) | L.1.70 |
| B1058 | (I.D) | L.1.71 |
| B1059 | (I.D) | L.1.72 |
| B1060 | (I.D) | L.1.73 |
| B1061 | (I.D) | L.1.74 |
| B1062 | (I.D) | L.1.75 |
| B1063 | (I.D) | L.1.76 |
| B1064 | (I.D) | L.1 77 |
| B1065 | (I.D) | L.1.78 |
| B1066 | (I.D) | L.1.79 |
| B1067 | (I.D) | L.1.80 |
| B1068 | (I.D) | L.1.81 |
| B1069 | (I.D) | L.1.82 |
| B1070 | (I.D) | L.1.83 |
| B1071 | (I.D) | L.1.84 |
| B1072 | (I.D) | L.1.85 |
| B1073 | (I.D) | L.1.86 |
| B1074 | (I.D) | L.1.87 |
| B1075 | (I.D) | L.1.88 |
| B1076 | (I.D) | L.1.89 |
| B1077 | (I.D) | L.1.90 |
| B1078 | (I.D) | L.1.91 |
| B1079 | (I.D) | L.1.92 |
| B1080 | (I.D) | L.1.93 |
| B1081 | (I.D) | L.1.94 |
| B1082 | (I.D) | L.1.95 |
| B1083 | (I.D) | L.1.96 |
| B1084 | (I.D) | L.2.1 |
| B1085 | (I.D) | L.2.2 |
| B1086 | (I.D) | L.2.3 |
| B1087 | (I.D) | L.2.4 |
| B1088 | (I.D) | L.2.5 |
| B1089 | (I.D) | L.2.6 |
| B1090 | (I.D) | L.2.7 |
| B1091 | (I.D) | L.2.8 |
| B1092 | (I.D) | L.2.9 |
| B1093 | (I.D) | L.2.10 |
| B1094 | (I.D) | L.2.11 |
| B1095 | (I.D) | L.2.12 |
| B1096 | (I.D) | L.2.13 |
| B1097 | (I.D) | L.2.14 |
| B1098 | (I.D) | L.2.15 |
| B1099 | (I.D) | L.2.16 |
| B1100 | (I.D) | L.2.17 |
| B1101 | (I.D) | L.2.18 |
| B1102 | (I.D) | L.2.19 |
| B1103 | (I.D) | L.2.20 |
| B1104 | (I.D) | L.2.21 |
| B1105 | (I.D) | L.2.22 |
| B1106 | (I.D) | L.2.23 |
| B1107 | (I.D) | L.2.24 |
| B1108 | (I.D) | L.2.25 |
| B1109 | (I.D) | L.2.26 |
| B1110 | (I.D) | L.2.27 |
| B1111 | (I.D) | L.2.28 |
| B1112 | (I.D) | L.2.29 |
| B1113 | (I.D) | L.2.30 |
| B1114 | (I.D) | L.2.31 |
| B1115 | (I.D) | L.2.32 |
| B1116 | (I.D) | L.2.33 |
| B1117 | (I.D) | L.3.1 |
| B1118 | (I.D) | L.3.2 |
| B1119 | (I.D) | L.3.3 |
| B1120 | (I.D) | L.3.4 |
| B1121 | (I.D) | L.3.5 |
| B1122 | (I.D) | L.3.6 |
| B1123 | (I.D) | L.3.7 |
| B1124 | (I.D) | L.3.8 |
| B1125 | (I.D) | L.3.9 |
| B1126 | (I.D) | L.3.10 |
| B1127 | (I.D) | L.3.11 |
| B1128 | (I.D) | L.3.12 |
| B1129 | (I.D) | L.3.13 |
| B1130 | (I.D) | L.3.14 |
| B1131 | (I.D) | L.3.15 |
| B1132 | (I.D) | L.3.16 |
| B1133 | (I.D) | L.3.17 |
| B1134 | (I.D) | L.3.18 |
| B1135 | (I.D) | L.3.19 |
| B1136 | (I.D) | L.3.20 |
| B1137 | (I.D) | L.3.21 |
| B1138 | (I.D) | L.3.22 |
| B1139 | (I.D) | L.3.23 |
| B1140 | (I.D) | L.3.24 |
| B1141 | (I.D) | L.3.25 |
| B1142 | (I.D) | L.3.28 |
| B1143 | (I.D) | L.3.27 |
| B1144 | (I.D) | L.3.28 |
| B1145 | (I.D) | L.3.29 |
| B1146 | (I.D) | L.3.30 |
| B1147 | (I.D) | L.3.31 |
| B1148 | (I.D) | L.3.32 |
| B1149 | (I.D) | L.3.33 |
| B1150 | (I.D) | L.3.34 |
| B1151 | (I.D) | L.3.35 |
| B1152 | (I.D) | L.3.36 |
| B1153 | (I.D) | L.3.37 |
| B1154 | (I.D) | L.3.38 |
| B1155 | (I.D) | L.3.39 |
| B1156 | (I.D) | L.3.40 |
| B1157 | (I.D) | L.3.41 |
| B1158 | (I.D) | L.3.42 |
| B1159 | (I.D) | L.3.43 |
| B1160 | (I.D) | L.3.44 |
| B1161 | (I.D) | L.3.45 |
| B1162 | (I.D) | L.3.46 |
| B1163 | (I.D) | L.3.47 |
| B1164 | (I.D) | L.3.48 |
| B1165 | (I.D) | L.3.49 |
| B1166 | (I.D) | L.3.50 |
| B1167 | (I.D) | L.3.51 |
| B1168 | (I.D) | L.3.52 |
| B1169 | (I.D) | L.3.53 |
| B1170 | (I.D) | L.3.54 |
| B1171 | (I.D) | L.3.55 |
| B1172 | (I.D) | L.3.56 |
| B1173 | (I.D) | L.3.57 |
| B1174 | (I.D) | L.3.58 |
| B1175 | (I.D) | L.3.59 |
| B1176 | (I.D) | L.3.60 |
| B1177 | (I.D) | L.3.61 |
| B1178 | (I.D) | L.3.62 |
| B1179 | (I.D) | L.3.63 |
| B1180 | (I.D) | L.3.1 |
| B1181 | (I.D) | L.3.2 |
| B1182 | (I.D) | L.4.1 |
| B1183 | (I.D) | L.4.2 |
| B1184 | (I.D) | L.4.3 |
| B1185 | (I.D) | L.4.4 |
| B1186 | (I.D) | L.4.5 |
| B1187 | (I.D) | L.4.6 |
| B1188 | (I.D) | L.4.7 |
| B1189 | (I.D) | L.4.8 |
| B1190 | (I.D) | L.4.9 |
| B1191 | (I.D) | L.4.10 |
| B1192 | (I.D) | L.4.11 |
| B1193 | (I.D) | L.4.12 |
| B1194 | (I.D) | L.4.13 |
| B1195 | (I.D) | L.4.14 |
| B1196 | (I.D) | L.4.15 |
| B1197 | (I.D) | L.4.16 |
| B1198 | (I.D) | L.4.17 |
| B1199 | (I.D) | L.4.18 |
| B1200 | (I.D) | L.4.19 |
| B1201 | (I.D) | L.4.20 |
| B1202 | (I.D) | L.4.21 |
| B1203 | (I.D) | L.4.22 |
| B1204 | (I.D) | L.4.23 |
| B1205 | (I.D) | L.4.24 |
| B1206 | (I.D) | L.4.25 |
| B1207 | (I.D) | L.4.26 |
| B1208 | (I.D) | L.4.27 |
| B1209 | (I.D) | L.4.28 |
| B1210 | (I.D) | L.4.29 |
| B1211 | (I.D) | L.4.30 |
| B1212 | (I.D) | L.4.31 |
| B1213 | (I.D) | L.4.32 |
| B1214 | (I.D) | L.4.33 |
| B1215 | (I.D) | L.5.1 |
| B1216 | (I.D) | L.5.2 |
| B1217 | (I.D) | L.5.3 |
| B1218 | (I.D) | L.5.4 |
| B1219 | (I.D) | L.5.5 |
| B1220 | (I.D) | L.5.6 |
| B1221 | (I.D) | L.5.7 |
| B1222 | (I.D) | L.5.8 |
| B1223 | (I.D) | L.5.9 |
| B1224 | (I.D) | L.5.10 |
| B1225 | (I.D) | L.5.11 |
| B1226 | (I.D) | L.5.12 |
| B1227 | (I.D) | L.5.13 |
| B1228 | (I.D) | L.5.14 |
| B1229 | (I.D) | L.5.15 |
| B1230 | (I.D) | L.5.16 |
| B1231 | (I.D) | L.5.17 |
| B1232 | (I.D) | L.5.18 |
| B1233 | (I.D) | L.5.19 |
| B1234 | (I.D) | L.5.20 |
| B1235 | (I.D) | L.5.21 |
| B1236 | (I.D) | L.5.22 |
| B1237 | (I.D) | L.5.23 |
| B1238 | (I.D) | L.5.24 |
| B1239 | (I.D) | L.5.25 |
| B1240 | (I.D) | L.5.26 |
| B1241 | (I.D) | L.5.27 |
| B1242 | (I.D) | L.5.28 |
| B1243 | (I.D) | L.5.29 |
| B1244 | (I.D) | L.5.30 |
| B1245 | (I.D) | L.5.31 |
| B1246 | (I.D) | L.5.32 |
| B1247 | (I.D) | L.5.33 |
| B1248 | (I.D) | L.5.34 |
| B1249 | (I.D) | L.5.35 |
| B1250 | (I.D) | L.5.36 |
| B1251 | (I.D) | L.5.37 |
| B1252 | (I.D) | L.5.38 |
| B1253 | (I.D) | L.5.39 |
| B1254 | (I.D) | L.5.40 |
| B1255 | (I.D) | L.5.41 |
| B1256 | (I.D) | L.5.42 |
| B1257 | (I.D) | L.5.43 |
| B1258 | (I.D) | L.5.44 |
| B1259 | (I.D) | L.5.45 |
| B1260 | (I.D) | L.5.46 |
| B1261 | (I.D) | L.5.47 |
| B1262 | (I.D) | L.5.48 |
| B1263 | (I.D) | L.5.49 |
| B1264 | (I.D) | L.5.50 |
| B1265 | (I.D) | L.5.51 |
| B1266 | (I.D) | L.5.52 |
| B1267 | (I.D) | L.5.53 |
| B1268 | (I.D) | L.5.54 |
| B1269 | (I.D) | L.5.55 |
| B1270 | (I.D) | L.5.56 |
| B1271 | (I.D) | L.5.57 |
| B1272 | (I.D) | L.5.58 |
| B1273 | (I.D) | L.5.59 |
| B1274 | (I.D) | L.5.60 |
| B1275 | (I.D) | L.5.61 |
| B1276 | (I.D) | L.5.62 |
| B1277 | (I.D) | L.5.63 |
| B1278 | (I.D) | L.5.64 |
| B1279 | (I.D) | L.5.65 |
| B1280 | (I.D) | L.5.66 |
| B1281 | (I.D) | L.5.67 |
| B1282 | (I.D) | L.5.68 |
| B1283 | (I.D) | L.5.69 |
| B1284 | (I.D) | L.5.70 |
| B1285 | (I.D) | L.5.71 |
| B1286 | (I.D) | L.5.72 |
| B1287 | (I.D) | L.5.73 |
| B1288 | (I.D) | L.5.74 |
| B1289 | (I.D) | L.5.75 |
| B1290 | (I.D) | L.5.76 |
| B1291 | (I.D) | L.5.77 |
| B1292 | (I.D) | L.5.78 |
| B1293 | (I.D) | L.5.79 |
| B1294 | (I.D) | L.5.80 |
| B1295 | (I.D) | L.5.81 |
| B1296 | (I.D) | L.5.82 |
| B1297 | (I.D) | L.5.83 |
| B1298 | (I.D) | L.5.84 |
| B1299 | (I.D) | L.6.1 |
| B1300 | (I.D) | L.6.2 |
| B1301 | (I.D) | L.6.3 |
| B1302 | (I.D) | L.6.4 |
| B1303 | (I.D) | L.6.5 |
| B1304 | (I.D) | L.6.6 |
| B1305 | (I.D) | L.6.7 |
| B1306 | (I.D) | L.6.8 |
| B1307 | (I.D) | L.6.9 |
| B1308 | (I.D) | L.6.10 |
| B1309 | (I.D) | L.6.11 |
| B1310 | (I.D) | L.6.12 |
| B1311 | (I.D) | L.6.13 |
| B1312 | (I.D) | L.6.14 |
| B1313 | (I.D) | L.6.15 |
| B1314 | (I.D) | L.6.16 |
| B1315 | (I.D) | L.6.17 |
| B1316 | (I.D) | L.6.18 |

B = Mixture;
I = compound I;
II = compound II

TABLE 54

| B | I | II |
|---|---|---|
| B1317 | (I.E) | L.1.1 |
| B1318 | (I.E) | L.1.2 |
| B1319 | (I.E) | L.1.3 |
| B1320 | (I.E) | L.1.4 |
| B1321 | (I.E) | L.1.5 |
| B1322 | (I.E) | L.1.6 |
| B1323 | (I.E) | L.1.7 |
| B1324 | (I.E) | L.1.8 |
| B1325 | (I.E) | L.1.9 |
| B1326 | (I.E) | L.1.10 |
| B1327 | (I.E) | L.1.11 |
| B1328 | (I.E) | L.1.12 |
| B1329 | (I.E) | L.1.13 |
| B1330 | (I.E) | L.1.14 |
| B1331 | (I.E) | L.1.15 |
| B1332 | (I.E) | L.1.16 |
| B1333 | (I.E) | L.1.17 |
| B1334 | (I.E) | L.1.18 |
| B1335 | (I.E) | L.1.19 |
| B1336 | (I.E) | L.1.20 |
| B1337 | (I.E) | L.1.21 |
| B1338 | (I.E) | L.1.22 |
| B1339 | (I.E) | L.1.23 |
| B1340 | (I.E) | L.1.24 |
| B1341 | (I.E) | L.1.25 |
| B1342 | (I.E) | L.1.26 |
| B1343 | (I.E) | L.1.27 |
| B1344 | (I.E) | L.1.28 |
| B1345 | (I.E) | L.1.29 |
| B1346 | (I.E) | L.1.30 |
| B1347 | (I.E) | L.1.31 |
| B1348 | (I.E) | L.1.32 |
| B1349 | (I.E) | L.1.33 |
| B1350 | (I.E) | L.1.34 |
| B1351 | (I.E) | L.1.35 |
| B1352 | (I.E) | L.1.36 |
| B1353 | (I.E) | L.1.37 |
| B1354 | (I.E) | L.1.38 |
| B1355 | (I.E) | L.1.39 |
| B1356 | (I.E) | L.1.40 |
| B1357 | (I.E) | L.1.41 |
| B1358 | (I.E) | L.1.42 |
| B1359 | (I.E) | L.1.43 |
| B1360 | (I.E) | L.1.44 |
| B1361 | (I.E) | L.1.45 |
| B1362 | (I.E) | L.1.46 |
| B1363 | (I.E) | L.1.47 |
| B1364 | (I.E) | L.1.48 |
| B1365 | (I.E) | L.1.49 |
| B1366 | (I.E) | L.1.50 |
| B1367 | (I.E) | L.1.51 |
| B1368 | (I.E) | L.1.52 |
| B1369 | (I.E) | L.1.53 |
| B1370 | (I.E) | L.1.54 |
| B1371 | (I.E) | L.1.55 |
| B1372 | (I.E) | L.1.56 |
| B1373 | (I.E) | L.1.57 |
| B1374 | (I.E) | L.1.58 |
| B1375 | (I.E) | L.1.59 |
| B1376 | (I.E) | L.1.60 |
| B1377 | (I.E) | L.1.61 |
| B1378 | (I.E) | L.1.62 |
| B1379 | (I.E) | L.1.63 |
| B1380 | (I.E) | L.1.64 |
| B1381 | (I.E) | L.1.65 |
| B1382 | (I.E) | L.1.66 |
| B1383 | (I.E) | L.1.67 |
| B1384 | (I.E) | L.1.68 |
| B1385 | (I.E) | L.1.69 |
| B1386 | (I.E) | L.1.70 |
| B1387 | (I.E) | L.1.71 |
| B1388 | (I.E) | L.1.72 |
| B1389 | (I.E) | L.1.73 |
| B1390 | (I.E) | L.1.74 |
| B1391 | (I.E) | L.1.75 |
| B1392 | (I.E) | L.1.76 |
| B1393 | (I.E) | L.1.77 |
| B1394 | (I.E) | L.1.78 |
| B1395 | (I.E) | L.1.79 |
| B1396 | (I.E) | L.1.80 |
| B1397 | (I.E) | L.1.81 |
| B1398 | (I.E) | L.1.82 |
| B1399 | (I.E) | L.1.83 |
| B1400 | (I.E) | L.1.84 |
| B1401 | (I.E) | L.1.85 |
| B1402 | (I.E) | L.1.86 |
| B1403 | (I.E) | L.1.87 |
| B1404 | (I.E) | L.1.88 |
| B1405 | (I.E) | L.1.89 |
| B1406 | (I.E) | L.1.90 |
| B1407 | (I.E) | L.1.91 |
| B1408 | (I.E) | L.1.92 |
| B1409 | (I.E) | L.1.93 |
| B1410 | (I.E) | L.1.94 |
| B1411 | (I.E) | L.1.95 |
| B1412 | (I.E) | L.1.96 |
| B1413 | (I.E) | L.2.1 |
| B1414 | (I.E) | L.2.2 |
| B1415 | (I.E) | L.2.3 |
| B1416 | (I.E) | L.2.4 |
| B1417 | (I.E) | L.2.5 |
| B1418 | (I.E) | L.2.6 |
| B1419 | (I.E) | L.2.7 |
| B1420 | (I.E) | L.2.8 |
| B1421 | (I.E) | L.2.9 |
| B1422 | (I.E) | L.2.10 |
| B1423 | (I.E) | L.2.11 |
| B1424 | (I.E) | L.2.12 |
| B1425 | (I.E) | L.2.13 |
| B1426 | (I.E) | L.2.14 |
| B1427 | (I.E) | L.2.15 |
| B1428 | (I.E) | L.2.16 |
| B1429 | (I.E) | L.2.17 |
| B1430 | (I.E) | L.2.18 |
| B1431 | (I.E) | L.2.19 |
| B1432 | (I.E) | L.2.20 |
| B1433 | (I.E) | L.2.21 |
| B1434 | (I.E) | L.2.22 |
| B1435 | (I.E) | L.2.23 |
| B1436 | (I.E) | L.2.24 |
| B1437 | (I.E) | L.2.25 |
| B1438 | (I.E) | L.2.26 |
| B1439 | (I.E) | L.2.27 |
| B1440 | (I.E) | L.2.28 |
| B1441 | (I.E) | L.2.29 |
| B1442 | (I.E) | L.2.30 |
| B1443 | (I.E) | L.2.31 |
| B1444 | (I.E) | L.2.32 |
| B1445 | (I.E) | L.2.33 |
| B1446 | (I.E) | L.3.1 |
| B1447 | (I.E) | L.3.2 |
| B1448 | (I.E) | L.3.3 |
| B1449 | (I.E) | L.3.4 |
| B1450 | (I.E) | L.3.5 |
| B1451 | (I.E) | L.3.6 |
| B1452 | (I.E) | L.3.7 |
| B1453 | (I.E) | L.3.8 |
| B1454 | (I.E) | L.3.9 |
| B1455 | (I.E) | L.3.10 |
| B1456 | (I.E) | L.3.11 |
| B1457 | (I.E) | L.3.12 |
| B1458 | (I.E) | L.3.13 |
| B1459 | (I.E) | L.3.14 |
| B1460 | (I.E) | L.3.15 |
| B1461 | (I.E) | L.3.16 |
| B1462 | (I.E) | L.3.17 |
| B1463 | (I.E) | L.3.18 |
| B1464 | (I.E) | L.3.19 |
| B1465 | (I.E) | L.3.20 |
| B1466 | (I.E) | L.3.21 |
| B1467 | (I.E) | L.3.22 |
| B1468 | (I.E) | L.3.23 |
| B1469 | (I.E) | L.3.24 |
| B1470 | (I.E) | L.3.25 |
| B1471 | (I.E) | L.3.26 |
| B1472 | (I.E) | L.3.27 |
| B1473 | (I.E) | L.3.28 |
| B1474 | (I.E) | L.3.29 |
| B1475 | (I.E) | L.3.30 |
| B1476 | (I.E) | L.3.31 |
| B1477 | (I.E) | L.3.32 |
| B1478 | (I.E) | L.3.33 |
| B1479 | (I.E) | L.3.34 |
| B1480 | (I.E) | L.3.35 |
| B1481 | (I.E) | L.3.36 |
| B1482 | (I.E) | L.3.37 |
| B1483 | (I.E) | L.3.38 |
| B1484 | (I.E) | L.3.39 |
| B1485 | (I.E) | L.3.40 |
| B1486 | (I.E) | L.3.41 |
| B1487 | (I.E) | L.3.42 |
| B1488 | (I.E) | L.3.43 |
| B1489 | (I.E) | L.3.44 |
| B1490 | (I.E) | L.3.45 |
| B1491 | (I.E) | L.3.46 |
| B1492 | (I.E) | L.3.47 |
| B1493 | (I.E) | L.3.48 |
| B1494 | (I.E) | L.3.49 |
| B1495 | (I.E) | L.3.50 |
| B1496 | (I.E) | L.3.51 |
| B1497 | (I.E) | L.3.52 |
| B1498 | (I.E) | L.3.53 |
| B1499 | (I.E) | L.3.54 |
| B1500 | (I.E) | L.3.55 |
| B1501 | (I.E) | L.3.56 |
| B1502 | (I.E) | L.3.57 |
| B1503 | (I.E) | L.3.58 |
| B1504 | (I.E) | L.3.59 |
| B1505 | (I.E) | L.3.60 |
| B1506 | (I.E) | L.3.61 |
| B1507 | (I.E) | L.3.62 |
| B1508 | (I.E) | L.3.63 |
| B1509 | (I.E) | L.3.1 |
| B1510 | (I.E) | L.3.2 |
| B1511 | (I.E) | L.4.1 |
| B1512 | (I.E) | L.4.2 |
| B1513 | (I.E) | L.4.3 |
| B1514 | (I.E) | L.4.4 |
| B1515 | (I.E) | L.4.5 |
| B1516 | (I.E) | L.4.6 |
| B1517 | (I.E) | L.4.7 |
| B1518 | (I.E) | L.4.8 |
| B1519 | (I.E) | L.4.9 |
| B1520 | (I.E) | L.4.10 |
| B1521 | (I.E) | L.4.11 |
| B1522 | (I.E) | L.4.12 |
| B1523 | (I.E) | L.4.13 |
| B1524 | (I.E) | L.4.14 |
| B1525 | (I.E) | L.4.15 |
| B1526 | (I.E) | L.4.16 |
| B1527 | (I.E) | L.4.17 |
| B1528 | (I.E) | L.4.18 |
| B1529 | (I.E) | L.4.19 |
| B1530 | (I.E) | L.4.20 |
| B1531 | (I.E) | L.4.21 |
| B1532 | (I.E) | L.4.22 |
| B1533 | (I.E) | L.4.23 |
| B1534 | (I.E) | L.4.24 |
| B1535 | (I.E) | L.4.25 |
| B1536 | (I.E) | L.4.26 |
| B1537 | (I.E) | L.4.27 |
| B1538 | (I.E) | L.4.28 |
| B1539 | (I.E) | L.4.29 |
| B1540 | (I.E) | L.4.30 |
| B1541 | (I.E) | L.4.31 |
| B1542 | (I.E) | L.4.32 |
| B1543 | (I.E) | L.4.33 |
| B1544 | (I.E) | L.5.1 |
| B1545 | (I.E) | L.5.2 |
| B1546 | (I.E) | L.5.3 |
| B1547 | (I.E) | L.5.4 |
| B1548 | (I.E) | L.5.5 |
| B1549 | (I.E) | L.5.6 |
| B1550 | (I.E) | L.5.7 |
| B1551 | (I.E) | L.5.8 |
| B1552 | (I.E) | L.5.9 |
| B1553 | (I.E) | L.5.10 |
| B1554 | (I.E) | L.5.11 |
| B1555 | (I.E) | L.5.12 |
| B1556 | (I.E) | L.5.13 |
| B1557 | (I.E) | L.5.14 |
| B1558 | (I.E) | L.5.15 |
| B1559 | (I.E) | L.5.16 |
| B1560 | (I.E) | L.5.17 |
| B1561 | (I.E) | L.5.18 |
| B1562 | (I.E) | L.5.19 |
| B1563 | (I.E) | L.5.20 |
| B1564 | (I.E) | L.5.21 |
| B1565 | (I.E) | L.5.22 |
| B1566 | (I.E) | L.5.23 |
| B1567 | (I.E) | L.5.24 |
| B1568 | (I.E) | L.5.25 |
| B1569 | (I.E) | L.5.26 |
| B1570 | (I.E) | L.5.27 |
| B1571 | (I.E) | L.5.28 |
| B1572 | (I.E) | L.5.29 |
| B1573 | (I.E) | L.5.30 |
| B1574 | (I.E) | L.5.31 |
| B1575 | (I.E) | L.5.32 |
| B1576 | (I.E) | L.5.33 |
| B1577 | (I.E) | L.5.34 |
| B1578 | (I.E) | L.5.35 |
| B1579 | (I.E) | L.5.36 |
| B1580 | (I.E) | L.5.37 |
| B1581 | (I.E) | L.5.38 |
| B1582 | (I.E) | L.5.39 |
| B1583 | (I.E) | L.5.40 |
| B1584 | (I.E) | L.5.41 |
| B1585 | (I.E) | L.5.42 |
| B1586 | (I.E) | L.5.43 |
| B1587 | (I.E) | L.5.44 |
| B1588 | (I.E) | L.5.45 |
| B1589 | (I.E) | L.5.46 |
| B1590 | (I.E) | L.5.47 |
| B1591 | (I.E) | L.5.48 |
| B1592 | (I.E) | L.5.49 |
| B1593 | (I.E) | L.5.50 |
| B1594 | (I.E) | L.5.51 |
| B1595 | (I.E) | L.5.52 |
| B1596 | (I.E) | L.5.53 |
| B1597 | (I.E) | L.5.54 |
| B1598 | (I.E) | L.5.55 |
| B1599 | (I.E) | L.5.56 |
| B1600 | (I.E) | L.5.57 |
| B1601 | (I.E) | L.5.58 |
| B1602 | (I.E) | L.5.59 |
| B1603 | (I.E) | L.5.60 |
| B1604 | (I.E) | L.5.61 |
| B1605 | (I.E) | L.5.62 |
| B1606 | (I.E) | L.5.63 |
| B1607 | (I.E) | L.5.64 |
| B1608 | (I.E) | L.5.65 |
| B1609 | (I.E) | L.5.66 |
| B1610 | (I.E) | L.5.67 |
| B1611 | (I.E) | L.5.68 |
| B1612 | (I.E) | L.5.69 |
| B1613 | (I.E) | L.5.70 |
| B1614 | (I.E) | L.5.71 |
| B1615 | (I.E) | L.5.72 |
| B1616 | (I.E) | L.5.73 |
| B1617 | (I.E) | L.5.74 |
| B1618 | (I.E) | L.5.75 |
| B1619 | (I.E) | L.5.76 |
| B1620 | (I.E) | L.5.77 |
| B1621 | (I.E) | L.5.78 |
| B1622 | (I.E) | L.5.79 |
| B1623 | (I.E) | L.5.80 |
| B1624 | (I.E) | L.5.81 |
| B1625 | (I.E) | L.5.82 |
| B1626 | (I.E) | L.5.83 |
| B1627 | (I.E) | L.5.84 |
| B1628 | (I.E) | L.6.1 |
| B1629 | (I.E) | L.6.2 |
| B1630 | (I.E) | L.6.3 |
| B1631 | (I.E) | L.6.4 |
| B1632 | (I.E) | L.6.5 |
| B1633 | (I.E) | L.6.6 |
| B1634 | (I.E) | L.6.7 |
| B1635 | (I.E) | L.6.8 |
| B1636 | (I.E) | L.6.9 |
| B1637 | (I.E) | L.6.10 |
| B1638 | (I.E) | L.6.11 |
| B1639 | (I.E) | L.6.12 |
| B1640 | (I.E) | L.6.13 |
| B1641 | (I.E) | L.6.14 |
| B1642 | (I.E) | L.6.15 |
| B1643 | (I.E) | L.6.16 |
| B1644 | (I.E) | L.6.17 |
| B1645 | (I.E) | L.6.18 |

B = Mixture;
I = compound I;
II = compound II

TABLE 55

| B | I | II |
|---|---|---|
| B1646 | (I.F) | L.1.1 |
| B1647 | (I.F) | L.1.2 |
| B1648 | (I.F) | L.1.3 |
| B1649 | (I.F) | L.1.4 |
| B1650 | (I.F) | L.1.5 |
| B1651 | (I.F) | L.1.6 |
| B1652 | (I.F) | L.1.7 |
| B1653 | (I.F) | L.1.8 |
| B1654 | (I.F) | L.1.9 |
| B1655 | (I.F) | L.1.10 |
| B1656 | (I.F) | L.1.11 |
| B1657 | (I.F) | L.1.12 |
| B1658 | (I.F) | L.1.13 |
| B1659 | (I.F) | L.1.14 |
| B1660 | (I.F) | L.1.15 |
| B1661 | (I.F) | L.1.16 |
| B1662 | (I.F) | L.1.17 |
| B1663 | (I.F) | L.1.18 |
| B1664 | (I.F) | L.1.19 |
| B1665 | (I.F) | L.1.20 |
| B1666 | (I.F) | L.1.21 |
| B1667 | (I.F) | L.1.22 |
| B1668 | (I.F) | L.1.23 |
| B1669 | (I.F) | L.1.24 |
| B1670 | (I.F) | L.1.25 |
| B1671 | (I.F) | L.1.26 |
| B1672 | (I.F) | L.1.27 |
| B1673 | (I.F) | L.1.28 |
| B1674 | (I.F) | L.1.29 |
| B1675 | (I.F) | L.1.30 |
| B1676 | (I.F) | L.1.31 |
| B1677 | (I.F) | L.1.32 |
| B1678 | (I.F) | L.1.33 |
| B1679 | (I.F) | L.1.34 |
| B1680 | (I.F) | L.1.35 |
| B1681 | (I.F) | L.1.36 |
| B1682 | (I.F) | L.1.37 |
| B1683 | (I.F) | L.1.38 |
| B1684 | (I.F) | L.1.39 |
| B1685 | (I.F) | L.1.40 |
| B1686 | (I.F) | L.1.41 |
| B1687 | (I.F) | L.1.42 |
| B1688 | (I.F) | L.1.43 |
| B1689 | (I.F) | L.1.44 |
| B1690 | (I.F) | L.1.45 |
| B1691 | (I.F) | L.1.46 |
| B1692 | (I.F) | L.1.47 |
| B1693 | (I.F) | L.1.48 |
| B1694 | (I.F) | L.1.49 |
| B1695 | (I.F) | L.1.50 |
| B1696 | (I.F) | L.1.51 |
| B1697 | (I.F) | L.1.52 |
| B1698 | (I.F) | L.1.53 |
| B1699 | (I.F) | L.1.54 |
| B1700 | (I.F) | L.1.55 |
| B1701 | (I.F) | L.1.56 |
| B1702 | (I.F) | L.1.57 |
| B1703 | (I.F) | L.1.58 |
| B1704 | (I.F) | L.1.59 |
| B1705 | (I.F) | L.1.60 |
| B1706 | (I.F) | L.1.61 |
| B1707 | (I.F) | L.1.62 |
| B1708 | (I.F) | L.1.63 |
| B1709 | (I.F) | L.1.64 |
| B1710 | (I.F) | L.1.65 |
| B1711 | (I.F) | 1.1.66 |
| B1712 | (I.F) | L.1.67 |
| B1713 | (I.F) | L.1.68 |
| B1714 | (I.F) | L.1.69 |
| B1715 | (I.F) | L.1.70 |
| B1716 | (I.F) | L.1.71 |
| B1717 | (I.F) | L.1.72 |
| B1718 | (I.F) | L.1.73 |
| B1719 | (I.F) | L.1.74 |
| B1720 | (I.F) | L.1.75 |
| B1721 | (I.F) | L.1.76 |
| B1722 | (I.F) | L.1.77 |
| B1723 | (I.F) | L.1.78 |
| B1724 | (I.F) | L.1.79 |
| B1725 | (I.F) | L.1.80 |
| B1726 | (I.F) | L.1.81 |
| B1727 | (I.F) | L.1.82 |
| B1728 | (I.F) | L.1.83 |
| B1729 | (I.F) | L.1.84 |
| B1730 | (I.F) | L.1.85 |
| B1731 | (I.F) | L.1.86 |
| B1732 | (I.F) | L.1.87 |
| B1733 | (I.F) | L.1.88 |
| B1734 | (I.F) | L.1.89 |
| B1735 | (I.F) | L.1.90 |
| B1736 | (I.F) | L.1.91 |
| B1737 | (I.F) | L.1.92 |
| B1738 | (I.F) | L.1.93 |
| B1739 | (I.F) | L.1.94 |
| B1740 | (I.F) | L.1.95 |
| B1741 | (I.F) | L.1.96 |
| B1742 | (I.F) | L.2.1 |
| B1743 | (I.F) | L.2.2 |
| B1744 | (I.F) | L.2.3 |
| B1745 | (I.F) | L.2.4 |
| B1746 | (I.F) | L.2.5 |
| B1747 | (I.F) | L.2.6 |
| B1748 | (I.F) | L.2.7 |
| B1749 | (I.F) | L.2.8 |
| B1750 | (I.F) | L.2.9 |
| B1751 | (I.F) | L.2.10 |
| B1752 | (I.F) | L.2.11 |
| B1753 | (I.F) | L.2.12 |
| B1754 | (I.F) | L.2.13 |
| B1755 | (I.F) | L.2.14 |
| B1756 | (I.F) | L.2.15 |
| B1757 | (I.F) | L.2.16 |
| B1758 | (I.F) | L.2.17 |
| B1759 | (I.F) | L.2.18 |
| B1760 | (I.F) | L.2.19 |
| B1761 | (I.F) | L.2.20 |
| B1762 | (I.F) | L.2.21 |
| B1763 | (I.F) | L.2.22 |
| B1764 | (I.F) | L.2.23 |
| B1765 | (I.F) | L.2.24 |
| B1766 | (I.F) | L.2.25 |
| B1767 | (I.F) | L.2.26 |
| B1768 | (I.F) | L.2.27 |
| B1769 | (I.F) | L.2.28 |
| B1770 | (I.F) | L.2.29 |
| B1771 | (I.F) | L.2.30 |
| B1772 | (I.F) | L.2.31 |
| B1773 | (I.F) | L.2.32 |
| B1774 | (I.F) | L.2.33 |
| B1775 | (I.F) | L.3.1 |
| B1776 | (I.F) | L.3.2 |
| B1777 | (I.F) | L.3.3 |
| B1778 | (I.F) | L.3.4 |
| B1779 | (I.F) | L.3.5 |
| B1780 | (I.F) | L.3.6 |
| B1781 | (I.F) | L.3.7 |
| B1782 | (I.F) | L.3.8 |
| B1783 | (I.F) | L.3.9 |
| B1784 | (I.F) | L.3.10 |
| B1785 | (I.F) | L.3.11 |
| B1786 | (I.F) | L.3.12 |
| B1787 | (I.F) | L.3.13 |
| B1788 | (I.F) | L.3.14 |
| B1789 | (I.F) | L.3.15 |
| B1790 | (I.F) | L.3.16 |
| B1791 | (I.F) | L.3.17 |
| B1792 | (I.F) | L.3.18 |
| B1793 | (I.F) | L.3.19 |
| B1794 | (I.F) | L.3.20 |
| B1795 | (I.F) | L.3.21 |
| B1796 | (I.F) | L.3.22 |
| B1797 | (I.F) | L.3.23 |
| B1798 | (I.F) | L.3.24 |
| B1799 | (I.F) | L.3.25 |
| B1800 | (I.F) | L.3.26 |
| B1801 | (I.F) | L.3.27 |
| B1802 | (I.F) | L.3.28 |
| B1803 | (I.F) | L.3.29 |
| B1804 | (I.F) | L.3.30 |
| B1805 | (I.F) | L.3.31 |
| B1806 | (I.F) | L.3.32 |
| B1807 | (I.F) | L.3.33 |
| B1808 | (I.F) | L.3.34 |
| B1809 | (I.F) | L.3.35 |
| B1810 | (I.F) | L.3.36 |
| B1811 | (I.F) | L.3.37 |
| B1812 | (I.F) | L.3.38 |
| B1813 | (I.F) | L.3.39 |
| B1814 | (I.F) | L.3.40 |
| B1815 | (I.F) | L.3.41 |
| B1816 | (I.F) | L.3.42 |
| B1817 | (I.F) | L.3.43 |
| B1818 | (I.F) | L.3.44 |
| B1819 | (I.F) | L.3.45 |
| B1820 | (I.F) | L.3.46 |
| B1821 | (I.F) | L.3.47 |
| B1822 | (I.F) | L.3.48 |
| B1823 | (I.F) | L.3.49 |
| B1824 | (I.F) | L.3.50 |
| B1825 | (I.F) | L.3.51 |
| B1826 | (I.F) | L.3.52 |
| B1827 | (I.F) | L.3.53 |
| B1828 | (I.F) | L.3.54 |
| B1829 | (I.F) | L.3.55 |
| B1830 | (I.F) | L.3.56 |
| B1831 | (I.F) | L.3.57 |
| B1832 | (I.F) | L.3.58 |
| B1833 | (I.F) | L.3.59 |
| B1834 | (I.F) | L.3.60 |
| B1835 | (I.F) | L.3.61 |
| B1836 | (I.F) | L.3.62 |
| B1837 | (I.F) | L.3.63 |
| B1838 | (I.F) | L.3.1 |
| B1839 | (I.F) | L.3.2 |
| B1840 | (I.F) | L.4.1 |
| B1841 | (I.F) | L.4.2 |
| B1842 | (I.F) | L.4.3 |
| B1843 | (I.F) | L.4.4 |
| B1844 | (I.F) | L.4.5 |
| B1845 | (I.F) | L.4.6 |
| B1846 | (I.F) | L.4.7 |
| B1847 | (I.F) | L.4.8 |
| B1848 | (I.F) | L.4.9 |
| B1849 | (I.F) | L.4.10 |
| B1850 | (I.F) | L.4.11 |
| B1851 | (I.F) | L.4.12 |
| B1852 | (I.F) | L.4.13 |
| B1853 | (I.F) | L.4.14 |
| B1854 | (I.F) | L.4.15 |
| B1855 | (I.F) | L.4.16 |
| B1856 | (I.F) | L.4.17 |
| B1857 | (I.F) | L.4.18 |
| B1858 | (I.F) | L.4.19 |
| B1859 | (I.F) | L.4.20 |
| B1860 | (I.F) | L.4.21 |
| B1861 | (I.F) | L.4.22 |
| B1862 | (I.F) | L.4.23 |
| B1863 | (I.F) | L.4.24 |
| B1864 | (I.F) | L.4.25 |
| B1865 | (I.F) | L.4.26 |
| B1866 | (I.F) | L.4.27 |
| B1867 | (I.F) | L.4.28 |
| B1868 | (I.F) | L.4.29 |
| B1869 | (I.F) | L.4.30 |
| B1870 | (I.F) | L.4.31 |
| B1871 | (I.F) | L.4.32 |
| B1872 | (I.F) | L.4.33 |
| B1873 | (I.F) | L.5.1 |
| B1874 | (I.F) | L.5.2 |
| B1875 | (I.F) | L.5.3 |
| B1876 | (I.F) | L.5.4 |
| B1877 | (I.F) | L.5.5 |
| B1878 | (I.F) | L.5.6 |
| B1879 | (I.F) | L.5.7 |
| B1880 | (I.F) | L.5.8 |
| B1881 | (I.F) | L.5.9 |
| B1882 | (I.F) | L.5.10 |
| B1883 | (I.F) | L.5.11 |
| B1884 | (I.F) | L.5.12 |
| B1885 | (I.F) | L.5.13 |
| B1886 | (I.F) | L.5.14 |
| B1887 | (I.F) | L.5.15 |
| B1888 | (I.F) | L.5.16 |
| B1889 | (I.F) | L.5.17 |
| B1890 | (I.F) | L.5.18 |
| B1891 | (I.F) | L.5.19 |
| B1892 | (I.F) | L.5.20 |
| B1893 | (I.F) | L.5.21 |
| B1894 | (I.F) | L.5.22 |
| B1895 | (I.F) | L.5.23 |
| B1896 | (I.F) | L.5.24 |
| B1897 | (I.F) | L.5.25 |
| B1898 | (I.F) | L.5.26 |
| B1899 | (I.F) | L.5.27 |
| B1900 | (I.F) | L.5.28 |
| B1901 | (I.F) | L.5.29 |
| B1902 | (I.F) | L.5.30 |
| B1903 | (I.F) | L.5.31 |
| B1904 | (I.F) | L.5.32 |
| B1905 | (I.F) | L.5.33 |
| B1906 | (I.F) | L.5.34 |
| B1907 | (I.F) | L.5.35 |
| B1908 | (I.F) | L.5.36 |
| B1909 | (I.F) | L.5.37 |
| B1910 | (I.F) | L.5.38 |
| B1911 | (I.F) | L.5.39 |
| B1912 | (I.F) | L.5.40 |
| B1913 | (I.F) | L.5.41 |
| B1914 | (I.F) | L.5.42 |
| B1915 | (I.F) | L.5.43 |
| B1916 | (I.F) | L.5.44 |
| B1917 | (I.F) | L.5.45 |
| B1918 | (I.F) | L.5.46 |
| B1919 | (I.F) | L.5.47 |
| B1920 | (I.F) | L.5.48 |
| B1921 | (I.F) | L.5.49 |
| B1922 | (I.F) | L.5.50 |
| B1923 | (I.F) | L.5.51 |
| B1924 | (I.F) | L.5.52 |
| B1925 | (I.F) | L.5.53 |
| B1926 | (I.F) | L.5.54 |
| B1927 | (I.F) | L.5.55 |
| B1928 | (I.F) | L.5.56 |
| B1929 | (I.F) | L.5.57 |
| B1930 | (I.F) | L.5.58 |
| B1931 | (I.F) | L.5.59 |
| B1932 | (I.F) | L.5.60 |
| B1933 | (I.F) | L.5.61 |
| B1934 | (I.F) | L.5.62 |
| B1935 | (I.F) | L.5.63 |
| B1936 | (I.F) | L.5.64 |
| B1937 | (I.F) | L.5.65 |
| B1938 | (I.F) | L.5.68 |
| B1939 | (I.F) | L.5.67 |
| B1940 | (I.F) | L.5.68 |
| B1941 | (I.F) | L.5.69 |
| B1942 | (I.F) | L.5.70 |
| B1943 | (I.F) | L.5.71 |
| B1944 | (I.F) | L.5.72 |
| B1945 | (I.F) | L.5.73 |
| B1946 | (I.F) | L.5.74 |
| B1947 | (I.F) | L.5.75 |
| B1948 | (I.F) | L.5.76 |
| B1949 | (I.F) | L.5.77 |
| B1950 | (I.F) | L.5.78 |
| B1951 | (I.F) | L.5.79 |
| B1952 | (I.F) | L.5.80 |
| B1953 | (I.F) | L.5.81 |
| B1954 | (I.F) | L.5.82 |

B = Mixture;
I = compound I;
II = compound II

TABLE 56

| B | I | II |
|---|---|---|
| B1975 | (I.G) | L.1.1 |
| B1976 | (I.G) | L.1.2 |
| B1977 | (I.G) | L.1.3 |
| B1978 | (I.G) | L.1.4 |
| B1979 | (I.G) | L.1.5 |
| B1980 | (I.G) | L.1.6 |
| B1981 | (I.G) | L.1.7 |
| B1982 | (I.G) | L.1.8 |
| B1983 | (I.G) | L.1.9 |
| B1984 | (I.G) | L.1.10 |
| B1985 | (I.G) | L.1.11 |
| B1986 | (I.G) | L.1.12 |
| B1987 | (I.G) | L.1.13 |
| B1988 | (I.G) | L.1.14 |
| B1989 | (I.G) | L.1.15 |
| B1990 | (I.G) | L.1.16 |
| B1991 | (I.G) | L.1.17 |
| B1992 | (I.G) | L.1.18 |
| B1993 | (I.G) | L.1.19 |
| B1994 | (I.G) | L.1.20 |
| B1995 | (I.G) | L.1.21 |
| B1996 | (I.G) | L.1.22 |
| B1997 | (I.G) | L.1.23 |
| B1998 | (I.G) | L.1.24 |
| B1999 | (I.G) | L.1.25 |
| B2000 | (I.G) | L.1.26 |
| B2001 | (I.G) | L.1.27 |
| B2002 | (I.G) | L.1.28 |
| B2003 | (I.G) | L.1.29 |
| B2004 | (I.G) | L.1.30 |
| B2005 | (I.G) | L.1.31 |
| B2006 | (I.G) | L.1.32 |
| B2007 | (I.G) | L.1.33 |
| B2008 | (I.G) | L.1.34 |
| B2009 | (I.G) | L.1.35 |
| B2010 | (I.G) | L.1.36 |
| B2011 | (I.G) | L.1.37 |
| B2012 | (I.G) | L.1.38 |
| B2013 | (I.G) | L.1.39 |
| B2014 | (I.G) | L.1.40 |
| B2015 | (I.G) | L.1.41 |
| B2016 | (I.G) | L.1.42 |
| B2017 | (I.G) | L.1.43 |
| B2018 | (I.G) | L.1.44 |
| B2019 | (I.G) | L.1.45 |
| B2020 | (I.G) | L.1.46 |
| B2021 | (I.G) | L.1.47 |
| B2022 | (I.G) | L.1.48 |
| B2023 | (I.G) | L.1.49 |
| B2024 | (I.G) | L.1.50 |
| B2025 | (I.G) | L.1.51 |
| B2026 | (I.G) | L.1.52 |
| B2027 | (I.G) | L.1.53 |
| B2028 | (I.G) | L.1.54 |
| B2029 | (I.G) | L.1.55 |
| B2030 | (I.G) | L.1.56 |
| B2031 | (I.G) | L.1.57 |
| B2032 | (I.G) | L.1.58 |
| B2033 | (I.G) | L.1.59 |
| B2034 | (I.G) | L.1.60 |
| B2035 | (I.G) | L.1.61 |
| B2036 | (I.G) | L.1.62 |
| B2037 | (I.G) | L.1.63 |
| B2038 | (I.G) | L.1.64 |
| B2039 | (I.G) | L.1.65 |
| B2040 | (I.G) | L.1.66 |
| B2041 | (I.G) | L.1.67 |
| B2042 | (I.G) | L.1.68 |
| B2043 | (I.G) | L.1.69 |
| B2044 | (I.G) | L.1.70 |
| B2045 | (LG) | L.1.71 |
| B2046 | (I.G) | L.1.72 |
| B2047 | (I.G) | L.1.73 |
| B2048 | (I.G) | L.1.74 |
| B2049 | (I.G) | L.1.75 |
| B2050 | (I.G) | L.1.76 |
| B2051 | (I.G) | L.1.77 |
| B2052 | (I.G) | L.1.78 |
| B2053 | (I.G) | L.1.79 |
| B2054 | (I.G) | L.1.80 |
| B2055 | (I.G) | L.1.81 |
| B2056 | (I.G) | L.1.82 |
| B2057 | (I.G) | L.1.83 |
| B2058 | (I.G) | L.1.84 |
| B2059 | (I.G) | L.1.85 |
| B2060 | (I.G) | L.1.86 |
| B2061 | (I.G) | L.1.87 |
| B2062 | (I.G) | L.1.88 |
| B2063 | (I.G) | L.1.89 |
| B2064 | (I.G) | L.1.90 |
| B2065 | (I.G) | L.1.91 |
| B2066 | (I.G) | L.1.92 |
| B2067 | (I.G) | L.1.93 |
| B2068 | (I.G) | L.1.94 |
| B2069 | (I.G) | L.1.95 |
| B2070 | (I.G) | L.1.96 |
| B2071 | (I.G) | L.2.1 |
| B2072 | (I.G) | L.2.2 |
| B2073 | (I.G) | L.2.3 |
| B2074 | (I.G) | L.2.4 |
| B2075 | (I.G) | L.2.5 |
| B2076 | (I.G) | L.2.6 |
| B2077 | (I.G) | L.2.7 |
| B2078 | (I.G) | L.2.8 |
| B2079 | (I.G) | L.2.9 |
| B2080 | (I.G) | L.2.10 |
| B2081 | (I.G) | L.2.11 |
| B2082 | (I.G) | L.2.12 |
| B2083 | (I.G) | L.2.13 |
| B2084 | (I.G) | L.2.14 |
| B2085 | (I.G) | L.2.15 |
| B2086 | (I.G) | L.2.16 |
| B2087 | (I.G) | L.2.17 |
| B2088 | (I.G) | L.2.18 |
| B2089 | (I.G) | L.2.19 |
| B2090 | (I.G) | L.2.20 |
| B2091 | (I.G) | L.2.21 |
| B2092 | (I.G) | L.2.22 |
| B2093 | (I.G) | L.2.23 |
| B2094 | (I.G) | L.2.24 |
| B2095 | (I.G) | L.2.25 |
| B2096 | (I.G) | L.2.26 |
| B2097 | (I.G) | L.2.27 |
| B2098 | (I.G) | L.2.28 |
| B2099 | (I.G) | L.2.29 |
| B2100 | (I.G) | L.2.30 |
| B2101 | (I.G) | L.2.31 |
| B2102 | (I.G) | L.2.32 |
| B2103 | (I.G) | L.2.33 |
| B2104 | (I.G) | L.3.1 |
| B2105 | (I.G) | L.3.2 |
| B2106 | (I.G) | L.3.3 |
| B2107 | (I.G) | L.3.4 |
| B2108 | (I.G) | L.3.5 |
| B2109 | (I.G) | L.3.6 |
| B2110 | (I.G) | L.3.7 |
| B2111 | (I.G) | L.3.8 |
| B2112 | (I.G) | L.3.9 |
| B2113 | (I.G) | L.3.10 |
| B2114 | (I.G) | L.3.11 |
| B2115 | (I.G) | L.3.12 |
| B2116 | (I.G) | L.3.13 |
| B2117 | (I.G) | L.3.14 |
| B2118 | (I.G) | L.3.15 |
| B2119 | (I.G) | L.3.16 |
| B2120 | (I.G) | L.3.17 |
| B2121 | (I.G) | L.3.18 |
| B2122 | (I.G) | L.3.19 |
| B2123 | (I.G) | L.3.20 |
| B2124 | (I.G) | L.3.21 |
| B2125 | (I.G) | L.3.22 |
| B2126 | (I.G) | L.3.23 |
| B2127 | (I.G) | L.3.24 |
| B2128 | (I.G) | L.3.25 |
| B2129 | (I.G) | L.3.26 |
| B2130 | (I.G) | L.3.27 |
| B2131 | (I.G) | L.3.28 |
| B2132 | (I.G) | L.3.29 |
| B2133 | (I.G) | L.3.30 |
| B2134 | (I.G) | L.3.31 |
| B2135 | (I.G) | L.3.32 |
| B2136 | (I.G) | L.3.33 |
| B2137 | (I.G) | L.3.34 |
| B2138 | (I.G) | L.3.35 |
| B2139 | (I.G) | L.3.36 |
| B2140 | (I.G) | L.3.37 |
| B2141 | (I.G) | L.3.38 |
| B2142 | (I.G) | L.3.39 |
| B2143 | (I.G) | L.3.40 |
| B2144 | (I.G) | L.3.41 |
| B2145 | (I.G) | L.3.42 |
| B2146 | (I.G) | L.3.43 |
| B2147 | (I.G) | L.3.44 |
| B2148 | (I.G) | L.3.45 |
| B2149 | (I.G) | L.3.46 |
| B2150 | (I.G) | L.3.47 |
| B2151 | (I.G) | L.3.48 |
| B2152 | (I.G) | L.3.49 |
| B2153 | (LG) | L.3.50 |
| B2154 | (I.G) | L.3.51 |
| B2155 | (I.G) | L.3.52 |
| B2156 | (I.G) | L.3.53 |
| B2157 | (I.G) | L.3.54 |
| B2158 | (I.G) | L.3.55 |
| B2159 | (I.G) | L.3.56 |
| B2160 | (I.G) | L.3.57 |
| B2161 | (I.G) | L.3.58 |
| B2162 | (I.G) | L.3.59 |
| B2163 | (I.G) | L.3.60 |
| B2164 | (I.G) | L.3.61 |
| B2165 | (I.G) | L.3.62 |
| B2166 | (I.G) | L.3.63 |
| B2167 | (I.G) | L.3.1 |
| B2168 | (I.G) | L.3.2 |
| B2169 | (I.G) | L.4.1 |
| B2170 | (I.G) | L.4.2 |
| B2171 | (I.G) | L.4.3 |
| B2172 | (I.G) | L.4.4 |
| B2173 | (I.G) | L.4.5 |
| B2174 | (I.G) | L.4.6 |
| B2175 | (I.G) | L.4.7 |
| B2176 | (I.G) | L.4.8 |
| B2177 | (I.G) | L.4.9 |
| B2178 | (I.G) | L.4.10 |
| B2179 | (I.G) | L.4.11 |
| B2180 | (I.G) | L.4.12 |
| B2181 | (I.G) | L.4.13 |
| B2182 | (I.G) | L.4.14 |
| B2183 | (I.G) | L.4.15 |
| B2184 | (I.G) | L.4.16 |
| B2185 | (I.G) | L.4.17 |
| B2186 | (I.G) | L.4.18 |
| B2187 | (I.G) | L.4.19 |
| B2188 | (I.G) | L.4.20 |
| B2189 | (I.G) | L.4.21 |
| B2190 | (I.G) | L.4.22 |
| B2191 | (I.G) | L.4.23 |
| B2192 | (I.G) | L.4.24 |
| B2193 | (I.G) | L.4.25 |
| B2194 | (I.G) | L.4.26 |
| B2195 | (I.G) | L.4.27 |
| B2196 | (I.G) | L.4.28 |
| B2197 | (I.G) | L.4.29 |
| B2198 | (I.G) | L.4.30 |
| B2199 | (I.G) | L.4.31 |
| B2200 | (I.G) | L.4.32 |
| B2201 | (I.G) | L.4.33 |
| B2202 | (I.G) | L.5.1 |
| B2203 | (I.G) | L.5.2 |
| B2204 | (I.G) | L.5.3 |
| B2205 | (I.G) | L.5.4 |
| B2206 | (I.G) | L.5.5 |
| B2207 | (I.G) | L.5.6 |
| B2208 | (I.G) | L.5.7 |
| B2209 | (I.G) | L.5.8 |
| B2210 | (I.G) | L.5.9 |
| B2211 | (I.G) | L.5.10 |
| B2212 | (I.G) | L.5.11 |
| B2213 | (I.G) | L.5.12 |
| B2214 | (I.G) | L.5.13 |
| B2215 | (I.G) | L.5.14 |
| B2216 | (I.G) | L.5.15 |
| B2217 | (I.G) | L.5.16 |
| B2218 | (I.G) | L.5.17 |
| B2219 | (I.G) | L.5.18 |
| B2220 | (I.G) | L.5.19 |
| B2221 | (I.G) | L.5.20 |
| B2222 | (I.G) | L.5.21 |
| B2223 | (I.G) | L.5.22 |
| B2224 | (I.G) | L.5.23 |
| B2225 | (I.G) | L.5.24 |
| B2226 | (I.G) | L.5.25 |
| B2227 | (I.G) | L.5.26 |
| R2228 | (I.G) | L.5.27 |
| B2229 | (I.G) | L.5.28 |
| B2230 | (I.G) | L.5.29 |
| B2231 | (I.G) | L.5.30 |
| B2232 | (I.G) | L.5.31 |
| B2233 | (I.G) | L.5.32 |
| B2234 | (I.G) | L.5.33 |
| B2235 | (I.G) | L.5.34 |
| B2236 | (I.G) | L.5.35 |
| B2237 | (I.G) | L.5.36 |
| B2238 | (I.G) | L.5.37 |
| B2239 | (I.G) | L.5.38 |
| B2240 | (I.G) | L.5.39 |
| B2241 | (I.G) | L.5.40 |
| B2242 | (I.G) | L.5.41 |
| B2243 | (I.G) | L.5.42 |
| B2244 | (I.G) | L.5.43 |
| B2245 | (I.G) | L.5.44 |
| B2246 | (I.G) | L.5.45 |
| B2247 | (I.G) | L.5.46 |
| B2248 | (I.G) | L.5.47 |
| B2249 | (I.G) | L.5.48 |
| B2250 | (I.G) | L.5.49 |
| B2251 | (I.G) | L.5.50 |
| B2252 | (I.G) | L.5.51 |
| B2253 | (I.G) | L.5.52 |
| B2254 | (I.G) | L.5.53 |
| B2255 | (I.G) | L.5.54 |
| B2256 | (I.G) | L.5.55 |
| B2257 | (I.G) | L.5.56 |
| B2258 | (I.G) | L.5.57 |
| B2259 | (I.G) | L.5.58 |
| B2260 | (I.G) | L.5.59 |
| B2261 | (I.G) | L.5.60 |
| B2262 | (I.G) | L.5.61 |
| B2263 | (I.G) | L.5.62 |
| B2264 | (I.G) | L.5.63 |
| B2265 | (I.G) | L.5.64 |
| B2266 | (I.G) | L.5.65 |
| B2267 | (I.G) | L.5.66 |
| B2268 | (I.G) | L.5.67 |
| B2269 | (I.G) | L.5.68 |
| B2270 | (I.G) | L.5.69 |
| B2271 | (I.G) | L.5.70 |
| B2272 | (I.G) | L.5.71 |
| B2273 | (I.G) | L.5.72 |
| B2274 | (I.G) | L.5.73 |
| B2275 | (I.G) | L.5.74 |
| B2276 | (I.G) | L.5.75 |
| B2277 | (I.G) | L.5.76 |
| B2278 | (I.G) | L.5.77 |
| B2279 | (I.G) | L.5.78 |
| B2280 | (I.G) | L.5.79 |
| B2281 | (I.G) | L.5.80 |
| B2282 | (I.G) | L.5.81 |
| B2283 | (I.G) | L.5.82 |
| B2284 | (I.G) | L.5.83 |
| B2285 | (I.G) | L.5.84 |
| B2286 | (I.G) | L.6.1 |
| B2287 | (I.G) | L.6.2 |
| B2288 | (I.G) | L.6.3 |
| B2289 | (I.G) | L.6.4 |
| B2290 | (I.G) | L.6.5 |
| B2291 | (I.G) | L.6.6 |
| B2292 | (I.G) | L.6.7 |
| B2293 | (I.G) | L.6.8 |
| B2294 | (I.G) | L.6.9 |
| B2295 | (I.G) | L.6.10 |
| B2296 | (I.G) | L.6.11 |
| B2297 | (I.G) | L.6.12 |
| B2298 | (I.G) | L.6.13 |
| B2299 | (I.G) | L.6.14 |
| B2300 | (I.G) | L.6.15 |
| B2301 | (I.G) | L.6.16 |
| B2302 | (I.G) | L.6.17 |
| B2303 | (I.G) | L.6.18 |

B = Mixture;
I = compound I;
II = compound II

TABLE 57

| B | I | II |
|---|---|---|
| B2304 | (I.H) | L.1.1 |
| B2305 | (I.H) | L.1.2 |
| B2306 | (I.H) | L.1.3 |
| B2307 | (I.H) | L.1.4 |
| B2308 | (I.H) | L.1.5 |
| B2309 | (I.H) | L.1.6 |
| B2310 | (I.H) | L.1.7 |
| B2311 | (I.H) | L.1.8 |
| B2312 | (I.H) | L.1.9 |
| B2313 | (I.H) | L.1.10 |
| B2314 | (I.H) | L.1.11 |
| B2315 | (I.H) | L.1.12 |
| B2316 | (I.H) | L.1.13 |
| B2317 | (I.H) | L.1.14 |
| B2318 | (I.H) | L.1.15 |
| B2319 | (I.H) | L.1.16 |
| B2320 | (I.H) | L.1.17 |
| B2321 | (I.H) | L.1.18 |
| B2322 | (I.H) | L.1.19 |
| B2323 | (I.H) | L.1.20 |
| B2324 | (I.H) | L.1.21 |
| B2325 | (I.H) | L.1.22 |
| B2326 | (I.H) | L.1.23 |
| B2327 | (I.H) | L.1.24 |
| B2328 | (I.H) | L.1.25 |
| B2329 | (I.H) | L.1.26 |
| B2330 | (I.H) | L.1.27 |
| B2331 | (I.H) | L.1.28 |
| B2332 | (I.H) | L.1.29 |
| B2333 | (I.H) | L.1.30 |
| B2334 | (I.H) | L.1.31 |
| B2335 | (I.H) | L.1.32 |
| B2336 | (I.H) | L.1.33 |
| B2337 | (I.H) | L.1.34 |
| B2338 | (I.H) | L.1.35 |
| B2339 | (I.H) | L.1.36 |
| B2340 | (I.H) | L.1.37 |
| B2341 | (I.H) | L.1.38 |
| B2342 | (I.H) | L.1.39 |
| B2343 | (I.H) | L.1.40 |
| B2344 | (I.H) | L.1.41 |
| B2345 | (I.H) | L.1.42 |
| B2346 | (I.H) | L.1.43 |
| B2347 | (I.H) | L.1.44 |
| B2348 | (I.H) | L.1.45 |
| B2349 | (I.H) | L.1.46 |
| B2350 | (I.H) | L.1.47 |
| B2351 | (I.H) | L.1.48 |
| B2352 | (I.H) | L.1.49 |
| B2353 | (I.H) | L.1.50 |
| B2354 | (I.H) | L.1.51 |
| B2355 | (I.H) | L.1.52 |
| B2356 | (I.H) | L.1.53 |
| B2357 | (I.H) | L.1.54 |
| B2358 | (I.H) | L.1.55 |
| B2359 | (I.H) | L.1.56 |
| B2360 | (I.H) | L.1.57 |
| B2361 | (I.H) | L.1.58 |
| B2362 | (I.H) | L.1.59 |
| B2363 | (I.H) | L.1.60 |
| B2364 | (I.H) | L.1.61 |
| B2365 | (I.H) | L.1.62 |
| B2366 | (I.H) | L.1.63 |
| B2367 | (I.H) | L.1.64 |
| B2368 | (I.H) | L.1.65 |
| B2369 | (I.H) | L.1.66 |
| B2370 | (I.H) | L.1.67 |
| B2371 | (I.H) | L.1.68 |
| B2372 | (I.H) | L.1.69 |
| B2373 | (I.H) | L.1.70 |
| B2374 | (I.H) | L.1.71 |
| B2375 | (I.H) | L.1.72 |
| B2376 | (I.H) | L.1.73 |
| B2377 | (I.H) | L.1.74 |
| B2378 | (I.H) | L.1.75 |
| B2379 | (I.H) | L.1.76 |
| B2380 | (I.H) | L.1.77 |
| B2381 | (I.H) | L.1.78 |
| B2382 | (I.H) | L.1.79 |
| B2383 | (I.H) | L.1.80 |
| B2384 | (I.H) | L.1.81 |
| B2385 | (I.H) | L.1.82 |
| B2386 | (I.H) | L.1.83 |
| B2387 | (I.H) | L.1.84 |
| B2388 | (I.H) | L.1.85 |
| B2389 | (I.H) | L.1.86 |
| B2390 | (I.H) | L.1.87 |
| B2391 | (I.H) | L.1.88 |
| B2392 | (I.H) | L.1.89 |
| B2393 | (I.H) | L.1.90 |
| B2394 | (I.H) | L.1.91 |
| B2395 | (I.H) | L.1.92 |
| B2396 | (I.H) | L.1.93 |
| B2397 | (I.H) | L.1.94 |
| B2398 | (I.H) | L.1.95 |
| B2399 | (I.H) | L.1.96 |
| B2400 | (I.H) | L.2.1 |
| B2401 | (I.H) | L.2.2 |
| B2402 | (I.H) | L.2.3 |
| B2403 | (I.H) | L.2.4 |
| B2404 | (I.H) | L.2.5 |
| B2405 | (I.H) | L.2.6 |
| B2406 | (I.H) | L.2.7 |
| B2407 | (I.H) | L.2.8 |
| B2408 | (I.H) | L.2.9 |
| B2409 | (I.H) | L.2.10 |
| B2410 | (I.H) | L.2.11 |
| B2411 | (I.H) | L.2.12 |
| B2412 | (I.H) | L.2.13 |
| B2413 | (I.H) | L.2.14 |
| B2414 | (I.H) | L.2.15 |
| B2415 | (I.H) | L.2.16 |
| B2416 | (I.H) | L.2.17 |
| B2417 | (I.H) | L.2.18 |
| B2418 | (I.H) | L.2.19 |
| B2419 | (I.H) | L.2.20 |
| B2420 | (I.H) | L.2.21 |
| B2421 | (I.H) | L.2.22 |
| B2422 | (I.H) | L.2.23 |
| B2423 | (I.H) | L.2.24 |
| B2424 | (I.H) | L.2.25 |
| B2425 | (I.H) | L.2.26 |
| B2426 | (I.H) | L.2.27 |
| B2427 | (I.H) | L.2.28 |
| B2428 | (I.H) | L.2.29 |
| B2429 | (I.H) | L.2.30 |
| B2430 | (I.H) | L.2.31 |
| B2431 | (I.H) | L.2.32 |
| B2432 | (I.H) | L.2.33 |
| B2433 | (I.H) | L.3.1 |
| B2434 | (I.H) | L.3.2 |
| B2435 | (I.H) | L.3.3 |
| B2436 | (I.H) | L.3.4 |
| B2437 | (I.H) | L.3.5 |
| B2438 | (I.H) | L.3.6 |
| B2439 | (I.H) | L.3.7 |
| B2440 | (I.H) | L.3.8 |
| B2441 | (I.H) | L.3.9 |
| B2442 | (I.H) | L.3.10 |
| B2443 | (I.H) | L.3.11 |
| B2444 | (I.H) | L.3.12 |
| B2445 | (I.H) | L.3.13 |
| B2446 | (I.H) | L.3.14 |
| B2447 | (I.H) | L.3.15 |
| B2448 | (I.H) | L.3.16 |
| B2449 | (I.H) | L.3.17 |
| B2450 | (I.H) | L.3.18 |
| B2451 | (I.H) | L.3.19 |
| B2452 | (I.H) | L.3.20 |
| B2453 | (I.H) | L.3.21 |
| B2454 | (I.H) | L.3.22 |
| B2455 | (I.H) | L.3.23 |
| B2456 | (I.H) | L.3.24 |
| B2457 | (I.H) | L.3.25 |
| B2458 | (I.H) | L.3.26 |
| B2459 | (I.H) | L.3.27 |
| B2460 | (I.H) | L.3.28 |
| B2461 | (I.H) | L.3.29 |
| B2462 | (I.H) | L.3.30 |
| B2463 | (I.H) | L.3.31 |
| B2464 | (I.H) | L.3.32 |
| B2465 | (I.H) | L.3.33 |
| B2466 | (I.H) | L.3.34 |
| B2467 | (I.H) | L.3.35 |
| B2468 | (I.H) | L.3.36 |
| B2469 | (I.H) | L.3.37 |
| B2470 | (I.H) | L.3.38 |
| B2471 | (I.H) | L.3.39 |
| B2472 | (I.H) | L.3.40 |
| B2473 | (I.H) | L.3.41 |
| B2474 | (I.H) | L.3.42 |
| B2475 | (I.H) | L.3.43 |
| B2476 | (I.H) | L.3.44 |
| B2477 | (I.H) | L.3.45 |
| B2478 | (I.H) | L.3.46 |
| B2479 | (I.H) | L.3.47 |
| B2480 | (I.H) | L.3.48 |
| B2481 | (I.H) | L.3.49 |
| B2482 | (I.H) | L.3.50 |
| B2483 | (I.H) | L.3.51 |
| B2484 | (I.H) | L.3.52 |
| B2485 | (I.H) | L.3.53 |
| B2486 | (I.H) | L.3.54 |
| B2487 | (I.H) | L.3.55 |
| B2488 | (I.H) | L.3.56 |
| B2489 | (I.H) | L.3.57 |
| B2490 | (I.H) | L.3.58 |
| B2491 | (I.H) | L.3.59 |
| B2492 | (I.H) | L.3.60 |
| B2493 | (I.H) | L.3.61 |
| B2494 | (I.H) | L.3.62 |
| B2495 | (I.H) | L.3.63 |
| B2496 | (I.H) | L.3.1 |
| B2497 | (I.H) | L.3.2 |
| B2498 | (I.H) | L.4.1 |
| B2499 | (I.H) | L.4.2 |
| B2500 | (I.H) | L.4.3 |
| B2501 | (I.H) | L.4.4 |
| B2502 | (I.H) | L.4.5 |
| B2503 | (I.H) | L.4.6 |
| B2504 | (I.H) | L.4.7 |
| B2505 | (I.H) | L.4.8 |
| B2506 | (I.H) | L.4.9 |
| B2507 | (I.H) | L.4.10 |
| B2508 | (I.H) | L.4.11 |
| B2509 | (I.H) | L.4.12 |
| B2510 | (I.H) | L.4.13 |
| B2511 | (I.H) | L.4.14 |
| B2512 | (I.H) | L.4.15 |
| B2513 | (I.H) | L.4.16 |
| B2514 | (I.H) | L.4.17 |
| B2515 | (I.H) | L.4.18 |
| B2516 | (I.H) | L.4.19 |
| B2517 | (I.H) | L.4.20 |
| B2518 | (I.H) | L.4.21 |
| B2519 | (I.H) | L.4.22 |
| B2520 | (I.H) | L.4.23 |
| B2521 | (I.H) | L.4.24 |
| B2522 | (I.H) | L.4.25 |
| B2523 | (I.H) | L.4.26 |
| B2524 | (I.H) | L.4.27 |
| B2525 | (I.H) | L.4.28 |
| B2526 | (I.H) | L.4.29 |
| B2527 | (I.H) | L.4.30 |
| B2528 | (I.H) | L.4.31 |
| B2529 | (I.H) | L.4.32 |
| B2530 | (I.H) | L.4.33 |
| B2531 | (I.H) | L.5.1 |
| B2532 | (I.H) | L.5.2 |
| B2533 | (I.H) | L.5.3 |
| B2534 | (I.H) | L.5.4 |
| B2535 | (I.H) | L.5.5 |
| B2536 | (I.H) | L.5.6 |
| B2537 | (I.H) | L.5.7 |
| B2538 | (I.H) | L.5.8 |
| B2539 | (I.H) | L.5.9 |
| B2540 | (I.H) | L.5.10 |
| B2541 | (I.H) | L.5.11 |
| B2542 | (I.H) | L.5.12 |
| B2543 | (I.H) | L.5.13 |
| B2544 | (I.H) | L.5.14 |
| B2545 | (I.H) | L.5.15 |
| B2546 | (I.H) | L.5.16 |
| B2547 | (I.H) | L.5.17 |
| B2548 | (I.H) | L.5.18 |
| B2549 | (I.H) | L.5.19 |
| B2550 | (I.H) | L.5.20 |
| B2551 | (I.H) | L.5.21 |
| B2552 | (I.H) | L.5.22 |
| B2553 | (I.H) | L.5.23 |
| B2554 | (I.H) | L.5.24 |
| B2555 | (I.H) | L.5.25 |
| B2556 | (I.H) | L.5.26 |
| B2557 | (I.H) | L.5.27 |
| B2558 | (I.H) | L.5.28 |
| B2559 | (I.H) | L.5.29 |
| B2560 | (I.H) | L.5.30 |
| B2561 | (I.H) | L.5.31 |
| B2562 | (I.H) | L.5.32 |
| B2563 | (I.H) | L.5.33 |
| B2564 | (I.H) | L.5.34 |
| B2565 | (I.H) | L.5.35 |
| B2566 | (I.H) | L.5.36 |
| B2567 | (I.H) | L.5.37 |
| B2568 | (I.H) | L.5.38 |
| B2569 | (I.H) | L.5.39 |
| B2570 | (I.H) | L.5.40 |
| B2571 | (I.H) | L.5.41 |
| B2572 | (I.H) | L.5.42 |
| B2573 | (I.H) | L.5.43 |
| B2574 | (I.H) | L.5.44 |
| B2575 | (I.H) | L.5.45 |
| B2576 | (I.H) | L.5.46 |
| B2577 | (I.H) | L.5.47 |
| B2578 | (I.H) | L.5.48 |
| B2579 | (I.H) | L.5.49 |
| B2580 | (I.H) | L.5.50 |
| B2581 | (I.H) | L.5.51 |
| B2582 | (I.H) | L.5.52 |
| B2583 | (I.H) | L.5.53 |
| B2584 | (I.H) | L.5.54 |
| B2585 | (I.H) | L.5.55 |
| B2586 | (I.H) | L.5.56 |
| B2587 | (I.H) | L.5.57 |
| B2588 | (I.H) | L.5.58 |
| B2589 | (I.H) | L.5.59 |
| B2590 | (I.H) | L.5.60 |
| B2591 | (I.H) | L.5.61 |
| B2592 | (I.H) | L.5.62 |
| B2593 | (I.H) | L.5.63 |
| B2594 | (I.H) | L.5.64 |
| B2595 | (I.H) | L.5.65 |
| B2596 | (I.H) | L.5.66 |
| B2597 | (I.H) | L.5.67 |
| B2598 | (I.H) | L.5.68 |
| B2599 | (I.H) | L.5.69 |
| B2600 | (I.H) | L.5.70 |
| B2601 | (I.H) | L.5.71 |
| B2602 | (I.H) | L.5.72 |
| B2603 | (I.H) | L.5.73 |
| B2604 | (I.H) | L.5.74 |
| B2605 | (I.H) | L.5.75 |
| B2606 | (I.H) | L.5.76 |
| B2607 | (I.H) | L.5.77 |
| B2608 | (I.H) | L.5.78 |
| B2609 | (I.H) | L.5.79 |
| B2610 | (I.H) | L.5.80 |
| B2611 | (I.H) | L.5.81 |
| B2612 | (I.H) | L.5.82 |
| B2613 | (I.H) | L.5.83 |
| B2614 | (I.H) | L.5.84 |
| B2615 | (I.H) | L.6.1 |
| B2616 | (I.H) | L.6.2 |
| B2617 | (I.H) | L.6.3 |
| B2618 | (I.H) | L.6.4 |
| B2619 | (I.H) | L.6.5 |
| B2620 | (I.H) | L.6.6 |
| B2621 | (I.H) | L.6.7 |
| B2622 | (I.H) | L.6.8 |
| B2623 | (I.H) | L.6.9 |
| B2624 | (I.H) | L.6.10 |
| B2625 | (I.H) | L.6.11 |
| B2626 | (I.H) | L.6.12 |
| B2627 | (I.H) | L.6.13 |
| B2628 | (I.H) | L.6.14 |
| B2629 | (I.H) | L.6.15 |
| B2630 | (I.H) | L.6.16 |
| B2631 | (I.H) | L.6.17 |
| B2632 | (I.H) | L.6.18 |

B = Mixture;
I = compound I;
II = compound II

TABLE 58

| B | I | II |
|---|---|---|
| B2633 | (I.J) | L.1.1 |
| B2634 | (I.J) | L.1.2 |
| B2635 | (I.J) | L.1.3 |
| B2636 | (I.J) | L.1.4 |
| B2637 | (I.J) | L.1.5 |
| B2638 | (I.J) | L.1.6 |
| B2639 | (I.J) | L.1.7 |
| B2640 | (I.J) | L.1.8 |
| B2641 | (I.J) | L.1.9 |
| B2642 | (I.J) | L.1.10 |
| B2643 | (I.J) | L.1.11 |
| B2644 | (I.J) | L.1.12 |
| B2645 | (I.J) | L.1.13 |
| B2646 | (I.J) | L.1.14 |
| B2647 | (I.J) | L.1.15 |
| B2648 | (I.J) | L.1.16 |
| B2649 | (I.J) | L.1.17 |
| B2650 | (I.J) | L.1.18 |
| B2651 | (I.J) | L.1.19 |
| B2652 | (I.J) | L.1.20 |
| B2653 | (I.J) | L.1.21 |
| B2654 | (I.J) | L.1.22 |
| B2655 | (I.J) | L.1.23 |
| B2656 | (I.J) | L.1.24 |
| B2657 | (I.J) | L.1.25 |
| B2658 | (I.J) | L.1.26 |
| B2659 | (I.J) | L.1.27 |
| B2660 | (I.J) | L.1.28 |
| B2661 | (I.J) | L.1.29 |
| B2662 | (I.J) | L.1.30 |
| B2663 | (I.J) | L.1.31 |
| B2664 | (I.J) | L.1.32 |
| B2665 | (I.J) | L.1.33 |
| B2666 | (I.J) | L.1.34 |
| B2667 | (I.J) | L.1.35 |
| B2668 | (I.J) | L.1.36 |
| B2669 | (I.J) | L.1.37 |
| B2670 | (I.J) | L.1.38 |
| B2671 | (I.J) | L.1.39 |
| B2672 | (I.J) | L.1.40 |
| B2673 | (I.J) | L.1.41 |
| B2674 | (I.J) | L.1.42 |
| B2675 | (I.J) | L.1.43 |
| B2676 | (I.J) | L.1.44 |
| B2677 | (I.J) | L.1.45 |
| B2678 | (I.J) | L.1.46 |
| B2679 | (I.J) | L.1.47 |
| B2680 | (I.J) | L.1.48 |
| B2681 | (I.J) | L.1.49 |
| B2682 | (I.J) | L.1.50 |
| B2683 | (I.J) | L.1.51 |
| B2684 | (I.J) | L.1.52 |
| B2685 | (I.J) | L.1.53 |
| B2686 | (I.J) | L.1.54 |
| B2687 | (I.J) | L.1.55 |
| B2688 | (I.J) | L.1.56 |
| B2689 | (I.J) | L.1.57 |
| B2690 | (I.J) | L.1.58 |
| B2691 | (I.J) | L.1.59 |
| B2692 | (I.J) | L.1.60 |
| B2693 | (I.J) | L.1.61 |
| B2694 | (I.J) | L.1.62 |
| B2695 | (I.J) | L.1.63 |
| B2696 | (I.J) | L.1.64 |
| B2697 | (I.J) | L.1.65 |
| B3698 | (I.J) | L.1.66 |
| B2699 | (I.J) | L.1.67 |
| B2700 | (I.J) | L.1.68 |
| B2701 | (I.J) | L.1.69 |
| B2702 | (I.J) | L.1.70 |
| B2703 | (I.J) | L.1.71 |
| B2704 | (I.J) | L.1.72 |
| B2705 | (I.J) | L.1.73 |
| B2706 | (I.J) | L.1.74 |
| B2707 | (I.J) | L.1.75 |
| B2708 | (I.J) | L.1.76 |
| B2709 | (I.J) | L.1.77 |
| B2710 | (I.J) | L.1.78 |
| B2711 | (I.J) | L.1.79 |
| B2712 | (I.J) | L.1.80 |
| B2713 | (I.J) | L.1.81 |
| B2714 | (I.J) | L.1.82 |
| B2715 | (I.J) | L.1.83 |
| B2716 | (I.J) | L.1.84 |
| B2717 | (I.J) | L.1.85 |
| B2718 | (I.J) | L.1.86 |
| B2719 | (I.J) | L.1.87 |
| B2720 | (I.J) | L.1.88 |
| B2721 | (I.J) | L.1.89 |
| B2722 | (I.J) | L.1.90 |
| B2723 | (I.J) | L.1.91 |
| B2724 | (I.J) | L.1.92 |
| B2725 | (I.J) | L.1.93 |
| B2726 | (I.J) | L.1.94 |
| B2727 | (I.J) | L.1.95 |
| B2728 | (I.J) | L.1.96 |
| B2729 | (I.J) | L.2.1 |
| B2730 | (I.J) | L.2.2 |
| B2731 | (I.J) | L.2.3 |
| B2732 | (I.J) | L.2.4 |
| B2733 | (I.J) | L.2.5 |
| B2734 | (I.J) | L.2.6 |
| B2735 | (I.J) | L.2.7 |
| B2736 | (I.J) | L.2.8 |
| B2737 | (I.J) | L.2.9 |
| B2738 | (I.J) | L.2.10 |
| B2739 | (I.J) | L.2.11 |
| B2740 | (I.J) | L.2.12 |
| B2741 | (I.J) | L.2.13 |
| B2742 | (I.J) | L.2.14 |
| B2743 | (I.J) | L.2.15 |
| B2744 | (I.J) | L.2.16 |
| B2745 | (I.J) | L.2.17 |
| B2746 | (I.J) | L.2.18 |
| B2747 | (I.J) | L.2.19 |
| B2748 | (I.J) | L.2.20 |
| B2749 | (I.J) | L.2.21 |
| B2750 | (I.J) | L.2.22 |
| B2751 | (I.J) | L.2.23 |
| B2752 | (I.J) | L.2.24 |
| B2753 | (I.J) | L.2.25 |
| B2754 | (I.J) | L.2.26 |
| B2755 | (I.J) | L.2.27 |
| B2756 | (I.J) | L.2.28 |
| B2757 | (I.J) | L.2.29 |
| B2758 | (I.J) | L.2.30 |
| B2759 | (I.J) | L.2.31 |
| B2760 | (I.J) | L.2.32 |
| B2761 | (I.J) | L.2.33 |
| B2762 | (I.J) | L.3.1 |
| B2763 | (I.J) | L.3.2 |
| B2764 | (I.J) | L.3.3 |
| B2765 | (I.J) | L.3.4 |
| B2766 | (I.J) | L.3.5 |
| B2767 | (I.J) | L.3.6 |
| B2768 | (I.J) | L.3.7 |
| B2769 | (I.J) | L.3.8 |
| B2770 | (I.J) | L.3.9 |
| B2771 | (I.J) | L.3.10 |
| B2772 | (I.J) | L.3.11 |
| B2773 | (I.J) | L.3.12 |
| B2774 | (I.J) | L.3.13 |
| B2775 | (I.J) | L.3.14 |
| B2776 | (I.J) | L.3.15 |
| B2777 | (I.J) | L.3.16 |
| B2778 | (I.J) | L.3.17 |
| B2779 | (I.J) | L.3.18 |
| B2780 | (I.J) | L.3.19 |
| B2781 | (I.J) | L.3.20 |
| B2782 | (I.J) | L.3.21 |
| B2783 | (I.J) | L.3.22 |
| B2784 | (I.J) | L.3.23 |
| B2785 | (I.J) | L.3.24 |
| B2786 | (I.J) | L.3.25 |
| B2787 | (I.J) | L.3.26 |
| B2788 | (I.J) | L.3.27 |
| B2789 | (I.J) | L.3.28 |
| B2790 | (I.J) | L.3.29 |
| B2791 | (I.J) | L.3.30 |
| B2792 | (I.J) | L.3.31 |
| B2793 | (I.J) | L.3.32 |
| B2794 | (I.J) | L.3.33 |
| B2795 | (I.J) | L.3.34 |
| B2796 | (I.J) | L.3.35 |
| B2797 | (I.J) | L.3.36 |
| B2798 | (I.J) | L.3.37 |
| B2799 | (I.J) | L.3.38 |
| B2800 | (I.J) | L.3.39 |
| B2801 | (I.J) | L.3.40 |
| B2802 | (I.J) | L.3.41 |
| B2803 | (I.J) | L.3.42 |
| B2804 | (I.J) | L.3.43 |
| B2805 | (I.J) | L.3.44 |
| B2806 | (I.J) | L.3.45 |
| B2807 | (I.J) | L.3.46 |
| B2808 | (I.J) | L.3.47 |
| B2809 | (I.J) | L.3.48 |
| B2810 | (I.J) | L.3.49 |
| B2811 | (I.J) | L.3.50 |
| B2812 | (I.J) | L.3.51 |
| B2813 | (I.J) | L.3.52 |
| B2814 | (I.J) | L.3.53 |
| B2815 | (I.J) | L.3.54 |
| B2816 | (I.J) | L.3.55 |
| B2817 | (I.J) | L.3.56 |
| B2818 | (I.J) | L.3.57 |
| B2819 | (I.J) | L.3.58 |
| B2820 | (I.J) | L.3.59 |
| B2821 | (I.J) | L.3.60 |
| B2822 | (I.J) | L.3.61 |
| B2823 | (I.J) | L.3.62 |
| B2824 | (I.J) | L.3.63 |
| B2825 | (I.J) | L.3.1 |
| B2826 | (I.J) | L.3.2 |
| B2827 | (I.J) | L.4.1 |
| B2828 | (I.J) | L.4.2 |
| B2829 | (I.J) | L.4.3 |
| B2830 | (I.J) | L.4.4 |
| B2831 | (I.J) | L.4.5 |
| B2832 | (I.J) | L.4.6 |
| B2833 | (I.J) | L.4.7 |
| B2834 | (I.J) | L.4.8 |
| B2835 | (I.J) | L.4.9 |
| B2836 | (I.J) | L.4.10 |
| B2837 | (I.J) | L.4.11 |
| B2838 | (I.J) | L.4.12 |
| B2839 | (I.J) | L.4.13 |
| B2840 | (I.J) | L.4.14 |
| B2841 | (I.J) | L.4.15 |
| B2842 | (I.J) | L.4.16 |
| B2843 | (I.J) | L.4.17 |
| B2844 | (I.J) | L.4.18 |
| B2845 | (I.J) | L.4.19 |
| B2846 | (I.J) | L.4.20 |
| B2847 | (I.J) | L.4.21 |
| B2848 | (I.J) | L.4.22 |
| B2849 | (I.J) | L.4.23 |
| B2850 | (I.J) | L.4.24 |
| B2851 | (I.J) | L.4.25 |
| B2852 | (I.J) | L.4.26 |
| B2853 | (I.J) | L.4.27 |
| B2854 | (I.J) | L.4.28 |
| B2855 | (I.J) | L.4.29 |
| B2856 | (I.J) | L.4.30 |
| B2857 | (I.J) | L.4.31 |
| B2858 | (I.J) | L.4.32 |
| B2859 | (I.J) | L.4.33 |
| B2860 | (I.J) | L.5.1 |
| B2861 | (I.J) | L.5.2 |
| B2862 | (I.J) | L.5.3 |
| B2863 | (I.J) | L.5.4 |
| B2864 | (I.J) | L.5.5 |
| B2865 | (I.J) | L.5.6 |
| B2866 | (I.J) | L.5.7 |
| B2867 | (I.J) | L.5.8 |
| B2868 | (I.J) | L.5.9 |
| B2869 | (I.J) | L.5.10 |
| B2870 | (I.J) | L.5.11 |
| B2871 | (I.J) | L.5.12 |
| B2872 | (I.J) | L.5.13 |
| B2873 | (I.J) | L.5.14 |
| B2874 | (I.J) | L.5.15 |
| B2875 | (I.J) | L.5.16 |
| B2876 | (I.J) | L.5.17 |
| B2877 | (I.J) | L.5.18 |
| B2878 | (I.J) | L.5.19 |
| B2879 | (I.J) | L.5.20 |
| B2880 | (I.J) | L.5.21 |
| B2881 | (I.J) | L.5.22 |
| B2882 | (I.J) | L.5.23 |
| B2883 | (I.J) | L.5.24 |
| B2884 | (I.J) | L.5.25 |
| B2885 | (I.J) | L.5.26 |
| B2886 | (I.J) | L.5.27 |
| B2887 | (I.J) | L.5.28 |
| B2888 | (I.J) | L.5.29 |
| B2889 | (I.J) | L.5.30 |
| B2890 | (I.J) | L.5.31 |
| B2891 | (I.J) | L.5.32 |
| B2892 | (I.J) | L.5.33 |
| B2893 | (I.J) | L.5.34 |
| B2894 | (I.J) | L.5.35 |
| B2895 | (I.J) | L.5.36 |
| B2896 | (I.J) | L.5.37 |
| B2897 | (I.J) | L.5.38 |
| B2898 | (I.J) | L.5.39 |
| B2899 | (I.J) | L.5.40 |
| B2900 | (I.J) | L.5.41 |
| B2901 | (I.J) | L.5.42 |
| B2902 | (I.J) | L.5.43 |
| B2903 | (I.J) | L.5.44 |
| B2904 | (I.J) | L.5.45 |
| B2905 | (I.J) | L.5.46 |
| B2906 | (I.J) | L.5.47 |
| B2907 | (I.J) | L.5.48 |
| B2908 | (I.J) | L.5.49 |
| B2909 | (I.J) | L.5.50 |
| B2910 | (I.J) | L.5.51 |
| B2911 | (I.J) | L.5.52 |
| B2912 | (I.J) | L.5.53 |
| B2913 | (I.J) | L.5.54 |
| B2914 | (I.J) | L.5.55 |
| B2915 | (I.J) | L.5.56 |
| B2916 | (I.J) | L.5.57 |
| B2917 | (I.J) | L.5.58 |
| B2918 | (I.J) | L.5.59 |
| B2919 | (I.J) | L.5.60 |
| B2920 | (I.J) | L.5.61 |
| B2921 | (I.J) | L.5.62 |
| B2922 | (I.J) | L.5.63 |
| B2923 | (I.J) | L.5.64 |
| B2924 | (I.J) | L.5.65 |
| B2925 | (I.J) | L.5.66 |
| B2926 | (I.J) | L.5.67 |
| B2927 | (I.J) | L.5.68 |
| B2928 | (I.J) | L.5.69 |
| B2929 | (I.J) | L.5.70 |
| B2930 | (I.J) | L.5.71 |
| B2931 | (I.J) | L.5.72 |
| B2932 | (I.J) | L.5.73 |
| B2933 | (I.J) | L.5.74 |
| B2934 | (I.J) | L.5.75 |
| B2935 | (I.J) | L.5.76 |
| B2936 | (I.J) | L.5.77 |
| B2937 | (I.J) | L.5.78 |
| B2938 | (I.J) | L.5.79 |
| B2939 | (I.J) | L.5.80 |
| B2940 | (I.J) | L.5.81 |
| B2941 | (I.J) | L.5.82 |
| B2942 | (I.J) | L.5.83 |
| B2943 | (I.J) | L.5.84 |
| B2944 | (I.J) | L.6.1 |
| B2945 | (I.J) | L.6.2 |
| B2946 | (I.J) | L.6.3 |
| B2947 | (I.J) | L.6.4 |
| B2948 | (I.J) | L.6.5 |
| B2949 | (I.J) | L.6.6 |
| B2950 | (I.J) | L.6.7 |
| B2951 | (I.J) | L.6.8 |
| B2952 | (I.J) | L.6.9 |
| B2953 | (I.J) | L.6.10 |
| B2954 | (I.J) | L.6.11 |
| B2955 | (I.J) | L.6.12 |
| B2956 | (I.J) | L.6.13 |
| B2957 | (I.J) | L.6.14 |
| B2958 | (I.J) | L.6.15 |
| B2959 | (I.J) | L.6.16 |
| B2960 | (I.J) | L.6.17 |
| B2961 | (I.J) | L.6.18 |

B = Mixture;
I = compound I;
II = compound II

TABLE 59

| B | I | II |
|---|---|---|
| B2962 | (I.K) | L.1.1 |
| B2963 | (I.K) | L.1.2 |
| B2964 | (I.K) | L.1.3 |
| B2965 | (I.K) | L.1.4 |
| B2966 | (I.K) | L.1.5 |
| B2967 | (I.K) | L.1.6 |
| B2968 | (I.K) | L.1.7 |
| B2969 | (I.K) | L.1.8 |
| B2970 | (I.K) | L.1.9 |
| B2971 | (I.K) | L.1.10 |
| B2972 | (I.K) | L.1.11 |
| B2973 | (I.K) | L.1.12 |
| B2974 | (I.K) | L.1.13 |
| B2975 | (I.K) | L.1.14 |
| B2976 | (I.K) | L.1.15 |
| B2977 | (I.K) | L.1.16 |
| B2978 | (I.K) | L.1.17 |
| B2979 | (I.K) | L.1.18 |
| B2980 | (I.K) | L.1.19 |
| B2981 | (I.K) | L.1.20 |
| B2982 | (I.K) | L.1.21 |
| B2983 | (I.K) | L.1.22 |
| B2984 | (I.K) | L.1.23 |
| B2985 | (I.K) | L.1.24 |
| B2986 | (I.K) | L.1.25 |
| B2987 | (I.K) | L.1.26 |
| B2988 | (I.K) | L.1.27 |
| B2989 | (I.K) | L.1.28 |
| R2990 | (I.K) | L.1.29 |
| B2991 | (I.K) | L.1.30 |
| B2992 | (I.K) | L.1.31 |
| B2993 | (I.K) | L.1.32 |
| B2994 | (I.K) | L.1.33 |
| B2995 | (I.K) | L.1.34 |
| B2996 | (I.K) | L.1.35 |
| B2997 | (I.K) | L.1.36 |
| B2998 | (I.K) | L.1.37 |
| B2999 | (I.K) | L.1.38 |
| B3000 | (I.K) | L.1.39 |
| B3001 | (I.K) | L.1.40 |
| B3002 | (I.K) | L.1.41 |
| B3003 | (I.K) | L.1.42 |
| B3004 | (I.K) | L.1.43 |
| B3005 | (I.K) | L.1.44 |
| B3006 | (I.K) | L.1.45 |
| B3007 | (I.K) | L.1.46 |
| B3008 | (I.K) | L.1.47 |
| B3009 | (I.K) | L.1.48 |
| B3010 | (I.K) | L.1.49 |
| B3011 | (I.K) | L.1.50 |
| B3012 | (I.K) | L.1.51 |
| B3013 | (I.K) | L.1.52 |
| B3014 | (I.K) | L.1.53 |
| B3015 | (I.K) | L.1.54 |
| B3016 | (I.K) | L.1.55 |
| B3017 | (I.K) | L.1.56 |
| B3018 | (I.K) | L.1.57 |
| B3019 | (I.K) | L.1.58 |
| B3020 | (I.K) | L.1.59 |
| B3021 | (I.K) | L.1.60 |
| B3022 | (I.K) | L.1.61 |
| B3023 | (I.K) | L.1.62 |
| B3024 | (I.K) | L.1.63 |
| B3025 | (I.K) | L.1.64 |
| B3026 | (I.K) | L.1.65 |
| B3027 | (I.K) | L.1.66 |
| B3028 | (I.K) | L.1.67 |
| B3029 | (I.K) | L.1.68 |
| B3030 | (I.K) | L.1.69 |
| B3031 | (I.K) | L.1.70 |
| B3032 | (I.K) | L.1.71 |
| B3033 | (I.K) | L.1.72 |
| B3034 | (I.K) | L.1.73 |
| B3035 | (I.K) | L.1.74 |
| B3036 | (I.K) | L.1.75 |
| B3037 | (I.K) | L.1.76 |
| B3038 | (I.K) | L.1.77 |
| B3039 | (I.K) | L.1.78 |
| B3040 | (I.K) | L.1.79 |
| B3041 | (I.K) | L.1.80 |
| B3042 | (I.K) | L.1.81 |
| B3043 | (I.K) | L.1.82 |
| B3044 | (I.K) | L.1.83 |
| B3045 | (I.K) | L.1.84 |
| B3046 | (I.K) | L.1.85 |
| B3047 | (I.K) | L.1.86 |
| B3048 | (I.K) | L.1.87 |
| B3049 | (I.K) | L.1.88 |
| B3050 | (I.K) | L.1.89 |
| B3051 | (I.K) | L.1.90 |
| B3052 | (I.K) | L.1.91 |
| B3053 | (I.K) | L.1.92 |
| B3054 | (I.K) | L.1.93 |
| B3055 | (I.K) | L.1.94 |
| B3056 | (I.K) | L.1.95 |
| B3057 | (I.K) | L.1.96 |
| B3058 | (I.K) | L.2.1 |
| B3059 | (I.K) | L.2.2 |
| B3060 | (I.K) | L.2.3 |
| B3061 | (I.K) | L.2.4 |
| B3062 | (I.K) | L.2.5 |
| B3063 | (I.K) | L.2.6 |
| B3064 | (I.K) | L.2.7 |
| B3065 | (I.K) | L.2.8 |
| B3066 | (I.K) | L.2.9 |
| B3067 | (I.K) | L.2.10 |
| B3068 | (I.K) | L.2.11 |
| B3069 | (I.K) | L.2.12 |
| B3070 | (I.K) | L.2.13 |
| B3071 | (I.K) | L.2.14 |
| B3072 | (I.K) | L.2.15 |
| B3073 | (I.K) | L.2.16 |
| B3074 | (I.K) | L.2.17 |
| B3075 | (I.K) | L.2.18 |
| B3076 | (I.K) | L.2.19 |
| B3077 | (I.K) | L.2.20 |
| B3078 | (I.K) | L.2.21 |
| B3079 | (I.K) | L.2.22 |
| B3080 | (I.K) | L.2.23 |
| B3081 | (I.K) | L.2.24 |
| B3082 | (I.K) | L.2.25 |
| B3083 | (I.K) | L.2.26 |
| B3084 | (I.K) | L.2.27 |
| B3085 | (I.K) | L.2.28 |
| B3086 | (I.K) | L.2.29 |
| B3087 | (I.K) | L.2.30 |
| B3088 | (I.K) | L.2.31 |
| B3089 | (I.K) | L.2.32 |
| B3090 | (I.K) | L.2.33 |
| B3091 | (I.K) | L.3.1 |
| B3092 | (I.K) | L.3.2 |
| B3093 | (I.K) | L.3.3 |
| B3094 | (I.K) | L.3.4 |
| B3095 | (I.K) | L.3.5 |
| B3096 | (I.K) | L.3.6 |
| B3097 | (I.K) | L.3.7 |
| B3098 | (I.K) | L.3.8 |
| B3099 | (I.K) | L.3.9 |
| B3100 | (I.K) | L.3.10 |
| B3101 | (I.K) | L.3.11 |
| B3102 | (I.K) | L.3.12 |
| B3103 | (I.K) | L.3.13 |
| B3104 | (I.K) | L.3.14 |
| B3105 | (I.K) | L.3.15 |
| B3106 | (I.K) | L.3.16 |
| B3107 | (I.K) | L.3.17 |
| B3108 | (I.K) | L.3.18 |
| B3109 | (I.K) | L.3.19 |
| B3110 | (I.K) | L.3.20 |
| B3111 | (I.K) | L.3.21 |
| B3112 | (I.K) | L.3.22 |
| B3113 | (I.K) | L.3.23 |
| B3114 | (I.K) | L.3.24 |
| B3115 | (I.K) | L.3.25 |
| B3116 | (I.K) | L.3.26 |
| B3117 | (I.K) | L.3.27 |
| B3118 | (I.K) | L.3.28 |
| B3119 | (I.K) | L.3.29 |
| B3120 | (I.K) | L.3.30 |
| B3121 | (I.K) | L.3.31 |
| B3122 | (I.K) | L.3.32 |
| B3123 | (I.K) | L.3.33 |
| B3124 | (I.K) | L.3.34 |
| B3125 | (I.K) | L.3.35 |
| B3126 | (I.K) | L.3.36 |
| B3127 | (I.K) | L.3.37 |
| B3128 | (I.K) | L.3.38 |
| B3129 | (I.K) | L.3.39 |
| B3130 | (I.K) | L.3.40 |
| B3131 | (I.K) | L.3.41 |
| B3132 | (I.K) | L.3.42 |
| B3133 | (I.K) | L.3.43 |
| B3134 | (I.K) | L.3.44 |
| B3135 | (I.K) | L.3.45 |
| B3136 | (I.K) | L.3.46 |
| B3137 | (I.K) | L.3.47 |
| B3138 | (I.K) | L.3.48 |
| B3139 | (I.K) | L.3.49 |
| B3140 | (I.K) | L.3.50 |
| B3141 | (I.K) | L.3.51 |
| B3142 | (I.K) | L.3.52 |
| B3143 | (I.K) | L.3.53 |
| B3144 | (I.K) | L.3.54 |
| B3145 | (I.K) | L.3.55 |
| B3146 | (I.K) | L.3.56 |
| B3147 | (I.K) | L.3.57 |
| B3148 | (I.K) | L.3.58 |
| B3149 | (I.K) | L.3.59 |
| B3150 | (I.K) | L.3.60 |
| B3151 | (I.K) | L.3.61 |
| B3152 | (I.K) | L.3.62 |
| B3153 | (I.K) | L.3.63 |
| B3154 | (I.K) | L.3.1 |
| B3155 | (I.K) | L.3.2 |
| B3156 | (I.K) | L.4.1 |
| B3157 | (I.K) | L.4.2 |
| B3158 | (I.K) | L.4.3 |
| B3159 | (I.K) | L.4.4 |
| B3160 | (I.K) | L.4.5 |
| B3161 | (I.K) | L.4.6 |
| B3162 | (I.K) | L.4.7 |
| B3163 | (I.K) | L.4.8 |
| B3164 | (I.K) | L.4.9 |
| B3165 | (I.K) | L.4.10 |
| B3166 | (I.K) | L.4.11 |
| B3167 | (I.K) | L.4.12 |
| B3168 | (I.K) | L.4.13 |
| B3169 | (I.K) | L.4.14 |
| B3170 | (I.K) | L.4.15 |
| B3171 | (I.K) | L.4.16 |
| B3172 | (I.K) | L.4.17 |
| B3173 | (I.K) | L.4.18 |
| B3174 | (I.K) | L.4.19 |
| B3175 | (I.K) | L.4.20 |
| B3176 | (I.K) | L.4.21 |
| B3177 | (I.K) | L.4.22 |
| B3178 | (I.K) | L.4.23 |
| B3179 | (I.K) | L.4.24 |
| B3180 | (I.K) | L.4.25 |
| B3181 | (I.K) | L.4.26 |
| B3182 | (I.K) | L.4.27 |
| B3183 | (I.K) | L.4.28 |
| B3184 | (I.K) | L.4.29 |
| B3185 | (I.K) | L.4.30 |
| B3186 | (I.K) | L.4.31 |
| B3187 | (I.K) | L.4.32 |
| B3188 | (I.K) | L.4.33 |
| B3189 | (I.K) | L.5.1 |
| B3190 | (I.K) | L.5.2 |
| B3191 | (I.K) | L.5.3 |
| B3192 | (I.K) | L.5.4 |
| B3193 | (I.K) | L.5.5 |
| B3194 | (I.K) | L.5.6 |
| B3195 | (I.K) | L.5.7 |
| B3196 | (I.K) | L.5.8 |
| B3197 | (I.K) | L.5.9 |
| B3198 | (I.K) | L.5.10 |
| B3199 | (I.K) | L.5.11 |
| B3200 | (I.K) | L.5.12 |
| B3201 | (I.K) | L.5.13 |
| B3202 | (I.K) | L.5.14 |
| B3203 | (I.K) | L.5.15 |
| B3204 | (I.K) | L.5.16 |
| B3205 | (I.K) | L.5.17 |
| B3206 | (I.K) | L.5.18 |
| B3207 | (I.K) | L.5.19 |
| B3208 | (I.K) | L.5.20 |
| B3209 | (I.K) | L.5.21 |
| B3210 | (I.K) | L.5.22 |
| B3211 | (I.K) | L.5.23 |
| B3212 | (I.K) | L.5.24 |
| B3213 | (I.K) | L.5.25 |
| B3214 | (I.K) | L.5.26 |
| B3215 | (I.K) | L.5.27 |
| B3216 | (I.K) | L.5.28 |
| B3217 | (I.K) | L.5.29 |
| B3218 | (I.K) | L.5.30 |
| B3219 | (I.K) | L.5.31 |
| B3220 | (I.K) | L.5.32 |
| B3221 | (I.K) | L.5.33 |
| B3222 | (I.K) | L.5.34 |
| B3223 | (I.K) | L.5.35 |
| B3224 | (I.K) | L.5.36 |
| B3225 | (I.K) | L.5.37 |
| B3226 | (I.K) | L.5.38 |
| B3227 | (I.K) | L.5.39 |
| B3228 | (I.K) | L.5.40 |
| B3229 | (I.K) | L.5.41 |
| B3230 | (I.K) | L.5.42 |
| B3231 | (I.K) | L.5.43 |
| B3232 | (I.K) | L.5.44 |
| B3233 | (I.K) | L.5.45 |
| B3234 | (I.K) | L.5.46 |
| B3235 | (I.K) | L.5.47 |
| B3236 | (I.K) | L.5.48 |
| B3237 | (I.K) | L.5.49 |
| B3238 | (I.K) | L.5.50 |
| B3239 | (I.K) | L.5.51 |
| B3240 | (I.K) | L.5.52 |
| B3241 | (I.K) | L.5.53 |
| B3242 | (I.K) | L.5.54 |
| B3243 | (I.K) | L.5.55 |
| B3244 | (I.K) | L.5.56 |
| B3245 | (I.K) | L.5.57 |
| B3246 | (I.K) | L.5.58 |
| B3247 | (I.K) | L.5.59 |
| B3248 | (I.K) | L.5.60 |
| B3249 | (I.K) | L.5.61 |
| B3250 | (I.K) | L.5.62 |
| B3251 | (I.K) | L.5.63 |
| B3252 | (I.K) | L.5.64 |
| B3253 | (I.K) | L.5.65 |
| B3254 | (I.K) | L.5.66 |
| B3255 | (I.K) | L.5.67 |
| B3256 | (I.K) | L.5.68 |
| B3257 | (I.K) | L.5.69 |
| B3258 | (I.K) | L.5.70 |
| B3259 | (I.K) | L.5.71 |
| B3260 | (I.K) | L.5.72 |
| B3261 | (I.K) | L.5.73 |
| B3262 | (I.K) | L.5.74 |
| B3263 | (I.K) | L.5.75 |
| B3264 | (I.K) | L.5.76 |
| B3265 | (I.K) | L.5.77 |
| B3266 | (I.K) | L.5.78 |
| B3267 | (I.K) | L.5.79 |
| B3268 | (I.K) | L.5.80 |
| B3269 | (I.K) | L.5.81 |
| B3270 | (I.K) | L.5.82 |
| B3271 | (I.K) | L.5.83 |
| B3272 | (I.K) | L.5.84 |
| B3273 | (I.K) | L.6.1 |
| B3274 | (I.K) | L.6.2 |
| B3275 | (I.K) | L.6.3 |
| B3276 | (I.K) | L.6.4 |
| B3277 | (I.K) | L.6.5 |
| B3278 | (I.K) | L.6.6 |
| B3279 | (I.K) | L.6.7 |
| B3280 | (I.K) | L.6.8 |
| B3281 | (I.K) | L.6.9 |
| B3282 | (I.K) | L.6.10 |
| B3283 | (I.K) | L.6.11 |
| B3284 | (I.K) | L.6.12 |
| B3285 | (I.K) | L.6.13 |
| B3286 | (I.K) | L.6.14 |
| B3287 | (I.K) | L.6.15 |
| B3288 | (I.K) | L.6.16 |
| B3289 | (I.K) | L.6.17 |
| B3990 | (I.K) | L.6.18 |

B = Mixture;
I = compound I;
II = compound II

TABLE 60

| B | I | II |
|---|---|---|
| B3291 | (I.L) | L.1.1 |
| B3292 | (I.L) | L.1.2 |
| B3293 | (I.L) | L.1.3 |
| B3294 | (I.L) | L.1.4 |
| B3295 | (I.L) | L.1.5 |
| B3296 | (I.L) | L.1.6 |
| B3297 | (I.L) | L.1.7 |
| B3298 | (I.L) | L.1.8 |
| B3299 | (I.L) | L.1.9 |
| B3300 | (I.L) | L.1.10 |
| B3301 | (I.L) | L.1.11 |
| B3302 | (I.L) | L.1.12 |
| B3303 | (I.L) | L.1.13 |
| B3304 | (I.L) | L.1.14 |
| B3305 | (I.L) | L.1.15 |
| B3306 | (I.L) | L.1.16 |
| B3307 | (I.L) | L.1.17 |
| B3308 | (I.L) | L.1.18 |
| B3309 | (I.L) | L.1.19 |
| B3310 | (I.L) | L.1.20 |
| B3311 | (I.L) | L.1.21 |
| B3312 | (I.L) | L.1.22 |
| B3313 | (I.L) | L.1.23 |
| B3314 | (I.L) | L.1.24 |
| B3315 | (I.L) | L.1.25 |
| B3316 | (I.L) | L.1.26 |
| B3317 | (I.L) | L.1.27 |
| B3318 | (I.L) | L.1.28 |
| B3319 | (I.L) | L.1.29 |
| B3320 | (I.L) | L.1.30 |
| B3321 | (I.L) | L.1.31 |
| B3322 | (I.L) | L.1.32 |
| B3323 | (I.L) | L.1.33 |
| B3324 | (I.L) | L.1.34 |
| B3325 | (I.L) | L.1.35 |
| B3326 | (I.L) | L.1.36 |
| B3327 | (I.L) | L.1.37 |
| B3328 | (I.L) | L.1.38 |
| B3329 | (I.L) | L.1.39 |
| B3330 | (I.L) | L.1.40 |
| B3331 | (I.L) | L.1.41 |
| B3332 | (I.L) | L.1.42 |
| B3333 | (I.L) | L.1.43 |
| B3334 | (I.L) | L.1.44 |
| B3335 | (I.L) | L.1.45 |
| B3336 | (I.L) | L.1.46 |
| B3337 | (I.L) | L.1.47 |
| B3338 | (I.L) | L.1.48 |
| B3339 | (I.L) | L.1.49 |
| B3340 | (I.L) | L.1.50 |
| B3341 | (I.L) | L.1.51 |
| B3342 | (I.L) | L.1.52 |
| B3343 | (I.L) | L.1.53 |
| B3344 | (I.L) | L.1.54 |
| B3345 | (I.L) | L.1.55 |
| B3346 | (I.L) | L.1.56 |
| B3347 | (I.L) | L.1.57 |
| B3348 | (I.L) | L.1.58 |
| B3349 | (I.L) | L.1.59 |
| B3350 | (I.L) | L.1.60 |
| B3351 | (I.L) | L.1.61 |
| B3352 | (I.L) | L.1.62 |
| B3353 | (I.L) | L.1.63 |
| B3354 | (I.L) | L.1.64 |
| B3355 | (I.L) | L.1.65 |
| B3356 | (I.L) | L.1.66 |
| B3357 | (I.L) | L.1.67 |
| B3358 | (I.L) | L.1.68 |
| B3359 | (I.L) | L.1.69 |
| B3360 | (I.L) | L.1.70 |
| B3361 | (I.L) | L.1.71 |
| B3362 | (I.L) | L.1.72 |
| B3363 | (I.L) | L.1.73 |
| B3364 | (I.L) | L.1.74 |
| B3365 | (I.L) | L.1.75 |
| B3366 | (I.L) | L.1.76 |
| B3367 | (I.L) | L.1.77 |
| B3368 | (I.L) | L.1.78 |
| B3369 | (I.L) | L.1.79 |
| B3370 | (I.L) | L.1.80 |
| B3371 | (I.L) | L.1.81 |
| B3372 | (I.L) | L.1.82 |
| B3373 | (I.L) | L.1.83 |
| B3374 | (I.L) | L.1.84 |
| B3375 | (I.L) | L.1.85 |
| B3376 | (I.L) | L.1.86 |
| B3377 | (I.L) | L.1.87 |
| B3378 | (I.L) | L.1.88 |
| B3379 | (I.L) | L.1.89 |
| B3380 | (I.L) | L.1.90 |
| B3381 | (I.L) | L.1.91 |
| B3382 | (I.L) | L.1.92 |
| B3383 | (I.L) | L.1.93 |
| B3384 | (I.L) | L.1.94 |
| B3385 | (I.L) | L.1.95 |
| B3386 | (I.L) | L.1.96 |
| B3387 | (I.L) | L.2.1 |
| B3388 | (I.L) | L.2.2 |
| B3389 | (I.L) | L.2.3 |
| B3390 | (I.L) | L.2.4 |
| B3391 | (I.L) | L.2.5 |
| B3392 | (I.L) | L.2.6 |
| B3393 | (I.L) | L.2.7 |
| B3394 | (I.L) | L.2.8 |
| B3395 | (I.L) | L.2.9 |
| B3396 | (I.L) | L.2.10 |
| B3397 | (I.L) | L.2.11 |
| B3398 | (I.L) | L.2.12 |
| B3399 | (I.L) | L.2.13 |
| B3400 | (I.L) | L.2.14 |
| B3401 | (I.L) | L.2.15 |
| B3402 | (I.L) | L.2.16 |
| B3403 | (I.L) | L.2.17 |
| B3404 | (I.L) | L.2.18 |
| B3405 | (I.L) | L.2.19 |
| B3406 | (I.L) | L.2.20 |
| B3407 | (I.L) | L.2.21 |
| B3408 | (I.L) | L.2.22 |
| B3409 | (I.L) | L.2.23 |
| B3410 | (I.L) | L.2.24 |
| B3411 | (I.L) | L.2.25 |
| B3412 | (I.L) | L.2.26 |
| B3413 | (I.L) | L.2.27 |
| B3414 | (I.L) | L.2.28 |
| B3415 | (I.L) | L.2.29 |
| B3416 | (I.L) | L.2.30 |
| B3417 | (I.L) | L.2.31 |
| B3418 | (I.L) | L.2.32 |
| B3419 | (I.L) | L.2.33 |
| B3420 | (I.L) | L.3.1 |
| B3421 | (I.L) | L.3.2 |
| B3422 | (I.L) | L.3.3 |
| B3423 | (I.L) | L.3.4 |
| B3424 | (I.L) | L.3.5 |
| B3425 | (I.L) | L.3.6 |
| B3426 | (I.L) | L.3.7 |
| B3427 | (I.L) | L.3.8 |
| B3428 | (I.L) | L.3.9 |
| B3429 | (I.L) | L.3.10 |
| B3430 | (I.L) | L.3.11 |
| B3431 | (I.L) | L.3.12 |
| B3432 | (I.L) | L.3.13 |
| B3433 | (I.L) | L.3.14 |
| B3434 | (I.L) | L.3.15 |
| B3435 | (I.L) | L.3.16 |
| B3436 | (I.L) | L.3.17 |
| B3437 | (I.L) | L.3.18 |
| B3438 | (I.L) | L.3.19 |
| B3439 | (I.L) | L.3.20 |
| B3440 | (I.L) | L.3.21 |
| B3441 | (I.L) | L.3.22 |
| B3442 | (I.L) | L.3.23 |
| B3443 | (I.L) | L.3.24 |
| B3444 | (I.L) | L.3.25 |
| B3445 | (I.L) | L.3.26 |
| B3446 | (I.L) | L.3.27 |
| B3447 | (I.L) | L.3.28 |
| B3448 | (I.L) | L.3.29 |
| B3449 | (I.L) | L.3.30 |
| B3450 | (I.L) | L.3.31 |
| B3451 | (I.L) | L.3.32 |
| B3452 | (I.L) | L.3.33 |
| B3453 | (I.L) | L.3.34 |
| B3454 | (I.L) | L.3.35 |
| B3455 | (I.L) | L.3.36 |
| B3456 | (I.L) | L.3.37 |
| B3457 | (I.L) | L.3.38 |
| B3458 | (I.L) | L.3.39 |
| B3459 | (I.L) | L.3.40 |
| B3460 | (I.L) | L.3.41 |
| B3461 | (I.L) | L.3.42 |
| B3462 | (I.L) | L.3.43 |
| B3463 | (I.L) | L.3.44 |
| B3464 | (I.L) | L.3.45 |
| B3465 | (I.L) | L.3.46 |
| B3466 | (I.L) | L.3.47 |
| B3467 | (I.L) | L.3.48 |
| B3468 | (I.L) | L.3.49 |
| B3469 | (I.L) | L.3.50 |
| B3470 | (I.L) | L.3.51 |
| B3471 | (I.L) | L.3.52 |
| B3472 | (I.L) | L.3.53 |
| B3473 | (I.L) | L.3.54 |
| B3474 | (I.L) | L.3.55 |
| B3475 | (I.L) | L.3.56 |
| B3476 | (I.L) | L.3.57 |
| B3477 | (I.L) | L.3.58 |
| B3478 | (I.L) | L.3.59 |
| B3479 | (I.L) | L.3.60 |
| B3480 | (I.L) | L.3.61 |
| B3481 | (I.L) | L.3.62 |
| B3482 | (I.L) | L.3.63 |
| B3483 | (I.L) | L.3.1 |
| B3484 | (I.L) | L.3.2 |
| B3485 | (I.L) | L.4.1 |
| B3486 | (I.L) | L.4.2 |
| B3487 | (I.L) | L.4.3 |
| B3488 | (I.L) | L.4.4 |
| B3489 | (I.L) | L.4.5 |
| B3490 | (I.L) | L.4.6 |
| B3491 | (I.L) | L.4.7 |
| B3492 | (I.L) | L.4.8 |
| B3493 | (I.L) | L.4.9 |
| B3494 | (I.L) | L.4.10 |
| B3495 | (I.L) | L.4.11 |
| B3496 | (I.L) | L.4.12 |
| B3497 | (I.L) | L.4.13 |
| B3498 | (I.L) | L.4.14 |
| B3499 | (I.L) | L.4.15 |
| B3500 | (I.L) | L.4.16 |
| B3501 | (I.L) | L.4.17 |
| B3502 | (I.L) | L.4.18 |
| B3503 | (I.L) | L.4.19 |
| B3504 | (I.L) | L.4.20 |
| B3505 | (I.L) | L.4.21 |
| B3506 | (I.L) | L.4.22 |
| B3507 | (I.L) | L.4.23 |
| B3508 | (I.L) | L.4.24 |
| B3509 | (I.L) | L.4.25 |
| B3510 | (I.L) | L.4.26 |
| B3511 | (I.L) | L.4.27 |
| B3512 | (I.L) | L.4.28 |
| B3513 | (I.L) | L.4.29 |
| B3514 | (I.L) | L.4.30 |
| B3515 | (I.L) | L.4.31 |
| B3516 | (I.L) | L.4.32 |
| B3517 | (I.L) | L.4.33 |
| B3518 | (I.L) | L.5.1 |
| B3519 | (I.L) | L.5.2 |
| B3520 | (I.L) | L.5.3 |
| B3521 | (I.L) | L.5.4 |
| B3522 | (I.L) | L.5.5 |
| B3523 | (I.L) | L.5.6 |
| B3524 | (I.L) | L.5.7 |
| B3525 | (I.L) | L.5.8 |
| B3526 | (I.L) | L.5.9 |
| B3527 | (I.L) | L.5.10 |
| B3528 | (I.L) | L.5.11 |
| B3529 | (I.L) | L.5.12 |
| B3530 | (I.L) | L.5.13 |
| B3531 | (I.L) | L.5.14 |
| B3532 | (I.L) | L.5.15 |
| B3533 | (I.L) | L.5.16 |
| B3534 | (I.L) | L.5.17 |
| B3535 | (I.L) | L.5.18 |
| B3536 | (I.L) | L.5.19 |
| B3537 | (I.L) | L.5.20 |
| B3538 | (I.L) | L.5.21 |
| B3539 | (I.L) | L.5.22 |
| B3540 | (I.L) | L.5.23 |
| B3541 | (I.L) | L.5.24 |
| B3542 | (I.L) | L.5.25 |
| B3543 | (I.L) | L.5.26 |
| B3544 | (I.L) | L.5.27 |
| B3545 | (I.L) | L.5.28 |
| B3546 | (I.L) | L.5.29 |
| B3547 | (I.L) | L.5.30 |
| B3548 | (I.L) | L.5.31 |
| B3549 | (I.L) | L.5.32 |
| B3550 | (I.L) | L.5.33 |
| B3551 | (I.L) | L.5.34 |
| B3552 | (I.L) | L.5.35 |
| B3553 | (I.L) | L.5.36 |
| B3554 | (I.L) | L.5.37 |
| B3555 | (I.L) | L.5.38 |
| B3556 | (I.L) | L.5.39 |
| B3557 | (I.L) | L.5.40 |
| B3558 | (I.L) | L.5.41 |
| B3559 | (I.L) | L.5.42 |
| B3560 | (I.L) | L.5.43 |
| B3561 | (I.L) | L.5.44 |
| B3562 | (I.L) | L.5.45 |
| B3563 | (I.L) | L.5.46 |
| B3564 | (I.L) | L.5.47 |
| B3565 | (I.L) | L.5.48 |
| B3566 | (I.L) | L.5.49 |
| B3567 | (I.L) | L.5.50 |
| B3568 | (I.L) | L.5.51 |
| B3569 | (I.L) | L.5.52 |
| B3570 | (I.L) | L.5.53 |
| B3571 | (I.L) | L.5.54 |
| B3572 | (I.L) | L.5.55 |
| B3573 | (I.L) | L.5.56 |
| B3574 | (I.L) | L.5.57 |
| B3575 | (I.L) | L.5.58 |
| B3576 | (I.L) | L.5.59 |
| B3577 | (I.L) | L.5.60 |
| B3578 | (I.L) | L.5.61 |
| B3579 | (I.L) | L.5.62 |
| B3580 | (I.L) | L.5.63 |
| B3581 | (I.L) | L.5.64 |
| B3582 | (I.L) | L.5.65 |
| B3583 | (I.L) | L.5.66 |
| B3584 | (I.L) | L.5.67 |
| B3585 | (I.L) | L.5.68 |
| B3586 | (I.L) | L.5.69 |
| B3587 | (I.L) | L.5.70 |
| B3588 | (I.L) | L.5.71 |
| B3589 | (I.L) | L.5.72 |
| B3590 | (I.L) | L.5.73 |
| B3591 | (I.L) | L.5.74 |
| B3592 | (I.L) | L.5.75 |
| B3593 | (I.L) | L.5.76 |
| B3594 | (I.L) | L.5.77 |
| B3595 | (I.L) | L.5.78 |
| B3596 | (I.L) | L.5.79 |
| B3597 | (I.L) | L.5.80 |
| B3598 | (I.L) | L.5.81 |
| B3599 | (I.L) | L.5.82 |
| B3600 | (I.L) | L.5.83 |
| B3601 | (I.L) | L.5.84 |
| B3602 | (I.L) | L.6.1 |
| B3603 | (I.L) | L.6.2 |
| B3604 | (I.L) | L.6.3 |
| B3605 | (I.L) | L.6.4 |
| B3606 | (I.L) | L.6.5 |
| B3607 | (I.L) | L.6.6 |
| B3608 | (I.L) | L.6.7 |
| B3609 | (I.L) | L.6.8 |
| B3610 | (I.L) | L.6.9 |
| B3611 | (I.L) | L.6.10 |
| B3612 | (I.L) | L.6.11 |
| B3613 | (I.L) | L.6.12 |
| B3614 | (I.L) | L.6.13 |
| B3615 | (I.L) | L.6.14 |
| B3616 | (I.L) | L.6.15 |
| B3617 | (I.L) | L.6.16 |
| B3618 | (I.L) | L.6.17 |
| B3619 | (I.L) | L.6.18 |

B = Mixture;
I = compound I;
II = compound II

TABLE 61

| B | I | II |
|---|---|---|
| B3620 | (I.M) | L.1.1 |
| B3621 | (I.M) | L.1.2 |
| B3622 | (I.M) | L.1.3 |
| B3623 | (I.M) | L.1.4 |
| B3624 | (I.M) | L.1.5 |
| B3625 | (I.M) | L.1.6 |
| B3626 | (I.M) | L.1.7 |
| B3627 | (I.M) | L.1.8 |
| B3628 | (I.M) | L.1.9 |
| B3629 | (I.M) | L.1.10 |
| B3630 | (I.M) | L.1.11 |
| B3631 | (I.M) | L.1.12 |
| B3632 | (I.M) | L.1.13 |
| B3633 | (I.M) | L.1.14 |
| B3634 | (I.M) | L.1.15 |
| B3635 | (I.M) | L.1.16 |
| B3636 | (I.M) | L.1.17 |
| B3637 | (I.M) | L.1.18 |
| B3638 | (I.M) | L.1.19 |
| B3639 | (I.M) | L.1.20 |
| B3640 | (I.M) | L.1.21 |
| B3641 | (I.M) | L.1.22 |
| B3642 | (I.M) | L.1.23 |
| B3643 | (I.M) | L.1.24 |
| B3644 | (I.M) | L.1.25 |
| B3645 | (I.M) | L.1.26 |
| B3646 | (I.M) | L.1.27 |
| B3647 | (I.M) | L.1.28 |
| B3648 | (I.M) | L.1.29 |
| B3649 | (I.M) | L.1.30 |
| B3650 | (I.M) | L.1.31 |
| B3651 | (I.M) | L.1.32 |
| B3652 | (I.M) | L.1.33 |
| B3653 | (I.M) | L.1.34 |
| B3654 | (I.M) | L.1.35 |
| B3655 | (I.M) | L.1.36 |
| B3656 | (I.M) | L.1.37 |
| B3657 | (I.M) | L.1.38 |
| B3658 | (I.M) | L.1.39 |
| B3659 | (I.M) | L.1.40 |
| B3660 | (I.M) | L.1.41 |
| B3661 | (I.M) | L.1.42 |
| B3662 | (I.M) | L.1.43 |
| B3663 | (I.M) | L.1.44 |
| B3664 | (I.M) | L.1.45 |
| B3665 | (I.M) | L.1.46 |
| B3666 | (I.M) | L.1.47 |
| B3667 | (I.M) | L.1.48 |
| B3668 | (I.M) | L.1.49 |
| B3669 | (I.M) | L.1.50 |
| B3670 | (I.M) | L.1.51 |
| B3671 | (I.M) | L.1.52 |
| B3672 | (I.M) | L.1.53 |
| B3673 | (I.M) | L.1.54 |
| B3674 | (I.M) | L.1.55 |
| B3675 | (I.M) | L.1.56 |
| B3676 | (I.M) | L.1.57 |
| B3677 | (I.M) | L.1.58 |
| B3678 | (I.M) | L.1.59 |
| B3679 | (I.M) | L.1.60 |
| B3680 | (I.M) | L.1.61 |
| B3681 | (I.M) | L.1.62 |
| B3682 | (I.M) | L.1.63 |
| B3683 | (I.M) | L.1.64 |
| B3684 | (I.M) | L.1.65 |
| B3685 | (I.M) | L.1.66 |
| B3686 | (I.M) | L.1.67 |
| B3687 | (I.M) | L.1.68 |
| B3688 | (I.M) | L.1.69 |
| B3689 | (I.M) | L.1.70 |
| B3690 | (I.M) | L.1.71 |
| B3691 | (I.M) | L.1.72 |
| B3692 | (I.M) | L.1.73 |
| B3693 | (I.M) | L.1.74 |
| B3694 | (I.M) | L.1.75 |
| B3695 | (I.M) | L.1.76 |
| B3696 | (I.M) | L.1.77 |
| B3697 | (I.M) | L.1.78 |
| B3698 | (I.M) | L.1.79 |
| B3699 | (I.M) | L.1.80 |
| B3700 | (I.M) | L.1.81 |
| B3701 | (I.M) | L.1.82 |
| B3702 | (I.M) | L.1.83 |
| B3703 | (I.M) | L.1.84 |
| B3704 | (I.M) | L.1.85 |
| B3705 | (I.M) | L.1.86 |
| B3706 | (I.M) | L.1.87 |
| B3707 | (I.M) | L.1.88 |
| B3708 | (I.M) | L.1.89 |
| B3709 | (I.M) | L.1.90 |
| B3710 | (I.M) | L.1.91 |
| B3711 | (I.M) | L.1.92 |
| B3712 | (I.M) | L.1.93 |
| B3713 | (I.M) | L.1.94 |
| B3714 | (I.M) | L.1.95 |
| B3715 | (I.M) | L.1.96 |
| B3716 | (I.M) | L.2.1 |
| B3717 | (I.M) | L.2.2 |
| B3718 | (I.M) | L.2.3 |
| B3719 | (I.M) | L.2.4 |
| B3720 | (I.M) | L.2.5 |
| B3721 | (I.M) | L.2.6 |
| B3722 | (I.M) | L.2.7 |
| B3723 | (I.M) | L.2.8 |
| B3724 | (I.M) | L.2.9 |
| B3725 | (I.M) | L.2.10 |
| B3726 | (I.M) | L.2.11 |
| B3727 | (I.M) | L.2.12 |
| B3728 | (I.M) | L.2.13 |
| B3729 | (I.M) | L.2.14 |
| B3730 | (I.M) | L.2.15 |
| B3731 | (I.M) | L.2.16 |
| B3732 | (I.M) | L.2.17 |
| B3733 | (I.M) | L.2.18 |
| B3734 | (I.M) | L.2.19 |
| B3735 | (I.M) | L.2.20 |
| B3736 | (I.M) | L.2.21 |
| B3737 | (I.M) | L.2.22 |
| B3738 | (I.M) | L.2.23 |
| B3739 | (I.M) | L.2.24 |
| B3740 | (I.M) | L.2.25 |
| B3741 | (I.M) | L.2.26 |
| B3742 | (I.M) | L.2.27 |
| B3743 | (I.M) | L.2.28 |
| B3744 | (I.M) | L.2.29 |
| B3745 | (I.M) | L.2.30 |
| B3746 | (I.M) | L.2.31 |
| B3747 | (I.M) | L.2.32 |
| B3748 | (I.M) | L.2.33 |
| B3749 | (I.M) | L.3.1 |
| B3750 | (I.M) | L.3.2 |
| B3751 | (I.M) | L.3.3 |
| B3752 | (I.M) | L.3.4 |
| B3753 | (I.M) | L.3.5 |
| B3754 | (I.M) | L.3.6 |
| B3755 | (I.M) | L.3.7 |
| B3756 | (I.M) | L.3.8 |
| B3757 | (I.M) | L.3.9 |
| B3758 | (I.M) | L.3.10 |
| B3759 | (I.M) | L.3.11 |
| B3760 | (I.M) | L.3.12 |
| B3761 | (I.M) | L.3.13 |
| B3762 | (I.M) | L.3.14 |
| B3763 | (I.M) | L.3.15 |
| B3764 | (I.M) | L.3.16 |
| B3765 | (I.M) | L.3.17 |
| B3766 | (I.M) | L.3.18 |
| B3767 | (I.M) | L.3.19 |
| B3768 | (I.M) | L.3.20 |
| B3769 | (I.M) | L.3.21 |
| B3770 | (I.M) | L.3.22 |
| B3771 | (I.M) | L.3.23 |
| B3772 | (I.M) | L.3.24 |
| B3773 | (I.M) | L.3.25 |
| B3774 | (I.M) | L.3.26 |
| B3775 | (I.M) | L.3.27 |
| B3776 | (I.M) | L.3.28 |
| B3777 | (I.M) | L.3.29 |
| B3778 | (I.M) | L.3.30 |
| B3779 | (I.M) | L.3.31 |
| B3780 | (I.M) | L.3.32 |
| B3781 | (I.M) | L.3.33 |
| B3782 | (I.M) | L.3.34 |
| B3783 | (I.M) | L.3.35 |
| B3784 | (I.M) | L.3.36 |
| B3785 | (I.M) | L.3.37 |
| B3786 | (I.M) | L.3.38 |
| B3787 | (I.M) | L.3.39 |
| B3788 | (I.M) | L.3.40 |
| B3789 | (I.M) | L.3.41 |
| B3790 | (I.M) | L.3.42 |
| B3791 | (I.M) | L.3.43 |
| B3792 | (I.M) | L.3.44 |
| B3793 | (I.M) | L.3.45 |
| B3794 | (I.M) | L.3.46 |
| B3795 | (I.M) | L.3.47 |
| B3796 | (I.M) | L.3.48 |
| B3797 | (I.M) | L.3.49 |
| B3798 | (I.M) | L.3.50 |
| B3799 | (I.M) | L.3.51 |
| B3800 | (I.M) | L.3.52 |
| B3801 | (I.M) | L.3.53 |
| B3802 | (I.M) | L.3.54 |
| B3803 | (I.M) | L.3.55 |
| B3804 | (I.M) | L.3.56 |
| B3805 | (I.M) | L.3.57 |
| B3806 | (I.M) | L.3.58 |
| B3807 | (I.M) | L.3.59 |
| B3808 | (I.M) | L.3.60 |
| B3809 | (I.M) | L.3.61 |
| B3810 | (I.M) | L.3.62 |
| B3811 | (I.M) | L.3.63 |
| B3812 | (I.M) | L.3.1 |
| B3813 | (I.M) | L.3.2 |
| B3814 | (I.M) | L.4.1 |
| B3815 | (I.M) | L.4.2 |
| B3816 | (I.M) | L.4.3 |
| B3817 | (I.M) | L.4.4 |
| B3818 | (I.M) | L.4.5 |
| B3819 | (I.M) | L.4.6 |
| B3820 | (I.M) | L.4.7 |
| B3821 | (I.M) | L.4.8 |
| B3822 | (I.M) | L.4.9 |
| B3823 | (I.M) | L.4.10 |
| B3824 | (I.M) | L.4.11 |
| B3825 | (I.M) | L.4.12 |
| B3826 | (I.M) | L.4.13 |
| B3827 | (I.M) | L.4.14 |
| B3828 | (I.M) | L.4.15 |
| B3829 | (I.M) | L.4.16 |
| B3830 | (I.M) | L.4.17 |
| B3831 | (I.M) | L.4.18 |
| B3832 | (I.M) | L.4.19 |
| B3833 | (I.M) | L.4.20 |
| B3834 | (I.M) | L.4.21 |
| B3835 | (I.M) | L.4.22 |
| B3836 | (I.M) | L.4.23 |
| B3837 | (I.M) | L.4.24 |
| B3838 | (I.M) | L.4.25 |
| B3839 | (I.M) | L.4.26 |
| B3840 | (I.M) | L.4.27 |
| B3841 | (I.M) | L.4.28 |
| B3842 | (I.M) | L.4.29 |
| B3843 | (I.M) | L.4.30 |
| B3844 | (I.M) | L.4.31 |
| B3845 | (I.M) | L.4.32 |
| B3846 | (I.M) | L.4.33 |
| B3847 | (I.M) | L.5.1 |
| B3848 | (I.M) | L.5.2 |
| B3849 | (I.M) | L.5.3 |
| B3850 | (I.M) | L.5.4 |
| B3851 | (I.M) | L.5.5 |
| B3852 | (I.M) | L.5.6 |
| B3853 | (I.M) | L.5.7 |
| B3854 | (I.M) | L.5.8 |
| B3855 | (I.M) | L.5.9 |
| B3856 | (I.M) | L.5.10 |
| B3857 | (I.M) | L.5.11 |
| B3858 | (I.M) | L.5.12 |
| B3859 | (I.M) | L.5.13 |
| B3860 | (I.M) | L.5.14 |
| B3861 | (I.M) | L.5.15 |
| B3862 | (I.M) | L.5.16 |
| B3863 | (I.M) | L.5.17 |
| B3864 | (I.M) | L.5.18 |
| B3865 | (I.M) | L.5.19 |
| B3866 | (I.M) | L.5.20 |
| B3867 | (I.M) | L.5.21 |
| B3868 | (I.M) | L.5.22 |
| B3869 | (I.M) | L.5.23 |
| B3870 | (I.M) | L.5.24 |
| B3871 | (I.M) | L.5.25 |
| B3872 | (I.M) | L.5.26 |
| B3873 | (I.M) | L.5.27 |
| B3874 | (I.M) | L.5.28 |
| B3875 | (I.M) | L.5.29 |
| B3876 | (I.M) | L.5.30 |
| B3877 | (I.M) | L.5.31 |
| B3878 | (I.M) | L.5.32 |
| B3879 | (I.M) | L.5.33 |
| B3880 | (I.M) | L.5.34 |
| B3881 | (I.M) | L.5.35 |
| B3882 | (I.M) | L.5.36 |
| B3883 | (I.M) | L.5.37 |
| B3884 | (I.M) | L.5.38 |
| B3885 | (I.M) | L.5.39 |
| B3886 | (I.M) | L.5.40 |
| B3887 | (I.M) | L.5.41 |
| B3888 | (I.M) | L.5.42 |
| B3889 | (I.M) | L.5.43 |
| B3890 | (I.M) | L.5.44 |
| B3891 | (I.M) | L.5.45 |
| B3892 | (I.M) | L.5.46 |
| B3893 | (I.M) | L.5.47 |
| B3894 | (I.M) | L.5.48 |
| B3895 | (I.M) | L.5.49 |
| B3896 | (I.M) | L.5.50 |
| B3897 | (I.M) | L.5.51 |
| B3898 | (I.M) | L.5.52 |
| B3899 | (I.M) | L.5.53 |
| B3900 | (I.M) | L.5.54 |
| B3901 | (I.M) | L.5.55 |
| B3902 | (I.M) | L.5.56 |
| B3903 | (I.M) | L.5.57 |
| B3904 | (I.M) | L.5.58 |
| B3905 | (I.M) | L.5.59 |
| B3906 | (I.M) | L.5.60 |
| B3907 | (I.M) | L.5.61 |
| B3908 | (I.M) | L.5.62 |
| B3909 | (I.M) | L.5.63 |
| B3910 | (I.M) | L.5.64 |
| B3911 | (I.M) | L.5.65 |
| B3912 | (I.M) | L.5.66 |
| B3913 | (I.M) | L.5.67 |
| B3914 | (I.M) | L.5.68 |
| B3915 | (I.M) | L.5.69 |
| B3916 | (I.M) | L.5.70 |
| B3917 | (I.M) | L.5.71 |
| B3918 | (I.M) | L.5.72 |
| B3919 | (I.M) | L.5.73 |
| B3920 | (I.M) | L.5.74 |
| B3921 | (I.M) | L.5.75 |
| B3922 | (I.M) | L.5.76 |
| B3923 | (I.M) | L.5.77 |
| B3924 | (I.M) | L.5.78 |
| B3925 | (I.M) | L.5.79 |
| B3926 | (I.M) | L.5.80 |
| B3927 | (I.M) | L.5.81 |
| B3928 | (I.M) | L.5.82 |
| B3929 | (I.M) | L.5.83 |
| B3930 | (I.M) | L.5.84 |
| B3931 | (I.M) | L.6.1 |
| B3932 | (I.M) | L.6.2 |
| B3933 | (I.M) | L.6.3 |
| B3934 | (I.M) | L.6.4 |
| B3935 | (I.M) | L.6.5 |
| B3936 | (I.M) | L.6.6 |
| B3937 | (I.M) | L.6.7 |
| B3938 | (I.M) | L.6.8 |
| B3939 | (I.M) | L.6.9 |
| B3940 | (I.M) | L.6.10 |
| B3941 | (I.M) | L.6.11 |
| B3942 | (I.M) | L.6.12 |
| B3943 | (I.M) | L.6.13 |
| B3944 | (I.M) | L.6.14 |
| B3945 | (I.M) | L.6.15 |
| B3946 | (I.M) | L.6.16 |
| B3947 | (I.M) | L.6.17 |
| B3948 | (I.M) | L.6.18 |

B = Mixture;
I = compound I;
II = compound II

TABLE 62

| B | I | II |
|---|---|---|
| B3949 | (I.N) | L.1.1 |
| B3950 | (I.N) | L.1.2 |
| B3951 | (I.N) | L.1.3 |
| B3952 | (I.N) | L.1.4 |
| B3953 | (I.N) | L.1.5 |
| B3954 | (I.N) | L.1.6 |
| B3955 | (I.N) | L.1.7 |
| B3956 | (I.N) | L.1.8 |
| B3957 | (I.N) | L.1.9 |
| B3958 | (I.N) | L.1.10 |
| B3959 | (I.N) | L.1.11 |
| B3960 | (I.N) | L.1.12 |
| B3961 | (I.N) | L.1.13 |
| B3962 | (I.N) | L.1.14 |
| B3963 | (I.N) | L.1.15 |
| B3964 | (I.N) | L.1.16 |
| B3965 | (I.N) | L.1.17 |
| B3966 | (I.N) | L.1.18 |
| B3967 | (I.N) | L.1.19 |
| B3968 | (I.N) | L.1.20 |
| B3969 | (I.N) | L.1.21 |
| B3970 | (I.N) | L.1.22 |
| B3971 | (I.N) | L.1.23 |
| B3972 | (I.N) | L.1.24 |
| B3973 | (I.N) | L.1.25 |
| B3974 | (I.N) | L.1.26 |
| B3975 | (I.N) | L.1.27 |
| B3976 | (I.N) | L.1.28 |
| B3977 | (I.N) | L.1.29 |
| B3978 | (I.N) | L.1.30 |
| B3979 | (I.N) | L.1.31 |
| B3980 | (I.N) | L.1.32 |
| B3981 | (I.N) | L.1.33 |
| B3982 | (I.N) | L.1.34 |
| B3983 | (I.N) | L.1.35 |
| B3984 | (I.N) | L.1.36 |
| B3985 | (I.N) | L.1.37 |
| B3986 | (I.N) | L.1.38 |
| B3987 | (I.N) | L.1.39 |
| B3988 | (I.N) | L.1.40 |
| B3989 | (I.N) | L.1.41 |
| B3990 | (I.N) | L.1.42 |
| B3991 | (I.N) | L.1.43 |
| B3992 | (I.N) | L.1.44 |
| B3993 | (I.N) | L.1.45 |
| B3994 | (I.N) | L.1.46 |
| B3995 | (I.N) | L.1.47 |
| B3996 | (I.N) | L.1.48 |
| B3997 | (I.N) | L.1.49 |
| B3998 | (I.N) | L.1.50 |
| B3999 | (I.N) | L.1.51 |
| B4000 | (I.N) | L.1.52 |
| B4001 | (I.N) | L.1.53 |
| B4002 | (I.N) | L.1.54 |
| B4003 | (I.N) | L.1.55 |
| B4004 | (I.N) | L.1.56 |
| B4005 | (I.N) | L.1.57 |
| B4006 | (I.N) | L.1.58 |
| B4007 | (I.N) | L.1.59 |
| B4008 | (I.N) | L.1.60 |
| B4009 | (I.N) | L.1.61 |
| B4010 | (I.N) | L.1.62 |
| B4011 | (I.N) | L.1.63 |
| B4012 | (I.N) | L.1.64 |
| B4013 | (I.N) | L.1.65 |
| B4014 | (I.N) | L.1.66 |
| B4015 | (I.N) | L.1.67 |
| B4016 | (I.N) | L.1.68 |
| B4017 | (I.N) | L.1.69 |
| B4018 | (I.N) | L.1.70 |
| B4019 | (I.N) | L.1.71 |
| B4020 | (I.N) | L.1.72 |
| B4021 | (I.N) | L.1.73 |
| B4022 | (I.N) | L.1.74 |
| B4023 | (I.N) | L.1.75 |
| B4024 | (I.N) | L.1.76 |
| B4025 | (I.N) | L.1.77 |
| B4026 | (I.N) | L.1.78 |
| B4027 | (I.N) | L.1.79 |
| B4028 | (I.N) | L.1.80 |
| B4029 | (I.N) | L.1.81 |
| B4030 | (I.N) | L.1.82 |
| B4031 | (I.N) | L.1.83 |
| B4032 | (I.N) | L.1.84 |
| B4033 | (I.N) | L.1.85 |
| B4034 | (I.N) | L.1.86 |
| B4035 | (I.N) | L.1.87 |
| B4036 | (I.N) | L.1.88 |
| B4037 | (I.N) | L.1.89 |
| B4038 | (I.N) | L.1.90 |
| B4039 | (I.N) | L.1.91 |
| B4040 | (I.N) | L.1.92 |
| B4041 | (I.N) | L.1.93 |
| B4042 | (I.N) | L.1.94 |
| B4043 | (I.N) | L.1.95 |
| B4044 | (I.N) | L.1.96 |
| B4045 | (I.N) | L.2.1 |
| B4046 | (I.N) | L.2.2 |
| B4047 | (I.N) | L.2.3 |
| B4048 | (I.N) | L.2.4 |
| B4049 | (I.N) | L.2.5 |
| B4050 | (I.N) | L.2.6 |
| B4051 | (I.N) | L.2.7 |
| B4052 | (I.N) | L.2.8 |
| B4053 | (I.N) | L.2.9 |
| B4054 | (I.N) | L.2.10 |
| B4055 | (I.N) | L.2.11 |
| B4056 | (I.N) | L.2.12 |
| B4057 | (I.N) | L.2.13 |
| B4058 | (I.N) | L.2.14 |
| B4059 | (I.N) | L.2.15 |
| B4060 | (I.N) | L.2.16 |
| B4061 | (I.N) | L.2.17 |
| B4062 | (I.N) | L.2.18 |
| B4063 | (I.N) | L.2.19 |
| B4064 | (I.N) | L.2.20 |
| B4065 | (I.N) | L.2.21 |
| B4066 | (I.N) | L.2.22 |
| B4067 | (I.N) | L.2.23 |
| B4068 | (I.N) | L.2.24 |
| B4069 | (I.N) | L.2.25 |
| B4070 | (I.N) | L.2.26 |
| B4071 | (I.N) | L.2.27 |
| B4072 | (I.N) | L.2.28 |
| B4073 | (I.N) | L.2.29 |
| B4074 | (I.N) | L.2.30 |
| B4075 | (I.N) | L.2.31 |
| B4076 | (I.N) | L.2.32 |
| B4077 | (I.N) | L.2.33 |
| B4078 | (I.N) | L.3.1 |
| B4079 | (I.N) | L.3.2 |
| B4080 | (I.N) | L.3.3 |
| B4081 | (I.N) | L.3.4 |
| B4082 | (I.N) | L.3.5 |
| B4083 | (I.N) | L.3.6 |
| B4084 | (I.N) | L.3.7 |
| B4085 | (I.N) | L.3.8 |
| B4086 | (I.N) | L.3.9 |
| B4087 | (I.N) | L.3.10 |
| B4088 | (I.N) | L.3.11 |
| B4089 | (I.N) | L.3.12 |
| B4090 | (I.N) | L.3.13 |
| B4091 | (I.N) | L.3.14 |
| B4092 | (I.N) | L.3.15 |
| B4093 | (I.N) | L.3.16 |
| B4094 | (I.N) | L.3.17 |
| B4095 | (I.N) | L.3.18 |
| B4096 | (I.N) | L.3.19 |
| B4097 | (I.N) | L.3.20 |
| B4098 | (I.N) | L.3.21 |
| B4099 | (I.N) | L.3.22 |
| B4100 | (I.N) | L.3.23 |
| B4101 | (I.N) | L.3.24 |
| B4102 | (I.N) | L.3.25 |
| B4103 | (I.N) | L.3.26 |
| B4104 | (I.N) | L.3.27 |
| B4105 | (I.N) | L.3.28 |
| B4106 | (I.N) | L.3.29 |
| B4107 | (I.N) | L.3.30 |
| B4108 | (I.N) | L.3.31 |
| B4109 | (I.N) | L.3.32 |
| B4110 | (I.N) | L.3.33 |
| B4111 | (I.N) | L.3.34 |
| B4112 | (I.N) | L.3.35 |
| B4113 | (I.N) | L.3.36 |
| B4114 | (I.N) | L.3.37 |
| B4115 | (I.N) | L.3.38 |
| B4116 | (I.N) | L.3.39 |
| B4117 | (I.N) | L.3.40 |
| B4118 | (I.N) | L.3.41 |
| B4119 | (I.N) | L.3.42 |
| B4120 | (I.N) | L.3.43 |
| B4121 | (I.N) | L.3.44 |
| B4122 | (I.N) | L.3.45 |
| B4123 | (I.N) | L.3.46 |
| B4124 | (I.N) | L.3.47 |
| B4125 | (I.N) | L.3.48 |
| B4126 | (I.N) | L.3.49 |
| B4127 | (I.N) | L.3.50 |
| B4128 | (I.N) | L.3.51 |
| B4129 | (I.N) | L.3.52 |
| B4130 | (I.N) | L.3.53 |
| B4131 | (I.N) | L.3.54 |
| B4132 | (I.N) | L.3.55 |
| B4133 | (I.N) | L.3.56 |
| B4134 | (I.N) | L.3.57 |
| B4135 | (I.N) | L.3.58 |
| B4136 | (I.N) | L.3.59 |
| B4137 | (I.N) | L.3.60 |
| B4138 | (I.N) | L.3.61 |
| B4139 | (I.N) | L.3.62 |
| B4140 | (I.N) | L.3.63 |
| B4141 | (I.N) | L.3.1 |
| B4142 | (I.N) | L.3.2 |
| B4143 | (I.N) | L.4.1 |
| B4144 | (I.N) | L.4.2 |
| B4145 | (I.N) | L.4.3 |
| B4146 | (I.N) | L.4.4 |
| B4147 | (I.N) | L.4.5 |
| B4148 | (I.N) | L.4.6 |
| B4149 | (I.N) | L.4.7 |
| B4150 | (I.N) | L.4.8 |
| B4151 | (I.N) | L.4.9 |
| B4152 | (I.N) | L.4.10 |
| B4153 | (I.N) | L.4.11 |
| B4154 | (I.N) | L.4.12 |
| B4155 | (I.N) | L.4.13 |
| B4156 | (I.N) | L.4.14 |
| B4157 | (I.N) | L.4.15 |
| B4158 | (I.N) | L.4.16 |
| B4159 | (I.N) | L.4.17 |
| B4160 | (I.N) | L.4.18 |
| B4161 | (I.N) | L.4.19 |
| B4162 | (I.N) | L.4.20 |
| B4163 | (I.N) | L.4.21 |
| B4164 | (I.N) | L.4.22 |
| B4165 | (I.N) | L.4.23 |
| B4166 | (I.N) | L.4.24 |
| B4167 | (I.N) | L.4.25 |
| B4168 | (I.N) | L.4.26 |
| B4169 | (I.N) | L.4.27 |
| B4170 | (I.N) | L.4.28 |
| B4171 | (I.N) | L.4.29 |
| B4172 | (I.N) | L.4.30 |
| B4173 | (I.N) | L.4.31 |
| B4174 | (I.N) | L.4.32 |
| B4175 | (I.N) | L.4.33 |
| B4176 | (I.N) | L.5.1 |
| B4177 | (I.N) | L.5.2 |
| B4178 | (I.N) | L.5.3 |
| B4179 | (I.N) | L.5.4 |
| B4180 | (I.N) | L.5.5 |
| B4181 | (I.N) | L.5.6 |
| B4182 | (I.N) | L.5.7 |
| B4183 | (I.N) | L.5.8 |
| B4184 | (I.N) | L.5.9 |
| B4185 | (I.N) | L.5.10 |
| B4186 | (I.N) | L.5.11 |
| B4187 | (I.N) | L.5.12 |
| B4188 | (I.N) | L.5.13 |
| B4189 | (I.N) | L.5.14 |
| B4190 | (I.N) | L.5.15 |
| B4191 | (I.N) | L.5.16 |
| B4192 | (I.N) | L.5.17 |
| B4193 | (I.N) | L.5.18 |
| B4194 | (I.N) | L.5.19 |
| B4195 | (I.N) | L.5.20 |
| B4196 | (I.N) | L.5.21 |
| B4197 | (I.N) | L.5.22 |
| B4198 | (I.N) | L.5.23 |
| B4199 | (I.N) | L.5.24 |
| B4200 | (I.N) | L.5.25 |
| B4201 | (I.N) | L.5.26 |
| B4202 | (I.N) | L.5.27 |
| B4203 | (I.N) | L.5.28 |
| B4204 | (I.N) | L.5.29 |
| B4205 | (I.N) | L.5.30 |
| B4206 | (I.N) | L.5.31 |
| B4207 | (I.N) | L.5.32 |
| B4208 | (I.N) | L.5.33 |
| B4209 | (I.N) | L.5.34 |
| B4210 | (I.N) | L.5.35 |
| B4211 | (I.N) | L.5.36 |
| B4212 | (I.N) | L.5.37 |
| B4213 | (I.N) | L.5.38 |
| B4214 | (I.N) | L.5.39 |
| B4215 | (I.N) | L.5.40 |
| B4216 | (I.N) | L.5.41 |
| B4217 | (I.N) | L.5.42 |
| B4218 | (I.N) | L.5.43 |
| B4219 | (I.N) | L.5.44 |
| B4220 | (I.N) | L.5.45 |
| B4221 | (I.N) | L.5.46 |
| B4222 | (I.N) | L.5.47 |
| B4223 | (I.N) | L.5.48 |
| B4224 | (I.N) | L.5.49 |
| B4225 | (I.N) | L.5.50 |
| B4226 | (I.N) | L.5.51 |
| B4227 | (I.N) | L.5.52 |
| B4228 | (I.N) | L.5.53 |
| B4229 | (I.N) | L.5.54 |
| B4230 | (I.N) | L.5.55 |
| B4231 | (I.N) | L.5.56 |
| B4232 | (I.N) | L.5.57 |
| B4233 | (I.N) | L.5.58 |
| B4234 | (I.N) | L.5.59 |
| B4235 | (I.N) | L.5.60 |
| B4236 | (I.N) | L.5.61 |
| B4237 | (I.N) | L.5.62 |
| B4238 | (I.N) | L.5.63 |
| B4239 | (I.N) | L.5.64 |
| B4240 | (I.N) | L.5.65 |
| B4241 | (I.N) | L.5.66 |
| B4242 | (I.N) | L.5.67 |
| B4243 | (I.N) | L.5.68 |
| B4244 | (I.N) | L.5.69 |
| B4245 | (I.N) | L.5.70 |
| B4246 | (I.N) | L.5.71 |
| B4247 | (I.N) | L.5.72 |
| B4248 | (I.N) | L.5.73 |
| B4249 | (I.N) | L.5.74 |
| B4250 | (I.N) | L.5.75 |
| B4251 | (I.N) | L.5.76 |
| B4252 | (I.N) | L.5.77 |
| B4253 | (I.N) | L.5.78 |
| B4254 | (I.N) | L.5.79 |
| B4255 | (I.N) | L.5.80 |
| B4256 | (I.N) | L.5.81 |
| B4257 | (I.N) | L.5.82 |
| B4258 | (I.N) | L.5.83 |
| B4259 | (I.N) | L.5.84 |
| B4260 | (I.N) | L.6.1 |
| B4261 | (I.N) | L.6.2 |
| B4262 | (I.N) | L.6.3 |
| B4263 | (I.N) | L.6.4 |
| B4264 | (I.N) | L.6.5 |
| B4265 | (I.N) | L.6.6 |
| B4266 | (I.N) | L.6.7 |
| B4267 | (I.N) | L.6.8 |
| B4268 | (I.N) | L.6.9 |
| B4269 | (I.N) | L.6.10 |
| B4270 | (I.N) | L.6.11 |
| B4271 | (I.N) | L.6.12 |
| B4272 | (I.N) | L.6.13 |
| B4273 | (I.N) | L.6.14 |
| B4274 | (I.N) | L.6.15 |
| B4275 | (I.N) | L.6.16 |
| B4276 | (I.N) | L.6.17 |
| B4277 | (I.N) | L.6.18 |

B = Mixture;
I = compound I;
II = compound II;

TABLE 63

| B | I | II |
|---|---|---|
| B4278 | (I.O) | L.1.1 |
| B4279 | (I.O) | L.1.2 |
| B4280 | (I.O) | L.1.3 |
| B4281 | (I.O) | L.1.4 |
| B4282 | (I.O) | L.1.5 |
| B4283 | (I.O) | L.1.6 |
| B4284 | (I.O) | L.1.7 |
| B4285 | (I.O) | L.1.8 |
| B4286 | (I.O) | L.1.9 |
| B4287 | (I.O) | L.1.10 |
| B4288 | (I.O) | L.1.11 |
| B4289 | (I.O) | L.1.12 |
| B4290 | (I.O) | L.1.13 |
| B4291 | (I.O) | L.1.14 |
| B4292 | (I.O) | L.1.15 |
| B4293 | (I.O) | L.1.16 |
| B4294 | (I.O) | L.1.17 |
| B4295 | (I.O) | L.1.18 |
| B4296 | (I.O) | L.1.19 |
| B4297 | (I.O) | L.1.20 |
| B4298 | (I.O) | L.1.21 |
| B4299 | (I.O) | L.1.22 |
| B4300 | (I.O) | L.1.23 |
| B4301 | (I.O) | L.1.24 |
| B4302 | (I.O) | L.1.25 |
| B4303 | (I.O) | L.1.26 |
| B4304 | (I.O) | L.1.27 |
| B4305 | (I.O) | L.1.28 |
| B4306 | (I.O) | L.1.29 |
| B4307 | (I.O) | L.1.30 |
| B4308 | (I.O) | L.1.31 |
| B4309 | (I.O) | L.1.32 |
| B4310 | (I.O) | L.1.33 |
| B4311 | (I.O) | L.1.34 |
| B4312 | (I.O) | L.1.35 |
| B4313 | (I.O) | L.1.36 |
| B4314 | (I.O) | L.1.37 |
| B4315 | (I.O) | L.1.38 |
| B4316 | (I.O) | L.1.39 |
| B4317 | (I.O) | L.1.40 |
| B4318 | (I.O) | L.1.41 |
| B4319 | (I.O) | L.1.42 |
| B4320 | (I.O) | L.1.43 |
| B4321 | (I.O) | L.1.44 |
| B4322 | (I.O) | L.1.45 |
| B4323 | (I.O) | L.1.46 |
| B4324 | (I.O) | L.1.47 |
| B4325 | (I.O) | L.1.48 |
| B4326 | (I.O) | L.1.49 |
| B4327 | (I.O) | L.1.50 |
| B4328 | (I.O) | L.1.51 |
| B4329 | (I.O) | L.1.52 |
| B4330 | (I.O) | L.1.53 |
| B4331 | (I.O) | L.1.54 |
| B4332 | (I.O) | L.1.55 |
| B4333 | (I.O) | L.1.56 |
| B4334 | (I.O) | L.1.57 |
| B4335 | (I.O) | L.1.58 |
| B4336 | (I.O) | L.1.59 |
| B4337 | (I.O) | L.1.60 |
| B4338 | (I.O) | L.1.61 |
| B4339 | (I.O) | L.1.62 |
| B4340 | (I.O) | L.1.63 |
| B4341 | (I.O) | L.1.64 |
| B4342 | (I.O) | L.1.65 |
| B4343 | (I.O) | L.1.66 |
| B4344 | (I.O) | L.1.67 |
| B4345 | (I.O) | L.1.68 |
| B4346 | (I.O) | L.1.69 |
| B4347 | (I.O) | L.1.70 |
| B4348 | (I.O) | L.1.71 |
| B4349 | (I.O) | L.1.72 |
| B4350 | (I.O) | L.1.73 |
| B4351 | (I.O) | L.1.74 |
| B4352 | (I.O) | L.1.75 |
| B4353 | (I.O) | L.1.76 |
| B4354 | (I.O) | L.1.77 |
| B4355 | (I.O) | L.1.78 |
| B4356 | (I.O) | L.1.79 |
| B4357 | (I.O) | L.1.80 |
| B4358 | (I.O) | L.1.81 |
| B4359 | (I.O) | L.1.82 |
| B4360 | (I.O) | L.1.83 |
| B4361 | (I.O) | L.1.84 |
| B4362 | (I.O) | L.1.85 |
| B4363 | (I.O) | L.1.86 |
| B4364 | (I.O) | L.1.87 |
| B4365 | (I.O) | L.1.88 |
| B4366 | (I.O) | L.1.89 |
| B4367 | (I.O) | L.1.90 |
| B4368 | (I.O) | L.1.91 |
| B4369 | (I.O) | L.1.92 |
| B4370 | (I.O) | L.1.93 |
| B4371 | (I.O) | L.1.94 |
| B4372 | (I.O) | L.1.95 |
| B4373 | (I.O) | L.1.96 |
| B4374 | (I.O) | L.2.1 |
| B4375 | (I.O) | L.2.2 |
| B4376 | (I.O) | L.2.3 |
| B4377 | (I.O) | L.2.4 |
| B4378 | (I.O) | L.2.5 |
| B4379 | (I.O) | L.2.6 |
| B4380 | (I.O) | L.2.7 |
| B4381 | (I.O) | L.2.8 |
| B4382 | (I.O) | L.2.9 |
| B4383 | (I.O) | L.2.10 |
| B4384 | (I.O) | L.2.11 |
| B4385 | (I.O) | L.2.12 |
| B4386 | (I.O) | L.2.13 |
| B4387 | (I.O) | L.2.14 |
| B4388 | (I.O) | L.2.15 |
| B4389 | (I.O) | L.2.16 |
| B4390 | (I.O) | L.2.17 |
| B4391 | (I.O) | L.2.18 |
| B4392 | (I.O) | L.2.19 |
| B4393 | (I.O) | L.2.20 |
| B4394 | (I.O) | L.2.21 |
| B4395 | (I.O) | L.2.22 |
| B4396 | (I.O) | L.2.23 |
| B4397 | (I.O) | L.2.24 |
| B4398 | (I.O) | L.2.25 |
| B4399 | (I.O) | L.2.26 |
| B4400 | (I.O) | L.2.27 |
| B4401 | (I.O) | L.2.28 |
| B4402 | (I.O) | L.2.29 |
| B4403 | (I.O) | L.2.30 |
| B4404 | (I.O) | L.2.31 |
| B4405 | (I.O) | L.2.32 |
| B4406 | (I.O) | L.2.33 |
| B4407 | (I.O) | L.3.1 |
| B4408 | (I.O) | L.3.2 |
| B4409 | (I.O) | L.3.3 |
| B4410 | (I.O) | L.3.4 |
| B4411 | (I.O) | L.3.5 |
| B4412 | (I.O) | L.3.6 |
| B4413 | (I.O) | L.3.7 |
| B4414 | (I.O) | L.3.8 |
| B4415 | (I.O) | L.3.9 |
| B4416 | (I.O) | L.3.10 |
| B4417 | (I.O) | L.3.11 |
| B4418 | (I.O) | L.3.12 |
| B4419 | (I.O) | L.3.13 |
| B4420 | (I.O) | L.3.14 |
| B4421 | (I.O) | L.3.15 |
| B4422 | (I.O) | L.3.16 |
| B4423 | (I.O) | L.3.17 |
| B4424 | (I.O) | L.3.18 |
| B4425 | (I.O) | L.3.19 |
| B4426 | (I.O) | L.3.20 |
| B4427 | (I.O) | L.3.21 |
| B4428 | (I.O) | L.3.22 |
| B4429 | (I.O) | L.3.23 |
| B4430 | (I.O) | L.3.24 |
| B4431 | (I.O) | L.3.25 |
| B4432 | (I.O) | L.3.26 |
| B4433 | (I.O) | L.3.27 |
| B4434 | (I.O) | L.3.28 |
| B4435 | (I.O) | L.3.29 |
| B4436 | (I.O) | L.3.30 |
| B4437 | (I.O) | L.3.31 |
| B4438 | (I.O) | L.3.32 |
| B4439 | (I.O) | L.3.33 |
| B4440 | (I.O) | L.3.34 |
| B4441 | (I.O) | L.3.35 |
| B4442 | (I.O) | L.3.36 |
| B4443 | (I.O) | L.3.37 |
| B4444 | (I.O) | L.3.38 |
| B4445 | (I.O) | L.3.39 |
| B4446 | (I.O) | L.3.40 |
| B4447 | (I.O) | L.3.41 |
| B4448 | (I.O) | L.3.42 |
| B4449 | (I.O) | L.3.43 |
| B4450 | (I.O) | L.3.44 |
| B4451 | (I.O) | L.3.45 |
| B4452 | (I.O) | L.3.46 |
| B4453 | (I.O) | L.3.47 |
| B4454 | (I.O) | L.3.48 |
| B4455 | (I.O) | L.3.49 |
| B4456 | (I.O) | L.3.50 |
| B4457 | (I.O) | L.3.51 |
| B4458 | (I.O) | L.3.52 |
| B4459 | (I.O) | L.3.53 |
| B4460 | (I.O) | L.3.54 |
| B4461 | (I.O) | L.3.55 |
| B4462 | (I.O) | L.3.56 |
| B4463 | (I.O) | L.3.57 |
| B4464 | (I.O) | L.3.58 |
| B4465 | (I.O) | L.3.59 |
| B4466 | (I.O) | L.3.60 |
| B4467 | (I.O) | L.3.61 |
| B4468 | (I.O) | L.3.62 |
| B4469 | (I.O) | L.3.63 |
| B4470 | (I.O) | L.3.1 |
| B4471 | (I.O) | L.3.2 |
| B4472 | (I.O) | L.4.1 |
| B4473 | (I.O) | L.4.2 |
| B4474 | (I.O) | L.4.3 |
| B4475 | (I.O) | L.4.4 |
| B4476 | (I.O) | L.4.5 |
| B4477 | (I.O) | L.4.6 |
| B4478 | (I.O) | L.4.7 |
| B4479 | (I.O) | L.4.8 |
| B4480 | (I.O) | L.4.9 |
| B4481 | (I.O) | L.4.10 |
| B4482 | (I.O) | L.4.11 |
| B4483 | (I.O) | L.4.12 |
| B4484 | (I.O) | L.4.13 |
| B4485 | (I.O) | L.4.14 |
| B4486 | (I.O) | L.4.15 |
| B4487 | (I.O) | L.4.16 |
| B4488 | (I.O) | L.4.17 |
| B4489 | (I.O) | L.4.18 |
| B4490 | (I.O) | L.4.19 |
| B4491 | (I.O) | L.4.20 |
| B4492 | (I.O) | L.4.21 |
| B4493 | (I.O) | L.4.22 |
| B4494 | (I.O) | L.4.23 |
| B4495 | (I.O) | L.4.24 |
| B4496 | (I.O) | L.4.25 |
| B4497 | (I.O) | L.4.26 |
| B4498 | (I.O) | L.4.27 |
| B4499 | (I.O) | L.4.28 |
| B4500 | (I.O) | L.4.29 |
| B4501 | (I.O) | L.4.30 |
| B4502 | (I.O) | L.4.31 |
| B4503 | (I.O) | L.4.32 |
| B4504 | (I.O) | L.4.33 |
| B4505 | (I.O) | L.5.1 |
| B4506 | (I.O) | L.5.2 |
| B4507 | (I.O) | L.5.3 |
| B4508 | (I.O) | L.5.4 |
| B4509 | (I.O) | L.5.5 |
| B4510 | (I.O) | L.5.6 |
| B4511 | (I.O) | L.5.7 |
| B4512 | (I.O) | L.5.8 |
| B4513 | (I.O) | L.5.9 |
| B4514 | (I.O) | L.5.10 |
| B4515 | (I.O) | L.5.11 |
| B4516 | (I.O) | L.5.12 |
| B4517 | (I.O) | L.5.13 |
| B4518 | (I.O) | L.5.14 |
| B4519 | (I.O) | L.5.15 |
| B4520 | (I.O) | L.5.16 |
| B4521 | (I.O) | L.5.17 |
| B4522 | (I.O) | L.5.18 |
| B4523 | (I.O) | L.5.19 |
| B4524 | (I.O) | L.5.20 |
| B4525 | (I.O) | L.5.21 |
| B4526 | (I.O) | L.5.22 |
| B4527 | (I.O) | L.5.23 |
| B4528 | (I.O) | L.5.24 |
| B4529 | (I.O) | L.5.25 |
| B4530 | (I.O) | L.5.26 |
| B4531 | (I.O) | L.5.27 |
| B4532 | (I.O) | L.5.28 |
| B4533 | (I.O) | L.5.29 |
| B4534 | (I.O) | L.5.30 |
| B4535 | (I.O) | L.5.31 |
| B4536 | (I.O) | L.5.32 |
| B4537 | (I.O) | L.5.33 |
| B4538 | (I.O) | L.5.34 |
| B4539 | (I.O) | L.5.35 |
| B4540 | (I.O) | L.5.36 |
| B4541 | (I.O) | L.5.37 |
| B4542 | (I.O) | L.5.38 |
| B4543 | (I.O) | L.5.39 |
| B4544 | (I.O) | L.5.40 |
| B4545 | (I.O) | L.5.41 |
| B4546 | (I.O) | L.5.42 |
| B4547 | (I.O) | L.5.43 |
| B4548 | (I.O) | L.5.44 |
| B4549 | (I.O) | L.5.45 |
| B4550 | (I.O) | L.5.46 |
| B4551 | (I.O) | L.5.47 |
| B4552 | (I.O) | L.5.48 |
| B4553 | (I.O) | L.5.49 |
| B4554 | (I.O) | L.5.50 |
| B4555 | (I.O) | L.5.51 |
| B4556 | (I.O) | L.5.52 |
| B4557 | (I.O) | L.5.53 |
| B4558 | (I.O) | L.5.54 |
| B4559 | (I.O) | L.5.55 |
| B4560 | (I.O) | L.5.56 |
| B4561 | (I.O) | L.5.57 |
| B4562 | (I.O) | L.5.58 |
| B4563 | (I.O) | L.5.59 |
| B4564 | (I.O) | L.5.60 |
| B4565 | (I.O) | L.5.61 |
| B4566 | (I.O) | L.5.62 |
| B4567 | (I.O) | L.5.63 |
| B4568 | (I.O) | L.5.64 |
| B4569 | (I.O) | L.5.65 |
| B4570 | (I.O) | L.5.66 |
| B4571 | (I.O) | L.5.67 |
| B4572 | (I.O) | L.5.68 |
| B4573 | (I.O) | L.5.69 |
| B4574 | (I.O) | L.5.70 |
| B4575 | (I.O) | L.5.71 |
| B4576 | (I.O) | L.5.72 |
| B4577 | (I.O) | L.5.73 |
| B4578 | (I.O) | L.5.74 |
| B4579 | (I.O) | L.5.75 |
| B4580 | (I.O) | L.5.76 |
| B4581 | (I.O) | L.5.77 |
| B4582 | (I.O) | L.5.78 |
| B4583 | (I.O) | L.5.79 |
| B4584 | (I.O) | L.5.80 |
| B4585 | (I.O) | L.5.81 |
| B4586 | (I.O) | L.5.82 |
| B4587 | (I.O) | L.5.83 |
| B4588 | (I.O) | L.5.84 |
| B4589 | (I.O) | L.6.1 |
| B4590 | (I.O) | L.6.2 |
| B4591 | (I.O) | L.6.3 |
| B4592 | (I.O) | L.6.4 |
| B4593 | (I.O) | L.6.5 |
| B4594 | (I.O) | L.6.6 |
| B4595 | (I.O) | L.6.7 |
| B4596 | (I.O) | L.6.8 |
| B4597 | (I.O) | L.6.9 |
| B4598 | (I.O) | L.6.10 |
| B4599 | (I.O) | L.6.11 |
| B4600 | (I.O) | L.6.12 |
| B4601 | (I.O) | L.6.13 |
| B4602 | (I.O) | L.6.14 |
| B4603 | (I.O) | L.6.15 |
| B4604 | (I.O) | L.6.16 |
| B4605 | (I.O) | L.6.17 |
| B4606 | (I.O) | L.6.18 |

B = Mixture;
I = compound I;
II = compound II;

TABLE 64

| B | I | II |
|---|---|---|
| B4607 | (I.P) | L.1.1 |
| B4608 | (I.P) | L.1.2 |
| B4609 | (I.P) | L.1.3 |
| B4610 | (I.P) | L.1.4 |
| B4611 | (I.P) | L.1.5 |
| B4612 | (I.P) | L.1.6 |
| B4613 | (I.P) | L.1.7 |
| B4614 | (I.P) | L.1.8 |
| B4615 | (I.P) | L.1.9 |
| B4616 | (I.P) | L.1.10 |
| B4617 | (I.P) | L.1.11 |
| B4618 | (I.P) | L.1.12 |
| B4619 | (I.P) | L.1.13 |
| B4620 | (I.P) | L.1.14 |
| B4621 | (I.P) | L.1.15 |
| B4622 | (I.P) | L.1.16 |
| B4623 | (I.P) | L.1.17 |
| B4624 | (I.P) | L.1.18 |
| B4625 | (I.P) | L.1.19 |
| B4626 | (I.P) | L.1.20 |
| B4627 | (I.P) | L.1.21 |
| B4628 | (I.P) | L.1.22 |
| B4629 | (I.P) | L.1.23 |
| B4630 | (I.P) | L.1.24 |
| B4631 | (I.P) | L.1.25 |
| B4632 | (I.P) | L.1.26 |
| B4633 | (I.P) | L.1.27 |
| B4634 | (I.P) | L.1.28 |
| B4635 | (I.P) | L.1.29 |
| B4636 | (I.P) | L.1.30 |
| B4637 | (I.P) | L.1.31 |
| B4638 | (I.P) | L.1.32 |
| B4639 | (I.P) | L.1.33 |
| B4640 | (I.P) | L.1.34 |
| B4641 | (I.P) | L.1.35 |
| B4642 | (I.P) | L.1.36 |
| B4643 | (I.P) | L.1.37 |
| B4644 | (I.P) | L.1.38 |
| B4645 | (I.P) | L.1.39 |
| B4646 | (I.P) | L.1.40 |
| B4647 | (I.P) | L.1.41 |
| B4648 | (I.P) | L.1.42 |
| B4649 | (I.P) | L.1.43 |
| B4650 | (I.P) | L.1.44 |
| B4651 | (I.P) | L.1.45 |
| B4652 | (I.P) | L.1.46 |
| B4653 | (I.P) | L.1.47 |
| B4654 | (I.P) | L.1.48 |
| B4655 | (I.P) | L.1.49 |
| B4656 | (I.P) | L.1.50 |
| B4657 | (I.P) | L.1.51 |
| B4658 | (I.P) | L.1.52 |
| B4659 | (I.P) | L.1.53 |
| B4660 | (I.P) | L.1.54 |
| B4661 | (I.P) | L.1.55 |
| B4662 | (I.P) | L.1.56 |
| B4663 | (I.P) | L.1.57 |
| B4664 | (I.P) | L.1.58 |
| B4665 | (I.P) | L.1.59 |
| B4666 | (I.P) | L.1.60 |
| B4667 | (I.P) | L.1.61 |
| B4668 | (I.P) | L.1.62 |
| B4669 | (I.P) | L.1.63 |
| B4670 | (I.P) | L.1.64 |
| B4671 | (I.P) | L.1.65 |
| B4672 | (I.P) | L.1.66 |
| B4673 | (I.P) | L.1.67 |
| B4674 | (I.P) | L.1.68 |
| B4675 | (I.P) | L.1.69 |
| B4676 | (I.P) | L.1.70 |
| B4677 | (I.P) | L.1.71 |
| B4678 | (I.P) | L.1.72 |
| B4679 | (I.P) | L.1.73 |
| B4680 | (I.P) | L.1.74 |
| B4681 | (I.P) | L.1.75 |
| B4682 | (I.P) | L.1.76 |
| B4683 | (I.P) | L.1.77 |
| B4684 | (I.P) | L.1.78 |
| B4685 | (I.P) | L.1.79 |
| B4686 | (I.P) | L.1.80 |
| B4687 | (I.P) | L.1.81 |
| B4688 | (I.P) | L.1.82 |
| B4689 | (I.P) | L.1.83 |
| B4690 | (I.P) | L.1.84 |
| B4691 | (I.P) | L.1.85 |
| B4692 | (I.P) | L.1.86 |
| B4693 | (I.P) | L.1.87 |
| B4694 | (I.P) | L.1.88 |
| B4695 | (I.P) | L.1.89 |
| B4696 | (I.P) | L.1.90 |
| B4697 | (I.P) | L.1.91 |
| B4698 | (I.P) | L.1.92 |
| B4699 | (I.P) | L.1.93 |
| B4700 | (I.P) | L.1.94 |
| B4701 | (I.P) | L.1.95 |
| B4702 | (I.P) | L.1.96 |
| B4703 | (I.P) | L.2.1 |
| B4704 | (I.P) | L.2.2 |
| B4705 | (I.P) | L.2.3 |
| B4706 | (I.P) | L.2.4 |
| B4707 | (I.P) | L.2.5 |
| B4708 | (I.P) | L.2.6 |
| B4709 | (I.P) | L.2.7 |
| B4710 | (I.P) | L.2.8 |
| B4711 | (I.P) | L.2.9 |
| B4712 | (I.P) | L.2.10 |
| B4713 | (I.P) | L.2.11 |
| B4714 | (I.P) | L.2.12 |
| B4715 | (I.P) | L.2.13 |
| B4716 | (I.P) | L.2.14 |
| B4717 | (I.P) | L.2.15 |
| B4718 | (I.P) | L.2.16 |
| B4719 | (I.P) | L.2.17 |
| B4720 | (I.P) | L.2.18 |
| B4721 | (I.P) | L.2.19 |
| B4722 | (I.P) | L.2.20 |
| B4723 | (I.P) | L.2.21 |
| B4724 | (I.P) | L.2.22 |
| B4725 | (I.P) | L.2.23 |
| B4726 | (I.P) | L.2.24 |
| B4727 | (I.P) | L.2.25 |
| B4728 | (I.P) | L.2.26 |
| B4729 | (I.P) | L.2.27 |
| B4730 | (I.P) | L.2.28 |
| B4731 | (I.P) | L.2.29 |
| B4732 | (I.P) | L.2.30 |
| B4733 | (I.P) | L.2.31 |
| B4734 | (I.P) | L.2.32 |
| B4735 | (I.P) | L.2.33 |
| B4736 | (I.P) | L.3.1 |
| B4737 | (I.P) | L.3.2 |
| B4738 | (I.P) | L.3.3 |
| B4739 | (I.P) | L.3.4 |
| B4740 | (I.P) | L.3.5 |
| B4741 | (I.P) | L.3.6 |
| B4742 | (I.P) | L.3.7 |
| B4743 | (I.P) | L.3.8 |
| B4744 | (I.P) | L.3.9 |
| B4745 | (I.P) | L.3.10 |
| B4746 | (I.P) | L.3.11 |
| B4747 | (I.P) | L.3.12 |
| B4748 | (I.P) | L.3.13 |
| B4749 | (I.P) | L.3.14 |
| B4750 | (I.P) | L.3.15 |
| B4751 | (I.P) | L.3.16 |
| B4752 | (I.P) | L.3.17 |
| B4753 | (I.P) | L.3.18 |
| B4754 | (I.P) | L.3.19 |
| B4755 | (I.P) | L.3.20 |
| B4756 | (I.P) | L.3.21 |
| B4757 | (I.P) | L.3.22 |
| B4758 | (I.P) | L.3.23 |
| B4759 | (I.P) | L.3.24 |
| B4760 | (I.P) | L.3.25 |
| B4761 | (I.P) | L.3.26 |
| B4762 | (I.P) | L.3.27 |
| B4763 | (I.P) | L.3.28 |
| B4764 | (I.P) | L.3.29 |
| B4765 | (I.P) | L.3.30 |
| B4766 | (I.P) | L.3.31 |
| B4767 | (I.P) | L.3.32 |
| B4768 | (I.P) | L.3.33 |
| B4769 | (I.P) | L.3.34 |
| B4770 | (I.P) | L.3.35 |
| B4771 | (I.P) | L.3.36 |
| B4772 | (I.P) | L.3.37 |
| B4773 | (I.P) | L.3.38 |
| B4774 | (I.P) | L.3.39 |
| B4775 | (I.P) | L.3.40 |
| B4776 | (I.P) | L.3.41 |
| B4777 | (I.P) | L.3.42 |
| B4778 | (I.P) | L.3.43 |
| B4779 | (I.P) | L.3.44 |
| B4780 | (I.P) | L.3.45 |
| B4781 | (I.P) | L.3.46 |
| B4782 | (I.P) | L.3.47 |
| B4783 | (I.P) | L.3.48 |
| B4784 | (I.P) | L.3.49 |
| B4785 | (I.P) | L.3.50 |
| B4786 | (I.P) | L.3.51 |
| B4787 | (I.P) | L.3.52 |
| B4788 | (I.P) | L.3.53 |
| B4789 | (I.P) | L.3.54 |
| B4790 | (I.P) | L.3.55 |
| B4791 | (I.P) | L.3.56 |
| B4792 | (I.P) | L.3.57 |
| B4793 | (I.P) | L.3.58 |
| B4794 | (I.P) | L.3.59 |
| B4795 | (I.P) | L.3.60 |
| B4796 | (I.P) | L.3.61 |
| B4797 | (I.P) | L.3.62 |
| B4798 | (I.P) | L.3.63 |
| B4799 | (I.P) | L.3.1 |
| B4800 | (I.P) | L.3.2 |
| B4801 | (I.P) | L.4.1 |
| B4802 | (I.P) | L.4.2 |
| B4803 | (I.P) | L.4.3 |
| B4804 | (I.P) | L.4.4 |
| B4805 | (I.P) | L.4.5 |
| B4806 | (I.P) | L.4.6 |
| B4807 | (I.P) | L.4.7 |
| B4808 | (I.P) | L.4.8 |
| B4809 | (I.P) | L.4.9 |
| B4810 | (I.P) | L.4.10 |
| B4811 | (I.P) | L.4.11 |
| B4812 | (I.P) | L.4.12 |
| B4813 | (I.P) | L.4.13 |
| B4814 | (I.P) | L.4.14 |
| B4815 | (I.P) | L.4.15 |
| B4816 | (I.P) | L.4.16 |
| B4817 | (I.P) | L.4.17 |
| B4818 | (I.P) | L.4.18 |
| B4819 | (I.P) | L.4.19 |
| B4820 | (I.P) | L.4.20 |
| B4821 | (I.P) | L.4.21 |
| B4822 | (I.P) | L.4.22 |
| B4823 | (I.P) | L.4.23 |
| B4824 | (I.P) | L.4.24 |
| B4825 | (I.P) | L.4.25 |
| B4826 | (I.P) | L.4.26 |
| B4827 | (I.P) | L.4.27 |
| B4828 | (I.P) | L.4.28 |
| B4829 | (I.P) | L.4.29 |
| B4830 | (I.P) | L.4.30 |
| B4831 | (I.P) | L.4.31 |
| B4832 | (I.P) | L.4.32 |
| B4833 | (I.P) | L.4.33 |
| B4834 | (I.P) | L.5.1 |
| B4835 | (I.P) | L.5.2 |
| B4836 | (I.P) | L.5.3 |
| B4837 | (I.P) | L.5.4 |
| B4838 | (I.P) | L.5.5 |
| B4839 | (I.P) | L.5.6 |
| B4840 | (I.P) | L.5.7 |
| B4841 | (I.P) | L.5.8 |
| B4842 | (I.P) | L.5.9 |
| B4843 | (I.P) | L.5.10 |
| B4844 | (I.P) | L.5.11 |
| B4845 | (I.P) | L.5.12 |
| B4846 | (I.P) | L.5.13 |
| B4847 | (I.P) | L.5.14 |
| B4848 | (I.P) | L.5.15 |
| B4849 | (I.P) | L.5.16 |
| B4850 | (I.P) | L.5.17 |
| B4851 | (I.P) | L.5.18 |
| B4852 | (I.P) | L.5.19 |
| B4853 | (I.P) | L.5.20 |
| B4854 | (I.P) | L.5.21 |
| B4855 | (I.P) | L.5.22 |
| B4856 | (I.P) | L.5.23 |
| B4857 | (I.P) | L.5.24 |
| B4858 | (I.P) | L.5.25 |
| B4859 | (I.P) | L.5.26 |
| B4860 | (I.P) | L.5.27 |
| B4861 | (I.P) | L.5.28 |
| B4862 | (I.P) | L.5.29 |
| B4863 | (I.P) | L.5.30 |
| B4864 | (I.P) | L.5.31 |
| B4865 | (I.P) | L.5.32 |
| B4866 | (I.P) | L.5.33 |
| B4867 | (I.P) | L.5.34 |
| B4868 | (I.P) | L.5.35 |
| B4869 | (I.P) | L.5.36 |
| B4870 | (I.P) | L.5.37 |
| B4871 | (I.P) | L.5.38 |
| B4872 | (I.P) | L.5.39 |
| B4873 | (I.P) | L.5.40 |
| B4874 | (I.P) | L.5.41 |
| B4875 | (I.P) | L.5.42 |
| B4876 | (I.P) | L.5.43 |
| B4877 | (I.P) | L.5.44 |
| B4878 | (I.P) | L.5.45 |
| B4879 | (I.P) | L.5.46 |
| B4880 | (I.P) | L.5.47 |
| B4881 | (I.P) | L.5.48 |
| B4882 | (I.P) | L.5.49 |
| B4883 | (I.P) | L.5.50 |
| B4884 | (I.P) | L.5.51 |
| B4885 | (I.P) | L.5.52 |
| B4886 | (I.P) | L.5.53 |
| B4887 | (I.P) | L.5.54 |
| B4888 | (I.P) | L.5.55 |
| B4889 | (I.P) | L.5.56 |
| B4890 | (I.P) | L.5.57 |
| B4891 | (I.P) | L.5.58 |
| B4892 | (I.P) | L.5.59 |
| B4893 | (I.P) | L.5.60 |
| B4894 | (I.P) | L.5.61 |
| B4895 | (I.P) | L.5.62 |
| B4896 | (I.P) | L.5.63 |
| B4897 | (I.P) | L.5.64 |
| B4898 | (I.P) | L.5.65 |
| B4899 | (I.P) | L.5.66 |
| B4900 | (I.P) | L.5.67 |
| B4901 | (I.P) | L.5.68 |
| B4902 | (I.P) | L.5.69 |
| B4903 | (I.P) | L.5.70 |
| B4904 | (I.P) | L.5.71 |
| B4905 | (I.P) | L.5.72 |
| B4906 | (I.P) | L.5.73 |
| B4907 | (I.P) | L.5.74 |
| B4908 | (I.P) | L.5.75 |
| B4909 | (I.P) | L.5.76 |
| B4910 | (I.P) | L.5.77 |
| B4911 | (I.P) | L.5.78 |
| B4912 | (I.P) | L.5.79 |
| B4913 | (I.P) | L.5.80 |
| B4914 | (I.P) | L.5.81 |
| B4915 | (I.P) | L.5.82 |
| B4916 | (I.P) | L.5.83 |
| B4917 | (I.P) | L.5.84 |
| B4918 | (I.P) | L.6.1 |
| B4919 | (I.P) | L.6.2 |
| B4920 | (I.P) | L.6.3 |
| B4921 | (I.P) | L.6.4 |
| B4922 | (I.P) | L.6.5 |
| B4923 | (I.P) | L.6.6 |
| B4924 | (I.P) | L.6.7 |
| B4925 | (I.P) | L.6.8 |
| B4926 | (I.P) | L.6.9 |
| B4927 | (I.P) | L.6.10 |
| B4928 | (I.P) | L.6.11 |
| B4929 | (I.P) | L.6.12 |
| B4930 | (I.P) | L.6.13 |
| B4931 | (I.P) | L.6.14 |
| B4932 | (I.P) | L.6.15 |
| B4933 | (I.P) | L.6.16 |
| B4934 | (I.P) | L.6.17 |
| B4935 | (I.P) | L.6.18 |

B = Mixture;
I = compound I;
II = compound II;

TABLE 65

| B | I | II |
|---|---|---|
| B4936 | (I.Q) | L.1.1 |
| B4937 | (I.Q) | L.1.2 |
| B4938 | (I.Q) | L.1.3 |
| B4939 | (I.Q) | L.1.4 |
| B4940 | (I.Q) | L.1.5 |
| B4941 | (I.Q) | L.1.6 |
| B4942 | (I.Q) | L.1.7 |
| B4943 | (I.Q) | L.1.8 |
| B4944 | (I.Q) | L.1.9 |
| B4945 | (I.Q) | L.1.10 |
| B4946 | (I.Q) | L.1.11 |
| B4947 | (I.Q) | L.1.12 |
| B4948 | (I.Q) | L.1.13 |
| B4949 | (I.Q) | L.1.14 |
| B4950 | (I.Q) | L.1.15 |
| B4951 | (I.Q) | L.1.16 |
| B4952 | (I.Q) | L.1.17 |
| B4953 | (I.Q) | L.1.18 |
| B4954 | (I.Q) | L.1.19 |
| B4955 | (I.Q) | L.1.20 |
| B4956 | (I.Q) | L.1.21 |
| B4957 | (I.Q) | L.1.22 |
| B4958 | (I.Q) | L.1.23 |
| B4959 | (I.Q) | L.1.24 |
| B4960 | (I.Q) | L.1.25 |
| B4961 | (I.Q) | L.1.26 |
| B4962 | (I.Q) | L.1.27 |
| B4963 | (I.Q) | L.1.28 |
| B4964 | (I.Q) | L.1.29 |
| B4965 | (I.Q) | L.1.30 |
| B4966 | (I.Q) | L.1.31 |
| B4967 | (I.Q) | L.1.32 |
| B4968 | (I.Q) | L.1.33 |
| B4969 | (I.Q) | L.1.34 |
| B4970 | (I.Q) | L.1.35 |
| B4971 | (I.Q) | L.1.36 |
| B4972 | (I.Q) | L.1.37 |
| B4973 | (I.Q) | L.1.38 |
| B4974 | (I.Q) | L.1.39 |
| B4975 | (I.Q) | L.1.40 |
| B4976 | (I.Q) | L.1.41 |
| B4977 | (I.Q) | L.1.42 |
| B4978 | (I.Q) | L.1.43 |
| B4979 | (I.Q) | L.1.44 |
| B4980 | (I.Q) | L.1.45 |
| B4981 | (I.Q) | L.1.46 |
| B4982 | (I.Q) | L.1.47 |
| B4983 | (I.Q) | L.1.48 |
| B4984 | (I.Q) | L.1.49 |
| B4985 | (I.Q) | L.1.50 |
| B4986 | (I.Q) | L.1.51 |
| B4987 | (I.Q) | L.1.52 |
| B4988 | (I.Q) | L.1.53 |
| B4989 | (I.Q) | L.1.54 |
| B4990 | (I.Q) | L.1.55 |
| B4991 | (I.Q) | L.1.56 |
| B4992 | (I.Q) | L.1.57 |
| B4993 | (I.Q) | L.1.58 |
| B4994 | (I.Q) | L.1.59 |
| B4995 | (I.Q) | L.1.60 |
| B4996 | (I.Q) | L.1.61 |
| B4997 | (I.Q) | L.1.62 |
| B4998 | (I.Q) | L.1.63 |
| B4999 | (I.Q) | L.1.64 |
| B5000 | (I.Q) | L.1.65 |
| B5001 | (I.Q) | L.1.66 |
| B5002 | (I.Q) | L.1.67 |
| B5003 | (I.Q) | L.1.68 |
| B5004 | (I.Q) | L.1.69 |
| B5005 | (I.Q) | L.1.70 |
| B5006 | (I.Q) | L.1.71 |
| B5007 | (I.Q) | L.1.72 |
| B5008 | (I.Q) | L.1.73 |
| B5009 | (I.Q) | L.1.74 |
| B5010 | (I.Q) | L.1.75 |
| B5011 | (I.Q) | L.1.76 |
| B5012 | (I.Q) | L.1.77 |
| B5013 | (I.Q) | L.1.78 |
| B5014 | (I.Q) | L.1.79 |
| B5015 | (I.Q) | L.1.80 |
| B5016 | (I.Q) | L.1.81 |
| B5017 | (I.Q) | L.1.82 |
| B5018 | (I.Q) | L.1.83 |
| B5019 | (I.Q) | L.1.84 |
| B5020 | (I.Q) | L.1.85 |
| B5021 | (I.Q) | L.1.86 |
| B5022 | (I.Q) | L.1.87 |
| B5023 | (I.Q) | L.1.88 |
| B5024 | (I.Q) | L.1.89 |
| B5025 | (I.Q) | L.1.90 |
| B5026 | (I.Q) | L.1.91 |
| B5027 | (I.Q) | L.1.92 |
| B5028 | (I.Q) | L.1.93 |
| B5029 | (I.Q) | L.1.94 |
| B5030 | (I.Q) | L.1.95 |
| B5031 | (I.Q) | L.1.96 |
| B5032 | (I.Q) | L.2.1 |
| B5033 | (I.Q) | L.2.2 |
| B5034 | (I.Q) | L.2.3 |
| B5035 | (I.Q) | L.2.4 |
| B5036 | (I.Q) | L.2.5 |
| B5037 | (I.Q) | L.2.6 |
| B5038 | (I.Q) | L.2.7 |
| B5039 | (I.Q) | L.2.8 |
| B5040 | (I.Q) | L.2.9 |
| B5041 | (I.Q) | L.2.10 |
| B5042 | (I.Q) | L.2.11 |
| B5043 | (I.Q) | L.2.12 |
| B5044 | (I.Q) | L.2.13 |
| B5045 | (I.Q) | L.2.14 |
| B5046 | (I.Q) | L.2.15 |
| B5047 | (I.Q) | L.2.16 |
| B5048 | (I.Q) | L.2.17 |
| B5049 | (I.Q) | L.2.18 |
| B5050 | (I.Q) | L.2.19 |
| B5051 | (I.Q) | L.2.20 |
| B5052 | (I.Q) | L.2.21 |
| B5053 | (I.Q) | L.2.22 |
| B5054 | (I.Q) | L.2.23 |
| B5055 | (I.Q) | L.2.24 |
| B5056 | (I.Q) | L.2.25 |
| B5057 | (I.Q) | L.2.26 |
| B5058 | (I.Q) | L.2.27 |
| B5059 | (I.Q) | L.2.28 |
| B5060 | (I.Q) | L.2.29 |
| B5061 | (I.Q) | L.2.30 |
| B5062 | (I.Q) | L.2.31 |
| B5063 | (I.Q) | L.2.32 |
| B5064 | (I.Q) | L.2.33 |
| B5065 | (I.Q) | L.3.1 |
| B5066 | (I.Q) | L.3.2 |
| B5067 | (I.Q) | L.3.3 |
| B5068 | (I.Q) | L.3.4 |
| B5069 | (I.Q) | L.3.5 |
| B5070 | (I.Q) | L.3.6 |
| B5071 | (I.Q) | L.3.7 |
| B5072 | (I.Q) | L.3.8 |
| B5073 | (I.Q) | L.3.9 |
| B5074 | (I.Q) | L.3.10 |
| B5075 | (I.Q) | L.3.11 |
| B5076 | (I.Q) | L.3.12 |
| B5077 | (I.Q) | L.3.13 |
| B5078 | (I.Q) | L.3.14 |
| B5079 | (I.Q) | L.3.15 |
| B5080 | (I.Q) | L.3.16 |
| B5081 | (I.Q) | L.3.17 |
| B5082 | (I.Q) | L.3.18 |
| B5083 | (I.Q) | L.3.19 |
| B5084 | (I.Q) | L.3.20 |
| B5085 | (I.Q) | L.3.21 |
| B5086 | (I.Q) | L.3.22 |
| B5087 | (I.Q) | L.3.23 |
| B5088 | (I.Q) | L.3.24 |
| B5089 | (I.Q) | L.3.25 |
| B5090 | (I.Q) | L.3.26 |
| B5091 | (I.Q) | L.3.27 |
| B5092 | (I.Q) | L.3.28 |
| B5093 | (I.Q) | L.3.29 |
| B5094 | (I.Q) | L.3.30 |
| B5095 | (I.Q) | L.3.31 |
| B5096 | (I.Q) | L.3.32 |
| B5097 | (I.Q) | L.3.33 |
| B5098 | (I.Q) | L.3.34 |
| B5099 | (I.Q) | L.3.35 |
| B5100 | (I.Q) | L.3.36 |
| B5101 | (I.Q) | L.3.37 |
| B5102 | (I.Q) | L.3.38 |
| B5103 | (I.Q) | L.3.39 |
| B5104 | (I.Q) | L.3.40 |
| B5105 | (I.Q) | L.3.41 |
| B5106 | (I.Q) | L.3.42 |
| B5107 | (I.Q) | L.3.43 |
| B5108 | (I.Q) | L.3.44 |
| B5109 | (I.Q) | L.3.45 |
| B5110 | (I.Q) | L.3.46 |
| B5111 | (I.Q) | L.3.47 |
| B5112 | (I.Q) | L.3.48 |
| B5113 | (I.Q) | L.3.49 |
| B5114 | (I.Q) | L.3.50 |
| B5115 | (I.Q) | L.3.51 |
| B5116 | (I.Q) | L.3.52 |
| B5117 | (I.Q) | L.3.53 |
| B5118 | (I.Q) | L.3.54 |
| B5119 | (I.Q) | L.3.55 |
| B5120 | (I.Q) | L.3.56 |
| B5121 | (I.Q) | L.3.57 |
| B5122 | (I.Q) | L.3.58 |
| B5123 | (I.Q) | L.3.59 |
| B5124 | (I.Q) | L.3.60 |
| B5125 | (I.Q) | L.3.61 |
| B5126 | (I.Q) | L.3.62 |
| B5127 | (I.Q) | L.3.63 |
| B5128 | (I.Q) | L.3.1 |
| B5129 | (I.Q) | L.3.2 |
| B5130 | (I.Q) | L.4.1 |
| B5131 | (I.Q) | L.4.2 |
| B5132 | (I.Q) | L.4.3 |
| B5133 | (I.Q) | L.4.4 |
| B5134 | (I.Q) | L.4.5 |
| B5135 | (I.Q) | L.4.6 |
| B5136 | (I.Q) | L.4.7 |
| B5137 | (I.Q) | L.4.8 |
| B5138 | (I.Q) | L.4.9 |
| B5139 | (I.Q) | L.4.10 |
| B5140 | (I.Q) | L.4.11 |
| B5141 | (I.Q) | L.4.12 |
| B5142 | (I.Q) | L.4.13 |
| B5143 | (I.Q) | L.4.14 |
| B5144 | (I.Q) | L.4.15 |
| B5145 | (I.Q) | L.4.16 |
| B5146 | (I.Q) | L.4.17 |
| B5147 | (I.Q) | L.4.18 |
| B5148 | (I.Q) | L.4.19 |
| B5149 | (I.Q) | L.4.20 |
| B5150 | (I.Q) | L.4.21 |
| B5151 | (I.Q) | L.4.22 |
| B5152 | (I.Q) | L.4.23 |
| B5153 | (I.Q) | L.4.24 |
| B5154 | (I.Q) | L.4.25 |
| B5155 | (I.Q) | L.4.26 |
| B5156 | (I.Q) | L.4.27 |
| B5157 | (I.Q) | L.4.28 |
| B5158 | (I.Q) | L.4.29 |
| B5159 | (I.Q) | L.4.30 |
| B5160 | (I.Q) | L.4.31 |
| B5161 | (I.Q) | L.4.32 |
| B5162 | (I.Q) | L.4.33 |
| B5163 | (I.Q) | L.5.1 |
| B5164 | (I.Q) | L.5.2 |
| B5165 | (I.Q) | L.5.3 |
| B5166 | (I.Q) | L.5.4 |
| B5167 | (I.Q) | L.5.5 |
| B5168 | (I.Q) | L.5.6 |
| B5169 | (I.Q) | L.5.7 |
| B5170 | (I.Q) | L.5.8 |
| B5171 | (I.Q) | L.5.9 |
| B5172 | (I.Q) | L.5.10 |
| B5173 | (I.Q) | L.5.11 |
| B5174 | (I.Q) | L.5.12 |
| B5175 | (I.Q) | L.5.13 |
| B5176 | (I.Q) | L.5.14 |
| B5177 | (I.Q) | L.5.15 |
| B5178 | (I.Q) | L.5.16 |
| B5179 | (I.Q) | L.5.17 |
| B5180 | (I.Q) | L.5.18 |
| B5181 | (I.Q) | L.5.19 |
| B5182 | (I.Q) | L.5.20 |
| B5183 | (I.Q) | L.5.21 |
| B5184 | (I.Q) | L.5.22 |
| B5185 | (I.Q) | L.5.23 |
| B5186 | (I.Q) | L.5.24 |
| B5187 | (I.Q) | L.5.25 |
| B5188 | (I.Q) | L.5.26 |
| B5189 | (I.Q) | L.5.27 |
| B5190 | (I.Q) | L.5.28 |
| B5191 | (I.Q) | L.5.29 |
| B5192 | (I.Q) | L.5.30 |
| B5193 | (I.Q) | L.5.31 |
| B5194 | (I.Q) | L.5.32 |
| B5195 | (I.Q) | L.5.33 |
| B5196 | (I.Q) | L.5.34 |
| B5197 | (I.Q) | L.5.35 |
| B5198 | (I.Q) | L.5.36 |
| B5199 | (I.Q) | L.5.37 |
| B5200 | (I.Q) | L.5.38 |
| B5201 | (I.Q) | L.5.39 |
| B5202 | (I.Q) | L.5.40 |
| B5203 | (I.Q) | L.5.41 |
| B5204 | (I.Q) | L.5.42 |
| B5205 | (I.Q) | L.5.43 |
| B5206 | (I.Q) | L.5.44 |
| B5207 | (I.Q) | L.5.45 |
| B5208 | (I.Q) | L.5.46 |
| B5209 | (I.Q) | L.5.47 |
| B5210 | (I.Q) | L.5.48 |
| B5211 | (I.Q) | L.5.49 |
| B5212 | (I.Q) | L.5.50 |
| B5213 | (I.Q) | L.5.51 |
| B5214 | (I.Q) | L.5.52 |
| B5215 | (I.Q) | L.5.53 |
| B5216 | (I.Q) | L.5.54 |
| B5217 | (I.Q) | L.5.55 |
| B5218 | (I.Q) | L.5.56 |
| B5219 | (I.Q) | L.5.57 |
| B5220 | (I.Q) | L.5.58 |
| B5221 | (I.Q) | L.5.59 |
| B5222 | (I.Q) | L.5.60 |
| B5223 | (I.Q) | L.5.61 |
| B5224 | (I.Q) | L.5.62 |
| B5225 | (I.Q) | L.5.63 |
| B5226 | (I.Q) | L.5.64 |
| B5227 | (I.Q) | L.5.65 |
| B5228 | (I.Q) | L.5.66 |
| B5229 | (I.Q) | L.5.67 |
| B5230 | (I.Q) | L.5.68 |
| B5231 | (I.Q) | L.5.69 |
| B5232 | (I.Q) | L.5.70 |
| B5233 | (I.Q) | L.5.71 |
| B5234 | (I.Q) | L.5.72 |
| B5235 | (I.Q) | L.5.73 |
| B5236 | (I.Q) | L.5.74 |
| B5237 | (I.Q) | L.5.75 |
| B5238 | (I.Q) | L.5.76 |
| B5239 | (I.Q) | L.5.77 |
| B5240 | (I.Q) | L.5.78 |
| B5241 | (I.Q) | L.5.79 |
| B5242 | (I.Q) | L.5.80 |
| B5243 | (I.Q) | L.5.81 |
| B5244 | (I.Q) | L.5.82 |
| B5245 | (I.Q) | L.5.83 |
| B5246 | (I.Q) | L.5.84 |
| B5247 | (I.Q) | L.6.1 |
| B5248 | (I.Q) | L.6.2 |
| B5249 | (I.Q) | L.6.3 |
| B5250 | (I.Q) | L.6.4 |
| B5251 | (I.Q) | L.6.5 |
| B5252 | (I.Q) | L.6.6 |
| B5253 | (I.Q) | L.6.7 |
| B5254 | (I.Q) | L.6.8 |
| B5255 | (I.Q) | L.6.9 |
| B5256 | (I.Q) | L.6.10 |
| B5257 | (I.Q) | L.6.11 |
| B5258 | (I.Q) | L.6.12 |
| B5259 | (I.Q) | L.6.13 |
| B5260 | (I.Q) | L.6.14 |
| B5261 | (I.Q) | L.6.15 |
| B5262 | (I.Q) | L.6.16 |
| B5263 | (I.Q) | L.6.17 |
| B5264 | (I.Q) | L.6.18 |

B = Mixture;
I = compound I;
II = compound II;

TABLE 66

| B | I | II |
|---|---|---|
| B5265 | (I.R) | L.1.1 |
| B5266 | (I.R) | L.1.2 |
| B5267 | (I.R) | L.1.3 |
| B5268 | (I.R) | L.1.4 |
| B5269 | (I.R) | L.1.5 |
| B5270 | (I.R) | L.1.6 |
| B5271 | (I.R) | L.1.7 |
| B5272 | (I.R) | L.1.8 |
| B5273 | (I.R) | L.1.9 |
| B5274 | (I.R) | L.1.10 |
| B5275 | (I.R) | L.1.11 |
| B5276 | (I.R) | L.1.12 |
| B5277 | (I.R) | L.1.13 |
| B5278 | (I.R) | L.1.14 |
| B5279 | (I.R) | L.1.15 |
| B5280 | (I.R) | L.1.16 |
| B5281 | (I.R) | L.1.17 |
| B5282 | (I.R) | L.1.18 |
| B5283 | (I.R) | L.1.19 |
| B5284 | (I.R) | L.1.20 |
| B5285 | (I.R) | L.1.21 |
| B5286 | (I.R) | L.1.22 |
| B5287 | (I.R) | L.1.23 |
| B5288 | (I.R) | L.1.24 |
| B5289 | (I.R) | L.1.25 |
| B5290 | (I.R) | L.1.26 |
| B5291 | (I.R) | L.1.27 |
| B5292 | (I.R) | L.1.28 |
| B5293 | (I.R) | L.1.29 |
| B5294 | (I.R) | L.1.30 |
| B5295 | (I.R) | L.1.31 |
| B5296 | (I.R) | L.1.32 |
| B5297 | (I.R) | L.1.33 |
| B5298 | (I.R) | L.1.34 |
| B5299 | (I.R) | L.1.35 |
| B5300 | (I.R) | L.1.36 |
| B5301 | (I.R) | L.1.37 |
| B5302 | (I.R) | L.1.38 |
| B5303 | (I.R) | L.1.39 |
| B5304 | (I.R) | L.1.40 |
| B5305 | (I.R) | L.1.41 |
| B5306 | (I.R) | L.1.42 |
| B5307 | (I.R) | L.1.43 |
| B5308 | (I.R) | L.1.44 |
| B5309 | (I.R) | L.1.45 |
| B5310 | (I.R) | L.1.46 |
| B5311 | (I.R) | L.1.47 |
| B5312 | (I.R) | L.1.48 |
| B5313 | (I.R) | L.1.49 |
| B5314 | (I.R) | L.1.50 |
| B5315 | (I.R) | L.1.51 |
| B5316 | (I.R) | L.1.52 |
| B5317 | (I.R) | L.1.53 |
| B5318 | (I.R) | L.1.54 |
| B5319 | (I.R) | L.1.55 |
| B5320 | (I.R) | L.1.56 |
| B5321 | (I.R) | L.1.57 |
| B5322 | (I.R) | L.1.58 |
| B5323 | (I.R) | L.1.59 |
| B5324 | (I.R) | L.1.60 |
| B5325 | (I.R) | L.1.61 |
| B5326 | (I.R) | L.1.62 |
| B5327 | (I.R) | L.1.63 |
| B5328 | (I.R) | L.1.64 |
| B5329 | (I.R) | L.1.65 |
| B5330 | (I.R) | L.1.66 |
| B5331 | (I.R) | L.1.67 |
| B5332 | (I.R) | L.1.68 |
| B5333 | (I.R) | L.1.69 |
| B5334 | (I.R) | L.1.70 |
| B5335 | (I.R) | L.1.71 |
| B5336 | (I.R) | L.1.72 |
| B5337 | (I.R) | L.1.73 |
| B5338 | (I.R) | L.1.74 |
| B5339 | (I.R) | L.1.75 |
| B5340 | (I.R) | L.1.76 |
| B5341 | (I.R) | L.1.77 |
| B5342 | (I.R) | L.1.78 |
| B5343 | (I.R) | L.1.79 |
| B5344 | (I.R) | L.1.80 |
| B5345 | (I.R) | L.1.81 |
| B5346 | (I.R) | L.1.82 |
| B5347 | (I.R) | L.1.83 |
| B5348 | (I.R) | L.1.84 |
| B5349 | (I.R) | L.1.85 |
| B5350 | (I.R) | L.1.86 |
| B5351 | (I.R) | L.1.87 |
| B5352 | (I.R) | L.1.88 |
| B5353 | (I.R) | L.1.89 |
| B5354 | (I.R) | L.1.90 |
| B5355 | (I.R) | L.1.91 |
| B5356 | (I.R) | L.1.92 |
| B5357 | (I.R) | L.1.93 |
| B5358 | (I.R) | L.1.94 |
| B5359 | (I.R) | L.1.95 |
| B5360 | (I.R) | L.1.96 |
| B5361 | (I.R) | L.2.1 |
| B5362 | (I.R) | L.2.2 |
| B5363 | (I.R) | L.2.3 |
| B5364 | (I.R) | L.2.4 |
| B5365 | (I.R) | L.2.5 |
| B5366 | (I.R) | L.2.6 |
| B5367 | (I.R) | L.2.7 |
| B5368 | (I.R) | L.2.8 |
| B5369 | (I.R) | L.2.9 |
| B5370 | (I.R) | L.2.10 |
| B5371 | (I.R) | L.2.11 |
| B5372 | (I.R) | L.2.12 |
| B5373 | (I.R) | L.2.13 |
| B5374 | (I.R) | L.2.14 |
| B5375 | (I.R) | L.2.15 |
| B5376 | (I.R) | L.2.16 |
| B5377 | (I.R) | L.2.17 |
| B5378 | (I.R) | L.2.18 |
| B5379 | (I.R) | L.2.19 |
| B5380 | (I.R) | L.2.20 |
| B5381 | (I.R) | L.2.21 |
| B5382 | (I.R) | L.2.22 |
| B5383 | (I.R) | L.2.23 |
| B5384 | (I.R) | L.2.24 |
| B5385 | (I.R) | L.2.25 |
| B5386 | (I.R) | L.2.26 |
| B5387 | (I.R) | L.2.27 |
| B5388 | (I.R) | L.2.28 |
| B5389 | (I.R) | L.2.29 |
| B5390 | (I.R) | L.2.30 |
| B5391 | (I.R) | L.2.31 |
| B5392 | (I.R) | L.2.32 |
| B5393 | (I.R) | L.2.33 |
| B5394 | (I.R) | L.3.1 |
| B5395 | (I.R) | L.3.2 |
| B5396 | (I.R) | L.3.3 |
| B5397 | (I.R) | L.3.4 |
| B5398 | (I.R) | L.3.5 |
| B5399 | (I.R) | L.3.6 |
| B5400 | (I.R) | L.3.7 |
| B5401 | (I.R) | L.3.8 |
| B5402 | (I.R) | L.3.9 |
| B5403 | (I.R) | L.3.10 |
| B5404 | (I.R) | L.3.11 |
| B5405 | (I.R) | L.3.12 |
| B5406 | (I.R) | L.3.13 |
| B5407 | (I.R) | L.3.14 |
| B5408 | (I.R) | L.3.15 |
| B5409 | (I.R) | L.3.16 |
| B5410 | (I.R) | L.3.17 |
| B5411 | (I.R) | L.3.18 |
| B5412 | (I.R) | L.3.19 |
| B5413 | (I.R) | L.3.20 |
| B5414 | (I.R) | L.3.21 |
| B5415 | (I.R) | L.3.22 |
| B5416 | (I.R) | L.3.23 |
| B5417 | (I.R) | L.3.24 |
| B5418 | (I.R) | L.3.25 |
| B5419 | (I.R) | L.3.26 |
| B5420 | (I.R) | L.3.27 |
| B5421 | (I.R) | L.3.28 |
| B5422 | (I.R) | L.3.29 |
| B5423 | (I.R) | L.3.30 |
| B5424 | (I.R) | L.3.31 |
| B5425 | (I.R) | L.3.32 |
| B5426 | (I.R) | L.3.33 |
| B5427 | (I.R) | L.3.34 |
| B5428 | (I.R) | L.3.35 |
| B5429 | (I.R) | L.3.36 |
| B5430 | (I.R) | L.3.37 |
| B5431 | (I.R) | L.3.38 |
| B5432 | (I.R) | L.3.39 |
| B5433 | (I.R) | L.3.40 |
| B5434 | (I.R) | L.3.41 |
| B5435 | (I.R) | L.3.42 |
| B5436 | (I.R) | L.3.43 |
| B5437 | (I.R) | L.3.44 |
| B5438 | (I.R) | L.3.45 |
| B5439 | (I.R) | L.3.46 |
| B5440 | (I.R) | L.3.47 |
| B5441 | (I.R) | L.3.48 |
| B5442 | (I.R) | L.3.49 |
| B5443 | (I.R) | L.3.50 |
| B5444 | (I.R) | L.3.51 |
| B5445 | (I.R) | L.3.52 |
| B5446 | (I.R) | L.3.53 |
| B5447 | (I.R) | L.3.54 |
| B5448 | (I.R) | L.3.55 |
| B5449 | (I.R) | L.3.56 |
| B5450 | (I.R) | L.3.57 |
| B5451 | (I.R) | L.3.58 |
| B5452 | (I.R) | L.3.59 |
| B5453 | (I.R) | L.3.60 |
| B5454 | (I.R) | L.3.61 |
| B5455 | (I.R) | L.3.62 |
| B5456 | (I.R) | L.3.63 |
| B5457 | (I.R) | L.3.1 |
| B5458 | (I.R) | L.3.2 |
| B5459 | (I.R) | L.4.1 |
| B5460 | (I.R) | L.4.2 |
| B5461 | (I.R) | L.4.3 |
| B5462 | (I.R) | L.4.4 |
| B5463 | (I.R) | L.4.5 |
| B5464 | (I.R) | L.4.6 |
| B5465 | (I.R) | L.4.7 |
| B5466 | (I.R) | L.4.8 |
| B5467 | (I.R) | L.4.9 |
| B5468 | (I.R) | L.4.10 |
| B5469 | (I.R) | L.4.11 |
| B5470 | (I.R) | L.4.12 |
| B5471 | (I.R) | L.4.13 |
| B5472 | (I.R) | L.4.14 |
| B5473 | (I.R) | L.4.15 |
| B5474 | (I.R) | L.4.16 |
| B5475 | (I.R) | L.4.17 |
| B5476 | (I.R) | L.4.18 |
| B5477 | (I.R) | L.4.19 |
| B5478 | (I.R) | L.4.20 |
| B5479 | (I.R) | L.4.21 |
| B5480 | (I.R) | L.4.22 |
| B5481 | (I.R) | L.4.23 |
| B5482 | (I.R) | L.4.24 |
| B5483 | (I.R) | L.4.25 |
| B5484 | (I.R) | L.4.26 |
| B5485 | (I.R) | L.4.27 |
| B5486 | (I.R) | L.4.28 |
| B5487 | (I.R) | L.4.29 |
| B5488 | (I.R) | L.4.30 |
| B5489 | (I.R) | L.4.31 |
| B5490 | (I.R) | L.4.32 |
| B5491 | (I.R) | L.4.33 |
| B5492 | (I.R) | L.5.1 |
| B5493 | (I.R) | L.5.2 |
| B5494 | (I.R) | L.5.3 |
| B5495 | (I.R) | L.5.4 |
| B5496 | (I.R) | L.5.5 |
| B5497 | (I.R) | L.5.6 |
| B5498 | (I.R) | L.5.7 |
| B5499 | (I.R) | L.5.8 |
| B5500 | (I.R) | L.5.9 |
| B5501 | (I.R) | L.5.10 |
| B5502 | (I.R) | L.5.11 |
| B5503 | (I.R) | L.5.12 |
| B5504 | (I.R) | L.5.13 |
| B5505 | (I.R) | L.5.14 |
| B5506 | (I.R) | L.5.15 |
| B5507 | (I.R) | L.5.16 |
| B5508 | (I.R) | L.5.17 |
| B5509 | (I.R) | L.5.18 |
| B5510 | (I.R) | L.5.19 |
| B5511 | (I.R) | L.5.20 |
| B5512 | (I.R) | L.5.21 |
| B5513 | (I.R) | L.5.22 |
| B5514 | (I.R) | L.5.23 |
| B5515 | (I.R) | L.5.24 |
| B5516 | (I.R) | L.5.25 |
| B5517 | (I.R) | L.5.26 |
| B5518 | (I.R) | L.5.27 |
| B5519 | (I.R) | L.5.28 |
| B5520 | (I.R) | L.5.29 |
| B5521 | (I.R) | L.5.30 |
| B5522 | (I.R) | L.5.31 |
| B5523 | (I.R) | L.5.32 |
| B5524 | (I.R) | L.5.33 |
| B5525 | (I.R) | L.5.34 |
| B5526 | (I.R) | L.5.35 |
| B5527 | (I.R) | L.5.36 |
| B5528 | (I.R) | L.5.37 |
| B5529 | (I.R) | L.5.38 |
| B5530 | (I.R) | L.5.39 |
| B5531 | (I.R) | L.5.40 |
| B5532 | (I.R) | L.5.41 |
| B5533 | (I.R) | L.5.42 |
| B5534 | (I.R) | L.5.43 |
| B5535 | (I.R) | L.5.44 |
| B5536 | (I.R) | L.5.45 |
| B5537 | (I.R) | L.5.46 |
| B5538 | (I.R) | L.5.47 |
| B5539 | (I.R) | L.5.48 |
| B5540 | (I.R) | L.5.49 |
| B5541 | (I.R) | L.5.50 |
| B5542 | (I.R) | L.5.51 |
| B5543 | (I.R) | L.5.52 |
| B5544 | (I.R) | L.5.53 |
| B5545 | (I.R) | L.5.54 |
| B5546 | (I.R) | L.5.55 |
| B5547 | (I.R) | L.5.56 |
| B5548 | (I.R) | L.5.57 |
| B5549 | (I.R) | L.5.58 |
| B5550 | (I.R) | L.5.59 |
| B5551 | (I.R) | L.5.60 |
| B5552 | (I.R) | L.5.61 |
| B5553 | (I.R) | L.5.62 |
| B5554 | (I.R) | L.5.63 |
| B5555 | (I.R) | L.5.64 |
| B5556 | (I.R) | L.5.65 |
| B5557 | (I.R) | L.5.66 |
| B5558 | (I.R) | L.5.67 |
| B5559 | (I.R) | L.5.68 |
| B5560 | (I.R) | L.5.69 |
| B5561 | (I.R) | L.5.70 |
| B5562 | (I.R) | L.5.71 |
| B5563 | (I.R) | L.5.72 |
| B5564 | (I.R) | L.5.73 |
| B5565 | (I.R) | L.5.74 |
| B5566 | (I.R) | L.5.75 |
| B5567 | (I.R) | L.5.76 |
| B5568 | (I.R) | L.5.77 |
| B5569 | (I.R) | L.5.78 |
| B5570 | (I.R) | L.5.79 |
| B5571 | (I.R) | L.5.80 |
| B5572 | (I.R) | L.5.81 |
| B5573 | (I.R) | L.5.82 |
| B5574 | (I.R) | L.5.83 |
| B5575 | (I.R) | L.5.84 |
| B5576 | (I.R) | L.6.1 |
| B5577 | (I.R) | L.6.2 |
| B5578 | (I.R) | L.6.3 |
| B5579 | (I.R) | L.6.4 |
| B5580 | (I.R) | L.6.5 |
| B5581 | (I.R) | L.6.6 |
| B5582 | (I.R) | L.6.7 |
| B5583 | (I.R) | L.6.8 |
| B5584 | (I.R) | L.6.9 |
| B5585 | (I.R) | L.6.10 |
| B5586 | (I.R) | L.6.11 |
| B5587 | (I.R) | L.6.12 |
| B5588 | (I.R) | L.6.13 |
| B5589 | (I.R) | L.6.14 |
| B5590 | (I.R) | L.6.15 |
| B5591 | (I.R) | L.6.16 |
| B5592 | (I.R) | L.6.17 |
| B5593 | (I.R) | L.6.18 |

B = Mixture;
I = compound I;
II = compound II;

TABLE 67

| B | I | II |
|---|---|---|
| B5594 | (I.S) | L.1.1 |
| B5595 | (I.S) | L.1.2 |
| B5596 | (I.S) | L.1.3 |
| B5597 | (I.S) | L.1.4 |
| B5598 | (I.S) | L.1.5 |
| B5599 | (I.S) | L.1.6 |
| B5600 | (I.S) | L.1.7 |
| B5601 | (I.S) | L.1.8 |
| B5602 | (I.S) | L.1.9 |
| B5603 | (I.S) | L.1.10 |
| B5604 | (I.S) | L.1.11 |
| B5605 | (I.S) | L.1.12 |
| B5606 | (I.S) | L.1.13 |
| B5607 | (I.S) | L.1.14 |
| B5608 | (I.S) | L.1.15 |
| B5609 | (I.S) | L.1.16 |
| B5610 | (I.S) | L.1.17 |
| B5611 | (I.S) | L.1.18 |
| B5612 | (I.S) | L.1.19 |
| B5613 | (I.S) | L.1.20 |
| B5614 | (I.S) | L.1.21 |
| B5615 | (I.S) | L.1.22 |
| B5616 | (I.S) | L.1.23 |
| B5617 | (I.S) | L.1.24 |
| B5618 | (I.S) | L.1.25 |
| B5619 | (I.S) | L.1.26 |
| B5620 | (I.S) | L.1.27 |
| B5621 | (I.S) | L.1.28 |
| B5622 | (I.S) | L.1.29 |
| B5623 | (I.S) | L.1.30 |
| B5624 | (I.S) | L.1.31 |
| B5625 | (I.S) | L.1.32 |
| B5626 | (I.S) | L.1.33 |
| B5627 | (I.S) | L.1.34 |
| B5628 | (I.S) | L.1.35 |
| B5629 | (I.S) | L.1.36 |
| B5630 | (I.S) | L.1.37 |
| B5631 | (I.S) | L.1.38 |
| B5632 | (I.S) | L.1.39 |
| B5633 | (I.S) | L.1.40 |
| B5634 | (I.S) | L.1.41 |
| B5635 | (I.S) | L.1.42 |
| B5636 | (I.S) | L.1.43 |
| B5637 | (I.S) | L.1.44 |
| B5638 | (I.S) | L.1.45 |
| B5639 | (I.S) | L.1.46 |
| B5640 | (I.S) | L.1.47 |
| B5641 | (I.S) | L.1.48 |
| B5642 | (I.S) | L.1.49 |
| B5643 | (I.S) | L.1.50 |
| B5644 | (I.S) | L.1.51 |
| B5645 | (I.S) | L.1.52 |
| B5646 | (I.S) | L.1.53 |
| B5647 | (I.S) | L.1.54 |
| B5648 | (I.S) | L.1.55 |
| B5649 | (I.S) | L.1.56 |
| B5650 | (I.S) | L.1.57 |
| B5651 | (I.S) | L.1.58 |
| B5652 | (I.S) | L.1.59 |
| B5653 | (I.S) | L.1.60 |
| B5654 | (I.S) | L.1.61 |
| B5655 | (I.S) | L.1.62 |
| B5656 | (I.S) | L.1.63 |
| B5657 | (I.S) | L.1.64 |
| B5658 | (I.S) | L.1.65 |
| B5659 | (I.S) | L.1.66 |
| B5660 | (I.S) | L.1.67 |
| B5661 | (I.S) | L.1.68 |
| B5662 | (I.S) | L.1.69 |
| B5663 | (I.S) | L.1.70 |
| B5664 | (I.S) | L.1.71 |
| B5665 | (I.S) | L.1.72 |
| B5666 | (I.S) | L.1.73 |
| B5667 | (I.S) | L.1.74 |
| B5668 | (I.S) | L.1.75 |
| B5669 | (I.S) | L.1.76 |
| B5670 | (I.S) | L.1.77 |
| B5671 | (I.S) | L.1.78 |
| B5672 | (I.S) | L.1.79 |
| B5673 | (I.S) | L.1.80 |
| B5674 | (I.S) | L.1.81 |
| B5675 | (I.S) | L.1.82 |
| B5676 | (I.S) | L.1.83 |
| B5677 | (I.S) | L.1.84 |
| B5678 | (I.S) | L.1.85 |
| B5679 | (I.S) | L.1.86 |
| B5680 | (I.S) | L.1.87 |
| B5681 | (I.S) | L.1.88 |
| B5682 | (I.S) | L.1.89 |
| B5683 | (I.S) | L.1.90 |
| B5684 | (I.S) | L.1.91 |
| B5685 | (I.S) | L.1.92 |
| B5686 | (I.S) | L.1.93 |
| B5687 | (I.S) | L.1.94 |
| B5688 | (I.S) | L.1.95 |
| B5689 | (I.S) | L.1.96 |
| B5690 | (I.S) | L.2.1 |
| B5691 | (I.S) | L.2.2 |
| B5692 | (I.S) | L.2.3 |
| B5693 | (I.S) | L.2.4 |
| B5694 | (I.S) | L.2.5 |
| B5695 | (I.S) | L.2.6 |
| B5696 | (I.S) | L.2.7 |
| B5697 | (I.S) | L.2.8 |
| B5698 | (I.S) | L.2.9 |
| B5699 | (I.S) | L.2.10 |
| B5700 | (I.S) | L.2.11 |
| B5701 | (I.S) | L.2.12 |
| B5702 | (I.S) | L.2.13 |
| B5703 | (I.S) | L.2.14 |
| B5704 | (I.S) | L.2.15 |
| B5705 | (I.S) | L.2.16 |
| B5706 | (I.S) | L.2.17 |
| B5707 | (I.S) | L.2.18 |
| B5708 | (I.S) | L.2.19 |
| B5709 | (I.S) | L.2.20 |
| B5710 | (I.S) | L.2.21 |
| B5711 | (I.S) | L.2.22 |
| B5712 | (I.S) | L.2.23 |
| B5713 | (I.S) | L.2.24 |
| B5714 | (I.S) | L.2.25 |
| B5715 | (I.S) | L.2.26 |
| B5716 | (I.S) | L.2.27 |
| B5717 | (I.S) | L.2.28 |
| B5718 | (I.S) | L.2.29 |
| B5719 | (I.S) | L.2.30 |
| B5720 | (I.S) | L.2.31 |
| B5721 | (I.S) | L.2.32 |
| B5722 | (I.S) | L.2.33 |
| B5723 | (I.S) | L.3.1 |
| B5724 | (I.S) | L.3.2 |
| B5725 | (I.S) | L.3.3 |
| B5726 | (I.S) | L.3.4 |
| B5727 | (I.S) | L.3.5 |
| B5728 | (I.S) | L.3.6 |
| B5729 | (I.S) | L.3.7 |
| B5730 | (I.S) | L.3.8 |
| B5731 | (I.S) | L.3.9 |
| B5732 | (I.S) | L.3.10 |
| B5733 | (I.S) | L.3.11 |
| B5734 | (I.S) | L.3.12 |
| B5735 | (I.S) | L.3.13 |
| B5736 | (I.S) | L.3.14 |
| B5737 | (I.S) | L.3.15 |
| B5738 | (I.S) | L.3.16 |
| B5739 | (I.S) | L.3.17 |
| B5740 | (I.S) | L.3.18 |
| B5741 | (I.S) | L.3.19 |
| B5742 | (I.S) | L.3.20 |
| B5743 | (I.S) | L.3.21 |
| B5744 | (I.S) | L.3.22 |
| B5745 | (I.S) | L.3.23 |
| B5746 | (I.S) | L.3.24 |
| B5747 | (I.S) | L.3.25 |
| B5748 | (I.S) | L.3.26 |
| B5749 | (I.S) | L.3.27 |
| B5750 | (I.S) | L.3.28 |
| B5751 | (I.S) | L.3.29 |
| B5752 | (I.S) | L.3.30 |
| B5753 | (I.S) | L.3.31 |
| B5754 | (I.S) | L.3.32 |
| B5755 | (I.S) | L.3.33 |
| B5756 | (I.S) | L.3.34 |
| B5757 | (I.S) | L.3.35 |
| B5758 | (I.S) | L.3.36 |
| B5759 | (I.S) | L.3.37 |
| B5760 | (I.S) | L.3.38 |
| B5761 | (I.S) | L.3.39 |
| B5762 | (I.S) | L.3.40 |
| B5763 | (I.S) | L.3.41 |
| B5764 | (I.S) | L.3.42 |
| B5765 | (I.S) | L.3.43 |
| B5766 | (I.S) | L.3.44 |
| B5767 | (I.S) | L.3.45 |
| B5768 | (I.S) | L.3.46 |
| B5769 | (I.S) | L.3.47 |
| B5770 | (I.S) | L.3.48 |
| B5771 | (I.S) | L.3.49 |
| B5772 | (I.S) | L.3.50 |
| B5773 | (I.S) | L.3.51 |
| B5774 | (I.S) | L.3.52 |
| B5775 | (I.S) | L.3.53 |
| B5776 | (I.S) | L.3.54 |
| B5777 | (I.S) | L.3.55 |
| B5778 | (I.S) | L.3.56 |
| B5779 | (I.S) | L.3.57 |
| B5780 | (I.S) | L.3.58 |
| B5781 | (I.S) | L.3.59 |
| B5782 | (I.S) | L.3.60 |
| B5783 | (I.S) | L.3.61 |
| B5784 | (I.S) | L.3.62 |
| B5785 | (I.S) | L.3.63 |
| B5786 | (I.S) | L.3.1 |
| B5787 | (I.S) | L.3.2 |
| B5788 | (I.S) | L.4.1 |
| B5789 | (I.S) | L.4.2 |
| B5790 | (I.S) | L.4.3 |
| B5791 | (I.S) | L.4.4 |
| B5792 | (I.S) | L.4.5 |
| B5793 | (I.S) | L.4.6 |
| B5794 | (I.S) | L.4.7 |
| B5795 | (I.S) | L.4.8 |
| B5796 | (I.S) | L.4.9 |
| B5797 | (I.S) | L.4.10 |
| B5798 | (I.S) | L.4.11 |
| B5799 | (I.S) | L.4.12 |
| B5800 | (I.S) | L.4.13 |
| B5801 | (I.S) | L.4.14 |
| B5802 | (I.S) | L.4.15 |
| B5803 | (I.S) | L.4.16 |
| B5804 | (I.S) | L.4.17 |
| B5805 | (I.S) | L.4.18 |
| B5806 | (I.S) | L.4.19 |
| B5807 | (I.S) | L.4.20 |
| B5808 | (I.S) | L.4.21 |
| B5809 | (I.S) | L.4.22 |
| B5810 | (I.S) | L.4.23 |
| B5811 | (I.S) | L.4.24 |
| B5812 | (I.S) | L.4.25 |
| B5813 | (I.S) | L.4.26 |
| B5814 | (I.S) | L.4.27 |
| B5815 | (I.S) | L.4.28 |
| B5816 | (I.S) | L.4.29 |
| B5817 | (I.S) | L.4.30 |
| B5818 | (I.S) | L.4.31 |
| B5819 | (I.S) | L.4.32 |
| B5820 | (I.S) | L.4.33 |
| B5821 | (I.S) | L.5.1 |
| B5822 | (I.S) | L.5.2 |
| B5823 | (I.S) | L.5.3 |
| B5824 | (I.S) | L.5.4 |
| B5825 | (I.S) | L.5.5 |
| B5826 | (I.S) | L.5.6 |
| B5827 | (I.S) | L.5.7 |
| B5828 | (I.S) | L.5.8 |
| B5829 | (I.S) | L.5.9 |
| B5830 | (I.S) | L.5.10 |
| B5831 | (I.S) | L.5.11 |
| B5832 | (I.S) | L.5.12 |
| B5833 | (I.S) | L.5.13 |
| B5834 | (I.S) | L.5.14 |
| B5835 | (I.S) | L.5.15 |
| B5836 | (I.S) | L.5.16 |
| B5837 | (I.S) | L.5.17 |
| B5838 | (I.S) | L.5.18 |
| B5839 | (I.S) | L.5.19 |
| B5840 | (I.S) | L.5.20 |
| B5841 | (I.S) | L.5.21 |
| B5842 | (I.S) | L.5.22 |
| B5843 | (I.S) | L.5.23 |
| B5844 | (I.S) | L.5.24 |
| B5845 | (I.S) | L.5.25 |
| B5846 | (I.S) | L.5.26 |
| B5847 | (I.S) | L.5.27 |
| B5848 | (I.S) | L.5.28 |
| B5849 | (I.S) | L.5.29 |
| B5850 | (I.S) | L.5.30 |
| B5851 | (I.S) | L.5.31 |
| B5852 | (I.S) | L.5.32 |
| B5853 | (I.S) | L.5.33 |
| B5854 | (I.S) | L.5.34 |
| B5855 | (I.S) | L.5.35 |
| B5856 | (I.S) | L.5.36 |
| B5857 | (I.S) | L.5.37 |
| B5858 | (I.S) | L.5.38 |
| B5859 | (I.S) | L.5.39 |
| B5860 | (I.S) | L.5.40 |
| B5861 | (I.S) | L.5.41 |
| B5862 | (I.S) | L.5.42 |
| B5863 | (I.S) | L.5.43 |
| B5864 | (I.S) | L.5.44 |
| B5865 | (I.S) | L.5.45 |
| B5866 | (I.S) | L.5.46 |
| B5867 | (I.S) | L.5.47 |
| B5868 | (I.S) | L.5.48 |
| B5869 | (I.S) | L.5.49 |
| B5870 | (I.S) | L.5.50 |
| B5871 | (I.S) | L.5.51 |
| B5872 | (I.S) | L.5.52 |
| B5873 | (I.S) | L.5.53 |
| B5874 | (I.S) | L.5.54 |
| B5875 | (I.S) | L.5.55 |
| B5876 | (I.S) | L.5.56 |
| B5877 | (I.S) | L.5.57 |
| B5878 | (I.S) | L.5.58 |
| B5879 | (I.S) | L.5.59 |
| B5880 | (I.S) | L.5.60 |
| B5881 | (I.S) | L.5.61 |
| B5882 | (I.S) | L.5.62 |
| B5883 | (I.S) | L.5.63 |
| B5884 | (I.S) | L.5.64 |
| B5885 | (I.S) | L.5.65 |
| B5886 | (I.S) | L.5.66 |
| B5887 | (I.S) | L.5.67 |
| B5888 | (I.S) | L.5.68 |
| B5889 | (I.S) | L.5.69 |
| B5890 | (I.S) | L.5.70 |
| B5891 | (I.S) | L.5.71 |
| B5892 | (I.S) | L.5.72 |
| B5893 | (I.S) | L.5.73 |
| B5894 | (I.S) | L.5.74 |
| B5895 | (I.S) | L.5.75 |
| B5896 | (I.S) | L.5.76 |
| B5897 | (I.S) | L.5.77 |
| B5898 | (I.S) | L.5.78 |
| B5899 | (I.S) | L.5.79 |
| B5900 | (I.S) | L.5.80 |
| B5901 | (I.S) | L.5.81 |
| B5902 | (I.S) | L.5.82 |
| B5903 | (I.S) | L.5.83 |
| B5904 | (I.S) | L.5.84 |
| B5905 | (I.S) | L.6.1 |
| B5906 | (I.S) | L.6.2 |
| B5907 | (I.S) | L.6.3 |
| B5908 | (I.S) | L.6.4 |
| B5909 | (I.S) | L.6.5 |
| B5910 | (I.S) | L.6.6 |
| B5911 | (I.S) | L.6.7 |
| B5912 | (I.S) | L.6.8 |
| B5913 | (I.S) | L.6.9 |
| B5914 | (I.S) | L.6.10 |
| B5915 | (I.S) | L.6.11 |
| B5916 | (I.S) | L.6.12 |
| B5917 | (I.S) | L.6.13 |
| B5918 | (I.S) | L.6.14 |
| B5919 | (I.S) | L.6.15 |
| B5920 | (I.S) | L.6.16 |
| B5921 | (I.S) | L.6.17 |
| B5922 | (I.S) | L.6.18 |

B = Mixture;
I = compound I;
II = compound II;

TABLE 68

| B | I | II |
|---|---|---|
| B5923 | (I.T) | L.1.1 |
| B5924 | (I.T) | L.1.2 |
| B5925 | (I.T) | L.1.3 |
| B5926 | (I.T) | L.1.4 |
| B5927 | (I.T) | L.1.5 |
| B5928 | (I.T) | L.1.6 |
| B5929 | (I.T) | L.1.7 |
| B5930 | (I.T) | L.1.8 |
| B5931 | (I.T) | L.1.9 |
| B5932 | (I.T) | L.1.10 |
| B5933 | (I.T) | L.1.11 |
| B5934 | (I.T) | L.1.12 |
| B5935 | (I.T) | L.1.13 |
| B5936 | (I.T) | L.1.14 |
| B5937 | (I.T) | L.1.15 |
| B5938 | (I.T) | L.1.16 |
| B5939 | (I.T) | L.1.17 |
| B5940 | (I.T) | L.1.18 |
| B5941 | (I.T) | L.1.19 |
| B5942 | (I.T) | L.1.20 |
| B5943 | (I.T) | L.1.21 |
| B5944 | (I.T) | L.1.22 |
| B5945 | (I.T) | L.1.23 |
| B5946 | (I.T) | L.1.24 |
| B5947 | (I.T) | L.1.25 |
| B5948 | (I.T) | L.1.26 |
| B5949 | (I.T) | L.1.27 |
| B5950 | (I.T) | L.1.28 |
| B5951 | (I.T) | L.1.29 |
| B5952 | (I.T) | L.1.30 |
| B5953 | (I.T) | L.1.31 |
| B5954 | (I.T) | L.1.32 |
| B5955 | (I.T) | L.1.33 |
| B5956 | (I.T) | L.1.34 |
| B5957 | (I.T) | L.1.35 |
| B5958 | (I.T) | L.1.36 |
| B5959 | (I.T) | L.1.37 |
| B5960 | (I.T) | L.1.38 |
| B5961 | (I.T) | L.1.39 |
| B5962 | (I.T) | L.1.40 |
| B5963 | (I.T) | L.1.41 |
| B5964 | (I.T) | L.1.42 |
| B5965 | (I.T) | L.1.43 |
| B5966 | (I.T) | L.1.44 |
| B5967 | (I.T) | L.1.45 |
| B5968 | (I.T) | L.1.46 |
| B5969 | (I.T) | L.1.47 |
| B5970 | (I.T) | L.1.48 |
| B5971 | (I.T) | L.1.49 |
| B5972 | (I.T) | L.1.50 |
| B5973 | (I.T) | L.1.51 |
| B5974 | (I.T) | L.1.52 |
| B5975 | (I.T) | L.1.53 |
| B5976 | (I.T) | L.1.54 |
| B5977 | (I.T) | L.1.55 |
| B5978 | (I.T) | L.1.56 |
| B5979 | (I.T) | L.1.57 |
| B5980 | (I.T) | L.1.58 |
| B5981 | (I.T) | L.1.59 |
| B5982 | (I.T) | L.1.60 |
| B5983 | (I.T) | L.1.61 |
| B5984 | (I.T) | L.1.62 |
| B5985 | (I.T) | L.1.63 |
| B5986 | (I.T) | L.1.64 |
| B5987 | (I.T) | L.1.65 |
| B5988 | (I.T) | L.1.66 |
| B5989 | (I.T) | L.1.67 |
| B5990 | (I.T) | L.1.68 |
| B5991 | (I.T) | L.1.69 |
| B5992 | (I.T) | L.1.70 |
| B5993 | (I.T) | L.1.71 |
| B5994 | (I.T) | L.1.72 |
| B5995 | (I.T) | L.1.73 |
| B5996 | (I.T) | L.1.74 |
| B5997 | (I.T) | L.1.75 |
| B5998 | (I.T) | L.1.76 |
| B5999 | (I.T) | L.1.77 |
| B6000 | (I.T) | L.1.78 |
| B6001 | (I.T) | L.1.79 |
| B6002 | (I.T) | L.1.80 |
| B6003 | (I.T) | L.1.81 |
| B6004 | (I.T) | L.1.82 |
| B6005 | (I.T) | L.1.83 |
| B6006 | (I.T) | L.1.84 |
| B6007 | (I.T) | L.1.85 |
| B6008 | (I.T) | L.1.86 |
| B6009 | (I.T) | L.1.87 |
| B6010 | (I.T) | L.1.88 |
| B6011 | (I.T) | L.1.89 |
| B6012 | (I.T) | L.1.90 |
| B6013 | (I.T) | L.1.91 |
| B6014 | (I.T) | L.1.92 |
| B6015 | (I.T) | L.1.93 |
| B6016 | (I.T) | L.1.94 |
| B6017 | (I.T) | L.1.95 |
| B6018 | (I.T) | L.1.96 |
| B6019 | (I.T) | L.2.1 |
| B6020 | (I.T) | L.2.2 |
| B6021 | (I.T) | L.2.3 |
| B6022 | (I.T) | L.2.4 |
| B6023 | (I.T) | L.2.5 |
| B6024 | (I.T) | L.2.6 |
| B6025 | (I.T) | L.2.7 |
| B6026 | (I.T) | L.2.8 |
| B6027 | (I.T) | L.2.9 |
| B6028 | (I.T) | L.2.10 |
| B6029 | (I.T) | L.2.11 |
| B6030 | (I.T) | L.2.12 |
| B6031 | (I.T) | L.2.13 |
| B6032 | (I.T) | L.2.14 |
| B6033 | (I.T) | L.2.15 |
| B6034 | (I.T) | L.2.16 |
| B6035 | (I.T) | L.2.17 |
| B6036 | (I.T) | L.2.18 |
| B6037 | (I.T) | L.2.19 |
| B6038 | (I.T) | L.2.20 |
| B6039 | (I.T) | L.2.21 |
| B6040 | (I.T) | L.2.22 |
| B6041 | (I.T) | L.2.23 |
| B6042 | (I.T) | L.2.24 |
| B6043 | (I.T) | L.2.25 |
| B6044 | (I.T) | L.2.26 |
| B6045 | (I.T) | L.2.27 |
| B6046 | (I.T) | L.2.28 |
| B6047 | (I.T) | L.2.29 |
| B6048 | (I.T) | L.2.30 |
| B6049 | (I.T) | L.2.31 |
| B6050 | (I.T) | L.2.32 |
| B6051 | (I.T) | L.2.33 |
| B6052 | (I.T) | L.3.1 |
| B6053 | (I.T) | L.3.2 |
| B6054 | (I.T) | L.3.3 |
| B6055 | (I.T) | L.3.4 |
| B6056 | (I.T) | L.3.5 |
| B6057 | (I.T) | L.3.6 |
| B6058 | (I.T) | L.3.7 |
| B6059 | (I.T) | L.3.8 |
| B6060 | (I.T) | L.3.9 |
| B6061 | (I.T) | L.3.10 |
| B6062 | (I.T) | L.3.11 |
| B6063 | (I.T) | L.3.12 |
| B6064 | (I.T) | L.3.13 |
| B6065 | (I.T) | L.3.14 |
| B6066 | (I.T) | L.3.15 |
| B6067 | (I.T) | L.3.16 |
| B6068 | (I.T) | L.3.17 |
| B6069 | (I.T) | L.3.18 |
| B6070 | (I.T) | L.3.19 |
| B6071 | (I.T) | L.3.20 |
| B6072 | (I.T) | L.3.21 |
| B6073 | (I.T) | L.3.22 |
| B6074 | (I.T) | L.3.23 |
| B6075 | (I.T) | L.3.24 |
| B6076 | (I.T) | L.3.25 |
| B6077 | (I.T) | L.3.26 |
| B6078 | (I.T) | L.3.27 |
| B6079 | (I.T) | L.3.28 |
| B6080 | (I.T) | L.3.29 |
| B6081 | (I.T) | L.3.30 |
| B6082 | (I.T) | L.3.31 |
| B6083 | (I.T) | L.3.32 |
| B6084 | (I.T) | L.3.33 |
| B6085 | (I.T) | L.3.34 |
| B6086 | (I.T) | L.3.35 |
| B6087 | (I.T) | L.3.36 |
| B6088 | (I.T) | L.3.37 |
| B6089 | (I.T) | L.3.38 |
| B6090 | (I.T) | L.3.39 |
| B6091 | (I.T) | L.3.40 |
| B6092 | (I.T) | L.3.41 |
| B6093 | (I.T) | L.3.42 |
| B6094 | (I.T) | L.3.43 |
| B6095 | (I.T) | L.3.44 |
| B6096 | (I.T) | L.3.45 |
| B6097 | (I.T) | L.3.46 |
| B6098 | (I.T) | L.3.47 |
| B6099 | (I.T) | L.3.48 |
| B6100 | (I.T) | L.3.49 |
| B6101 | (I.T) | L.3.50 |
| B6102 | (I.T) | L.3.51 |
| B6103 | (I.T) | L.3.52 |
| B6104 | (I.T) | L.3.53 |
| B6105 | (I.T) | L.3.54 |
| B6106 | (I.T) | L.3.55 |
| B6107 | (I.T) | L.3.56 |
| B6108 | (I.T) | L.3.57 |
| B6109 | (I.T) | L.3.58 |
| B6110 | (I.T) | L.3.59 |
| B6111 | (I.T) | L.3.60 |
| B6112 | (I.T) | L.3.61 |
| B6113 | (I.T) | L.3.62 |
| B6114 | (I.T) | L.3.63 |
| B6115 | (I.T) | L.3.1 |
| B6116 | (I.T) | L.3.2 |
| B6117 | (I.T) | L.4.1 |
| B6118 | (I.T) | L.4.2 |
| B6119 | (I.T) | L.4.3 |
| B6120 | (I.T) | L.4.4 |
| B6121 | (I.T) | L.4.5 |
| B6122 | (I.T) | L.4.6 |
| B6123 | (I.T) | L.4.7 |
| B6124 | (I.T) | L.4.8 |
| B6125 | (I.T) | L.4.9 |
| B6126 | (I.T) | L.4.10 |
| B6127 | (I.T) | L.4.11 |
| B6128 | (I.T) | L.4.12 |
| B6129 | (I.T) | L.4.13 |
| B6130 | (I.T) | L.4.14 |
| B6131 | (I.T) | L.4.15 |
| B6132 | (I.T) | L.4.16 |
| B6133 | (I.T) | L.4.17 |
| B6134 | (I.T) | L.4.18 |
| B6135 | (I.T) | L.4.19 |
| B6136 | (I.T) | L.4.20 |
| B6137 | (I.T) | L.4.21 |
| B6138 | (I.T) | L.4.22 |
| B6139 | (I.T) | L.4.23 |
| B6140 | (I.T) | L.4.24 |
| B6141 | (I.T) | L.4.25 |
| B6142 | (I.T) | L.4.26 |
| B6143 | (I.T) | L.4.27 |
| B6144 | (I.T) | L.4.28 |
| B6145 | (I.T) | L.4.29 |
| B6146 | (I.T) | L.4.30 |
| B6147 | (I.T) | L.4.31 |
| B6148 | (I.T) | L.4.32 |
| B6149 | (I.T) | L.4.33 |
| B6150 | (I.T) | L.5.1 |
| B6151 | (I.T) | L.5.2 |
| B6152 | (I.T) | L.5.3 |
| B6153 | (I.T) | L.5.4 |
| B6154 | (I.T) | L.5.5 |
| B6155 | (I.T) | L.5.6 |
| B6156 | (I.T) | L.5.7 |
| B6157 | (I.T) | L.5.8 |
| B6158 | (I.T) | L.5.9 |
| B6159 | (I.T) | L.5.10 |
| B6160 | (I.T) | L.5.11 |
| B6161 | (I.T) | L.5.12 |
| B6162 | (I.T) | L.5.13 |
| B6163 | (I.T) | L.5.14 |
| B6164 | (I.T) | L.5.15 |
| B6165 | (I.T) | L.5.16 |
| B6166 | (I.T) | L.5.17 |
| B6167 | (I.T) | L.5.18 |
| B6168 | (I.T) | L.5.19 |
| B6169 | (I.T) | L.5.20 |
| B6170 | (I.T) | L.5.21 |
| B6171 | (I.T) | L.5.22 |
| B6172 | (I.T) | L.5.23 |
| B6173 | (I.T) | L.5.24 |
| B6174 | (I.T) | L.5.25 |
| B6175 | (I.T) | L.5.26 |
| B6176 | (I.T) | L.5.27 |
| B6177 | (I.T) | L.5.28 |
| B6178 | (I.T) | L.5.29 |
| B6179 | (I.T) | L.5.30 |
| B6180 | (I.T) | L.5.31 |
| B6181 | (I.T) | L.5.32 |
| B6182 | (I.T) | L.5.33 |
| B6183 | (I.T) | L.5.34 |
| B6184 | (I.T) | L.5.35 |
| B6185 | (I.T) | L.5.36 |
| B6186 | (I.T) | L.5.37 |
| B6187 | (I.T) | L.5.38 |
| B6188 | (I.T) | L.5.39 |
| B6189 | (I.T) | L.5.40 |
| B6190 | (I.T) | L.5.41 |
| B6191 | (I.T) | L.5.42 |
| B6192 | (I.T) | L.5.43 |
| B6193 | (I.T) | L.5.44 |
| B6194 | (I.T) | L.5.45 |
| B6195 | (I.T) | L.5.46 |
| B6196 | (I.T) | L.5.47 |
| B6197 | (I.T) | L.5.48 |
| B6198 | (I.T) | L.5.49 |
| B6199 | (I.T) | L.5.50 |
| B6200 | (I.T) | L.5.51 |
| B6201 | (I.T) | L.5.52 |
| B6202 | (I.T) | L.5.53 |
| B6203 | (I.T) | L.5.54 |
| B6204 | (I.T) | L.5.55 |
| B6205 | (I.T) | L.5.56 |
| B6206 | (I.T) | L.5.57 |
| B6207 | (I.T) | L.5.58 |
| B6208 | (I.T) | L.5.59 |
| B6209 | (I.T) | L.5.60 |
| B6210 | (I.T) | L.5.61 |
| B6211 | (I.T) | L.5.62 |
| B6212 | (I.T) | L.5.63 |
| B6213 | (I.T) | L.5.64 |
| B6214 | (I.T) | L.5.65 |
| B6215 | (I.T) | L.5.66 |
| B6216 | (I.T) | L.5.67 |
| B6217 | (I.T) | L.5.68 |
| B6218 | (I.T) | L.5.69 |
| B6219 | (I.T) | L.5.70 |
| B6220 | (I.T) | L.5.71 |
| B6221 | (I.T) | L.5.72 |
| B6222 | (I.T) | L.5.73 |
| B6223 | (I.T) | L.5.74 |
| B6224 | (I.T) | L.5.75 |
| B6225 | (I.T) | L.5.76 |
| B6226 | (I.T) | L.5.77 |
| B6227 | (I.T) | L.5.78 |
| B6228 | (I.T) | L.5.79 |
| B6229 | (I.T) | L.5.80 |
| B6230 | (I.T) | L.5.81 |
| B6231 | (I.T) | L.5.82 |
| B6232 | (I.T) | L.5.83 |
| B6233 | (I.T) | L.5.84 |
| B6234 | (I.T) | L.6.1 |
| B6235 | (I.T) | L.6.2 |
| B6236 | (I.T) | L.6.3 |
| B6237 | (I.T) | L.6.4 |
| B6238 | (I.T) | L.6.5 |
| B6239 | (I.T) | L.6.6 |
| B6240 | (I.T) | L.6.7 |
| B6241 | (I.T) | L.6.8 |
| B6242 | (I.T) | L.6.9 |
| B6243 | (I.T) | L.6.10 |
| B6244 | (I.T) | L.6.11 |
| B6245 | (I.T) | L.6.12 |
| B6246 | (I.T) | L.6.13 |
| B6247 | (I.T) | L.6.14 |
| B6248 | (I.T) | L.6.15 |
| B6249 | (I.T) | L.6.16 |
| B6251 | (I.T) | L.6.18 |
| B6250 | (I.T) | L.6.17 |

B = Mixture;
I = compound I;
II = compound II;

TABLE 69

| B | I | II |
|---|---|---|
| B6252 | (I.U) | L.1.1 |
| B6253 | (I.U) | L.1.2 |
| B6254 | (I.U) | L.1.3 |
| B6255 | (I.U) | L.1.4 |
| B6256 | (I.U) | L.1.5 |
| B6257 | (I.U) | L.1.6 |
| B6258 | (I.U) | L.1.7 |
| B6259 | (I.U) | L.1.8 |
| B6260 | (I.U) | L.1.9 |
| B6261 | (I.U) | L.1.10 |
| B6262 | (I.U) | L.1.11 |
| B6263 | (I.U) | L.1.12 |
| B6264 | (I.U) | L.1.13 |
| B6265 | (I.U) | L.1.14 |
| B6266 | (I.U) | L.1.15 |
| B6267 | (I.U) | L.1.16 |
| B6268 | (I.U) | L.1.17 |
| B6269 | (I.U) | L.1.18 |
| B6270 | (I.U) | L.1.19 |
| B6271 | (I.U) | L.1.20 |
| B6272 | (I.U) | L.1.21 |
| B6273 | (I.U) | L.1.22 |
| B6274 | (I.U) | L.1.23 |
| B6275 | (I.U) | L.1.24 |
| B6276 | (I.U) | L.1.25 |
| B6277 | (I.U) | L.1.26 |
| B6278 | (I.U) | L.1.27 |
| B6279 | (I.U) | L.1.28 |
| B6280 | (I.U) | L.1.29 |
| B6281 | (I.U) | L.1.30 |
| B6282 | (I.U) | L.1.31 |
| B6283 | (I.U) | L.1.32 |
| B6284 | (I.U) | L.1.33 |
| B6285 | (I.U) | L.1.34 |
| B6286 | (I.U) | L.1.35 |
| B6287 | (I.U) | L.1.36 |
| B6288 | (I.U) | L.1.37 |
| B6289 | (I.U) | L.1.38 |
| B6290 | (I.U) | L.1.39 |
| B6291 | (I.U) | L.1.40 |
| B6292 | (I.U) | L.1.41 |
| B6293 | (I.U) | L.1.42 |
| B6294 | (I.U) | L.1.43 |
| B6295 | (I.U) | L.1.44 |
| B6296 | (I.U) | L.1.45 |
| B6297 | (I.U) | L.1.46 |
| B6298 | (I.U) | L.1.47 |
| B6299 | (I.U) | L.1.48 |
| B6300 | (I.U) | L.1.49 |
| B6301 | (I.U) | L.1.50 |
| B6302 | (I.U) | L.1.51 |
| B6303 | (I.U) | L.1.52 |
| B6304 | (I.U) | L.1.53 |
| B6305 | (I.U) | L.1.54 |
| B6306 | (I.U) | L.1.55 |
| B6307 | (I.U) | L.1.56 |
| B6308 | (I.U) | L.1.57 |
| B6309 | (I.U) | L.1.58 |
| B6310 | (I.U) | L.1.59 |
| B6311 | (I.U) | L.1.60 |
| B6312 | (I.U) | L.1.61 |
| B6313 | (I.U) | L.1.62 |
| B6314 | (I.U) | L.1.63 |
| B6315 | (I.U) | L.1.64 |
| B6316 | (I.U) | L.1.65 |
| B6317 | (I.U) | L.1.66 |
| B6318 | (I.U) | L.1.67 |
| B6319 | (I.U) | L.1.68 |
| B6320 | (I.U) | L.1.69 |
| B6321 | (I.U) | L.1.70 |
| B6322 | (I.U) | L.1.71 |
| B6323 | (I.U) | L.1.72 |
| B6324 | (I.U) | L.1.73 |
| B6325 | (I.U) | L.1.74 |
| B6326 | (I.U) | L.1.75 |
| B6327 | (I.U) | L.1.76 |
| B6328 | (I.U) | L.1.77 |
| B6329 | (I.U) | L.1.78 |
| B6330 | (I.U) | L.1.79 |
| B6331 | (I.U) | L.1.80 |
| B6332 | (I.U) | L.1.81 |
| B6333 | (I.U) | L.1.82 |
| B6334 | (I.U) | L.1.83 |
| B6335 | (I.U) | L.1.84 |
| B6336 | (I.U) | L.1.85 |
| B6337 | (I.U) | L.1.86 |
| B6338 | (I.U) | L.1.87 |
| B6339 | (I.U) | L.1.88 |
| B6340 | (I.U) | L.1.89 |
| B6341 | (I.U) | L.1.90 |
| B6342 | (I.U) | L.1.91 |
| B6343 | (I.U) | L.1.92 |
| B6344 | (I.U) | L.1.93 |
| B6345 | (I.U) | L.1.94 |
| B6346 | (I.U) | L.1.95 |
| B6347 | (I.U) | L.1.96 |
| B6348 | (I.U) | L.2.1 |
| B6349 | (I.U) | L.2.2 |
| B6350 | (I.U) | L.2.3 |
| B6351 | (I.U) | L.2.4 |
| B6352 | (I.U) | L.2.5 |
| B6353 | (I.U) | L.2.6 |
| B6354 | (I.U) | L.2.7 |
| B6355 | (I.U) | L.2.8 |
| B6356 | (I.U) | L.2.9 |
| B6357 | (I.U) | L.2.10 |
| B6358 | (I.U) | L.2.11 |
| B6359 | (I.U) | L.2.12 |
| B6360 | (I.U) | L.2.13 |
| B6361 | (I.U) | L.2.14 |
| B6362 | (I.U) | L.2.15 |
| B6363 | (I.U) | L.2.16 |
| B6364 | (I.U) | L.2.17 |
| B6365 | (I.U) | L.2.18 |
| B6366 | (I.U) | L.2.19 |
| B6367 | (I.U) | L.2.20 |
| B6368 | (I.U) | L.2.21 |
| B6369 | (I.U) | L.2.22 |
| B6370 | (I.U) | L.2.23 |
| B6371 | (I.U) | L.2.24 |
| B6372 | (I.U) | L.2.25 |
| B6373 | (I.U) | L.2.26 |
| B6374 | (I.U) | L.2.27 |
| B6375 | (I.U) | L.2.28 |
| B6376 | (I.U) | L.2.29 |
| B6377 | (I.U) | L.2.30 |
| B6378 | (I.U) | L.2.31 |
| B6379 | (I.U) | L.2.32 |
| B6380 | (I.U) | L.2.33 |
| B6381 | (I.U) | L.3.1 |
| B6382 | (I.U) | L.3.2 |
| B6383 | (I.U) | L.3.3 |
| B6384 | (I.U) | L.3.4 |
| B6385 | (I.U) | L.3.5 |
| B6386 | (I.U) | L.3.6 |
| B6387 | (I.U) | L.3.7 |
| B6388 | (I.U) | L.3.8 |
| B6389 | (I.U) | L.3.9 |
| B6390 | (I.U) | L.3.10 |
| B6391 | (I.U) | L.3.11 |
| B6392 | (I.U) | L.3.12 |
| B6393 | (I.U) | L.3.13 |
| B6394 | (I.U) | L.3.14 |
| B6395 | (I.U) | L.3.15 |
| B6396 | (I.U) | L.3.16 |
| B6397 | (I.U) | L.3.17 |
| B6398 | (I.U) | L.3.18 |
| B6399 | (I.U) | L.3.19 |
| B6400 | (I.U) | L.3.20 |
| B6401 | (I.U) | L.3.21 |
| B6402 | (I.U) | L.3.22 |
| B6403 | (I.U) | L.3.23 |
| B6404 | (I.U) | L.3.24 |
| B6405 | (I.U) | L.3.25 |
| B6406 | (I.U) | L.3.26 |
| B6407 | (I.U) | L.3.27 |
| B6408 | (I.U) | L.3.28 |
| B6409 | (I.U) | L.3.29 |
| B6410 | (I.U) | L.3.30 |
| B6411 | (I.U) | L.3.31 |
| B6412 | (I.U) | L.3.32 |
| B6413 | (I.U) | L.3.33 |
| B6414 | (I.U) | L.3.34 |
| B6415 | (I.U) | L.3.35 |
| B6416 | (I.U) | L.3.36 |
| B6417 | (I.U) | L.3.37 |
| B6418 | (I.U) | L.3.38 |
| B6419 | (I.U) | L.3.39 |
| B6420 | (I.U) | L.3.40 |
| B6421 | (I.U) | L.3.41 |
| B6422 | (I.U) | L.3.42 |
| B6423 | (I.U) | L.3.43 |
| B6424 | (I.U) | L.3.44 |
| B6425 | (I.U) | L.3.45 |
| B6426 | (I.U) | L.3.46 |
| B6427 | (I.U) | L.3.47 |
| B6428 | (I.U) | L.3.48 |
| B6429 | (I.U) | L.3.49 |
| B6430 | (I.U) | L.3.50 |
| B6431 | (I.U) | L.3.51 |
| B6432 | (I.U) | L.3.52 |
| B6433 | (I.U) | L.3.53 |
| B6434 | (I.U) | L.3.54 |
| B6435 | (I.U) | L.3.55 |
| B6436 | (I.U) | L.3.56 |
| B6437 | (I.U) | L.3.57 |
| B6438 | (I.U) | L.3.58 |
| B6439 | (I.U) | L.3.59 |
| B6440 | (I.U) | L.3.60 |
| B6441 | (I.U) | L.3.61 |
| B6442 | (I.U) | L.3.62 |
| B6443 | (I.U) | L.3.63 |
| B6444 | (I.U) | L.3.1 |
| B6445 | (I.U) | L.3.2 |
| B6446 | (I.U) | L.4.1 |
| B6447 | (I.U) | L.4.2 |
| B6448 | (I.U) | L.4.3 |
| B6449 | (I.U) | L.4.4 |
| B6450 | (I.U) | L.4.5 |
| B6451 | (I.U) | L.4.6 |
| B6452 | (I.U) | L.4.7 |
| B6453 | (I.U) | L.4.8 |
| B6454 | (I.U) | L.4.9 |
| B6455 | (I.U) | L.4.10 |
| B6456 | (I.U) | L.4.11 |
| B6457 | (I.U) | L.4.12 |
| B6458 | (I.U) | L.4.13 |
| B6459 | (I.U) | L.4.14 |
| B6460 | (I.U) | L.4.15 |
| B6461 | (I.U) | L.4.16 |
| B6462 | (I.U) | L.4.17 |
| B6463 | (I.U) | L.4.18 |
| B6464 | (I.U) | L.4.19 |
| B6465 | (I.U) | L.4.20 |
| B6466 | (I.U) | L.4.21 |
| B6467 | (I.U) | L.4.22 |
| B6468 | (I.U) | L.4.23 |
| B6469 | (I.U) | L.4.24 |
| B6470 | (I.U) | L.4.25 |
| B6471 | (I.U) | L.4.26 |
| B6472 | (I.U) | L.4.27 |
| B6473 | (I.U) | L.4.28 |
| B6474 | (I.U) | L.4.29 |
| B6475 | (I.U) | L.4.30 |
| B6476 | (I.U) | L.4.31 |
| B6477 | (I.U) | L.4.32 |
| B6478 | (I.U) | L.4.33 |
| B6479 | (I.U) | L.5.1 |
| B6480 | (I.U) | L.5.2 |
| B6481 | (I.U) | L.5.3 |
| B6482 | (I.U) | L.5.4 |
| B6483 | (I.U) | L.5.5 |
| B6484 | (I.U) | L.5.6 |
| B6485 | (I.U) | L.5.7 |
| B6486 | (I.U) | L.5.8 |
| B6487 | (I.U) | L.5.9 |
| B6488 | (I.U) | L.5.10 |
| B6489 | (I.U) | L.5.11 |
| B6490 | (I.U) | L.5.12 |
| B6491 | (I.U) | L.5.13 |
| B6492 | (I.U) | L.5.14 |
| B6493 | (I.U) | L.5.15 |
| B6494 | (I.U) | L.5.16 |
| B6495 | (I.U) | L.5.17 |
| B6496 | (I.U) | L.5.18 |
| B6497 | (I.U) | L.5.19 |
| B6498 | (I.U) | L.5.20 |
| B6499 | (I.U) | L.5.21 |
| B6500 | (I.U) | L.5.22 |
| B6501 | (I.U) | L.5.23 |
| B6502 | (I.U) | L.5.24 |
| B6503 | (I.U) | L.5.25 |
| B6504 | (I.U) | L.5.26 |
| B6505 | (I.U) | L.5.27 |
| B6506 | (I.U) | L.5.28 |
| B6507 | (I.U) | L.5.29 |
| B6508 | (I.U) | L.5.30 |
| B6509 | (I.U) | L.5.31 |
| B6510 | (I.U) | L.5.32 |
| B6511 | (I.U) | L.5.33 |
| B6512 | (I.U) | L.5.34 |
| B6513 | (I.U) | L.5.35 |
| B6514 | (I.U) | L.5.36 |
| B6515 | (I.U) | L.5.37 |
| B6516 | (I.U) | L.5.38 |
| B6517 | (I.U) | L.5.39 |
| B6518 | (I.U) | L.5.40 |
| B6519 | (I.U) | L.5.41 |
| B6520 | (I.U) | L.5.42 |
| B6521 | (I.U) | L.5.43 |
| B6522 | (I.U) | L.5.44 |
| B6523 | (I.U) | L.5.45 |
| B6524 | (I.U) | L.5.46 |
| B6525 | (I.U) | L.5.47 |
| B6526 | (I.U) | L.5.48 |
| B6527 | (I.U) | L.5.49 |
| B6528 | (I.U) | L.5.50 |
| B6529 | (I.U) | L.5.51 |
| B6530 | (I.U) | L.5.52 |
| B6531 | (I.U) | L.5.53 |
| B6532 | (I.U) | L.5.54 |
| B6533 | (I.U) | L.5.55 |
| B6534 | (I.U) | L.5.56 |
| B6535 | (I.U) | L.5.57 |
| B6536 | (I.U) | L.5.58 |
| B6537 | (I.U) | L.5.59 |
| B6538 | (I.U) | L.5.60 |
| B6539 | (I.U) | L.5.61 |
| B6540 | (I.U) | L.5.62 |
| B6541 | (I.U) | L.5.63 |
| B6542 | (I.U) | L.5.64 |
| B6543 | (I.U) | L.5.65 |
| B6544 | (I.U) | L.5.66 |
| B6545 | (I.U) | L.5.67 |
| B6546 | (I.U) | L.5.68 |
| B6547 | (I.U) | L.5.69 |
| B6548 | (I.U) | L.5.70 |
| B6549 | (I.U) | L.5.71 |
| B6550 | (I.U) | L.5.72 |
| B6551 | (I.U) | L.5.73 |
| B6552 | (I.U) | L.5.74 |
| B6553 | (I.U) | L.5.75 |
| B6554 | (I.U) | L.5.76 |
| B6555 | (I.U) | L.5.77 |
| B6556 | (I.U) | L.5.78 |
| B6557 | (I.U) | L.5.79 |
| B6558 | (I.U) | L.5.80 |
| B6559 | (I.U) | L.5.81 |
| B6560 | (I.U) | L.5.82 |
| B6561 | (I.U) | L.5.83 |
| B6562 | (I.U) | L.5.84 |
| B6563 | (I.U) | L.6.1 |
| B6564 | (I.U) | L.6.2 |
| B6565 | (I.U) | L.6.3 |
| B6566 | (I.U) | L.6.4 |
| B6567 | (I.U) | L.6.5 |
| B6568 | (I.U) | L.6.6 |
| B6569 | (I.U) | L.6.7 |
| B6570 | (I.U) | L.6.8 |
| B6571 | (I.U) | L.6.9 |
| B6572 | (I.U) | L.6.10 |
| B6573 | (I.U) | L.6.11 |
| B6574 | (I.U) | L.6.12 |
| B6575 | (I.U) | L.6.13 |
| B6576 | (I.U) | L.6.14 |
| B6577 | (I.U) | L.6.15 |
| B6578 | (I.U) | L.6.16 |
| B6579 | (I.U) | L.6.17 |
| B6580 | (I.U) | L.6.18 |

B = Mixture;
I = compound I;
II = compound II

TABLE 70

| B | I | II |
|---|---|---|
| B6581 | (I.V) | L.1.1 |
| B6582 | (I.V) | L.1.2 |
| B6583 | (I.V) | L.1.3 |
| B6584 | (I.V) | L.1.4 |
| B6585 | (I.V) | L.1.5 |
| B6586 | (I.V) | L.1.6 |
| B6587 | (I.V) | L.1.7 |
| B6588 | (I.V) | L.1.8 |
| B6589 | (I.V) | L.1.9 |
| B6590 | (I.V) | L.1.10 |
| B6591 | (I.V) | L.1.11 |
| B6592 | (I.V) | L.1.12 |
| B6593 | (I.V) | L.1.13 |
| B6594 | (I.V) | L.1.14 |
| B6595 | (I.V) | L.1.15 |
| B6596 | (I.V) | L.1.16 |
| B6597 | (I.V) | L.1.17 |
| B6598 | (I.V) | L.1.18 |
| B6599 | (I.V) | L.1.19 |
| B6600 | (I.V) | L.1.20 |
| B6601 | (I.V) | L.1.21 |
| B6602 | (I.V) | L.1.22 |
| B6603 | (I.V) | L.1.23 |
| B6604 | (I.V) | L.1.24 |
| B6605 | (I.V) | L.1.25 |
| B6606 | (I.V) | L.1.26 |
| B6607 | (I.V) | L.1.27 |
| B6608 | (I.V) | L.1.28 |
| B6609 | (I.V) | L.1.29 |
| B6610 | (I.V) | L.1.30 |
| B6611 | (I.V) | L.1.31 |
| B6612 | (I.V) | L.1.32 |
| B6613 | (I.V) | L.1.33 |
| B6614 | (I.V) | L.1.34 |
| B6615 | (I.V) | L.1.35 |
| B6616 | (I.V) | L.1.36 |
| B6617 | (I.V) | L.1.37 |
| B6618 | (I.V) | L.1.38 |
| B6619 | (I.V) | L.1.39 |
| B6620 | (I.V) | L.1.40 |
| B6621 | (I.V) | L.1.41 |
| B6622 | (I.V) | L.1.42 |
| B6623 | (I.V) | L.1.43 |
| B6624 | (I.V) | L.1.44 |
| B6625 | (I.V) | L.1.45 |
| B6626 | (I.V) | L.1.46 |
| B6627 | (I.V) | L.1.47 |
| B6628 | (I.V) | L.1.48 |
| B6629 | (I.V) | L.1.49 |
| B6630 | (I.V) | L.1.50 |
| B6631 | (I.V) | L.1.51 |
| B6632 | (I.V) | L.1.52 |
| B6633 | (I.V) | L.1.53 |
| B6634 | (I.V) | L.1.54 |
| B6635 | (I.V) | L.1.55 |
| B6636 | (I.V) | L.1.56 |
| B6637 | (I.V) | L.1.57 |
| B6638 | (I.V) | L.1.58 |
| B6639 | (I.V) | L.1.59 |
| B6640 | (I.V) | L.1.60 |
| B6641 | (I.V) | L.1.61 |
| B6642 | (I.V) | L.1.62 |
| B6643 | (I.V) | L.1.63 |
| B6644 | (I.V) | L.1.64 |
| B6645 | (I.V) | L.1.65 |
| B6646 | (I.V) | L.1.66 |
| B6647 | (I.V) | L.1.67 |
| B6648 | (I.V) | L.1.68 |
| B6649 | (I.V) | L.1.69 |
| B6650 | (I.V) | L.1.70 |
| B6651 | (I.V) | L.1.71 |
| B6652 | (I.V) | L.1.72 |
| B6653 | (I.V) | L.1.73 |
| B6654 | (I.V) | L.1.74 |
| B6655 | (I.V) | L.1.75 |
| B6656 | (I.V) | L.1.76 |
| B6657 | (I.V) | L.1.77 |
| B6658 | (I.V) | L.1.78 |
| B6659 | (I.V) | L.1.79 |
| B6660 | (I.V) | L.1.80 |
| B6661 | (I.V) | L.1.81 |
| B6662 | (I.V) | L.1.82 |
| B6663 | (I.V) | L.1.83 |
| B6664 | (I.V) | L.1.84 |
| B6665 | (I.V) | L.1.85 |
| B6666 | (I.V) | L.1.86 |
| B6667 | (I.V) | L.1.87 |
| B6668 | (I.V) | L.1.88 |
| B6669 | (I.V) | L.1.89 |
| B6670 | (I.V) | L.1.90 |
| B6671 | (I.V) | L.1.91 |
| B6672 | (I.V) | L.1.92 |
| B6673 | (I.V) | L.1.93 |
| B6674 | (I.V) | L.1.94 |
| B6675 | (I.V) | L.1.95 |
| B6676 | (I.V) | L.1.96 |
| B6677 | (I.V) | L.2.1 |
| B6678 | (I.V) | L.2.2 |
| B6679 | (I.V) | L.2.3 |
| B6680 | (I.V) | L.2.4 |
| B6681 | (I.V) | L.2.5 |
| B6682 | (I.V) | L.2.6 |
| B6683 | (I.V) | L.2.7 |
| B6684 | (I.V) | L.2.8 |
| B6685 | (I.V) | L.2.9 |
| B6686 | (I.V) | L.2.10 |
| B6687 | (I.V) | L.2.11 |
| B6688 | (I.V) | L.2.12 |
| B6689 | (I.V) | L.2.13 |
| B6690 | (I.V) | L.2.14 |
| B6691 | (I.V) | L.2.15 |
| B6692 | (I.V) | L.2.16 |
| B6693 | (I.V) | L.2.17 |
| B6694 | (I.V) | L.2.18 |
| B6695 | (I.V) | L.2.19 |
| B6696 | (I.V) | L.2.20 |
| B6697 | (I.V) | L.2.21 |
| B6698 | (I.V) | L.2.22 |
| B6699 | (I.V) | L.2.23 |
| B6700 | (I.V) | L.2.24 |
| B6701 | (I.V) | L.2.25 |
| B6702 | (I.V) | L.2.26 |
| B6703 | (I.V) | L.2.27 |
| B6704 | (I.V) | L.2.28 |
| B6705 | (I.V) | L.2.29 |
| B6706 | (I.V) | L.2.30 |
| B6707 | (I.V) | L.2.31 |
| B6708 | (I.V) | L.2.32 |
| B6709 | (I.V) | L.2.33 |
| B6710 | (I.V) | L.3.1 |
| B6711 | (I.V) | L.3.2 |
| B6712 | (I.V) | L.3.3 |
| B6713 | (I.V) | L.3.4 |
| B6714 | (I.V) | L.3.5 |
| B6715 | (I.V) | L.3.6 |
| B6716 | (I.V) | L.3.7 |
| B6717 | (I.V) | L.3.8 |
| B6718 | (I.V) | L.3.9 |
| B6719 | (I.V) | L.3.10 |
| B6720 | (I.V) | L.3.11 |
| B6721 | (I.V) | L.3.12 |
| B6722 | (I.V) | L.3.13 |
| B6723 | (I.V) | L.3.14 |
| B6724 | (I.V) | L.3.15 |
| B6725 | (I.V) | L.3.16 |
| B6726 | (I.V) | L.3.17 |
| B6727 | (I.V) | L.3.18 |
| B6728 | (I.V) | L.3.19 |
| B6729 | (I.V) | L.3.20 |
| B6730 | (I.V) | L.3.21 |
| B6731 | (I.V) | L.3.22 |
| B6732 | (I.V) | L.3.23 |
| B6733 | (I.V) | L.3.24 |
| B6734 | (I.V) | L.3.25 |
| B6735 | (I.V) | L.3.26 |
| B6736 | (I.V) | L.3.27 |
| B6737 | (I.V) | L.3.28 |
| B6738 | (I.V) | L.3.29 |
| B6739 | (I.V) | L.3.30 |
| B6740 | (I.V) | L.3.31 |
| B6741 | (I.V) | L.3.32 |
| B6742 | (I.V) | L.3.33 |
| B6743 | (I.V) | L.3.34 |
| B6744 | (I.V) | L.3.35 |
| B6745 | (I.V) | L.3.36 |
| B6746 | (I.V) | L.3.37 |
| B6747 | (I.V) | L.3.38 |
| B6748 | (I.V) | L.3.39 |
| B6749 | (I.V) | L.3.40 |
| B6750 | (I.V) | L.3.41 |
| B6751 | (I.V) | L.3.42 |
| B6752 | (I.V) | L.3.43 |
| B6753 | (I.V) | L.3.44 |
| B6754 | (I.V) | L.3.45 |
| B6755 | (I.V) | L.3.46 |
| B6756 | (I.V) | L.3.47 |
| B6757 | (I.V) | L.3.48 |
| B6758 | (I.V) | L.3.49 |
| B6759 | (I.V) | L.3.50 |
| B6760 | (I.V) | L.3.51 |
| B6761 | (I.V) | L.3.52 |
| B6762 | (I.V) | L.3.53 |
| B6763 | (I.V) | L.3.54 |
| B6764 | (I.V) | L.3.55 |
| B6765 | (I.V) | L.3.56 |
| B6766 | (I.V) | L.3.57 |
| B6767 | (I.V) | L.3.58 |
| B6768 | (I.V) | L.3.59 |
| B6769 | (I.V) | L.3.60 |
| B6770 | (I.V) | L.3.61 |
| B6771 | (I.V) | L.3.62 |
| B6772 | (I.V) | L.3.63 |
| B6773 | (I.V) | L.3.1 |
| B6774 | (I.V) | L.3.2 |
| B6775 | (I.V) | L.4.1 |
| B6776 | (I.V) | L.4.2 |
| B6777 | (I.V) | L.4.3 |
| B6778 | (I.V) | L.4.4 |
| B6779 | (I.V) | L.4.5 |
| B6780 | (I.V) | L.4.6 |
| B6781 | (I.V) | L.4.7 |
| B6782 | (I.V) | L.4.8 |
| B6783 | (I.V) | L.4.9 |
| B6784 | (I.V) | L.4.10 |
| B6785 | (I.V) | L.4.11 |
| B6786 | (I.V) | L.4.12 |
| B6787 | (I.V) | L.4.13 |
| B6788 | (I.V) | L.4.14 |
| B6789 | (I.V) | L.4.15 |
| B6790 | (I.V) | L.4.16 |
| B6791 | (I.V) | L.4.17 |
| B6792 | (I.V) | L.4.18 |
| B6793 | (I.V) | L.4.19 |
| B6794 | (I.V) | L.4.20 |
| B6795 | (I.V) | L.4.21 |
| B6796 | (I.V) | L.4.22 |
| B6797 | (I.V) | L.4.23 |
| B6798 | (I.V) | L.4.24 |
| B6799 | (I.V) | L.4.25 |
| B6800 | (I.V) | L.4.26 |
| B6801 | (I.V) | L.4.27 |
| B6802 | (I.V) | L.4.28 |
| B6803 | (I.V) | L.4.29 |
| B6804 | (I.V) | L.4.30 |
| B6805 | (I.V) | L.4.31 |
| B6806 | (I.V) | L.4.32 |
| B6807 | (I.V) | L.4.33 |
| B6808 | (I.V) | L.5.1 |
| B6809 | (I.V) | L.5.2 |
| B6810 | (I.V) | L.5.3 |
| B6811 | (I.V) | L.5.4 |
| B6812 | (I.V) | L.5.5 |
| B6813 | (I.V) | L.5.6 |
| B6814 | (I.V) | L.5.7 |
| B6815 | (I.V) | L.5.8 |
| B6816 | (I.V) | L.5.9 |
| B6817 | (I.V) | L.5.10 |
| B6818 | (I.V) | L.5.11 |
| B6819 | (I.V) | L.5.12 |
| B6820 | (I.V) | L.5.13 |
| B6821 | (I.V) | L.5.14 |
| B6822 | (I.V) | L.5.15 |
| B6823 | (I.V) | L.5.16 |
| B6824 | (I.V) | L.5.17 |
| B6825 | (I.V) | L.5.18 |
| B6826 | (I.V) | L.5.19 |
| B6827 | (I.V) | L.5.20 |
| B6828 | (I.V) | L.5.21 |
| B6829 | (I.V) | L.5.22 |
| B6830 | (I.V) | L.5.23 |
| B6831 | (I.V) | L.5.24 |
| B6832 | (I.V) | L.5.25 |
| B6833 | (I.V) | L.5.26 |
| B6834 | (I.V) | L.5.27 |
| B6835 | (I.V) | L.5.28 |
| B6836 | (I.V) | L.5.29 |
| B6837 | (I.V) | L.5.30 |
| B6838 | (I.V) | L.5.31 |
| B6839 | (I.V) | L.5.32 |
| B6840 | (I.V) | L.5.33 |
| B6841 | (I.V) | L.5.34 |
| B6842 | (I.V) | L.5.35 |
| B6843 | (I.V) | L.5.36 |
| B6844 | (I.V) | L.5.37 |
| B6845 | (I.V) | L.5.38 |
| B6846 | (I.V) | L.5.39 |
| B6847 | (I.V) | L.5.40 |
| B6848 | (I.V) | L.5.41 |
| B6849 | (I.V) | L.5.42 |
| B6850 | (I.V) | L.5.43 |
| B6851 | (I.V) | L.5.44 |
| B6852 | (I.V) | L.5.45 |
| B6853 | (I.V) | L.5.46 |
| B6854 | (I.V) | L.5.47 |
| B6855 | (I.V) | L.5.48 |
| B6856 | (I.V) | L.5.49 |
| B6857 | (I.V) | L.5.50 |
| B6858 | (I.V) | L.5.51 |
| B6859 | (I.V) | L.5.52 |
| B6860 | (I.V) | L.5.53 |
| B6861 | (I.V) | L.5.54 |
| B6862 | (I.V) | L.5.55 |
| B6863 | (I.V) | L.5.56 |
| B6864 | (I.V) | L.5.57 |
| B6865 | (I.V) | L.5.58 |
| B6866 | (I.V) | L.5.59 |
| B6867 | (I.V) | L.5.60 |
| B6868 | (I.V) | L.5.61 |
| B6869 | (I.V) | L.5.62 |
| B6870 | (I.V) | L.5.63 |
| B6871 | (I.V) | L.5.64 |
| B6872 | (I.V) | L.5.65 |
| B6873 | (I.V) | L.5.66 |
| B6874 | (I.V) | L.5.67 |
| B6875 | (I.V) | L.5.68 |
| B6876 | (I.V) | L.5.69 |
| B6877 | (I.V) | L.5.70 |
| B6878 | (I.V) | L.5.71 |
| B6879 | (I.V) | L.5.72 |
| B6880 | (I.V) | L.5.73 |
| B6881 | (I.V) | L.5.74 |
| B6882 | (I.V) | L.5.75 |
| B6883 | (I.V) | L.5.76 |
| B6884 | (I.V) | L.5.77 |
| B6885 | (I.V) | L.5.78 |
| B6886 | (I.V) | L.5.79 |
| B6887 | (I.V) | L.5.80 |
| B6888 | (I.V) | L.5.81 |
| B6889 | (I.V) | L.5.82 |
| B6890 | (I.V) | L.5.83 |
| B6891 | (I.V) | L.5.84 |
| B6892 | (I.V) | L.6.1 |
| B6893 | (I.V) | L.6.2 |
| B6894 | (I.V) | L.6.3 |
| B6895 | (I.V) | L.6.4 |
| B6896 | (I.V) | L.6.5 |
| B6897 | (I.V) | L.6.6 |
| B6898 | (I.V) | L.6.7 |
| B6899 | (I.V) | L.6.8 |
| B6900 | (I.V) | L.6.9 |
| B6901 | (I.V) | L.6.10 |
| B6902 | (I.V) | L.6.11 |
| B6903 | (I.V) | L.6.12 |
| B6904 | (I.V) | L.6.13 |
| B6905 | (I.V) | L.6.14 |
| B6906 | (I.V) | L.6.15 |
| B6907 | (I.V) | L.6.16 |
| B6908 | (I.V) | L.6.17 |
| B6909 | (I.V) | L.6.18 |

B = Mixture;
I = compound I;
II = compound II

TABLE 71

| B | I | II |
|---|---|---|
| B6910 | (I.W) | L.1.1 |
| B6911 | (I.W) | L.1.2 |
| B6912 | (I.W) | L.1.3 |
| B6913 | (I.W) | L.1.4 |
| B6914 | (I.W) | L.1.5 |
| B6915 | (I.W) | L.1.6 |
| B6916 | (I.W) | L.1.7 |
| B6917 | (I.W) | L.1.8 |
| B6918 | (I.W) | L.1.9 |
| B6919 | (I.W) | L.1.10 |
| B6920 | (I.W) | L.1.11 |
| B6921 | (I.W) | L.1.12 |
| B6922 | (I.W) | L.1.13 |
| B6923 | (I.W) | L.1.14 |
| B6924 | (I.W) | L.1.15 |
| B6925 | (I.W) | L.1.16 |
| B6926 | (I.W) | L.1.17 |
| B6927 | (I.W) | L.1.18 |
| B6928 | (I.W) | L.1.19 |
| B6929 | (I.W) | L.1.20 |
| B6930 | (I.W) | L.1.21 |
| B6931 | (I.W) | L.1.22 |
| B6932 | (I.W) | L.1.23 |
| B6933 | (I.W) | L.1.24 |
| B6934 | (I.W) | L.1.25 |
| B6935 | (I.W) | L.1.26 |
| B6936 | (I.W) | L.1.27 |
| B6937 | (I.W) | L.1.28 |
| B6938 | (I.W) | L.1.29 |
| B6939 | (I.W) | L.1.30 |
| B6940 | (I.W) | L.1.31 |
| B6941 | (I.W) | L.1.32 |
| B6942 | (I.W) | L.1.33 |
| B6943 | (I.W) | L.1.34 |
| B6944 | (I.W) | L.1.35 |
| B6945 | (I.W) | L.1.36 |
| B6946 | (I.W) | L.1.37 |
| B6947 | (I.W) | L.1.38 |
| B6948 | (I.W) | L.1.39 |
| B6949 | (I.W) | L.1.40 |
| B6950 | (I.W) | L.1.41 |
| B6951 | (I.W) | L.1.42 |
| B6952 | (I.W) | L.1.43 |
| B6953 | (I.W) | L.1.44 |
| B6954 | (I.W) | L.1.45 |
| B6955 | (I.W) | L.1.46 |
| B6956 | (I.W) | L.1.47 |
| B6957 | (I.W) | L.1.48 |
| B6958 | (I.W) | L.1.49 |
| B6959 | (I.W) | L.1.50 |
| B6960 | (I.W) | L.1.51 |
| B6961 | (I.W) | L.1.52 |
| B6962 | (I.W) | L.1.53 |
| B6963 | (I.W) | L.1.54 |
| B6964 | (I.W) | L.1.55 |
| B6965 | (I.W) | L.1.56 |
| B6966 | (I.W) | L.1.57 |
| B6967 | (I.W) | L.1.58 |
| B6968 | (I.W) | L.1.59 |
| B6969 | (I.W) | L.1.60 |
| B6970 | (I.W) | L.1.61 |
| B6971 | (I.W) | L.1.62 |
| B6972 | (I.W) | L.1.63 |
| B6973 | (I.W) | L.1.64 |
| B6974 | (I.W) | L.1.65 |
| B6975 | (I.W) | L.1.66 |
| B6976 | (I.W) | L.1.67 |
| B6977 | (I.W) | L.1.68 |
| B6978 | (I.W) | L.1.69 |
| B6979 | (I.W) | L.1.70 |
| B6980 | (I.W) | L.1.71 |
| B6981 | (I.W) | L.1.72 |
| B6982 | (I.W) | L.1.73 |
| B6983 | (I.W) | L.1.74 |
| B6984 | (I.W) | L.1.75 |
| B6985 | (I.W) | L.1.76 |
| B6986 | (I.W) | L.1.77 |
| B6987 | (I.W) | L.1.78 |
| B6988 | (I.W) | L.1.79 |
| B6989 | (I.W) | L.1.80 |
| B6990 | (I.W) | L.1.81 |
| B6991 | (I.W) | L.1.82 |
| B6992 | (I.W) | L.1.83 |
| B6993 | (I.W) | L.1.84 |
| B6994 | (I.W) | L.1.85 |
| B6995 | (I.W) | L.1.86 |
| B6996 | (I.W) | L.1.87 |
| B6997 | (I.W) | L.1.88 |
| B6998 | (I.W) | L.1.89 |
| B6999 | (I.W) | L.1.90 |
| B7000 | (I.W) | L.1.91 |
| B7001 | (I.W) | L.1.92 |
| B7002 | (I.W) | L.1.93 |
| B7003 | (I.W) | L.1.94 |
| B7004 | (I.W) | L.1.95 |
| B7005 | (I.W) | L.1.96 |
| B7006 | (I.W) | L.2.1 |
| B7007 | (I.W) | L.2.2 |
| B7008 | (I.W) | L.2.3 |
| B7009 | (I.W) | L.2.4 |
| B7010 | (I.W) | L.2.5 |
| B7011 | (I.W) | L.2.6 |
| B7012 | (I.W) | L.2.7 |
| B7013 | (I.W) | L.2.8 |
| B7014 | (I.W) | L.2.9 |
| B7015 | (I.W) | L.2.10 |
| B7016 | (I.W) | L.2.11 |
| B7017 | (I.W) | L.2.12 |
| B7018 | (I.W) | L.2.13 |
| B7019 | (I.W) | L.2.14 |
| B7020 | (I.W) | L.2.15 |
| B7021 | (I.W) | L.2.16 |
| B7022 | (I.W) | L.2.17 |
| B7023 | (I.W) | L.2.18 |
| B7024 | (I.W) | L.2.19 |
| B7025 | (I.W) | L.2.20 |
| B7026 | (I.W) | L.2.21 |
| B7027 | (I.W) | L.2.22 |
| B7028 | (I.W) | L.2.23 |
| B7029 | (I.W) | L.2.24 |
| B7030 | (I.W) | L.2.25 |
| B7031 | (I.W) | L.2.26 |
| B7032 | (I.W) | L.2.27 |
| B7033 | (I.W) | L.2.28 |
| B7034 | (I.W) | L.2.29 |
| B7035 | (I.W) | L.2.30 |
| B7036 | (I.W) | L.2.31 |
| B7037 | (I.W) | L.2.32 |
| B7038 | (I.W) | L.2.33 |
| B7039 | (I.W) | L.3.1 |
| B7040 | (I.W) | L.3.2 |
| B7041 | (I.W) | L.3.3 |
| B7042 | (I.W) | L.3.4 |
| B7043 | (I.W) | L.3.5 |
| B7044 | (I.W) | L.3.6 |
| B7045 | (I.W) | L.3.7 |
| B7046 | (I.W) | L.3.8 |
| B7047 | (I.W) | L.3.9 |
| B7048 | (I.W) | L.3.10 |
| B7049 | (I.W) | L.3.11 |
| B7050 | (I.W) | L.3.12 |
| B7051 | (I.W) | L.3.13 |
| B7052 | (I.W) | L.3.14 |
| B7053 | (I.W) | L.3.15 |
| B7054 | (I.W) | L.3.16 |
| B7055 | (I.W) | L.3.17 |
| B7056 | (I.W) | L.3.18 |
| B7057 | (I.W) | L.3.19 |
| B7058 | (I.W) | L.3.20 |
| B7059 | (I.W) | L.3.21 |
| B7060 | (I.W) | L.3.22 |
| B7061 | (I.W) | L.3.23 |
| B7062 | (I.W) | L.3.24 |
| B7063 | (I.W) | L.3.25 |
| B7064 | (I.W) | L.3.26 |
| B7065 | (I.W) | L.3.27 |
| B7066 | (I.W) | L.3.28 |
| B7067 | (I.W) | L.3.29 |
| B7068 | (I.W) | L.3.30 |
| B7069 | (I.W) | L.3.31 |
| B7070 | (I.W) | L.3.32 |
| B7071 | (I.W) | L.3.33 |
| B7072 | (I.W) | L.3.34 |
| B7073 | (I.W) | L.3.35 |
| B7074 | (I.W) | L.3.36 |
| B7075 | (I.W) | L.3.37 |
| B7076 | (I.W) | L.3.38 |
| B7077 | (I.W) | L.3.39 |
| B7078 | (I.W) | L.3.40 |
| B7079 | (I.W) | L.3.41 |
| B7080 | (I.W) | L.3.42 |
| B7081 | (I.W) | L.3.43 |
| B7082 | (I.W) | L.3.44 |
| B7083 | (I.W) | L.3.45 |
| B7084 | (I.W) | L.3.46 |
| B7085 | (I.W) | L.3.47 |
| B7086 | (I.W) | L.3.48 |
| B7087 | (I.W) | L.3.49 |
| B7088 | (I.W) | L.3.50 |
| B7089 | (I.W) | L.3.51 |
| B7090 | (I.W) | L.3.52 |
| B7091 | (I.W) | L.3.53 |
| B7092 | (I.W) | L.3.54 |
| B7093 | (I.W) | L.3.55 |
| B7094 | (I.W) | L.3.56 |
| B7095 | (I.W) | L.3.57 |
| B7096 | (I.W) | L.3.58 |
| B7097 | (I.W) | L.3.59 |
| B7098 | (I.W) | L.3.60 |
| B7099 | (I.W) | L.3.61 |
| B7100 | (I.W) | L.3.62 |
| B7101 | (I.W) | L.3.63 |
| B7102 | (I.W) | L.3.1 |
| B7103 | (I.W) | L.3.2 |
| B7104 | (I.W) | L.4.1 |
| B7105 | (I.W) | L.4.2 |
| B7106 | (I.W) | L.4.3 |
| B7107 | (I.W) | L.4.4 |
| B7108 | (I.W) | L.4.5 |
| B7109 | (I.W) | L.4.6 |
| B7110 | (I.W) | L.4.7 |
| B7111 | (I.W) | L.4.8 |
| B7112 | (I.W) | L.4.9 |
| B7113 | (I.W) | L.4.10 |
| B7114 | (I.W) | L.4.11 |
| B7115 | (I.W) | L.4.12 |
| B7116 | (I.W) | L.4.13 |
| B7117 | (I.W) | L.4.14 |
| B7118 | (I.W) | L.4.15 |
| B7119 | (I.W) | L.4.16 |
| B7120 | (I.W) | L.4.17 |
| B7121 | (I.W) | L.4.18 |
| B7122 | (I.W) | L.4.19 |
| B7123 | (I.W) | L.4.20 |
| B7124 | (I.W) | L.4.21 |
| B7125 | (I.W) | L.4.22 |
| B7126 | (I.W) | L.4.23 |
| B7127 | (I.W) | L.4.24 |
| B7128 | (I.W) | L.4.25 |
| B7129 | (I.W) | L.4.26 |
| B7130 | (I.W) | L.4.27 |
| B7131 | (I.W) | L.4.28 |
| B7132 | (I.W) | L.4.29 |
| B7133 | (I.W) | L.4.30 |
| B7134 | (I.W) | L.4.31 |
| B7135 | (I.W) | L.4.32 |
| B7136 | (I.W) | L.4.33 |
| B7137 | (I.W) | L.5.1 |
| B7138 | (I.W) | L.5.2 |
| B7139 | (I.W) | L.5.3 |
| B7140 | (I.W) | L.5.4 |
| B7141 | (I.W) | L.5.5 |
| B7142 | (I.W) | L.5.6 |
| B7143 | (I.W) | L.5.7 |
| B7144 | (I.W) | L.5.8 |
| B7145 | (I.W) | L.5.9 |
| B7146 | (I.W) | L.5.10 |
| B7147 | (I.W) | L.5.11 |
| B7148 | (I.W) | L.5.12 |
| B7149 | (I.W) | L.5.13 |
| B7150 | (I.W) | L.5.14 |
| B7151 | (I.W) | L.5.15 |
| B7152 | (I.W) | L.5.16 |
| B7153 | (I.W) | L.5.17 |
| B7154 | (I.W) | L.5.18 |
| B7155 | (I.W) | L.5.19 |
| B7156 | (I.W) | L.5.20 |
| B7157 | (I.W) | L.5.21 |
| B7158 | (I.W) | L.5.22 |
| B7159 | (I.W) | L.5.23 |
| B7160 | (I.W) | L.5.24 |
| B7161 | (I.W) | L.5.25 |
| B7162 | (I.W) | L.5.26 |
| B7163 | (I.W) | L.5.27 |
| B7164 | (I.W) | L.5.28 |
| B7165 | (I.W) | L.5.29 |
| B7166 | (I.W) | L.5.30 |
| B7167 | (I.W) | L.5.31 |
| B7168 | (I.W) | L.5.32 |
| B7169 | (I.W) | L.5.33 |
| B7170 | (I.W) | L.5.34 |
| B7171 | (I.W) | L.5.35 |
| B7172 | (I.W) | L.5.36 |
| B7173 | (I.W) | L.5.37 |
| B7174 | (I.W) | L.5.38 |
| B7175 | (I.W) | L.5.39 |
| B7176 | (I.W) | L.5.40 |
| B7177 | (I.W) | L.5.41 |
| B7178 | (I.W) | L.5.42 |
| B7179 | (I.W) | L.5.43 |
| B7180 | (I.W) | L.5.44 |
| B7181 | (I.W) | L.5.45 |
| B7182 | (I.W) | L.5.46 |
| B7183 | (I.W) | L.5.47 |
| B7184 | (I.W) | L.5.48 |
| B7185 | (I.W) | L.5.49 |
| B7186 | (I.W) | L.5.50 |
| B7187 | (I.W) | L.5.51 |
| B7188 | (I.W) | L.5.52 |
| B7189 | (I.W) | L.5.53 |
| B7190 | (I.W) | L.5.54 |
| B7191 | (I.W) | L.5.55 |
| B7192 | (I.W) | L.5.56 |
| B7193 | (I.W) | L.5.57 |
| B7194 | (I.W) | L.5.58 |
| B7195 | (I.W) | L.5.59 |
| B7196 | (I.W) | L.5.60 |
| B7197 | (I.W) | L.5.61 |
| B7198 | (I.W) | L.5.62 |
| B7199 | (I.W) | L.5.63 |
| B7200 | (I.W) | L.5.64 |
| B7201 | (I.W) | L.5.65 |
| B7202 | (I.W) | L.5.66 |
| B7203 | (I.W) | L.5.67 |
| B7204 | (I.W) | L.5.68 |
| B7205 | (I.W) | L.5.69 |
| B7206 | (I.W) | L.5.70 |
| B7207 | (I.W) | L.5.71 |
| B7208 | (I.W) | L.5.72 |
| B7209 | (I.W) | L.5.73 |
| B7210 | (I.W) | L.5.74 |
| B7211 | (I.W) | L.5.75 |
| B7212 | (I.W) | L.5.76 |
| B7213 | (I.W) | L.5.77 |
| B7214 | (I.W) | L.5.78 |
| B7215 | (I.W) | L.5.79 |
| B7216 | (I.W) | L.5.80 |
| B7217 | (I.W) | L.5.81 |
| B7218 | (I.W) | L.5.82 |
| B7219 | (I.W) | L.5.83 |
| B7220 | (I.W) | L.5.84 |
| B7221 | (I.W) | L.6.1 |
| B7222 | (I.W) | L.6.2 |
| B7223 | (I.W) | L.6.3 |
| B7224 | (I.W) | L.6.4 |
| B7225 | (I.W) | L.6.5 |
| B7226 | (I.W) | L.6.6 |
| B7227 | (I.W) | L.6.7 |
| B7228 | (I.W) | L.6.8 |
| B7229 | (I.W) | L.6.9 |
| B7230 | (I.W) | L.6.10 |
| B7231 | (I.W) | L.6.11 |
| B7232 | (I.W) | L.6.12 |
| B7233 | (I.W) | L.6.13 |
| B7234 | (I.W) | L.6.14 |
| B7235 | (I.W) | L.6.15 |
| B7236 | (I.W) | L.6.16 |
| B7237 | (I.W) | L.6.17 |
| B7238 | (I.W) | L.6.18 |

B = Mixture;
I = compound I;
II = compound II

TABLE 72

| B | I | II |
|---|---|---|
| B7239 | (I.X) | L.1.1 |
| B7240 | (I.X) | L.1.2 |
| B7241 | (I.X) | L.1.3 |
| B7242 | (I.X) | L.1.4 |
| B7243 | (I.X) | L.1.5 |
| B7244 | (I.X) | L.1.6 |
| B7245 | (I.X) | L.1.7 |
| B7246 | (I.X) | L.1.8 |
| B7247 | (I.X) | L.1.9 |
| B7248 | (I.X) | L.1.10 |
| B7249 | (I.X) | L.1.11 |
| B7250 | (I.X) | L.1.12 |
| B7251 | (I.X) | L.1.13 |
| B7252 | (I.X) | L.1.14 |
| B7253 | (I.X) | L.1.15 |
| B7254 | (I.X) | L.1.16 |
| B7255 | (I.X) | L.1.17 |
| B7256 | (I.X) | L.1.18 |
| B7257 | (I.X) | L.1.19 |
| B7258 | (I.X) | L.1.20 |
| B7259 | (I.X) | L.1.21 |
| B7260 | (I.X) | L.1.22 |
| B7261 | (I.X) | L.1.23 |
| B7262 | (I.X) | L.1.24 |
| B7263 | (I.X) | L.1.25 |
| B7264 | (I.X) | L.1.26 |
| B7265 | (I.X) | L.1.27 |
| B7266 | (I.X) | L.1.28 |
| B7267 | (I.X) | L.1.29 |
| B7268 | (I.X) | L.1.30 |
| B7269 | (I.X) | L.1.31 |
| B7270 | (I.X) | L.1.32 |
| B7271 | (I.X) | L.1.33 |
| B7272 | (I.X) | L.1.34 |
| B7273 | (I.X) | L.1.35 |
| B7274 | (I.X) | L.1.36 |
| B7275 | (I.X) | L.1.37 |
| B7276 | (I.X) | L.1.38 |
| B7277 | (I.X) | L.1.39 |
| B7278 | (I.X) | L.1.40 |
| B7279 | (I.X) | L.1.41 |
| B7280 | (I.X) | L.1.42 |
| B7281 | (I.X) | L.1.43 |
| B7282 | (I.X) | L.1.44 |
| B7283 | (I.X) | L.1.45 |
| B7284 | (I.X) | L.1.46 |
| B7285 | (I.X) | L.1.47 |
| B7286 | (I.X) | L.1.48 |
| B7287 | (I.X) | L.1.49 |
| B7288 | (I.X) | L.1.50 |
| B7289 | (I.X) | L.1.51 |
| B7290 | (I.X) | L.1.52 |
| B7291 | (I.X) | L.1.53 |
| B7292 | (I.X) | L.1.54 |
| B7293 | (I.X) | L.1.55 |
| B7294 | (I.X) | L.1.56 |
| B7295 | (I.X) | L.1.57 |
| B7296 | (I.X) | L.1.58 |
| B7297 | (I.X) | L.1.59 |
| B7298 | (I.X) | L.1.60 |
| B7299 | (I.X) | L.1.61 |
| B7300 | (I.X) | L.1.62 |
| B7301 | (I.X) | L.1.63 |
| B7302 | (I.X) | L.1.64 |
| B7303 | (I.X) | L.1.65 |
| B7304 | (I.X) | L.1.66 |
| B7305 | (I.X) | L.1.67 |
| B7306 | (I.X) | L.1.68 |
| B7307 | (I.X) | L.1.69 |
| B7308 | (I.X) | L.1.70 |
| B7309 | (I.X) | L.1.71 |
| B7310 | (I.X) | L.1.72 |
| B7311 | (I.X) | L.1.73 |
| B7312 | (I.X) | L.1.74 |
| B7313 | (I.X) | L.1.75 |
| B7314 | (I.X) | L.1.76 |
| B7315 | (I.X) | L.1.77 |
| B7316 | (I.X) | L.1.78 |
| B7317 | (I.X) | L.1.79 |
| B7318 | (I.X) | L.1.80 |
| B7319 | (I.X) | L.1.81 |
| B7320 | (I.X) | L.1.82 |
| B7321 | (I.X) | L.1.83 |
| B7322 | (I.X) | L.1.84 |
| B7323 | (I.X) | L.1.85 |
| B7324 | (I.X) | L.1.86 |
| B7325 | (I.X) | L.1.87 |
| B7326 | (I.X) | L.1.88 |
| B7327 | (I.X) | L.1.89 |
| B7328 | (I.X) | L.1.90 |
| B7329 | (I.X) | L.1.91 |
| B7330 | (I.X) | L.1.92 |
| B7331 | (I.X) | L.1.93 |
| B7332 | (I.X) | L.1.94 |
| B7333 | (I.X) | L.1.95 |
| B7334 | (I.X) | L.1.96 |
| B7335 | (I.X) | L.2.1 |
| B7336 | (I.X) | L.2.2 |
| B7337 | (I.X) | L.2.3 |
| B7338 | (I.X) | L.2.4 |
| B7339 | (I.X) | L.2.5 |
| B7340 | (I.X) | L.2.6 |
| B7341 | (I.X) | L.2.7 |
| B7342 | (I.X) | L.2.8 |
| B7343 | (I.X) | L.2.9 |
| B7344 | (I.X) | L.2.10 |
| B7345 | (I.X) | L.2.11 |
| B7346 | (I.X) | L.2.12 |
| B7347 | (I.X) | L.2.13 |
| B7348 | (I.X) | L.2.14 |
| B7349 | (I.X) | L.2.15 |
| B7350 | (I.X) | L.2.16 |
| B7351 | (I.X) | L.2.17 |
| B7352 | (I.X) | L.2.18 |
| B7353 | (I.X) | L.2.19 |
| B7354 | (I.X) | L.2.20 |
| B7355 | (I.X) | L.2.21 |
| B7356 | (I.X) | L.2.22 |
| B7357 | (I.X) | L.2.23 |
| B7358 | (I.X) | L.2.24 |
| B7359 | (I.X) | L.2.25 |
| B7360 | (I.X) | L.2.26 |
| B7361 | (I.X) | L.2.27 |
| B7362 | (I.X) | L.2.28 |
| B7363 | (I.X) | L.2.29 |
| B7364 | (I.X) | L.2.30 |
| B7365 | (I.X) | L.2.31 |
| B7366 | (I.X) | L.2.32 |
| B7367 | (I.X) | L.2.33 |
| B7368 | (I.X) | L.3.1 |
| B7369 | (I.X) | L.3.2 |
| B7370 | (I.X) | L.3.3 |
| B7371 | (I.X) | L.3.4 |
| B7372 | (I.X) | L.3.5 |
| B7373 | (I.X) | L.3.6 |
| B7374 | (I.X) | L.3.7 |
| B7375 | (I.X) | L.3.8 |
| B7376 | (I.X) | L.3.9 |
| B7377 | (I.X) | L.3.10 |
| B7378 | (I.X) | L.3.11 |
| B7379 | (I.X) | L.3.12 |
| B7380 | (I.X) | L.3.13 |
| B7381 | (I.X) | L.3.14 |
| B7382 | (I.X) | L.3.15 |
| B7383 | (I.X) | L.3.16 |
| B7384 | (I.X) | L.3.17 |
| B7385 | (I.X) | L.3.18 |
| B7386 | (I.X) | L.3.19 |
| B7387 | (I.X) | L.3.20 |
| B7388 | (I.X) | L.3.21 |
| B7389 | (I.X) | L.3.22 |
| B7390 | (I.X) | L.3.23 |
| B7391 | (I.X) | L.3.24 |
| B7392 | (I.X) | L.3.25 |
| B7393 | (I.X) | L.3.26 |
| B7394 | (I.X) | L.3.27 |
| B7395 | (I.X) | L.3.28 |
| B7396 | (I.X) | L.3.29 |
| B7397 | (I.X) | L.3.30 |
| B7398 | (I.X) | L.3.31 |
| B7399 | (I.X) | L.3.32 |
| B7400 | (I.X) | L.3.33 |
| B7401 | (I.X) | L.3.34 |
| B7402 | (I.X) | L.3.35 |
| B7403 | (I.X) | L.3.36 |
| B7404 | (I.X) | L.3.37 |
| B7405 | (I.X) | L.3.38 |
| B7406 | (I.X) | L.3.39 |
| B7407 | (I.X) | L.3.40 |
| B7408 | (I.X) | L.3.41 |
| B7409 | (I.X) | L.3.42 |
| B7410 | (I.X) | L.3.43 |
| B7411 | (I.X) | L.3.44 |
| B7412 | (I.X) | L.3.45 |
| B7413 | (I.X) | L.3.46 |
| B7414 | (I.X) | L.3.47 |
| B7415 | (I.X) | L.3.48 |
| B7416 | (I.X) | L.3.49 |
| B7417 | (I.X) | L.3.50 |
| B7418 | (I.X) | L.3.51 |
| B7419 | (I.X) | L.3.52 |
| B7420 | (I.X) | L.3.53 |
| B7421 | (I.X) | L.3.54 |
| B7422 | (I.X) | L.3.55 |
| B7423 | (I.X) | L.3.56 |
| B7424 | (I.X) | L.3.57 |
| B7425 | (I.X) | L.3.58 |
| B7426 | (I.X) | L.3.59 |
| B7427 | (I.X) | L.3.60 |
| B7428 | (I.X) | L.3.61 |
| B7429 | (I.X) | L.3.62 |
| B7430 | (I.X) | L.3.63 |
| B7431 | (I.X) | L.3.1 |
| B7432 | (I.X) | L.3.2 |
| B7433 | (I.X) | L.4.1 |
| B7434 | (I.X) | L.4.2 |
| B7435 | (I.X) | L.4.3 |
| B7436 | (I.X) | L.4.4 |
| B7437 | (I.X) | L.4.5 |
| B7438 | (I.X) | L.4.6 |
| B7439 | (I.X) | L.4.7 |
| B7440 | (I.X) | L.4.8 |
| B7441 | (I.X) | L.4.9 |
| B7442 | (I.X) | L.4.10 |
| B7443 | (I.X) | L.4.11 |
| B7444 | (I.X) | L.4.12 |
| B7445 | (I.X) | L.4.13 |
| B7446 | (I.X) | L.4.14 |
| B7447 | (I.X) | L.4.15 |
| B7448 | (I.X) | L.4.16 |
| B7449 | (I.X) | L.4.17 |
| B7450 | (I.X) | L.4.18 |
| B7451 | (I.X) | L.4.19 |
| B7452 | (I.X) | L.4.20 |
| B7453 | (I.X) | L.4.21 |
| B7454 | (I.X) | L.4.22 |
| B7455 | (I.X) | L.4.23 |
| B7456 | (I.X) | L.4.24 |
| B7457 | (I.X) | L.4.25 |
| B7458 | (I.X) | L.4.26 |
| B7459 | (I.X) | L.4.27 |
| B7460 | (I.X) | L.4.28 |
| B7461 | (I.X) | L.4.29 |
| B7462 | (I.X) | L.4.30 |
| B7463 | (I.X) | L.4.31 |
| B7464 | (I.X) | L.4.32 |
| B7465 | (I.X) | L.4.33 |
| B7466 | (I.X) | L.5.1 |
| B7467 | (I.X) | L.5.2 |
| B7468 | (I.X) | L.5.3 |
| B7469 | (I.X) | L.5.4 |
| B7470 | (I.X) | L.5.5 |
| B7471 | (I.X) | L.5.6 |
| B7472 | (I.X) | L.5.7 |
| B7473 | (I.X) | L.5.8 |
| B7474 | (I.X) | L.5.9 |
| B7475 | (I.X) | L.5.10 |
| B7476 | (I.X) | L.5.11 |
| B7477 | (I.X) | L.5.12 |
| B7478 | (I.X) | L.5.13 |
| B7479 | (I.X) | L.5.14 |
| B7480 | (I.X) | L.5.15 |
| B7481 | (I.X) | L.5.16 |
| B7482 | (I.X) | L.5.17 |
| B7483 | (I.X) | L.5.18 |
| B7484 | (I.X) | L.5.19 |
| B7485 | (I.X) | L.5.20 |
| B7486 | (I.X) | L.5.21 |
| B7487 | (I.X) | L.5.22 |
| B7488 | (I.X) | L.5.23 |
| B7489 | (I.X) | L.5.24 |
| B7490 | (I.X) | L.5.25 |
| B7491 | (I.X) | L.5.26 |
| B7492 | (I.X) | L.5.27 |
| B7493 | (I.X) | L.5.28 |
| B7494 | (I.X) | L.5.29 |
| B7495 | (I.X) | L.5.30 |
| B7496 | (I.X) | L.5.31 |
| B7497 | (I.X) | L.5.32 |
| B7498 | (I.X) | L.5.33 |
| B7499 | (I.X) | L.5.34 |
| B7500 | (I.X) | L.5.35 |
| B7501 | (I.X) | L.5.36 |
| B7502 | (I.X) | L.5.37 |
| B7503 | (I.X) | L.5.38 |
| B7504 | (I.X) | L.5.39 |
| B7505 | (I.X) | L.5.40 |
| B7506 | (I.X) | L.5.41 |
| B7507 | (I.X) | L.5.42 |
| B7508 | (I.X) | L.5.43 |
| B7509 | (I.X) | L.5.44 |
| B7510 | (I.X) | L.5.45 |
| B7511 | (I.X) | L.5.46 |
| B7512 | (I.X) | L.5.47 |
| B7513 | (I.X) | L.5.48 |
| B7514 | (I.X) | L.5.49 |
| B7515 | (I.X) | L.5.50 |
| B7516 | (I.X) | L.5.51 |
| B7517 | (I.X) | L.5.52 |
| B7518 | (I.X) | L.5.53 |
| B7519 | (I.X) | L.5.54 |
| B7520 | (I.X) | L.5.55 |
| B7521 | (I.X) | L.5.56 |
| B7522 | (I.X) | L.5.57 |
| B7523 | (I.X) | L.5.58 |
| B7524 | (I.X) | L.5.59 |
| B7525 | (I.X) | L.5.60 |
| B7526 | (I.X) | L.5.61 |
| B7527 | (I.X) | L.5.62 |
| B7528 | (I.X) | L.5.63 |
| B7529 | (I.X) | L.5.64 |
| B7530 | (I.X) | L.5.65 |
| B7531 | (I.X) | L.5.66 |
| B7532 | (I.X) | L.5.67 |
| B7533 | (I.X) | L.5.68 |
| B7534 | (I.X) | L.5.69 |
| B7535 | (I.X) | L.5.70 |
| B7536 | (I.X) | L.5.71 |
| B7537 | (I.X) | L.5.72 |
| B7538 | (I.X) | L.5.73 |
| B7539 | (I.X) | L.5.74 |
| B7540 | (I.X) | L.5.75 |
| B7541 | (I.X) | L.5.76 |
| B7542 | (I.X) | L.5.77 |
| B7543 | (I.X) | L.5.78 |
| B7544 | (I.X) | L.5.79 |
| B7545 | (I.X) | L.5.80 |
| B7546 | (I.X) | L.5.81 |
| B7547 | (I.X) | L.5.82 |
| B7548 | (I.X) | L.5.83 |
| B7549 | (I.X) | L.5.84 |
| B7550 | (I.X) | L.6.1 |
| B7551 | (I.X) | L.6.2 |
| B7552 | (I.X) | L.6.3 |
| B7553 | (I.X) | L.6.4 |
| B7554 | (I.X) | L.6.5 |
| B7555 | (I.X) | L.6.6 |
| B7556 | (I.X) | L.6.7 |
| B7557 | (I.X) | L.6.8 |
| B7558 | (I.X) | L.6.9 |
| B7559 | (I.X) | L.6.10 |
| B7560 | (I.X) | L.6.11 |
| B7561 | (I.X) | L.6.12 |
| B7562 | (I.X) | L.6.13 |
| B7563 | (I.X) | L.6.14 |
| B7564 | (I.X) | L.6.15 |
| B7565 | (I.X) | L.6.16 |
| B7566 | (I.X) | L.6.17 |
| B7567 | (I.X) | L.6.18 |

B = Mixture;
I = compound I;
II = compound II

TABLE 73

| B | I | II |
|---|---|---|
| B7568 | (I.Y) | L.1.1 |
| B7569 | (I.Y) | L.1.2 |
| B7570 | (I.Y) | L.1.3 |
| B7571 | (I.Y) | L.1.4 |
| B7572 | (I.Y) | L.1.5 |
| B7573 | (I.Y) | L.1.6 |
| B7574 | (I.Y) | L.1.7 |
| B7575 | (I.Y) | L.1.8 |
| B7576 | (I.Y) | L.1.9 |
| B7577 | (I.Y) | L.1.10 |
| B7578 | (I.Y) | L.1.11 |
| B7579 | (I.Y) | L.1.12 |
| B7580 | (I.Y) | L.1.13 |
| B7581 | (I.Y) | L.1.14 |
| B7582 | (I.Y) | L.1.15 |
| B7583 | (I.Y) | L.1.16 |
| B7584 | (I.Y) | L.1.17 |
| B7585 | (I.Y) | L.1.18 |
| B7586 | (I.Y) | L.1.19 |
| B7587 | (I.Y) | L.1.20 |
| B7588 | (I.Y) | L.1.21 |
| B7589 | (I.Y) | L.1.22 |
| B7590 | (I.Y) | L.1.23 |
| B7591 | (I.Y) | L.1.24 |
| B7592 | (I.Y) | L.1.25 |
| B7593 | (I.Y) | L.1.26 |
| B7594 | (I.Y) | L.1.27 |
| B7595 | (I.Y) | L.1.28 |
| B7596 | (I.Y) | L.1.29 |
| B7597 | (I.Y) | L.1.30 |
| B7598 | (I.Y) | L.1.31 |
| B7599 | (I.Y) | L.1.32 |
| B7600 | (I.Y) | L.1.33 |
| B7601 | (I.Y) | L.1.34 |
| B7602 | (I.Y) | L.1.35 |
| B7603 | (I.Y) | L.1.36 |
| B7604 | (I.Y) | L.1.37 |
| B7605 | (I.Y) | L.1.38 |
| B7606 | (I.Y) | L.1.39 |
| B7607 | (I.Y) | L.1.40 |
| B7608 | (I.Y) | L.1.41 |
| B7609 | (I.Y) | L.1.42 |
| B7610 | (I.Y) | L.1.43 |
| B7611 | (I.Y) | L.1.44 |
| B7612 | (I.Y) | L.1.45 |
| B7613 | (I.Y) | L.1.46 |
| B7614 | (I.Y) | L.1.47 |
| B7615 | (I.Y) | L.1.48 |
| B7616 | (I.Y) | L.1.49 |
| B7617 | (I.Y) | L.1.50 |
| B7618 | (I.Y) | L.1.51 |
| B7619 | (I.Y) | L.1.52 |
| B7620 | (I.Y) | L.1.53 |
| B7621 | (I.Y) | L.1.54 |
| B7622 | (I.Y) | L.1.55 |
| B7623 | (I.Y) | L.1.56 |
| B7624 | (I.Y) | L.1.57 |
| B7625 | (I.Y) | L.1.58 |
| B7626 | (I.Y) | L.1.59 |
| B7627 | (I.Y) | L.1.60 |
| B7628 | (I.Y) | L.1.61 |
| B7629 | (I.Y) | L.1.62 |
| B7630 | (I.Y) | L.1.63 |
| B7631 | (I.Y) | L.1.64 |
| B7632 | (I.Y) | L.1.65 |
| B7633 | (I.Y) | L.1.66 |
| B7634 | (I.Y) | L.1.67 |
| B7635 | (I.Y) | L.1.68 |
| B7636 | (I.Y) | L.1.69 |
| B7637 | (I.Y) | L.1.70 |
| B7638 | (I.Y) | L.1.71 |
| B7639 | (I.Y) | L.1.72 |
| B7640 | (I.Y) | L.1.73 |
| B7641 | (I.Y) | L.1.74 |
| B7642 | (I.Y) | L.1.75 |
| B7643 | (I.Y) | L.1.76 |
| B7644 | (I.Y) | L.1.77 |
| B7645 | (I.Y) | L.1.78 |
| B7646 | (I.Y) | L.1.79 |
| B7647 | (I.Y) | L.1.80 |
| B7648 | (I.Y) | L.1.81 |
| B7649 | (I.Y) | L.1.82 |
| B7650 | (I.Y) | L.1.83 |
| B7651 | (I.Y) | L.1.84 |
| B7652 | (I.Y) | L.1.85 |
| B7653 | (I.Y) | L.1.86 |
| B7654 | (I.Y) | L.1.87 |
| B7655 | (I.Y) | L.1.88 |
| B7656 | (I.Y) | L.1.89 |
| B7657 | (I.Y) | L.1.90 |
| B7658 | (I.Y) | L.1.91 |
| B7659 | (I.Y) | L.1.92 |
| B7660 | (I.Y) | L.1.93 |
| B7661 | (I.Y) | L.1.94 |
| B7662 | (I.Y) | L.1.95 |
| B7663 | (I.Y) | L.1.96 |
| B7664 | (I.Y) | L.2.1 |
| B7665 | (I.Y) | L.2.2 |
| B7666 | (I.Y) | L.2.3 |
| B7667 | (I.Y) | L.2.4 |
| B7668 | (I.Y) | L.2.5 |
| B7669 | (I.Y) | L.2.6 |
| B7670 | (I.Y) | L.2.7 |
| B7671 | (I.Y) | L.2.8 |
| B7672 | (I.Y) | L.2.9 |
| B7673 | (I.Y) | L.2.10 |
| B7674 | (I.Y) | L.2.11 |
| B7675 | (I.Y) | L.2.12 |
| B7676 | (I.Y) | L.2.13 |
| B7677 | (I.Y) | L.2.14 |
| B7678 | (I.Y) | L.2.15 |
| B7679 | (I.Y) | L.2.16 |
| B7680 | (I.Y) | L.2.17 |
| B7681 | (I.Y) | L.2.18 |
| B7682 | (I.Y) | L.2.19 |
| B7683 | (I.Y) | L.2.20 |
| B7684 | (I.Y) | L.2.21 |
| B7685 | (I.Y) | L.2.22 |
| B7686 | (I.Y) | L.2.23 |
| B7687 | (I.Y) | L.2.24 |
| B7688 | (I.Y) | L.2.25 |
| B7689 | (I.Y) | L.2.26 |
| B7690 | (I.Y) | L.2.27 |
| B7691 | (I.Y) | L.2.28 |
| B7692 | (I.Y) | L.2.29 |
| B7693 | (I.Y) | L.2.30 |
| B7694 | (I.Y) | L.2.31 |
| B7695 | (I.Y) | L.2.32 |
| B7696 | (I.Y) | L.2.33 |
| B7697 | (I.Y) | L.3.1 |
| B7698 | (I.Y) | L.3.2 |
| B7699 | (I.Y) | L.3.3 |
| B7700 | (I.Y) | L.3.4 |
| B7701 | (I.Y) | L.3.5 |
| B7702 | (I.Y) | L.3.6 |
| B7703 | (I.Y) | L.3.7 |
| B7704 | (I.Y) | L.3.8 |
| B7705 | (I.Y) | L.3.9 |
| B7706 | (I.Y) | L.3.10 |
| B7707 | (I.Y) | L.3.11 |
| B7708 | (I.Y) | L.3.12 |
| B7709 | (I.Y) | L.3.13 |
| B7710 | (I.Y) | L.3.14 |
| B7711 | (I.Y) | L.3.15 |
| B7712 | (I.Y) | L.3.16 |
| B7713 | (I.Y) | L.3.17 |
| B7714 | (I.Y) | L.3.18 |
| B7715 | (I.Y) | L.3.19 |
| B7716 | (I.Y) | L.3.20 |
| B7717 | (I.Y) | L.3.21 |
| B7718 | (I.Y) | L.3.22 |
| B7719 | (I.Y) | L.3.23 |
| B7720 | (I.Y) | L.3.24 |
| B7721 | (I.Y) | L.3.25 |
| B7722 | (I.Y) | L.3.26 |
| B7723 | (I.Y) | L.3.27 |
| B7724 | (I.Y) | L.3.28 |
| B7725 | (I.Y) | L.3.29 |
| B7726 | (I.Y) | L.3.30 |
| B7727 | (I.Y) | L.3.31 |
| B7728 | (I.Y) | L.3.32 |
| B7729 | (I.Y) | L.3.33 |
| B7730 | (I.Y) | L.3.34 |
| B7731 | (I.Y) | L.3.35 |
| B7732 | (I.Y) | L.3.36 |
| B7733 | (I.Y) | L.3.37 |
| B7734 | (I.Y) | L.3.38 |
| B7735 | (I.Y) | L.3.39 |
| B7736 | (I.Y) | L.3.40 |
| B7737 | (I.Y) | L.3.41 |
| B7738 | (I.Y) | L.3.42 |
| B7739 | (I.Y) | L.3.43 |
| B7740 | (I.Y) | L.3.44 |
| B7741 | (I.Y) | L.3.45 |
| B7742 | (I.Y) | L.3.46 |
| B7743 | (I.Y) | L.3.47 |
| B7744 | (I.Y) | L.3.48 |
| B7745 | (I.Y) | L.3.49 |
| B7746 | (I.Y) | L.3.50 |
| B7747 | (I.Y) | L.3.51 |
| B7748 | (I.Y) | L.3.52 |
| B7749 | (I.Y) | L.3.53 |
| B7750 | (I.Y) | L.3.54 |
| B7751 | (I.Y) | L.3.55 |
| B7752 | (I.Y) | L.3.56 |
| B7753 | (I.Y) | L.3.57 |
| B7754 | (I.Y) | L.3.58 |
| B7755 | (I.Y) | L.3.59 |
| B7756 | (I.Y) | L.3.60 |
| B7757 | (I.Y) | L.3.61 |
| B7758 | (I.Y) | L.3.62 |
| B7759 | (I.Y) | L.3.63 |
| B7760 | (I.Y) | L.3.1 |
| B7761 | (I.Y) | L.3.2 |
| B7762 | (I.Y) | L.4.1 |
| B7763 | (I.Y) | L.4.2 |
| B7764 | (I.Y) | L.4.3 |
| B7765 | (I.Y) | L.4.4 |
| B7766 | (I.Y) | L.4.5 |
| B7767 | (I.Y) | L.4.6 |
| B7768 | (I.Y) | L.4.7 |
| B7769 | (I.Y) | L.4.8 |
| B7770 | (I.Y) | L.4.9 |
| B7771 | (I.Y) | L.4.10 |
| B7772 | (I.Y) | L.4.11 |
| B7773 | (I.Y) | L.4.12 |
| B7774 | (I.Y) | L.4.13 |
| B7775 | (I.Y) | L.4.14 |
| B7776 | (I.Y) | L.4.15 |
| B7777 | (I.Y) | L.4.16 |
| B7778 | (I.Y) | L.4.17 |
| B7779 | (I.Y) | L.4.18 |
| B7780 | (I.Y) | L.4.19 |
| B7781 | (I.Y) | L.4.20 |
| B7782 | (I.Y) | L.4.21 |
| B7783 | (I.Y) | L.4.22 |
| B7784 | (I.Y) | L.4.23 |
| B7785 | (I.Y) | L.4.24 |
| B7786 | (I.Y) | L.4.25 |
| B7787 | (I.Y) | L.4.26 |
| B7788 | (I.Y) | L.4.27 |
| B7789 | (I.Y) | L.4.28 |
| B7790 | (I.Y) | L.4.29 |
| B7791 | (I.Y) | L.4.30 |
| B7792 | (I.Y) | L.4.31 |
| B7793 | (I.Y) | L.4.32 |
| B7794 | (I.Y) | L.4.33 |
| B7795 | (I.Y) | L.5.1 |
| B7796 | (I.Y) | L.5.2 |
| B7797 | (I.Y) | L.5.3 |
| B7798 | (I.Y) | L.5.4 |
| B7799 | (I.Y) | L.5.5 |
| B7800 | (I.Y) | L.5.6 |
| B7801 | (I.Y) | L.5.7 |
| B7802 | (I.Y) | L.5.8 |
| B7803 | (I.Y) | L.5.9 |
| B7804 | (I.Y) | L.5.10 |
| B7805 | (I.Y) | L.5.11 |
| B7806 | (I.Y) | L.5.12 |
| B7807 | (I.Y) | L.5.13 |
| B7808 | (I.Y) | L.5.14 |
| B7809 | (I.Y) | L.5.15 |
| B7810 | (I.Y) | L.5.16 |
| B7811 | (I.Y) | L.5.17 |
| B7812 | (I.Y) | L.5.18 |
| B7813 | (I.Y) | L.5.19 |
| B7814 | (I.Y) | L.5.20 |
| B7815 | (I.Y) | L.5.21 |
| B7816 | (I.Y) | L.5.22 |
| B7817 | (I.Y) | L.5.23 |
| B7818 | (I.Y) | L.5.24 |
| B7819 | (I.Y) | L.5.25 |
| B7820 | (I.Y) | L.5.26 |
| B7821 | (I.Y) | L.5.27 |
| B7822 | (I.Y) | L.5.28 |
| B7823 | (I.Y) | L.5.29 |
| B7824 | (I.Y) | L.5.30 |
| B7825 | (I.Y) | L.5.31 |
| B7826 | (I.Y) | L.5.32 |
| B7827 | (I.Y) | L.5.33 |
| B7828 | (I.Y) | L.5.34 |
| B7829 | (I.Y) | L.5.35 |
| B7830 | (I.Y) | L.5.36 |
| B7831 | (I.Y) | L.5.37 |
| B7832 | (I.Y) | L.5.38 |
| B7833 | (I.Y) | L.5.39 |
| B7834 | (I.Y) | L.5.40 |
| B7835 | (I.Y) | L.5.41 |
| B7836 | (I.Y) | L.5.42 |
| B7837 | (I.Y) | L.5.43 |
| B7838 | (I.Y) | L.5.44 |
| B7839 | (I.Y) | L.5.45 |
| B7840 | (I.Y) | L.5.46 |
| B7841 | (I.Y) | L.5.47 |
| B7842 | (I.Y) | L.5.48 |
| B7843 | (I.Y) | L.5.49 |
| B7844 | (I.Y) | L.5.50 |
| B7845 | (I.Y) | L.5.51 |
| B7846 | (I.Y) | L.5.52 |
| B7847 | (I.Y) | L.5.53 |
| B7848 | (I.Y) | L.5.54 |
| B7849 | (I.Y) | L.5.55 |
| B7850 | (I.Y) | L.5.56 |
| B7851 | (I.Y) | L.5.57 |
| B7852 | (I.Y) | L.5.58 |
| B7853 | (I.Y) | L.5.59 |
| B7854 | (I.Y) | L.5.60 |
| B7855 | (I.Y) | L.5.61 |
| B7856 | (I.Y) | L.5.62 |
| B7857 | (I.Y) | L.5.63 |
| B7858 | (I.Y) | L.5.64 |
| B7859 | (I.Y) | L.5.65 |
| B7860 | (I.Y) | L.5.66 |
| B7861 | (I.Y) | L.5.67 |
| B7862 | (I.Y) | L.5.68 |
| B7863 | (I.Y) | L.5.69 |
| B7864 | (I.Y) | L.5.70 |
| B7865 | (I.Y) | L.5.71 |
| B7866 | (I.Y) | L.5.72 |
| B7867 | (I.Y) | L.5.73 |
| B7868 | (I.Y) | L.5.74 |
| B7869 | (I.Y) | L.5.75 |
| B7870 | (I.Y) | L.5.76 |
| B7871 | (I.Y) | L.5.77 |
| B7872 | (I.Y) | L.5.78 |
| B7873 | (I.Y) | L.5.79 |
| B7874 | (I.Y) | L.5.80 |
| B7875 | (I.Y) | L.5.81 |
| B7876 | (I.Y) | L.5.82 |
| B7877 | (I.Y) | L.5.83 |
| B7878 | (I.Y) | L.5.84 |
| B7879 | (I.Y) | L.6.1 |
| B7880 | (I.Y) | L.6.2 |
| B7881 | (I.Y) | L.6.3 |
| B7882 | (I.Y) | L.6.4 |
| B7883 | (I.Y) | L.6.5 |
| B7884 | (I.Y) | L.6.6 |
| B7885 | (I.Y) | L.6.7 |
| B7886 | (I.Y) | L.6.8 |
| B7887 | (I.Y) | L.6.9 |
| B7888 | (I.Y) | L.6.10 |
| B7889 | (I.Y) | L.6.11 |
| B7890 | (I.Y) | L.6.12 |
| B7891 | (I.Y) | L.6.13 |
| B7892 | (I.Y) | L.6.14 |
| B7893 | (I.Y) | L.6.15 |
| B7894 | (I.Y) | L.6.16 |
| B7895 | (I.Y) | L.6.17 |
| B7896 | (I.Y) | L.6.18 |

B = Mixture;
I = compound I;
II = compound II

TABLE 74

| B | I | II |
|---|---|---|
| B7897 | (I.Z) | L.1.1 |
| B7898 | (I.Z) | L.1.2 |
| B7899 | (I.Z) | L.1.3 |
| B7900 | (I.Z) | L.1.4 |
| B7901 | (I.Z) | L.1.5 |
| B7902 | (I.Z) | L.1.6 |
| B7903 | (I.Z) | L.1.7 |
| B7904 | (I.Z) | L.1.8 |
| B7905 | (I.Z) | L.1.9 |
| B7906 | (I.Z) | L.1.10 |
| B7907 | (I.Z) | L.1.11 |
| B7908 | (I.Z) | L.1.12 |
| B7909 | (I.Z) | L.1.13 |
| B7910 | (I.Z) | L.1.14 |
| B7911 | (I.Z) | L.1.15 |
| B7912 | (I.Z) | L.1.16 |
| B7913 | (I.Z) | L.1.17 |
| B7914 | (I.Z) | L.1.18 |
| B7915 | (I.Z) | L.1.19 |
| B7916 | (I.Z) | L.1.20 |
| B7917 | (I.Z) | L.1.21 |
| B7918 | (I.Z) | L.1.22 |
| B7919 | (I.Z) | L.1.23 |
| B7920 | (I.Z) | L.1.24 |
| B7921 | (I.Z) | L.1.25 |
| B7922 | (I.Z) | L.1.26 |
| B7923 | (I.Z) | L.1.27 |
| B7924 | (I.Z) | L.1.28 |
| B7925 | (I.Z) | L.1.29 |
| B7926 | (I.Z) | L.1.30 |
| B7927 | (I.Z) | L.1.31 |
| B7928 | (I.Z) | L.1.32 |
| B7929 | (I.Z) | L.1.33 |
| B7930 | (I.Z) | L.1.34 |
| B7931 | (I.Z) | L.1.35 |
| B7932 | (I.Z) | L.1.36 |
| B7933 | (I.Z) | L.1.37 |
| B7934 | (I.Z) | L.1.38 |
| B7935 | (I.Z) | L.1.39 |
| B7936 | (I.Z) | L.1.40 |
| B7937 | (I.Z) | L.1.41 |
| B7938 | (I.Z) | L.1.42 |
| B7939 | (I.Z) | L.1.43 |
| B7940 | (I.Z) | L.1.44 |
| B7941 | (I.Z) | L.1.45 |
| B7942 | (I.Z) | L.1.46 |
| B7943 | (I.Z) | L.1.47 |
| B7944 | (I.Z) | L.1.48 |
| B7945 | (I.Z) | L.1.49 |
| B7946 | (I.Z) | L.1.50 |
| B7947 | (I.Z) | L.1.51 |
| B7948 | (I.Z) | L.1.52 |
| B7949 | (I.Z) | L.1.53 |
| B7950 | (I.Z) | L.1.54 |
| B7951 | (I.Z) | L.1.55 |
| B7952 | (I.Z) | L.1.56 |
| B7953 | (I.Z) | L.1.57 |
| B7954 | (I.Z) | L.1.58 |
| B7955 | (I.Z) | L.1.59 |
| B7956 | (I.Z) | L.1.60 |
| B7957 | (I.Z) | L.1.61 |
| B7958 | (I.Z) | L.1.62 |
| B7959 | (I.Z) | L.1.63 |
| B7960 | (I.Z) | L.1.64 |
| B7961 | (I.Z) | L.1.65 |
| B7962 | (I.Z) | L.1.66 |
| B7963 | (I.Z) | L.1.67 |
| B7964 | (I.Z) | L.1.68 |
| B7965 | (I.Z) | L.1.69 |
| B7966 | (I.Z) | L.1.70 |
| B7967 | (I.Z) | L.1.71 |
| B7968 | (I.Z) | L.1.72 |
| B7969 | (I.Z) | L.1.73 |
| B7970 | (I.Z) | L.1.74 |
| B7971 | (I.Z) | L.1.75 |
| B7972 | (I.Z) | L.1.76 |
| B7973 | (I.Z) | L.1.77 |
| B7974 | (I.Z) | L.1.78 |
| B7975 | (I.Z) | L.1.79 |
| B7976 | (I.Z) | L.1.80 |
| B7977 | (I.Z) | L.1.81 |
| B7978 | (I.Z) | L.1.82 |
| B7979 | (I.Z) | L.1.83 |
| B7980 | (I.Z) | L.1.84 |
| B7981 | (I.Z) | L.1.85 |
| B7982 | (I.Z) | L.1.86 |
| B7983 | (I.Z) | L.1.87 |
| B7984 | (I.Z) | L.1.88 |
| B7985 | (I.Z) | L.1.89 |
| B7986 | (I.Z) | L.1.90 |
| B7987 | (I.Z) | L.1.91 |
| B7988 | (I.Z) | L.1.92 |
| B7989 | (I.Z) | L.1.93 |
| B7990 | (I.Z) | L.1.94 |
| B7991 | (I.Z) | L.1.95 |
| B7992 | (I.Z) | L.1.96 |
| B7993 | (I.Z) | L.2.1 |
| B7994 | (I.Z) | L.2.2 |
| B7995 | (I.Z) | L.2.3 |
| B7996 | (I.Z) | L.2.4 |
| B7997 | (I.Z) | L.2.5 |
| B7998 | (I.Z) | L.2.6 |
| B7999 | (I.Z) | L.2.7 |
| B8000 | (I.Z) | L.2.8 |
| B8001 | (I.Z) | L.2.9 |
| B8002 | (I.Z) | L.2.10 |
| B8003 | (I.Z) | L.2.11 |
| B8004 | (I.Z) | L.2.12 |
| B8005 | (I.Z) | L.2.13 |
| B8006 | (I.Z) | L.2.14 |
| B8007 | (I.Z) | L.2.15 |
| B8008 | (I.Z) | L.2.16 |
| B8009 | (I.Z) | L.2.17 |
| B8010 | (I.Z) | L.2.18 |
| B8011 | (I.Z) | L.2.19 |
| B8012 | (I.Z) | L.2.20 |
| B8013 | (I.Z) | L.2.21 |
| B8014 | (I.Z) | L.2.22 |
| B8015 | (I.Z) | L.2.23 |
| B8016 | (I.Z) | L.2.24 |
| B8017 | (I.Z) | L.2.25 |
| B8018 | (I.Z) | L.2.26 |
| B8019 | (I.Z) | L.2.27 |
| B8020 | (I.Z) | L.2.28 |
| B8021 | (I.Z) | L.2.29 |
| B8022 | (I.Z) | L.2.30 |
| B8023 | (I.Z) | L.2.31 |
| B8024 | (I.Z) | L.2.32 |
| B8025 | (I.Z) | L.2.33 |
| B8026 | (I.Z) | L.3.1 |
| B8027 | (I.Z) | L.3.2 |
| B8028 | (I.Z) | L.3.3 |
| B8029 | (I.Z) | L.3.4 |
| B8030 | (I.Z) | L.3.5 |
| B8031 | (I.Z) | L.3.6 |
| B8032 | (I.Z) | L.3.7 |
| B8033 | (I.Z) | L.3.8 |
| B8034 | (I.Z) | L.3.9 |
| B8035 | (I.Z) | L.3.10 |
| B8036 | (I.Z) | L.3.11 |
| B8037 | (I.Z) | L.3.12 |
| B8038 | (I.Z) | L.3.13 |
| B8039 | (I.Z) | L.3.14 |
| B8040 | (I.Z) | L.3.15 |
| B8041 | (I.Z) | L.3.16 |
| B8042 | (I.Z) | L.3.17 |
| B8043 | (I.Z) | L.3.18 |
| B8044 | (I.Z) | L.3.19 |
| B8045 | (I.Z) | L.3.20 |
| B8046 | (I.Z) | L.3.21 |
| B8047 | (I.Z) | L.3.22 |
| B8048 | (I.Z) | L.3.23 |
| B8049 | (I.Z) | L.3.24 |
| B8050 | (I.Z) | L.3.25 |
| B8051 | (I.Z) | L.3.26 |
| B8052 | (I.Z) | L.3.27 |
| B8053 | (I.Z) | L.3.28 |
| B8054 | (I.Z) | L.3.29 |
| B8055 | (I.Z) | L.3.30 |
| B8056 | (I.Z) | L.3.31 |
| B8057 | (I.Z) | L.3.32 |
| B8058 | (I.Z) | L.3.33 |
| B8059 | (I.Z) | L.3.34 |
| B8060 | (I.Z) | L.3.35 |
| B8061 | (I.Z) | L.3.36 |
| B8062 | (I.Z) | L.3.37 |
| B8063 | (I.Z) | L.3.38 |
| B8064 | (I.Z) | L.3.39 |
| B8065 | (I.Z) | L.3.40 |
| B8066 | (I.Z) | L.3.41 |
| B8067 | (I.Z) | L.3.42 |
| B8068 | (I.Z) | L.3.43 |
| B8069 | (I.Z) | L.3.44 |
| B8070 | (I.Z) | L.3.45 |
| B8071 | (I.Z) | L.3.46 |
| B8072 | (I.Z) | L.3.47 |
| B8073 | (I.Z) | L.3.48 |
| B8074 | (I.Z) | L.3.49 |
| B8075 | (I.Z) | L.3.50 |
| B8076 | (I.Z) | L.3.51 |
| B8077 | (I.Z) | L.3.52 |
| B8078 | (I.Z) | L.3.53 |
| B8079 | (I.Z) | L.3.54 |
| B8080 | (I.Z) | L.3.55 |
| B8081 | (I.Z) | L.3.56 |
| B8082 | (I.Z) | L.3.57 |
| B8083 | (I.Z) | L.3.58 |
| B8084 | (I.Z) | L.3.59 |
| B8085 | (I.Z) | L.3.60 |
| B8086 | (I.Z) | L.3.61 |
| B8087 | (I.Z) | L.3.62 |
| B8088 | (I.Z) | L.3.63 |
| B8089 | (I.Z) | L.3.1 |
| B8090 | (I.Z) | L.3.2 |
| B8091 | (I.Z) | L.4.1 |
| B8092 | (I.Z) | L.4.2 |
| B8093 | (I.Z) | L.4.3 |
| B8094 | (I.Z) | L.4.4 |
| B8095 | (I.Z) | L.4.5 |
| B8096 | (I.Z) | L.4.6 |
| B8097 | (I.Z) | L.4.7 |
| B8098 | (I.Z) | L.4.8 |
| B8099 | (I.Z) | L.4.9 |
| B8100 | (I.Z) | L.4.10 |
| B8101 | (I.Z) | L.4.11 |
| B8102 | (I.Z) | L.4.12 |
| B8103 | (I.Z) | L.4.13 |
| B8104 | (I.Z) | L.4.14 |
| B8105 | (I.Z) | L.4.15 |
| B8106 | (I.Z) | L.4.16 |
| B8107 | (I.Z) | L.4.17 |
| B8108 | (I.Z) | L.4.18 |
| B8109 | (I.Z) | L.4.19 |
| B8110 | (I.Z) | L.4.20 |
| B8111 | (I.Z) | L.4.21 |
| B8112 | (I.Z) | L.4.22 |
| B8113 | (I.Z) | L.4.23 |
| B8114 | (I.Z) | L.4.24 |
| B8115 | (I.Z) | L.4.25 |
| B8116 | (I.Z) | L.4.26 |
| B8117 | (I.Z) | L.4.27 |
| B8118 | (I.Z) | L.4.28 |
| B8119 | (I.Z) | L.4.29 |
| B8120 | (I.Z) | L.4.30 |
| B8121 | (I.Z) | L.4.31 |
| B8122 | (I.Z) | L.4.32 |
| B8123 | (I.Z) | L.4.33 |
| B8124 | (I.Z) | L.5.1 |
| B8125 | (I.Z) | L.5.2 |
| B8126 | (I.Z) | L.5.3 |
| B8127 | (I.Z) | L.5.4 |
| B8128 | (I.Z) | L.5.5 |
| B8129 | (I.Z) | L.5.6 |
| B8130 | (I.Z) | L.5.7 |
| B8131 | (I.Z) | L.5.8 |
| B8132 | (I.Z) | L.5.9 |
| B8133 | (I.Z) | L.5.10 |
| B8134 | (I.Z) | L.5.11 |
| B8135 | (I.Z) | L.5.12 |
| B8136 | (I.Z) | L.5.13 |
| B8137 | (I.Z) | L.5.14 |
| B8138 | (I.Z) | L.5.15 |
| B8139 | (I.Z) | L.5.16 |
| B8140 | (I.Z) | L.5.17 |
| B8141 | (I.Z) | L.5.18 |
| B8142 | (I.Z) | L.5.19 |
| B8143 | (I.Z) | L.5.20 |
| B8144 | (I.Z) | L.5.21 |
| B8145 | (I.Z) | L.5.22 |
| B8146 | (I.Z) | L.5.23 |
| B8147 | (I.Z) | L.5.24 |
| B8148 | (I.Z) | L.5.25 |
| B8149 | (I.Z) | L.5.26 |
| B8150 | (I.Z) | L.5.27 |
| B8151 | (I.Z) | L.5.28 |
| B8152 | (I.Z) | L.5.29 |
| B8153 | (I.Z) | L.5.30 |
| B8154 | (I.Z) | L.5.31 |
| B8155 | (I.Z) | L.5.32 |
| B8156 | (I.Z) | L.5.33 |
| B8157 | (I.Z) | L.5.34 |
| B8158 | (I.Z) | L.5.35 |
| B8159 | (I.Z) | L.5.36 |
| B8160 | (I.Z) | L.5.37 |
| B8161 | (I.Z) | L.5.38 |
| B8162 | (I.Z) | L.5.39 |
| B8163 | (I.Z) | L.5.40 |
| B8164 | (I.Z) | L.5.41 |
| B8165 | (I.Z) | L.5.42 |
| B8166 | (I.Z) | L.5.43 |
| B8167 | (I.Z) | L.5.44 |
| B8168 | (I.Z) | L.5.45 |
| B8169 | (I.Z) | L.5.46 |
| B8170 | (I.Z) | L.5.47 |
| B8171 | (I.Z) | L.5.48 |
| B8172 | (I.Z) | L.5.49 |
| B8173 | (I.Z) | L.5.50 |
| B8174 | (I.Z) | L.5.51 |
| B8175 | (I.Z) | L.5.52 |
| B8176 | (I.Z) | L.5.53 |
| B8177 | (I.Z) | L.5.54 |
| B8178 | (I.Z) | L.5.55 |
| B8179 | (I.Z) | L.5.56 |
| B8180 | (I.Z) | L.5.57 |
| B8181 | (I.Z) | L.5.58 |
| B8182 | (I.Z) | L.5.59 |
| B8183 | (I.Z) | L.5.60 |
| B8184 | (I.Z) | L.5.61 |
| B8185 | (I.Z) | L.5.62 |
| B8186 | (I.Z) | L.5.63 |
| B8187 | (I.Z) | L.5.64 |
| B8188 | (I.Z) | L.5.65 |
| B8189 | (I.Z) | L.5.66 |
| B8190 | (I.Z) | L.5.67 |
| B8191 | (I.Z) | L.5.68 |
| B8192 | (I.Z) | L.5.69 |
| B8193 | (I.Z) | L.5.70 |
| B8194 | (I.Z) | L.5.71 |
| B8195 | (I.Z) | L.5.72 |
| B8196 | (I.Z) | L.5.73 |
| B8197 | (I.Z) | L.5.74 |
| B8198 | (I.Z) | L.5.75 |
| B8199 | (I.Z) | L.5.76 |
| B8200 | (I.Z) | L.5.77 |
| B8201 | (I.Z) | L.5.78 |
| B8202 | (I.Z) | L.5.79 |
| B8203 | (I.Z) | L.5.80 |
| B8204 | (I.Z) | L.5.81 |
| B8205 | (I.Z) | L.5.82 |
| B8206 | (I.Z) | L.5.83 |
| B8207 | (I.Z) | L.5.84 |
| B8208 | (I.Z) | L.6.1 |
| B8209 | (I.Z) | L.6.2 |
| B8210 | (I.Z) | L.6.3 |
| B8211 | (I.Z) | L.6.4 |
| B8212 | (I.Z) | L.6.5 |
| B8213 | (I.Z) | L.6.6 |
| B8214 | (I.Z) | L.6.7 |
| B8215 | (I.Z) | L.6.8 |
| B8216 | (I.Z) | L.6.9 |
| B8217 | (I.Z) | L.6.10 |
| B8218 | (I.Z) | L.6.11 |
| B8219 | (I.Z) | L.6.12 |
| B8220 | (I.Z) | L.6.13 |
| B8221 | (I.Z) | L.6.14 |
| B8222 | (I.Z) | L.6.15 |
| B8223 | (I.Z) | L.6.16 |
| B8224 | (I.Z) | L.6.17 |
| B8225 | (I.Z) | L.6.18 |

B = Mixture;
I = compound I;
II = compound II

Table 75: The binary mixtures A8500 to A8827 correspond to the mixtures B1 to B328, wherein compound I.A is replaced by compound I.AA.

Table 76: The binary mixtures A9000 to A9327 correspond to the mixtures B1 to B328, wherein compound I.A is replaced by compound I.AB.

Table 77: The binary mixtures A9500 to A9827 correspond to the mixtures B1 to B328, wherein compound I.A is replaced by compound I.AC.

Table 78: The binary mixtures A10000 to A10327 correspond to the mixtures B1 to B328, wherein compound I.A is replaced by compound I.AD.

Table 79: The binary mixtures A10500 to A10827 correspond to the mixtures B1 to B328, wherein compound I.A is replaced by compound I.AE.

Table 80: The binary mixtures A11000 to A11327 correspond to the mixtures B1 to B328, wherein compound I.A is replaced by compound I.AF.

Table 81: The binary mixtures A11500 to A11827 correspond to the mixtures B1 to B328, wherein compound I.A is replaced by compound I.AG.

Table 82: The binary mixtures A12000 to A12327 correspond to the mixtures B1 to B328, wherein compound I.A is replaced by compound I.AH.

Table 83: The binary mixtures A12500 to A12827 correspond to the mixtures B1 to B328, wherein compound I.A is replaced by compound I.AI.

Table 84: The binary mixtures A13000 to A13327 correspond to the mixtures B1 to B328, wherein compound I.A is replaced by compound I.AJ.

Table 85: The binary mixtures A13500 to A13827 correspond to the mixtures B1 to B328, wherein compound I.A is replaced by compound I.AK.

Table 86: The binary mixtures A14000 to A14327 correspond to the mixtures B1 to B328, wherein compound I.A is replaced by compound I.AL.

Table 87: The binary mixtures A14500 to A14827 correspond to the mixtures B1 to B328, wherein compound I.A is replaced by compound I.AM.

Table 88: The binary mixtures A15000 to A15327 correspond to the mixtures B1 to B328, wherein compound I.A is replaced by compound I.AN.

Table 89: The binary mixtures A15500 to A15827 correspond to the mixtures B1 to B328, wherein compound I.A is replaced by compound I.AO.

Table 90: The binary mixtures A16000 to A16327 correspond to the mixtures B1 to B328, wherein compound I.A is replaced by compound I.AP.

Table 91: The binary mixtures A16500 to A16827 correspond to the mixtures B1 to B328, wherein compound I.A is replaced by compound I.AQ.

Table 92: The binary mixtures A17000 to A17327 correspond to the mixtures B1 to B328, wherein compound I.A is replaced by compound I.AR.

Table 93: The binary mixtures A17500 to A17827 correspond to the mixtures B1 to B328, wherein compound I.A is replaced by compound I.AS.

Table 94: The binary mixtures A18000 to A18327 correspond to the mixtures B1 to B328, wherein compound I.A is replaced by compound I.AT.

Table 95: The binary mixtures A18500 to A18827 correspond to the mixtures B1 to B328, wherein compound I.A is replaced by compound I.AU.

Table 96: The binary mixtures A19000 to A19327 correspond to the mixtures B1 to B328, wherein compound I.A is replaced by compound I.AV.

Table 97: The binary mixtures A19500 to A19827 correspond to the mixtures B1 to B328, wherein compound I.A is replaced by compound I.AW.

Table 98: The binary mixtures A20000 to A20327 correspond to the mixtures B1 to B328, wherein compound I.A is replaced by compound I.AX.

Among the mixtures of tables 50 to 98, the mixtures comprising L.1.1, L.1.7, L.1.2, L.1.13, L.1.14, L.1.15, L.1.16, L.1.17, L.1.19, L.1.23, L.1.25, L.1.26, L.1.30, L.1.32, L.1.34, L.1.36, L.1.38, L.1.40, L.1.41, L.1.43, L.1.44, L.1.48, L.1.49, L.1.51, L.1.52, L.1.53, L.1.54, L.1.57, L.1.59, L.1.60, L.1.63, L.1.66, L.1.68, L.1.70, L.1.72, L.1.75, L.1.76, L.1.77, L.1.78, L.1.79, L.1.80, L.1.81, L.1.82, L.1.83, L.1.85, L.1.87, L.1.91, L.1.92, L.1.93 or L.1.96 are preferred mixtures according to the invention.

Among the mixtures of tables 50 to 98, the mixtures comprising L.2.1, L.2.2 or L.2.8 are preferred mixtures according to the invention.

Among the mixtures of tables 50 to 98, the mixtures comprising L.3.3, L.3.18, L.3.20, L.3.21, L.3.28, L.3.30, L.3.32, L.3.39, L.3.41, L.3.46, L.3.54, L.3.55, L.3.58, L.3.61, L.3.62 or L.3.63 are preferred mixtures according to the invention.

Among the mixtures of tables 50 to 98, the mixtures comprising L.4.9, L.4.13, L.4.31 or L.4.29 are preferred mixtures according to the invention.

Among the mixtures of tables 50 to 98, the mixtures comprising L.5.4, L.5.12, L.5.13, L.5.16, L.5.17, L.5.41, L.5.48, L.5.9, L.5.10, L.5.16, L.5.17, L.5.24, L.5.26, L.5.27, L.5.28, L.5.35, L.5.37, L.5.38, L.5.42, L.5.47, L.5.52, L.5.58, L.5.63, L.5.64, L.5.65, L.5.66, L.5.71, L.5.72, L.5.73, L.5.76, L.5.78, L.5.79, L.5.80, L.5.81, L.5.82, L.5.83 or L.5.84 are preferred mixtures according to the invention.

Among the mixtures of tables 50 to 98, the mixtures comprising L.6.10 or L.6.17 are preferred mixtures according to the invention.

The biopesticides from group L1) and/or L2) may also have insecticidal, acaricidal, molluscidal, pheromone, nematicidal, plant stress reducing, plant growth regulator, plant growth promoting and/or yield enhancing activity.

The biopesticides from group L3) and/or L4) may also have fungicidal, bactericidal, viricidal, plant defense activator, plant stress reducing, plant growth regulator, plant growth promoting and/or yield enhancing activity.

The biopesticides from group L5) and/or L6) may also have fungicidal, bactericidal, viricidal, plant defense activator, insecticidal, acaricidal, molluscidal, pheromone and/or nematicidal activity.

Many of these biopesticides have been deposited under deposition numbers mentioned herein (the prefaces refer to the acronym of the respective culture collection), are referred to in literature, registered and/or are commercially available: aluminium silicate (Screen™ Duo from Certis LLC, USA), Agrobacterium radiobacter K1026 (e.g. NoGall® from BASF Agricultural Specialties Pty Ltd, Australia), A. radiobacter K84 (Nature 280, 697-699, 1979; e.g. GallTroll® from AG Biochem, Inc., C, USA), Ampelomyces quisqualis M-10 (e.g. AQ 10® from Intrachem Bio GmbH & Co. KG, Germany), Ascophyllum nodosum (Norwegian kelp, Brown kelp) extract or filtrate (e.g. ORKA GOLD from BASF Agricultural Specialities (Pty) Ltd., South Africa; or Goemar® from Laboratoires Goemar, France), Aspergillus flavus NRRL 21882 isolated from a peanut in Georgia in 1991 by USDA, National Peanut Research Laboratory (e.g. in Afla-Guard® from Syngenta, CH), mixtures of Aureobasidium pullulans DSM14940 and DSM 14941 (e.g. blastospores in Blossom Protect® from bio-ferm GmbH, Germany), Azospirillum amazonense SpY2 (DN: BR 11140; Proc. 9^{th} Int. and 1^{st} Latin American PGPR meeting, Quimara, Medellin, Colombia 2012, p. 60, ISBN 978-958-46-0908-3), A. brasilense AZ39 (also called Az 39; INTA Az-39; Eur. J. Soil Biol 45(1), 28-35, 2009), A. brasilense XOH (e.g. AZOS from Xtreme Gardening, USA or RTI Reforestation Technologies International; USA), A. brasilense BR 11002 (Proc. 9^{th} Int. and 1^{st} Latin American PGPR meeting, Quimara, Medellin, Colombia 2012, p. 60, ISBN 978-958-46-0908-3), A. brasilense Sp245 (BR 11005; e.g. in GELFIX Gramineas from BASF Agricultural Specialties Ltd., Brazil), A. brasilense strains Ab-V5 and Ab-V6 (e.g. in AzoMax from Novozymes BioAg Produtos papra Agricultura Ltda., Quattro Barras, Brazil or SimbioseMaiz® from Simbiose-Agro, Cruz Alta, RS, Brazil; Plant Soil 331, 413-425, 2010), A. lipoferum BR 11646 (Sp31) (Proc. 9^{th} Int. and 1^{st} Latin American PGPR meeting, Quimara, Medellin, Colombia 2012, p. 60), Bacillus altitudinis 41KF2b (DSM 21631; Int. J. Syst. Evol. Microbiol. 56(7), 1465-1473, 2006), Bacillus amyloliquefaciens strains AP-136 (NRRL B-50614 and B-50330), AP-188 (NRRL B-50615 and B-50331), AP-218 (NRRL B-50618), AP-219 (NRRL B-50619 and B-50332), and AP-295 (NRRL B-50620 and B-50333) all known from U.S. Pat. No. 8,445,255; B. amyloliquefaciens IT-45 (CNCM I-3800) (e.g. Rhizocell C from ITHEC, France), B. amyloliquefaciens IN937a (J. Microbiol. Biotechnol. 17(2), 280-286, 2007; e.g. BioYield® from Gustafson LLC, TX, USA), B. amyloliquefaciens spp. plantarum D747 (US 20130236522 A1; FERM BP-8234; e.g. Double Nickel™ 55 WDG or Double Nickel™ LC from Certis LLC, USA), B. amyloliquefaciens spp. plantarum FZB24 isolated from plant pathogen-infested soil of a sugar beet field in Brandenburg, Germany (also called SB3615; DSM ID 96-2; J. Plant Dis. Prot. 105, 181-197, 1998; e.g. Taegro® from Novozyme Biologicals, Inc., USA),), B. amyloliquefaciens spp. plantarum SB3615vPPI being a phage-resistant variant of FZB24 (MRRL B-50349; US 2011/023045 A1; from Novozyme Biologicals, Inc., USA), B. amyloliquefaciens ssp. plantarum FZB42 isolated from plant pathogen-infested soil of a sugar beet field in Brandenburg, Germany (J. Plant Dis. Prot. 105, 181-197, 1998; DSM 23117; e.g. RhizoVital® 42 from AbiTEP GmbH, Berlin, Germany), B. amyloliquefaciens ssp. plantarumGB03 (also called GBO3; ATCC SD-1397; Phytopathol. 86(11), S36, 1996; e.g. Kodiak® or BioYield® from Gustafson, Inc., USA; or Companion® from Growth Products, Ltd., White Plains, N.Y. 10603, USA), B. amyloliquefaciens ssp. plantarum M B1600 also referred to as 1430 (NRRL B-50595; Int. J. Microbiol. Res. 3(2) (2011), 120-130; US 2012/0149571 A1; e.g. Integral®, Subtilex® NG from BASF Corp., USA), B. amyloliquefaciens spp. plantarum TJ1000 (also called 1 BE; CA 2471555 A1; ATCC BAA-390; e.g. QuickRoots™ from TJ Technologies, Watertown, S. Dak., USA), B. cereus CNCM I-1562 (U.S. Pat. No. 6,406,690), B. chitinosporus AQ746 isolated from roots in Saskatchewan, Canada (NRRL B-21618; U.S. Pat. No. 5,733,544; AgraQuest now Bayer CropScience LP, USA), B. firmus CNCM I-1582 (WO2009/126473, WO2009/124707, U.S. Pat. No. 6,406,690; e.g. Votivo® from Bayer CropScience LP, USA), Bacillus licheniformis strain RTI184 deposited as ATCC No. PTA-121722 and Bacillus licheniformis CH200 deposited as Accession No. DSM 17236 (known from US 2014/870,477 from FMC Corporation, Philadelphia (USA)), Bacillus licheniformis strain SB3086 having the ATCC Deposit No. 55406 (known from U.S. Ser. No. 10/043,297 from Novozymes, USA.), B. megaterium strains H491 (NRRL B-50769), M018 (NRRL B-50770) and J142 (NRRL B-50771) all known from US 2014/0051571 A1 from Marrone BioInnovations, Inc., USA; B. mojavensis AP-209 (NRRL B-50616; U.S. Pat. No. 8,445,255), B. mycoides AQ726 (NRRL B-21664; U.S. Pat. No. 5,906,818; from Bayer Crop Science, Germany), B. mycoides strain J (e.g. BmJ WG from Certis, USA against potato virus Y), B. pumilus GB34 (ATCC 700814; e.g. YieldShield® from Gustafson LLC, TX, USA), B. pumilus GHA 180 isolated from apple tree rhizosphere in Mexico (IDAC 260707-01; e.g. in PRO-MIX® BX from Premier Horticulture, 1, avenue Premier, Rivie're-du-Loup, Quebec, Canada G5R6C1), B. pumilus KFP9F (NRRL B-50754; WO2014/029697; e.g. BAC-UP or FUSION—P from BASF Agricultural Specialities (Pty) Ltd., South Africa), B. pumilus INR-7 otherwise referred to as BU-F22 and BU-F33 (NRRL B-50185, NRRL B-50153; U.S. Pat. No. 8,445,255), B. pumilus QST 2808 (NRRL B-30087; e.g. Sonata® or Ballad® Plus from AgraQuest Inc., USA), B. solisalsi AP-217 (NRRL B-50617; U.S. Pat. No. 8,445,255), B. subtilis CX-9060 (Federal Register 77(7), 1633-1637; by Certis U.S.A., L.L.C.), B. subtilis FB17 also called UD 1022 or UD10-22 isolated from red beet roots in North America (ATCC PTA-11857; System. Appl. Microbiol. 27, 372-379, 2004; US 2010/0260735; WO 2011/109395); B. subtilis GB07 (Phytopathol. 86(11), S36, 1996; Epic® from Gustafson, Inc., USA), B. subtilis QST-713 isolated from a California peach orchard in 1995 (NRRL B-21661; e.g. Rhapsody®, Serenade® MAX or Serenade® ASO from AgraQuest Inc., USA), B. thuringiensis ssp. aizawai ABTS-1857 (also called ABG-6346; ATCC SD-1372; e.g. XenTari® from BioFa AG, Münsingen, Germany), B. t. ssp. aizawai SAN 401 I, ABG-6305 (WO 2013/087709); Bacillus t. ssp. israelensis AM65-52 of Serotype H-14 (ATCC SD-1276; e.g. VectoBac® from Valent BioSciences, IL, USA), Bacillus thuringiensis ssp. kurstaki SB4 (NRRL B-50753; e.g. Beta Pro® from BASF Agricultural Specialities (Pty) Ltd., South Africa), B. t. ssp. kurstaki ABTS-351 identical to HD-1 (ATCC SD-1275; e.g. Dipel® DF from Valent BioSciences, IL, USA), B. t. ssp. kurstaki EG 2348 (NRRL B-18208; e.g. Lepinox® or Rapax® from CBC (Europe) S.r.I., Italy), B. t. ssp. tenebrionis DSM 2803 of Serotype H 8a, 8b (identical to NRRL B-15939; EP 0 585 215 B1; Mycogen Corp.), B. t. ssp. tenebrionis NB-125 (also referred to as SAN 418 I or ABG-6479; EP 0 585 215 B1; DSM 5526; former production strain of Novo-Nordisk), B. t. ssp. tenebrionis NB-176 (or NB-176-1; a gamma-irradiated, induced high-yielding mutant of strain NB-125; EP 585 215 B1; DSM 5480; e.g. Novodor® from Valent BioSciences, Switzerland), Beauveria bassiana JW-1 (ATCC 74040; e.g. Naturalis® from CBC (Europe) S.r.I., Italy), B. bassiana DSM 12256 (US 200020031495; e.g. BioExpert® SC from Live Sytems Technology S.A., Colombia), B. bassiana GHA (ATCC 74250; e.g. BotaniGard® 22WGP from Laverlam Int. Corp., USA), B. bassiana PPRI 5339 (ARSEF 5339; NRRL 50757; e.g. BroadBand® from BASF Agricultural Specialities (Pty) Ltd., South Africa), B. brongniartii for control of cockchafer (J. Appl. Microbiol. 100(5),1063-72, 2006; e.g. Melocont® from Agrifutur, Agrianello, Italy), Bradyrhizobium sp. (e.g. Vault® from BASF Corp., USA), B. sp. (Arachis) CB1015 presumably originally collected in India (IITA 1006, USDA 3446; from Australian Inoculants Research Group; http://www.gaseeds.com.au/inoculant_applic.php). B. sp. (Arachis) strains deposited at SEMIA and known from FEMS Microbiol. Letters 303(2), 123-131, 2010; Revista Brasileira de Ciencia do Solo 35(3), 739-742, 2011, ISSN 0100-0683: SEMIA 6144, SEMIA 6462 (BR 3267) and SEMIA 6464 (BR 3262); B. sp. (Vigna) PNL01 (Bisson and Mason, Apr. 29, 2010, Project report, Worcester Polytechnic Institute, Worcester, Mass., USA: http://www.wpi.edu/Pubs/E-project/Available/E-project-042810-163614/; e.g. Vault® Peanut Liquid from BASF Corp., USA), B. elkanii SEMIA 587 (Appl. Environ. Microbiol. 73(8), 2635, 2007; e.g. GELFIX 5 from BASF Agricultural Specialties Ltd., Brazil), B. elkanii SEMIA 5019 (=29W; Appl. Environ. Microbiol. 73(8), 2635, 2007; e.g. GELFIX 5 from BASF Agricultural Specialties Ltd., Brazil), B. elkanii USDA 76, B. elkanii USDA 94, B. elkanii USDA 3254, B. elkanii U-1301 and U-1302 (e.g. Nitragin® Optimize from Novozymes Bio As S.A., Brazil, or Nlitrasec for soybean from LAGE y Cia, Brazil), B. japonicum (e.g. VAULT® from BASF Corp., USA), B. japonicum 532c isolated from Wisconsin field (Nitragin 61A152; Can. J. Plant. Sci. 70, 661-666, 1990; e.g. in Rhizoflo®, Histick®, Hicoat® Super from BASF Agricultural Specialties Ltd., Canada), B. japonicum E-109 variant of strain USDA 138 (INTA E109, SEMIA 5085; Eur. J. Soil Biol. 45, 28-35, 2009; Biol. Fertil. Soils 47, 81-89, 2011), B. japonicumG49 (MSDJ G49; C. R. Acad. Agric. Fr. 73, 163-171, 1987); B. japonicum strains deposited at SEMIA known from Appl. Environ. Microbiol. 73(8), 2635, 2007: SEMIA 566 isolated from North American inoculant in 1966 and used in Brazilian commercial inoculants from 1966 to 1978, SEMIA 586 originally isolated in Maryland, USA, in 1961 but received from Australia in 1966 and used in Brazilian inoculants in 1977 (CB 1809, USDA 136, Nitragin 61A136, RCR 3407), SEMIA 5079 a natural variant of SEMIA 566 used in commercial inoculants since 1992 (CPAC 15; e.g. GELFIX 5 or ADHERE 60 from BASF Agricultural Specialties Ltd., Brazil), B. japonicum SEMIA 5080 a natural variant of SEMIA 586 used in commercial inoculants since 1992 (CPAC 7; e.g. GELFIX 5 or ADHERE 60 from BASF Agricultural Specialties Ltd., Brazil); B. japonicum TA-11 (TA11 NOD*) (NRRL B-18466; U.S. Pat. No. 5,021,076; Appl. Environ. Microbiol. 56, 2399-2403, 1990; e.g. VAULT® NP, from BASF Corp., USA), B. japonicum strains deposited at USDA known from U.S. Pat. No. 7,262,151 and Appl. Environ. Microbiol. 60, 940-94, 1994: USDA 3 isolated from Glycine max in Virginia (USA) in 1914, USDA 31 (=Nitragin 61A164) od Serogroup 31 isolated from Glycine max in Wisconsin (USA) in 1941, USDA 76 isolated from plant passage of strain USDA 74 (Serogroup 76) which has been isolated from G. max in California (USA) in 1956, USDA 110 (=IITA 2121, SEMIA 5032, RCR 3427, ARS 1-110 and Nitragin 61A89; Serogroup 110) isolated from G. max in Florida in 1959, USDA 121 isolated from G. max in Ohio (USA) in 1965 (Crop Science 26(5), 911-916, 1986); B. japonicum WB74 (e.g. Eco-Rhiz Soya from Plant Health Products (Pty) Ltd, South Africa; or Soybean inoculant from Stimuplant CC, South Africa), B. lupini LL13 isolated from Lupinus luteus nodules from French soils (deposited at INRA, France; http://agriculture.gouv.fr/IMG/pdf/ch20060216.pdf), B. lupini strains from Australia and known from Palta J. A., Berger J. B. (eds), Proceed. 12th International Lupin Conference, 14-18 Sep. 2008, Fremantle, Western Australia, International Lupin Association, Canterbury, New Zealand, 47-50, http://www.lupins.org/pdf/conference/2008/Agronomy%20and%20Production/John%20Howieson%20and%20G%20OHara.pdf; Appl. Environ. Microbiol. 71, 7041-7052, 2005; Australian J. Exp. Agricult. 36(1), 63-70, 1996: strains WU425 isolated in Esperance, Western Australia from a non-Australian legume Ornithopus compressus, WSM471 isolated from Ornithopus pinnatus in Oyster Harbour, Western Australia, and WSM4024 isolated from lupins in Australia by CRS during a 2005 survey; Burkholderiasp. A396 (NRRL B-50319; WO 2013/032693; Marrone Bio Innovations, Inc., USA), Candida oleophila I-182 (NRRL Y-18846; Phytoparasitica 23(3), 231-234, 1995; e.g. Aspire® from Ecogen Inc., USA;), C. oleophila strain 0 (NRRL Y-2317; Biological Control 51, 403-408, 2009), Candida saitoana (e.g. Biocure® [in mixture with lysozyme] and BioCoat® from Micro Flo Company, USA (BASF SE) and Arysta), chitosan (e.g. Armour-Zen® from BotriZen Ltd., NZ), Clonostachys rosea f. catenulate (also named Gliocladium catenulatum) J1446 isolated from Finnish field soil (NJF seminar No 389: Pest, disease and weed management in strawberry; Finland 8-9. November 2006 in NJF Report 2(10), 15-15, 2006; DSM 9212; e.g. Primastop® or Prestop® from Verdera Oy, Finland), Chromobacterium subtsugae PRAA4-1 isolated from soil under an eastern hemlock (Tsuga canadensis) in the Catoctin Mountain region of central Maryland (NRRL B-30655; e.g. Grandevo® from Marrone Bio Innovations, USA), Coniothyrium minitans CON/M/91-08 (WO1996/021358; DSM 9660; e.g. Contans® WG, Intercept® WG from Prophyta Biologischer Pflanzenschutz GmbH, Germany), Cryphonectria parasitica (hypovirulent strains; Microbiol. Reviews 56(4), 561-576, 1992; e.g. product Endothia parasitica from CNICM, France), Cryptococcus albidus (e.g. YIELD PLUS® from Anchor Bio-Technologies, South Africa), Cryptophlebia leucotreta granulovirus (CrleGV) (e.g. CRYPTEX from Adermatt Biocontrol, Switzerland), Cydia pomonella granulovirus (CpGV) V03 (DSM GV-0006; e.g. Madex® Max from Andermatt Biocontrol, Switzerland), CpGV V22 (DSM GV-0014; e.g. Madex® Twin from Adermatt Biocontrol, Switzerland), Delftia acidovorans RAY209 (ATCC PTA-4249; WO 2003/57861; e.g. BioBoost® from Brett Young, Winnipeg, Canada), Dilophosphora alopecuri (FarmNote 396, February 2010, Department of Agriculture and Food, Government of Western Australia; e.g. Twist Fungus from BASF Agricultural Specialties Pty Ltd, Australia), Ecklonia maxima (kelp) extract (J. Ecological Engineering 14(1), 48-52, 2013; e.g. KELPAK SL from Kelp Products Ltd, South Africa), Flavobacterium sp. H492 (ATCC B-505584; WO 2013/138398; e.g. MBI-302 from Marrone Bio Innovations, USA for soybean cyst nematode control), formononetin (U.S. Pat. No. 5,002,603; e.g. Myconate® from Plant Health Care plc, U.K.), Fusarium oxysporum Fo47 (non-pathogenic strain isolated from a suppressive soil located at Chåteaurenard, France; Appl. Environ. Microbiol 68(8), 4044-4060, 2002; Fusaclean® from Natural Plant Protection, N.P.P. (société anonyme) Route d′Artix F-64150 Nogueres, France), F. oxysporum 251/2RB (Prevention Today Vol. 2, n. 1-2, 47-62, 2006; e.g. Biofox® C from S.I.A.P.A., Italy); Glomus intraradices(e.g. Myc® 4000 from ITHEC, France), Glomus intraradices RTI-801 (e.g. MYKOS from Xtreme Gardening, USA or RTI Reforestation Technologies International; USA), grapefruit seeds and pulp extract (e.g. BC-1000 from Chemie S.A., Chile), harpin (alpha-beta) protein (Science 257, 85-88, 1992; e.g. Messenger™ or HARPN-Tek from Plant Health Care plc, U.K.), Helicoverpa armigera nucleopolyhedrovirus (HearNPV) (J. Invertebrate Pathol. 107, 112-126, 2011; e.g. Helicovex® from Adermatt Biocontrol, Switzerland), Heterorhabditis bacteriophora (e.g. Nemasys® G from BASF Agricultural Specialities Limited, UK), Isaria fumosorosea Apopka-97 (ATCC 20874; Biocontrol Science Technol. 22(7), 747-761, 2012; e.g. PFR-97™ or PreFeRal® from Certis LLC, USA), I. fumosorosea FE 9901 (ARSEF 4490; Biocontrol Science Technol. 22(7), 747-761, 2012; e.g. blastospores in NoFly™ WP from Natural Industries, Inc., Houston, Tex., USA or from Novozymes, U.S.A.), cis-jasmone (U.S. Pat. Nos. 6,890,525; 8,221,736; Plant Bioscience Limited, Norwich, U.K.), laminarin (e.g. in Vacciplant® from Laboratoires Goemar, St. Malo, France or Stähler SA, Switzerland), Lecanicillium longisporum KV42 and KV71 (e.g. Vertalec® from Koppert BV, Netherlands), L. muscarium Ve6 (also called KV01; IMI 19-79, CABI 268317, CBS 102071, ARSEF 5128; e.g. Mycotal® from Koppert BV, Netherlands), Lysobacter antibioticus 13-1 (Biological Control 45, 288-296, 2008), L. antibioticus HS124 (Curr. Microbiol. 59(6), 608-615, 2009), L. enzymogenes 3.1T8 (Microbiol. Res. 158, 107-115, 2003; Biological Control 31(2), 145-154, 2004); Melaleuca alternifolia extract (Mesorhizobium spp. strains known from Soil Biol. Biochem. 36(8), 1309-1317, 2004; Plant and Soil 348(1-2), 231-243, 2011: M. sp. WSM1271 collected in Sardinia, Italy, from plant host Biserrula pelecinus, M. sp. WSM 1497 collected in Mykonos, Greece, from Biserrula pelecinus, Mesorhizobium ciceri CC1192 collected in Israel from Cicer arietinum nodules (UPM 848, CECT 5549; Can. J. Microbiol. 48, 279-284, 2002; from Horticultural Research Station, Gosford, Australia), M. huakuill-IN3015 isolated from Astralagus sinicus in a rice-growing field of Southern China (World J. Microbiol. Biotechn. 23(6), 845-851, 2007, ISSN 0959-3993), M. loti CC829 isolated from L. ulginosus nodules in USA (NZP 2012; commerical inoculant for Lotus pedunculatus and L. ulginosus in Australia), and M. loti SU343 isolated from host nodules in USA (commercial inoculant for Lotus corniculatus in Australia); Metarhizium anisopliae FI-1045 (AGAL V10/0104285; WO 2012/018266; e.g. Biocane® from BASF Agricultural Specialties Pty Ltd, Australia), M. anisopliae var. anisopliae F52 also called 275 or V275 (DSM 3884, ATCC 90448; e.g. Met52® Novozymes Biologicals BioAg Group, Canada), M. anisopliae ICIPE 69 isolated from a soil sample obtained from the Democratic Republic of Congo (DRC) and using the Galleria bait method in 1990 (e.g. Metathripol from ICIPE, Nairobe, Kenya), M. anisopliae var. acridum IMI 330189 isolated from Ornithacris cavroisi in Niger (NRRL 50758; e.g. Green Muscle® from BASF Agricultural Specialities (Pty) Ltd., South Africa), M. a. var. acridum FI-985 isolated from a spur-throated locust, Austracris guttulosa (Walker), near Rockhampton, Queensland, Australia, in 1979 (ARSEF 324; Memoirs of the Entomological Society of Canada 171, 287-300, 1997; e.g. Green Guard® SC from BASF Agricultural Specialties Pty Ltd, Australia), Metschnikowia fructicola 277 isolated from the surface of grape berries (cv. Superior) grown in the central part of Israel (U.S. Pat. No. 6,994,849; NRRL Y-30752; e.g. Shemer® from Agrogreen, Israel, now distributed by Bayer CropSciences, Germany), Microdochium dimerum L13 (CNCM I-3141; e.g. Antibot® from Agrauxine, France), Microsphaeropsis ochracea P130A isolated from apple leaves from an abandoned orchard, St-Joseph-du-Lac, Quebec, Canada in 1993 (ATCC 74412; Mycologia 94(2), 297-301, 2002), Muscodor albus QST 20799 also called 620 originally isolated from the bark of a cinnamon tree in Honduras (NRRL 30547; e.g. Muscudor™ or QRD300 from AgraQuest, USA), Muscodor albus SA-13 (NRRL B-50774; US 2014/0086879 A1; e.g. MBI-601-EP from Marrone BioInnovations, Inc., USA), Neem oil (e.g. Trilogy®, Triact® 70 EC from Certis LLC, USA), Nomuraea rileyi strains SA86101, GU87401, SR86151, CG128 and VA9101 (Braz. Arch. Biol. Technol. 46(1), 13-19, 2003; WO2013/110594), Paecilomyces lilacinus 251 isolated from infected nematode eggs in the Philippines (AGAL 89/030550; WO1991/02051; Crop Protection 27, 352-361, 2008; e.g. BioAct®/MeloCon® from Prophyta, Germany), P. lilacinus DSM 15169 (e.g. Nemata® SC from Live Systems Technology S.A., Colombia), P. lilacinus BCP2 (NRRL 50756; Acta agriculturae Slovenica, 101-2, 263-275, 2013; e.g. PL Gold from BASF Agricultural Specialities (Pty) Ltd., South Africa), Paenibacillus alvei NAS6G6 (WO 2014/029697; NRRL B-50755; e.g. BAC-UP from BASF Agricultural Specialities (Pty) Ltd., South Africa in mixture with Bacillus pumilus KFP9F), P. polymyxa PKB1 (ATCC 202127; Can. J. Microbiol. 48(2), 159-169, 2002), Paenibacillus polymyxa Lu16774 (Accession No. DSM 26969), Paenibacillus polymyxa Lu17007 (Accession No. DSM 26970), Paenibacillus sp. Lu17015 (Accession No. DSM 26971; the Paenibacillus strains Lu16774, Lu 17007 and Lu17015 have been isolated from soil samples from a variety of European locations including Germany and deposited under the Budapest Treaty with the Deutsche Sammlung von Mikroorganismen and Zellkulturen (DSMZ) under the abovementioned Accession numbers on February 201h, 2013 by BASF SE, Germany; the Paenibacillus strains Lu16774, Lu 17007 and Lu17015 are known from WO2016/020371 and the unpublished applications PCT/EP2017/052532 and PCT/EP2017/052535 from BASF SE, Germany), Paenibacillus sp. strain NRRL B-50972 and Paenibacillus sp. strain NRRL B-67129 are known from WO2016/154297, Pantoea agglomerans E325 (NRRL B-21856; Phytopathol. 101(10), 1234-41, 2011; Trees 26, 227-238, 2012; Bloomtime Biological™ from Northwest Agricultural Products, Inc., USA), Pantoea vagans (formerly agglomerans) C9-1 originally isolated in 1994 from apple stem tissue for control of fire blight in apple (J. Bacteriol. 192(24), 6486-6487, 2010; e.g. BlightBan C9-1® from NuFrams America Inc., USA), Pasteuria sp. ATCC PTA-9643 (WO 2010/085795), Pasteuria sp. Ph3 isolated from turfgrass soil samples collected at the DeBary Golf Course in central Florida (ATCC SD-5832; WO2012/064527; for control of Hoplolaimus galeatus nematode from Pasteuria Bioscience, Inc. now Syngenta Crop Protection, LLC, USA), Pasteuria sp. Pr3 isolated from soil samples collected in the southeastern United States (ATCC SD-5834; for control of Rotylenchulus reniformis nematode potentially of species P. ramosa; Naviva® ST from Syngenta Crop Protection, LLC, USA), P. nishizawae (WO2010/80619), P. nishizawae Pn1 (Federal Register 76(22), 5808, Feb. 2, 2011; ATCC SD-5833; e.g. Clariva™ PN from Syngenta Crop Protection, LLC, USA), P. penetrans (U.S. Pat. No. 5,248,500; Del Monte Corp.), P. ramosa (WO 2010/080619), P. thornea (WO2010/080619), P. usgae BL1 (ATCC SD-5835; J. Nematol. 42(2): 87-90, 2010; ibid. 43(2), 101-109, 2011; e.g. Econem™ for control of Belonolaimus longicaudatus from Pasteuria BioScience now Syngenta sold by Harell's LLC, Florida, USA for use on turf for management of Belonolaimus longicaudatus), Penicillium bilaiae (also called P. bilaii) strains ATCC 18309 (=ATCC 74319), ATCC 20851 and/or ATCC 22348 (=ATCC 74318) originally isolated from soil in southern Alberta (Fertilizer Res. 39, 97-103, 1994; Can. J. Plant Sci. 78(1), 91-102, 1998; U.S. Pat. No. 5,026,417, WO 1995/017806; e.g. Jump Start®, Provide® from Novozymes Biologicals BioAg Group, Canada), P. bilaiae NRRL 50162 and NRRL 50169 (WO 2010/037228), Phlebiopsis gigantea (e.g. RotStop® from Verdera Oy, Finland), Pichia anomala WRL-076 (NRRL Y-30842; U.S. Pat. No. 8,206,972), potassium bicarbonate (e.g. Amicarb® from Stähler SA, Switzerland), potassium silicate (e.g. Sil-MATRIX™ from Certis LLC, USA), Pseudozyma flocculosa PF-A22 UL (e.g. Sporodex® L from Plant Products Co. Ltd., Canada), Pseudomonassp. Proradix (DSM 13134; WO 2001/40441, e.g. PRORADIX from Sourcon Padena GmbH & Co. KG, Hechinger Str. 262, 72072 Tubingen, Germany), P. chlororaphis MA 342 (Microbiology Monographs 18, 21-43, 2011; e.g. Cerall® or Cedemon® from BioAgri AB, Uppsala, Sweden or Intrachem Bio Deutschland GmbH & Co. KG, Bad Camberg, Germany), P. fluorescens (e.g. in Bio Cure-B from T. Stanes & Company Limited, India; or in Blight-End from Agri Naturals, Mumbai, India), P. fluorescens A506 (Phytopathol 97(2), 244-249, 2007; ATCC 31948; e.g. BlightBan® from NuFarm Americas, Inc., Morrisville, N.C., USA), P. fluorescens ATCC 13525 of biovar I=biotype A; originally isolated from pre-filter tanks in England (DSM 50090; registered for use in Canada), P. fluorescens CHAO (Mol. Plant Microbe Interact. 5(1), 4-13, 1992), P. fluorescens CL 145A (J. Invertebr. Pathol. 113(1), 104-14, 2013; e.g. Zequanox® from Marrone BioInnovations, Davis, Calif., USA), P. fluorescens NCIB 12089 (EP 0210734 AI; Victus® from Mauri Laboratories, 9 Moorebank Ave., Moorebank, NSW 2170, Australia), P. fluorescens Pf-5 isolated from root surface of cotton (ATCC BAA-477), P. putida ATCC 202153 (EMBRAPA 63/88 4 B; WO 2004/0245865), Pythium oligandrum DV 74 (US 2013/0035230; ATCC 38472; e.g. Poyversum® from Remeslo SSRO, Biopreparaty, Czech Rep. and from Gowan, USA), Reynoutria sachalinensis extract (EP 0307510 B1; e.g. Regalia® SC from Marrone BioInnovations, Davis, Calif., USA or Milsana® from BioFa AG, Germany), Rhizobium leguminosarum bv. phaseoli(e.g. RHIZO-STICK from BASF Corp., USA), R. leguminosarum bv. phaseoli RG-B10 (USDA 9041; from Int. J. Syst. Bacteriol. 46(1), 240-244, 1996; Int. J. Syst. Evol. Microbiol. 50, 159-170, 2000; e.g. Nodulator® Dry Bean in Africa, Histick NT Dry bean in US, and Nodulator® Dry Bean in Canada from BASF Corp., USA, or BASF Agricultural Specialties Ltd., Canada), R. I. bv. trifolii CB782 (Nodulaid® peat for Kenya white clover from BASF Agricultural Specialties Pty Ltd, Australia), R. I. bv. trifolii CC275e (Nodulaid® peat for NZ white clover from BASF Agricultural Specialties Pty Ltd, Australia), R. I. bv. trifolii CC283b (ICMP 4073b; Proc. New Zealand Grassland Assoc. 56, 101-105, 1994; Microbiol. 153, 3184-3195, 2007; Nodulaid® peat for Caucasian clover from BASF Agricultural Specialties Pty Ltd, Australia), R. I. bv. trifolii CC1099 (Inoculating Legumes: A Practical Guide, ed. Grain Research and Development Corporation, 2012, ISBN 978-1-921779-45-9; e.g. Nodulaid® peat for sainfoin from BASF Agricultural Specialties Pty Ltd, Australia), R. I. bv. trifolii RP113-7 (Appl. Environ. Microbiol. 44(5), 1096-1101, 1982; e.g. Dormal® from BASF Corp., USA), R. I. bv. trifolii TA1 (Appl. Environ. Microbiol. 49(1), 127-131, 1985; e.g. Nodulaid® peat for white clover from BASF Agricultural Specialties Pty Ltd, Australia), R. I. bv. trifolii strain WSM1325 isolated in 1993 from the Greek Island of Serifos (Stand. Genomic Sci. 2(3), 347-356, 2010; Inoculating Legumes: A Practical Guide, ed. Grain Research and Development Corporation, 2012, ISBN 978-1-921779-45-9; Nodulaid® peat for sub clover and Nodulator® granules for sub clover both from BASF Agricultural Specialties Pty Ltd, Australia, for a broad range of annual clovers of Mediterranean origin), R. I. bv. trifolii strain WSM2304 isolated from Trifolium polymorphum in Uruguay in 1998 (Stand. Genomic Sci. 2(1), 66-76, 2010), R. I. bv. viciae P1NP3Cst being a Streptomycin-resistant mutant of P1NP3C isolated from pea root nodules in Bretenière, France (also referred to as 1435; New Phytol. 176, 680-690, 2007; ibid. 179(1), 224-235, 2008; e.g. Nodulator® PL Peat Granule from BASF Corp., USA; or Nodulator® XL PL from BASF Agricultural Specialties Ltd., Canada), R. I. bv. viciae RG-P2 also called P2 isolated from pea root nodules in Saskatchewan, Canada (e. g RhizUP peat for peas and lentils in Canada from BASF Agricultural Specialties Ltd., Canada), R. bv. viciae SU303 (e.g. Nodulaid® Group E from BASF Agricultural Specialties Pty Ltd, Australia), R. I. bv. viciae WSM1455 (e.g. Nodulaid® Group F from BASF Agricultural Specialties Pty Ltd, Australia), R. tropici CC511 (Agronomy, N.Z. 36, 4-35, 2006; e.g. Nodulaid® peat for common bean from BASF Agricultural Specialties Pty Ltd, Australia) R. tropici CIAT 899 isolated in Colombia (SEMIA 4077; Rev. Ciênc. Agron. 44(4) Fortaleza October/December 2013; e.g. Nitrafix® FEIJÃO peat for beans from BASF Agricultural Specialties Ltd., Brazil in mixture with strain SEMIA 4080), R. tropici H12 isolated in Planaltina, DF, Cerrados, Brazil (SEMIA 4088; Appl. Microbiol. Biotechnol. 93(5), 2035-49, 2012; e.g. Nitrafix® FEIJÃO from BASF Agricultural Specialties Ltd., Brazil), R. tropici PRF 81 isolated in Paraná, Brazil (SEMIA 4080; Soil Biology & Biochemistry 39, 867-876, 2007; BMC Microbiol. 12, 84, 2012; Nitrafix® FEIJÃO peat for beans from BASF Agricultural Specialties Ltd., Brazil in mixture with strain SEMIA 4077), Sinorhizobium meliloti RCR2011 also called 2011 or SU47 (MSDJ0848; Mol. Gen. Genomics 272, 1-17, 2004; e.g. Dormal® Alfalfa & Luzerne from BASF Corp., USA; Nitragin® Gold from Novozymes Biologicals BioAg Group, Canada), Sphaerodes mycoparasitica SMCD2220 also called SMCD2220-01 (IDAC 301008-01; WO 2011/022809), Spodoptera littoralis nucleopolyhedrovirus (SpliNPV) (e.g. in LITTOVIR from Adermatt Biocontrol, Switzerland), Steinernema carpocapsae (e.g. Millenium® from BASF Agricultural Specialities Limited, UK), S. feltiae (Nemashield® from BioWorks, Inc., USA; Nemasys® from BASF Agricultural Specialities Limited, UK), S. kraussei L137 (Nemasys® L from BASF Agricultural Specialities Limited, UK), Streptomyces galbus AQ6047 (NRRL 30232; WO 2012/135763; AgraQuest now Bayer CropScience LP, USA); S. galbus M1064 (NRRL 50334; WO 2012/135763; AgraQuest now Bayer CropScience LP, USA); S. griseoviridis K61 (Crop Protection 25, 468-475, 2006; e.g. Mycostop® from Verdera Oy, Espoo, Finland), S. lydicus WYEC 108 (U.S. Pat. No. 5,403,584; e.g. Actinovate® from Natural Industries, Inc., USA), S. violaceusniger YCED-9 (U.S. Pat. No. 5,968,503; e.g. DT-9® from Natural Industries, Inc., USA), Talaromyces flavus V117b isolated from soil (e.g. Protus® WG from Prophyta, Germany), Trichoderma asperellum SKT-1 isolated from the rhizosphere of Japanese lawngrass (FERM P-16510; J. Gen. Plant Pathol. 71(5), 351-356, 2005; e.g. Eco-Hope® from Kumiai Chemical Industry Co., Ltd., Japan), T. asperellum ICC 012 isolated from a soil in central Italy that was found to suppress plant disease (IMI 392716; e.g. Tenet WP, Remdier WP or Bioten WP from Isagro NC, USA, Bio-Tam™ from AgraQuest, USA), T. asperellum TV1 formerly T. viride (MUCL 43093; e.g. T. viride TV1 from Agribiotec srl, Italy or Xedavir from Xeda Italia, Italy), T. atroviride LC52 (e.g. Sentinel® from Agrimm Technologies Ltd, NZ), T. atroviride CNCM I-1237 (e.g. Esquive® WG from Agrauxine S.A., France, e.g. against pruning wound diseases on vine and plant root pathogens), T. fertile JM41R (NRRL 50759; e.g. Trichoplus™ from BASF Agricultural Specialities (Pty) Ltd., South Africa), T. gamsii ICC 080 (IMI 392151; e.g. Tenet WP, Remdier WP, Bioten WP from Isagro NC, USA, Bio-Tam™ from AgraQuest, USA), T. harzianum T-22 also called KRL-AG2 (ATCC 20847; BioControl 57, 687-696, 2012; e.g. Plantshield® from BioWorks Inc., USA or SabrEx™ from Advanced Biological Marketing Inc., Van Wert, Ohio, USA), T. harzianum T-35 and T-315 (ATCC 20691; EP 0133878 B1; e.g. Root Pro® from Mycontrol Ltd., Israel), T. harzianum T-39 (CNCM I-952; EP 0466133 B2; e.g. Trichodex® or Trichoderma 2000® from Mycontrol Ltd., Israel and Makhteshim Ltd., Israel), mixture of T. harzianum and T. viride (e.g. Trichopel® from Agrimm Technologies Ltd, NZ), mixture of T. harzianum ICC012 and T v/ride ICC080 (e.g. Remdier® WP from Isagro Ricerca, Italy), T. polysporum IMI 206039 (ATCC 20476; e.g. Binab® from BINAB Bio-Innovation AB, Sweden in mixture with T. atroviride IMI 206040), T. stromaticum (e.g. Tricovab@ from C.E.P.L.A.C., Brazil), T. virensGI-3 also called G1-3 or GL-3 (CA2471555 A1; ATCC 58678; e.g. QuickRoots™ from TJ Technologies, Watertown, S. Dak., USA in mixture with B. amyloliquefaciens TJ1000), T. sirens GL-21 also called G1-21 isolated from a sclerotium of Sclerotinia minor (U.S. Pat. No. 7,429,477; e.g. Soilguard® 12G from Certis LLC, USA; EPA Registration Number: 70051-3 and EPA Establishment Number: 067250-IL-001), T. virens G-41 also called 041, #41X or ABM 127 isolated from soil samples taken from Aphanomyces-suppressive bean fields in Livingston County, New York (ATCC 20906; U.S. Pat. No. 4,996,157; e.g. Root-shield® PLUS from BioWorks, Inc., USA), T. viride (J. Biological Control 23(1), 31-36, 2009; e.g. Trieco® from Ecosense Labs. (India) Pvt. Ltd., India; or Bio-Cure® F from T. Stanes & Co. Ltd., India), and Ulocladium oudemansii HRU3 (Agronomy 3, 632-647, 2013; e.g. Botry-Zen® from Botry-Zen Ltd, NZ).

Strains can be obtained from culture collections and deposition centers (listed by their acronym=strain prefix here: http://www.wfcc.info/ccinfo/collection/by_acronym/) such as strains with prefaces AGAL or NMI from: National Measurement Institute, 1/153 Bertie Street, Port Melbourne, Victoria, Australia 3207; ATCC: American Type Culture Collection, 10801 University Blvd., Manassas, Va. 20110-2209, USA; BR: Embrapa Agrobiology Diazothrophic Microbial Culture Collection, P.O. Box 74.505, Seropedica, Rio de Janeiro, 23.851-970, Brazil; CABI or IMI: CABI Europe—International Mycological Institute, Bakeham Lane, Egham, Surrey, TW20 9TYNRRL, UK; CB: The CB Rhizobium Collection, School of Environment and Agriculture, University of Western Sydney, Hawkesbury, Locked Bag 1797, South Penrith Distribution Centre, NSW 1797, Australia; CBS: Centraalbureau voor Schimmelcultures, Fungal Biodiversity Centre, Uppsalaan 8, PO Box 85167, 3508 AD Utrecht, Netherlands; CC: Division of Plant Industry, CSIRO, Canberra, Australia; CNCM: Collection Nationale de Cultures de Microorganismes, Institute Pasteur, 25 rue du Docteur Roux, F-75724 PARIS Cedex 15; CPAC: Embrapa-Cerrados, CX. Postal 08223,Planaltina, DF, 73301-970, Brazil; DSM: Leibniz-lnstitut DSMZ-Deutsche Sammlung von Mikroorganismen and Zellkulturen GmbH, Inhoffenstraße 7 B, 38124 Braunschweig, Germany; IDAC: International Depositary Authority of Canada Collection, Canada; ICMP: International Collection of Micro-organisms from Plants, Landcare Research, Private Bag 92170, Auckland Mail Centre, Auckland 1142, New Zealand; IITA: IITA, PMB 5320, Ibadan, Nigeria; INTA: Agriculture Collection Laboratory of the Instituto de Microbiologia y Zoologia Agricola (IMYZA), Instituto Nacional de Tecnologi'a Agropecuaria (INTA), Castelar, Argentina; MSDJ: Laboratoire de Microbiologie des Sols, INRA, Dijon, France; MUCL: Mycothèque de l'Université catholique de Louvain, Croix du Sud 2, box L7.05.06, 1348 Louvain-la-Neuve, Belgium; NCIMB or NICB: The National Collections of Industrial and Marine Bacteria Ltd., Torry Research Station, P.O. Box 31, 135 Abbey Road, Aberdeen, AB9 8DG, Scotland; Nitragin: Nitragin strain collection, The Nitragin Company, Milwaukee, Wis., USA, NRRL or ARSEF (collection of entomopathogenic fungi): ARS Culture Collection of the National Center for Agricultural Utilization Research, Agricultural Research Service, U.S. Department of Agriculture, 1815 North University Street, Peoria, Ill. 61604, USA; NZP: Department of Scientific and Industrial Research Culture Collection, Applied Biochemistry Division, Palmerston North, New Zealand; PPRI: ARC-Plant Protection Research Institute, Private Bag X134, Queenswood Pretoria, Gauteng, 0121, South Africa; SEMIA: FEPAGRO-Fundação Estadual de Pesquisa Agropecuária, Rua Gonçalves Dias, 570, Bairro Menino Deus, Porto Alegre/RS, Brazil; SRDI: SARDI, Adelaide, South Australia; USDA: U.S. Department of Agriculture, Agricultural Research Service, Soybean and Alfalfa Research Laboratory, BARC-West, 10300 Baltimore Boulevard, Building 011, Beltsville, Md. 20705, USA (Beltsville Rhiz. Cult. Catalog: http://pdf.usaid.gov/pdf_docs/PNAAW891.pdf); and WSM: Murdoch University, Perth, Western Australia. Further strains may be found at: http://gcm.wfcc.info/; http://www.landcareresearch.co.nz/resources/collections/icmp.

Fusaricidins are a group of antibiotics isolated from Paenibacillus spp., which belong to the class of cyclic lipodepsipeptides. Among isolated fusaricidin antibiotics, fusaricidin A has shown the most promising antimicrobial activity against a variety of clinically relevant fungi and gram-positive bacteria such a Staphylococcus aureus (MIC value range: 0.78-3.12 μg/ml) (ChemMedChem 7, 871-882, 2012). Fusaricidins A, B, C and D are also reported to inhibit plant pathogenic fungi such as Fusarium oxysporum, Aspergillus niger, Aspergillus oryzae, and Penicillum thomii (J. Antibiotics 49(2), 129-135, 1996; J. Antibiotics 50(3), 220-228, 1997). Fusaricidins such as Li-F05, LI-F07 and LI-F08 have been found to have certain antifungal activity against various plant pathogenic fungi such as Fusarium moniliforme, F. oxysporum, F. roseum, Giberella fujkuroi, Helminthosporium sesamum and Penicillium expansum (J. Antibiotics 40(11), 1506-1514, 1987). Fusaricidins also have antibacterial activity to Gram-positive bacteria including Staphylococcus aureus (J. Antibiotics 49, 129-135, 1996; J. Antibiotics 50, 220-228, 1997). In addition, fusaricidins have antifungal activity against Leptosphaeria maculans which causes black root rot of canola (Can. J. Microbiol. 48, 159-169, 2002). Moreover, fusaricidins A and B and two related compounds thereof, wherein D-allo-Thr is bound via its hydroxyl group to an additional alanine using an ester bridge, produced by certain Paenibacillus strains were found to induce resistance reactions in cultured parsley cells and to inhibit growth of Fusarium oxysporum (WO2006/016558; EP1 788 074 A1). WO2007/086645 describes the fusaricidin synthetase enzyme and its encoding gene as isolated from Paenibacillus polymyxa strain E681 which enzyme is involved in the synthesis of fusaricidins A, B, C, D, LI-F03, LI-F05, LI-F07 and LI-F08. The genome of several Paenibacillus polymyxa strains has been published so far: inter alia for strain M-1 (NCBI acc. no. NC_017542; J. Bacteriol. 193 (29), 5862-63, 2011; BMC Microbiol. 13, 137, 2013), strain CR1 (GenBank acc. no. CP006941; Genome Announcements 2 (1), 1, 2014) and strain SC2 (GenBank acc. nos. CP002213 and CP002214; NCBI acc. no. NC_014622; J. Bacteriol. 193 (1), 311-312, 2011), for further strains see legend of FIG. 12 herein. The P. polymyxa strain M-1 has been deposited in China General Microbiological Culture Collection Center (CGMCC) under acc. no. CGMCC 7581. Fusaricidins isolated from Paenibacillus polymyxa include LI-F03, LI-F04, LI-F05, LI-F07 and LI-F08 (Kurusu K, Ohba K, Arai T and Fukushima K., J. Antibiotics, 40: 1506-1514, 1987) and additional fusaricidins A, B, C and D have been reported (Kajimura Y and Kaneda M., 1. Antibiotics, 49: 129-135, 1996; Kajimura Y and Kaneda M., J. Antibiotics, 50:220-228, 1997).

Fusaricidins 1A and 1B are known from WO2016/020371. Respective pesticidal mixtures comprising fusaricidins 1 A and/or 1B are known from the yet unpublished applications PCT/EP2017/052532 and PCT/EP2017/052535.

In one embodiment, compound II is a fusaricidin selected from the group consisting of fusaricidin A, fusaricidin B, fusaricidin C and fusaricidin D.

In one embodiment, compound II is a fusaricidin selected from the group consisting of LI-F04c, LI-F04d, LI-F05a, LI F06a, LI F06b, LI-F08a, LI-F08b, compound 1A and compound 1B.

In a preferred embodiment, compound II is a fusaricidin selected from compound 1A and/or compound 1B.

Paeniserines and paeniprolixines are known from WO2016/154297.

In one embodiment, compound II is a paeniserine selected from the group consisting of paeniserin A1, paeniserin B1, paeniserin A2, paeniserin A3, paeniserin A4, paeniserin B2, paeniserin B3, paeniserin B4, paeniserin C1, paeniserin C2, paeniserin C3, paeniserin C4, paeniserin D1, paeniserin D2, paeniserin D3, and paeniserin D4.

In one embodiment, compound II is a paeniprolixine selected from the group consisting of paeniprolixin A2, paeniprolixin B2, paeniprolixin C1, paeniprolixin A1, paeniprolixin B1, paeniprolixin C2, paeniprolixin D1, paeniprolixin D2, paeniprolixin E1, paeniprolixin E2, paeniprolixin F1, paeniprolixin F2, paeniprolixin G1, and paeniprolixin G2.

Jasmonic acid, its salts (jasmonates) or derivatives include without limitation potassium, sodium, lithium, ammonium, dimethylammonium, isopropylammonium, diolammonium and diethtriethanolammonium jasmonate; and also jasmonic acid methyl ester, jasmonic acid amide, jasmonic acid methylamide, jasmonic acid-L-amino acid (amide-linked) conjugates (e.g. conjugates with L-isoleucine, L-valine, L-leucine, or L-phenylalanine), 12-oxo-phytodienoic acid, coronatine, coronalon, coronafacoyl-L-serine, coronafacoyl-L-threonine, methyl esters of 1-oxo-indanoyl-isoleucine, methyl esters of 1-oxo-indanoyl-leucine, cis-jasmone, linoleic acid or derivatives thereof, and combinations of any of the above.

Humates are humic and fulvic acids extracted from a form of lignite coal and clay, known as leonardite. Humic acids are organic acids that occur in humus and other organically derived materials such as peat and certain soft coal. They have been shown to increase fertilizer efficiency in phosphate and micro-nutrient uptake by plants as well as aiding in the development of plant root systems.

The present invention furthermore relates to agrochemical compositions comprising a mixture of at least one compound I and at least one compound II selected from the group L), in particular at least one further fungicidal biopesticide selected from the groups L1) and L2), as described above, and if desired at least one suitable auxiliary.

The inventive mixtures comprising as compound II a microbial pesticide from groups L1), L3) and L5) may be formulated as an inoculant for a plant. The term “inoculant” means a preparation that includes an isolated culture of a microbial pesticide and optionally a carrier, which may include a biologically acceptable medium.

According to one embodiment, the microbial pesticides selected from groups L1), L3) and L5) embrace not only the isolated, pure cultures of the respective micro-organism as defined herein, but also its cell-free extract, its suspensions in a whole broth culture or as a metabolite-containing supernatant or a purified metabolite obtained from a whole broth culture of the microorganism or microorganism strain.

According to a further embodiment, the microbial pesticides selected from groups L1), L3 and L5) embraces not only the isolated, pure cultures of the respective micro-organism as defined herein, but also a cell-free extract thereof or at least one metabolite thereof, and/or a mutant of the respective micro-organism having all the identifying characteristics thereof and also a cell-free extract or at least one metabolite of the mutant.

The abovementioned microbial pesticides from groups L1), L3) and L5) may be isolated or substantially purified. The terms “isolated” or “substantially purified” refers to microbial pesticides that have been removed from a natural environment and have been isolated or separated, and are at least 60% free, preferably at least 75% free, and more preferably at least 90% free, even more preferably at least 95% free, and most preferably at least 100% free from other components with which they were naturally associated. An “isolated culture” or “substantially purified culture” refers to a culture of the microbial pesticides that does not include significant amounts of other materials such as other materials which normally are found in natural habitat in which the microbial pesticides grows and/or from which the microbial pesticides normally may be obtained. An “isolated culture” may be a culture that does not include any other biological, microorganism, and/or bacterial species in quantities sufficient to interfere with the replication of the isolated culture. Isolated cultures of microbial pesticides may, however, be combined to prepare a mixed culture of microbial pesticides.

Herein, microbial pesticides may be supplied in any physiological state such as active or dormant. Dormant microbial pesticides may be supplied for example frozen, dried, or lyophilized or partly desiccated (procedures to produce partly desiccated organisms are given in WO2008/002371) or in form of spores.

Microbial pesticides selected from groups L1), L3) and L5) used as organism in an active state can be delivered in a growth medium without any additional additives or materials or in combination with suitable nutrient mixtures.

The mixtures and compositions according to the invention can also be present together with further pesticides, e.g. with herbicides, insecticides, growth regulators, fungicides; or else with fertilizers, as pre-mix or, if appropriate, not until immediately prior to use (tank mix).

In one embodiment, the mixture according to the invention comprises as active components one active compound I (nitrification inhibitor), or an agriculturally useful salt thereof, and one active compound II (biopesticide) selected from groups L1) to L6) and one active compound III selected from group of herbicides, insecticides, growth regulators, fungicides, urease inhibitors, nitrification inhibitors, and denitrification inhibitors.

Mixing a composition comprising at least one compound I and at least one compound II with further fungicides results in many cases in an improvement of the nitrification inhibition effect and/or an improvement of the health of a plant and/or an improvement of the plant growth regulation. Furthermore, in many cases, synergistic effects are obtained.

Mixing a composition comprising at least one compound I and at least one compound II with further fungicides results in many cases in an expansion of the fungicidal spectrum of activity or in a prevention of fungicide resistance development. Furthermore, in many cases, synergistic effects are obtained.

Mixing a composition comprising at least one compound I and at least one compound II with further insecticides results in many cases in an expansion of the insecticidal spectrum of activity or in a prevention of insecticide resistance development. Furthermore, in many cases, synergistic effects are obtained.

The mixtures and compositions according to the invention are suitable as nitrification inhibitors, improvers for the plant yield, or improvers for the plant health.

The mixtures and compositions according to the invention are also suitable as fungicides. They are distinguished by an outstanding effectiveness against a broad spectrum of phytopathogenic fungi, including soil-borne fungi, which derive especially from the classes of the Plasmodiophoromycetes, Peronosporomycetes (syn. Oomycetes), Chytridiomycetes, Zygomycetes, Ascomycetes, Basidiomycetes and Deuteromycetes (syn. Fungi imperfecti). Some are systemically effective and they can be used in crop protection as foliar fungicides, fungicides for seed dressing and soil fungicides. Moreover, they are suitable for controlling harmful fungi, which inter alia occur in wood or roots of plants.

The mixtures and compositions according to the invention are particularly important in the control of a multitude of phytopathogenic fungi on various cultivated plants, such as cereals, e.g. wheat, rye, barley, triticale, oats or rice; beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (table grapes and grape juice grape vines); hop; turf; natural rubber plants or ornamental and forestry plants, such as flowers, shrubs, broad-leaved trees or evergreens, e.g. conifers; and on the plant propagation material, such as seeds, and the crop material of these plants.

Preferably the inventive mixtures and compositions are used for controlling a multitude of fungi on field crops, such as potatoes sugar beets, tobacco, wheat, rye, barley, oats, rice, corn, cotton, soybeans, rape, legumes, sunflowers, coffee or sugar cane; fruits; vines; ornamentals; or vegetables, such as cucumbers, tomatoes, beans or squashes.

The term “plant propagation material” is to be understood to denote all the generative parts of the plant such as seeds and vegetative plant material such as cuttings and tubers (e.g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil.

These young plants may also be protected before transplantation by a total or partial treatment by immersion or pouring.

Preferably, treatment of plant propagation materials with the inventive mixtures and compositions thereof, respectively, is used for controlling a multitude of fungi on cereals, such as wheat, rye, barley and oats; rice, corn, cotton and soybeans.

The term “cultivated plants” is to be understood as including plants which have been modified by breeding, mutagenesis or genetic engineering including but not limiting to agricultural biotech products on the market or in development (cf. http://cera-gmc.org/, see GM crop database therein). Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-transitional modification of protein(s), oligo- or polypeptides e.g. by glycosylation or polymer additions such as prenylated, acetylated or farnesylated moieties or PEG moieties.

Plants that have been modified by breeding, mutagenesis or genetic engineering, e.g. have been rendered tolerant to applications of specific classes of herbicides, such as hydroxyphenylpyruvate dioxygenase (HPPD) inhibitors; acetolactate synthase (ALS) inhibitors, such as sulfonyl ureas (see e.g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073) or imidazolinones (see e.g. U.S. Pat. No. 6,222,100, WO 01/82685, WO 00/026390, WO 97/41218, WO 98/002526, WO 98/02527, WO 04/106529, WO 05/20673, WO 03/014357, WO 03/13225, WO 03/14356, WO 04/16073); enolpyruvylshikimate-3-phosphate synthase (EPSPS) inhibitors, such as glyphosate (see e.g. WO 92/00377); glutamine synthetase (GS) inhibitors, such as glufosinate (see e.g. EP-A 242 236, EP-A 242 246) or oxynil herbicides (see e.g. U.S. Pat. No. 5,559,024) as a result of conventional methods of breeding or genetic engineering. Several cultivated plants have been rendered tolerant to herbicides by conventional methods of breeding (mutagenesis), e.g. Clearfield® summer rape (Canola, BASF SE, Germany) being tolerant to imidazolinones, e.g. imazamox. Genetic engineering methods have been used to render cultivated plants such as soybean, cotton, corn, beets and rape, tolerant to herbicides such as glyphosate and glufosinate, some of which are commercially available under the trade names RoundupReady® (glyphosate-tolerant, Monsanto, U.S.A.) and LibertyLink® (glufosinate-tolerant, Bayer CropScience, Germany).

Furthermore, plants are also covered that are by the use of recombinant DNA techniques capable to synthesize one or more insecticidal proteins, especially those known from the bacterial genus Bacillus, particularly from Bacillus thuringiensis, such as 6-endotoxins, e.g. CryIA(b), CryIA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, e.g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, e.g. WO02/015701). Further examples of such toxins or genetically modified plants capable of synthesizing such toxins are disclosed, e.g., in EP-A374753, WO93/007278, WO95/34656, EP-A427529, EP-A451 878, WO03/18810 and WO03/52073. The methods for producing such genetically modified plants are generally known to the person skilled in the art and are described, e.g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal proteins are, e.g., described in the publications mentioned above, and some of which are commercially available such as YieldGard® (corn cultivars producing the CryIAb toxin), YieldGard® Plus (corn cultivars producing CryIAb and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the CryIAc toxin), Bollgard® I (cotton cultivars producing the CryIAc toxin), Bollgard® II (cotton cultivars producing CryIAc and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protecta®, Bt11 (e.g. Agrisure® CB) and Bt176 from Syngenta Seeds SAS, France, (corn cultivars producing the Cry1Ab toxin and PAT enyzme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the CryIAc toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g. EP-A 392 225), plant disease resistance genes (e.g. potato cultivars, which express resistance genes acting against Phytophthora infestans derived from the Mexican wild potato Solanum bulbocastanum) or T4-lysozym (e.g. potato cultivars capable of synthesizing these proteins with increased resistance against bacteria such as Erwinia amylvora). The methods for producing such genetically modified plants are generally known to the person skilled in the art and are described, e.g. in the publications mentioned above.

Furthermore, plants are also covered that are by the use of recombinant DNA techniques capable to synthesize one or more proteins to increase the productivity (e.g. bio mass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e.g. oil crops that produce health-promoting long-chain omega-3 fatty acids or unsaturated omega-9 fatty acids (e.g. Nexera® rape, DOW Agro Sciences, Canada).

Furthermore, plants are also covered that contain by the use of recombinant DNA techniques a modified amount of substances of content or new substances of content, specifically to improve raw material production, e.g. potatoes that produce increased amounts of amylopectin (e.g. Amflora® potato, BASF SE, Germany).

The inventive mixtures and compositions are particularly suitable for controlling the following plant diseases:

Albugo spp. (white rust) on ornamentals, vegetables (e.g. A. candida) and sunflowers (e.g. A. tragopogonis); Alternaria spp. (Alternaria leaf spot) on vegetables, rape (A. brassicola or brassicae), sugar beets (A. lentils), fruits, rice, soybeans, potatoes (e.g. A. solani or A. alternata), tomatoes (e.g. A. solani or A. alternata) and wheat; Aphanomyces spp. on sugar beets and vegetables; Ascochyta spp. on cereals and vegetables, e.g. A. tritici (anthracnose) on wheat and A. hordei on barley; Bipolaris and Drechslera spp. (teleomorph: Cochliobolus spp.) on corn (e.g. D. maydis), cereals (e.g. B. sorokiniana: spot blotch), rice (e.g. B. oryzae) and turfs; Blumeria (formerly Erysiphe) graminis (powdery mildew) on cereals (e.g. on wheat or barley); Botrytis cinerea (teleomorph: Botryotinia fuckeliana: grey mold) on fruits and berries (e.g. strawberries), vegetables (e.g. lettuce, carrots, celery and cabbages), rape, flowers, vines, forestry plants and wheat; Bremia lactucae (downy mildew) on lettuce;
Ceratocystis (syn. Ophiostoma) spp. (rot or wilt) on broad-leaved trees and evergreens, e.g. C. ulmi (Dutch elm disease) on elms; Cercospora spp. (Cercospora leaf spots) on corn, rice, sugar beets (e.g. C. beticola), sugar cane, vegetables, coffee, soybeans (e.g. C. sojina or C. kikuchii) and rice; Cladosporium spp. on tomatoes (e.g. C. fulvum: leaf mold) and cereals, e.g. C. herbarum (black ear) on wheat; Claviceps purpurea (ergot) on cereals; Cochliobolus (anamorph: Helminthosporium of Bipolaris) spp. (leaf spots) on corn (C. carbonum), cereals (e.g. C. sativus, anamorph: B. sorokiniana) and rice (e.g. C. mivabeanus, anamorph: H. oryzae); Colletotrichum (teleomorph: Glomerella) spp. (anthracnose) on cotton (e.g. C. gossypii), corn (e.g. C. graminicola), soft fruits, potatoes (e.g. C. coccodes: black dot), beans (e.g. C. lindemuthianum) and soybeans (e.g. C. truncatum or C. gloeosporioides); Corticium spp., e.g. C. sasakii (sheath blight) on rice; Corynespora cassiicola (leaf spots) on soybeans and ornamentals; Cycloconium spp., e.g. C. oleaginum on olive trees; Cylindrocarpon spp. (e.g. fruit tree canker or young vine decline, teleomorph: Nectria or Neonectria spp.) on fruit trees, vines (e.g. C. liriodendri, teleomorph: Neonectria liriodendri: Black Foot Disease) and ornamentals; Dematophora (teleomorph: Rosellinia) necatrix (root and stem rot) on soybeans; Diaporthe spp., e.g. D. phaseolorum (damping off) on soybeans; Drechslera (syn. Helminthosporium, teleomorph: Pyrenophora) spp. on corn, cereals, such as barley (e.g. D. teres, net blotch) and wheat (e.g. D. tritici-repentis: tan spot), rice and turf; Esca (dieback, apoplexy) on vines, caused by Formitiporia (syn. Phellinus) punctata, F. mediterranea, Phaeomoniella chlamydospora (earlier Phaeoacremonium chlamydosporum), Phaeoacremonium aleophilum and/or Botryosphaeria obtusa, Elsinoe spp. on pome fruits (E. pyri), soft fruits (E. veneta: anthracnose) and vines (E. ampelina: anthracnose); Entyloma oryzae (leaf smut) on rice; Epicoccum spp. (black mold) on wheat; Erysiphe spp. (powdery mildew) on sugar beets (E. betae), vegetables (e.g. E. pisi), such as cucurbits (e.g. E. cichoracearum), cabbages, rape (e.g. E. cruciferarum); Eutypa lata (Eutypa canker or dieback, anamorph: Cytosporina lata, syn. Libertella blepharis) on fruit trees, vines and ornamental woods; Exserohilum (syn. Helminthosporium) spp. on corn (e.g. E. turcicum); Fusarium (teleomorph: Gibberella) spp. (wilt, root or stem rot) on various plants, such as F. graminearum or F. culmorum (root rot, scab or head blight) on cereals (e.g. wheat or barley), F. oxysporum on tomatoes, F. solani on soybeans and F. verticillioides on corn; Gaeumannomyces graminis (take-all) on cereals (e.g. wheat or barley) and corn; Gibberella spp. on cereals (e.g. G. zeae) and rice (e.g. G. fujikuror: Bakanae disease); Glomerella cingulata on vines, pome fruits and other plants and G. gossypii on cotton; Grainstaining complex on rice; Guignardia bidwellii (black rot) on vines; Gymnosporangium spp. on rosaceous plants and junipers, e.g. G. sabinae (rust) on pears; Helminthosporium spp. (syn. Drechslera, teleomorph: Cochliobolus) on corn, cereals and rice; Hemileia spp., e.g. H. vastatrix (coffee leaf rust) on coffee; Isariopsis clavispora (syn. Cladosporium vitis) on vines; Macrophomina phaseolina (syn. phaseoli) (root and stem rot) on soybeans and cotton; Microdochium (syn. Fusarium) nivale (pink snow mold) on cereals (e.g. wheat or barley); Microsphaera diffusa (powdery mildew) on soybeans; Monolinia spp., e.g. M. laxa, M. fructicola and M. fructigena (bloom and twig blight, brown rot) on stone fruits and other rosaceous plants; Mycosphaerella spp. on cereals, bananas, soft fruits and ground nuts, such as e.g. M graminicola (anamorph: Septoria tritici, Septoria blotch) on wheat; Peronospora spp. (downy mildew) on cabbage (e.g. P. brassicae), rape (e.g. P. parasitica), onions (e.g. P. destructor), tobacco (P. tabacina) and soybeans (e.g. P. manshurica); Phakopsora pachyrhizi and P. meibomiae (soybean rust) on soybeans; Phialophora spp. e.g. on vines (e.g. P. tracheiphila and P. tetraspora) and soybeans (e.g. P. gregata: stem rot); Phoma lingam (root and stem rot) on rape and cabbage and P. betae (root rot, leaf spot and damping-off) on sugar beets; Phomopsis spp. on sunflowers, vines (e.g. P. viticola: can and leaf spot) and soybeans (e.g. stem rot: P. phaseoli, teleomorph: Diaporthe phaseolorum); Physoderma maydis (brown spots) on corn; Phytophthora spp. (wilt, root, leaf, fruit and stem root) on various plants, such as paprika and cucurbits (e.g. P. capsid), soybeans (e.g. P. megasperma, syn. P. sojae), potatoes and tomatoes (e.g. P. infestans late blight) and broad-leaved trees (e.g. P. ramorum: sudden oak death); Plasmodiophora brassicae (club root) on cabbage, rape, radish and other plants; Plasmopara spp., e.g. P. viticola (grapevine downy mildew) on vines and P. halstedii on sunflowers; Podosphaera spp. (powdery mildew) on rosaceous plants, hop, pome and soft fruits, e.g. P. leucotricha on apples; Polymyxa spp., e.g. on cereals, such as barley and wheat (P. graminis) and sugar beets (P. betae) and thereby transmitted viral diseases; Pseudocercosporella herpotrichoides (eyespot, teleomorph: Tapesia yallundae) on cereals, e.g. wheat or barley; Pseudoperonospora (downy mildew) on various plants, e.g. P. cubensis on cucurbits or P. humili on hop; Pseudopezicula tracheiphila (red fire disease or ‘rotbrenner’, anamorph: Phialophora) on vines; Puccinia spp. (rusts) on various plants, e.g. P. triticina (brown or leaf rust), P. striiformis (stripe or yellow rust), P. hordei (dwarf rust), P. graminis (stem or black rust) or P. recondita (brown or leaf rust) on cereals, such as e.g. wheat, barley or rye, and asparagus (e.g. P. asparagi); Pyrenophora (anamorph: Drechslera) tritici-repentis (tan spot) on wheat or P. teres (net blotch) on barley; Pyricularia spp., e.g. P. oryzae (teleomorph: Magnaporthe grisea, rice blast) on rice and P. grisea on turf and cereals; Pythium spp. (damping-off) on turf, rice, corn, wheat, cotton, rape, sunflowers, soybeans, sugar beets, vegetables and various other plants (e.g. P. ultimum or P. aphanidermatum); Ramularia spp., e.g. R. collo-cygni(Ramularia leaf spots, Physiological leaf spots) on barley and R. beticola on sugar beets; Rhizoctonia spp. on cotton, rice, potatoes, turf, corn, rape, potatoes, sugar beets, vegetables and various other plants, e.g. R. solani (root and stem rot) on soybeans, R. solani (sheath blight) on rice or R. cerealis (Rhizoctonia spring blight) on wheat or barley; Rhizopus stolonifer (black mold, soft rot) on strawberries, carrots, cabbage, vines and tomatoes; Rhynchosporium secalis (scald) on barley, rye and triticale; Sarocladium oryzae and S. attenuatum (sheath rot) on rice; Sclerotinia spp. (stem rot or white mold) on vegetables and field crops, such as rape, sunflowers (e.g. S. sclerotiorum) and soybeans (e.g. S. rolfsi or S. sclerotiorum); Septoria spp. on various plants, e.g. S. glycines (brown spot) on soybeans, S. tritici (Septoria blotch) on wheat and S. (syn. Stagonospora) nodorum (Stagonospora blotch) on cereals; Uncinula (syn. Erysiphe) necator (powdery mildew, anamorph: Oidium tuckeri) on vines; Setospaeria spp. (leaf blight) on corn (e.g. S. turcicum, syn. Helminthosporium turcicum) and turf; Sphacelotheca spp. (smut) on corn, (e.g. S. reiliana: head smut), sorghum and sugar cane; Sphaerotheca fuliginea (powdery mildew) on cucurbits; Spongospora subterranea (powdery scab) on potatoes and thereby transmitted viral diseases; Stagonospora spp. on cereals, e.g. S. nodorum (Stagonospora blotch, teleomorph: Leptosphaeria [syn. Phaeosphaeria] nodorum) on wheat; Synchytrium endobioticum on potatoes (potato wart disease); Taphrina spp., e.g. T. deformans (leaf curl disease) on peaches and T. pruni (plum pocket) on plums; Thielaviopsis spp. (black root rot) on tobacco, pome fruits, vegetables, soybeans and cotton, e.g. T. basicola (syn. Chalara elegans); Tilletia spp. (common bunt or stinking smut) on cereals, such as e.g. T. tritici (syn. T. caries, wheat bunt) and T. controversa (dwarf bunt) on wheat; Typhula incarnata (grey snow mold) on barley or wheat; Urocystis spp., e.g. U. occulta (stem smut) on rye; Uromyces spp. (rust) on vegetables, such as beans (e.g. U. appendiculatus, syn. U. phaseoli) and sugar beets (e.g. U. betae); Ustilago spp. (loose smut) on cereals (e.g. U. nuda and U. avaenae), corn (e.g. U. maydis: corn smut) and sugar cane; Venturia spp. (scab) on apples (e.g. V. inaequalis) and pears; and Verticillium spp. (wilt) on various plants, such as fruits and ornamentals, vines, soft fruits, vegetables and field crops, e.g. V. dahliae on strawberries, rape, potatoes and tomatoes.

In a preferred embodiment the compounds I, mixtures comprising them and agrochemical compositions thereof, respectively, are particularly suitable for controlling the following plant diseases: Puccinia spp. (rusts) on various plants, for example, but not limited to P. triticina (brown or leaf rust), P. striiformis (stripe or yellow rust), P. hordei (dwarf rust), P. graminis (stem or black rust) or P. recondita (brown or leaf rust) on cereals, such as e.g. wheat, barley or rye and Phakopsoraceae spp. on various plants, in particular Phakopsora pachyrhizi and P. meibomiae (soybean rust) on soybeans.

In particular, the mixtures and compositions of the present invention are effective against plant pathogens in specialty crops such as vine, fruits, hop, vegetables and tobacco.

Bacteria pathogenic for plants are responsible for devastating losses in agriculture. The use of antibiotics to control such infections is restricted in many countries due to worries over the evolution and transmission of antibiotic resistance.

The mixtures and compositions according to the invention are also suitable as bactericides. They are distinguished by an outstanding effectiveness against a broad spectrum of phytopathogenic bacteria, including soil-borne bacteria, which derive especially from the genera of Agrobacterium, Clavibacter, Corynebacterium, Erwinia, Leifsonia, Pectobacterium, Pseudomonas, Ralstonia, Xanthomonas (e.g. Xanthomonas oryzae causing bacterial blight on rice) and Xylella; preferably Erwinia; even more preferably Erwinia amylovora causing fire blight on apples, pears and other member of the family Rosaceae.

The mixtures according to the present invention and compositions thereof, respectively, are also suitable for controlling harmful fungi in the protection of stored products or harvest and in the protection of materials. The term “protection of materials” is to be understood to denote the protection of technical and non-living materials, such as adhesives, glues, wood, paper and paperboard, textiles, leather, paint dispersions, plastics, coiling lubricants, fiber or fabrics, against the infestation and destruction by harmful microorganisms, such as fungi and bacteria. As to the protection of wood and other materials, the particular attention is paid to the following harmful fungi: Ascomycetes such as Ophiostoma spp., Ceratocystis spp., Aureobasidium pullulans, Sclerophoma spp., Chaetomium spp., Humicola spp., Petriella spp., Trichurus spp.; Basidiomycetes such as Coniophora spp., Coriolus spp., Gloeophyllum spp., Lentinus spp., Pleurotus spp., Poria spp., Serpula spp. and Tyromyces spp., Deuteromycetes such as Aspergillus spp., Cladosporium spp., Penicillium spp., Trichorma spp., Alternaria spp., Paecilomyces spp. and Zygomycetes such as Mucor spp., and in addition in the protection of stored products and harvest the following yeast fungi are worthy of note: Candida spp. and Saccharomyces cerevisae.

The method of treatment according to the invention can also be used in the field of protecting stored products or harvest against attack of fungi and microorganisms. According to the present invention, the term “stored products” is understood to denote natural substances of plant or animal origin and their processed forms, which have been taken from the natural life cycle and for which long-term protection is desired. Stored products of crop plant origin, such as plants or parts thereof, for example stalks, leafs, tubers, seeds, fruits or grains, can be protected in the freshly harvested state or in processed form, such as pre-dried, moistened, comminuted, ground, pressed or roasted, which process is also known as post-harvest treatment. Also falling under the definition of stored products is timber, whether in the form of crude timber, such as construction timber, electricity pylons and barriers, or in the form of finished articles, such as furniture or objects made from wood. Stored products of animal origin are hides, leather, furs, hairs and the like. The combinations according the present invention can prevent disadvantageous effects such as decay, discoloration or mold. Preferably “stored products” is understood to denote natural substances of plant origin and their processed forms, more preferably fruits and their processed forms, such as pomes, stone fruits, soft fruits and citrus fruits and their processed forms.

The mixtures and compositions according to the invention are particularly important in the control of a multitude of phytopathogenic insects or other pests (e.g. lepidopterans, beetles, dipterans, thrips, heteropterans, hemiptera, homoptera, termites, orthopterans, arachnids, and nematodes) on various cultivated plants, such as cereals, e.g. wheat, rye, barley, triticale, oats or rice; beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (table grapes and grape juice grape vines); hop; turf; natural rubber plants or ornamental and forestry plants, such as flowers, shrubs, broad-leaved trees or evergreens, e.g. conifers; and on the plant propagation material, such as seeds, and the crop material of these plants.

Preferably the inventive mixtures and compositions are used for controlling a multitude of pests on field crops, such as potatoes sugar beets, tobacco, wheat, rye, barley, oats, rice, corn, cotton, soybeans, rape, legumes, sunflowers, coffee or sugar cane; fruits; vines; ornamentals; or vegetables, such as cucumbers, tomatoes, beans or squashes.

The inventive mixtures and the compositions thereof, respectively, are particularly suitable for controlling the following harmful insects from the order of the

lepidopterans (Lepidoptera), for example Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Cheimatobla brumata, Choristoneura fumiferana, Choristoneura occidentalis, Cirphis unipuncta, Cydia pomonella, Dendrolimus pini, Diaphania Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Hellothis virescens, Heliothis zea, Hellula undalis, Hibernia defoliafia, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantfia monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Piers brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis,
beetles (Coleoptera), for example Agrilus sinuatus, Agfiotes lineatus, Agriotes obscurus, Amphimallus solstitialis, Anisandrus dispar, Anthonomus grandis, Anthonomus pomorum, Atomaria liearis, Blastophagus piniperda, Blitophaga undata, Bruchus rufimanus, Bruchus pisorum, Bruchus lentis, Byctiscus betulae, Cassida nebulosa, Cerotoma trifurcata, Ceuthorrhynchus assimilis, Ceuthorrhynchus napi, Chaetocnema tibialis, Conoderus vespertinus, Crioceris asparagi, Diabrotica longicornis, Diabrotica speciosa, Diabrotica 12-punctata, Diabrotica virgifera, Dlloboderus abderus, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius califomicus, Lissorhoptrus oryzophilus, Melanotus communis, Meligethes aeneus, Melolontha hippocastani, Melolontha melolontha, Oulema oryzae, Ortiorrhynchus sulcatus, Oryazophagus oryzae, Otiorrhynchus ovatus, Phaedon cochleariae, Phyllotreta chrysocephala, Phyllophaga sp., Phyllophaga cuyabana, Phyllophaga triticophaga, Phyllopertha horticola, Phyllotreta nemorum, Phyllotreta striolata, Popillia japonica, Sitona lineatus and Sitophllus granaria,
dipterans (Diptera), for example Aedes aegypti, Aedes vexans, Anastrepha ludens, Anopheles macullpennis, Ceratitis capitata, Chrysomya bezziana, Chrysomya hominivorax, Chiysomya macellaria, Contarinia sorghicola, Cordylobia anthropophaga, Culex pipiens, Dacus cucurbitae, Dacus oleae, Dasineura brassicae, Fannia canlculanis, Gasterophilus intestina/is, Glossina morsitans, Haematobia irritans, Haplodiplosis equestris, Hylemyia platura, Hypoderma lineata, Liriomyza sativae, Liriomyza trifolg Lucilia caprina, Lucilia cuprina, Lucilia sericata, Lycoria pectoralis, Mayetiola destructor, Musca domestica, Muscina stabulans, Oestrus ovis, Oscinella frit, Pegomya hysocyami, Phorbia antiqua, Phorbia brassicae, Phorbia coarctata, Rhagoletis cerasi, Rhagoletis pomonella, Tabanus bovinus, Tipula oleracea and Tipula paludosa,
thrips (Thysanoptera), e.g. Frankliniella fusca, Frankliniella occidentalis, Frankliniella tritict, Scirtothrips citri, Thrips oryzae, Thrips palmi and Thrips tabaci,
hymenopterans (Hymenoptera), e.g. Acromyrmex ambuguus, Acromyrmex crassispinus, Acromyrmex heiery, Acromyrmex landolti, Acromyrmex subterraneus, Athalia rosae, Atta capiguara, Atta cephalotes, Atta laevigata, Atta robusta, Atta sexdens, Atta texana, Hoplocampa minuta, Hoplocampa testudinea, Monomorium pharaonis, Solenopsis geminata and Solenopsis invicta,
heteropterans (Heteroptera), e.g. Acrosternum hllare, Blissus leucopterus, Cyrtopeltis notatus, Dichelops furcatus, Dysdercus cingulatus, Dysdercus intermedius, Euchistos heros, Eurygaster integriceps, Euschistus impictiventris, Leptoglossus phyllopus, Lygus lineolaris, Lygus pratensis, Nezara viridula, Piesma quadrata, Piezodorus guildini, Solubea insularis and Thyanta perdilor,

Hemiptera and Homoptera, e.g. Acrosternum hilare, Blissus leucopterus, Cyrtopeltis notatus, Diaphorina citric Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis, Thyanta perditor, Acyrthosiphon onoboichis, Adelges laricis, Aphidula nasturtii, Aphis fabae, Aphis forbest, Aphis pomi, Aphis gossypii, Aphis grossulariae, Aphis schneideri, Aphis spiraecola, Aphis sambuci, Acyrthosiphon pisum, Aulacorthum solani, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus Pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla malt, Psylla oiri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporarlorum, Toxoptera aurantlland, Viteus vitlfolli, Cirnex lectularius, Ciinex hemipterus, Reduvius senilis, Triatoma spp., and Arilus critatus,

termites (Isoptera), e.g. Calotermes flavicollis, Cornitermes cumulans, Heterotermes tents, Leucotermes flavipes, Neocapritemes opacus, Procornilermes triacifer; Reticufitermes lucifugus, Syntermes molestus, and Termes natalensis,
orthopterans (Orthoptera), e.g. Acheta domestica, Blatta orientalis, Blattella germanica, Forficula auricularia, Gryllotalpa Locusta migratoria, Melanoplus blvittatus, Melanoplus femur-rubrum, Melanoplus mexicanus, Melanoplus sanguinipes, Melanoplus spretus, Nomadacris septemfasciata, Periplaneta americana, Schistocerca americana, Schistocerca peregrine, Stauronotus maroccanus and Tachycines asynamorus,
Arachnoidea, such as arachnids, e.g. of the families Argasidae, Ixodidae and Sarcoptidae, such as Amblyomma americanum, Amblyomma variegatum, Argas persicus, Boophllus annulatus, Boophilus decoloratus, Boophllus microplus, Dermacentor silvarum, Hyalomma truncatum, Ixodes ricinus, Ixodes rubicundus, Ornithodorus moubata, Otobius megnio, Dermanyssus gallinae, Psoroptes ovis, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni; Tarsonemidae spp. such as Phytonemus pallidus and Polyphagotarsonemus latus; Tenuipalpidae spp. such as Brevipalpus phoenicis; Tetranychidae spp. such as Tetranychus cinnabarinus, Tetranychus kanzawai, Tetranychus pacificus, Tetranychus tetanus and Tetranychus urticae, Panonychus ulmi, Panonychus citri, and Oligonychus pratensis.

In particular, the inventive mixtures are suitable for combating pests of the orders Coleoptera, Lepidoptera, Thysanoptera, Homoptera, Isoptera, and Orthoptera.

They are also suitable for controlling the following plant parasitic nematodes such as root-knot nematodes, Meloidogyne arenaria, Meloidogyne chitwoodi, Meloidogyne exigua, Meloidogyne hapla, Meloidogyne incognita, Meloidogyne javanica and other Meloidogyne species; cyst nematodes, Globodera rostochiensis, Globodera pallida, Globodera tabacum and other Globodera species, Heterodera avenae, Heterodera glycines, Heterodera schachtii, Heterodera trifolii; and other Heterodera species; seed gall nematodes, Anguina funesta, Anguina tritici and other Anguina species; stem and foliar nematodes, Aphelenchoides besseyi, Aphelenchoides fragariae, Aphelenchoides ritzemabosi and other Aphelenchoides species, sting nematodes, Belonolaimus longicaudatus and other Belonolaimus species; pine nematodes, Bursaphelenchus xylophilus and other Bursaphelenchus species, ring nematodes, Criconema species, Criconemella species, Criconemodes species, and Mesocriconema species; stem and bulb nematodes, Ditylenchus destructor, Ditylenchus dipsaci, Ditylenchus myceliophagus and other Ditylenchus species; awl nematodes, Dolichodorus species; spiral nematodes, Helicotylenchus dihystera, Helicotylenchus multicinctus and other Helicotylenchus species, Rotylenchus robustus and other Rotylenchus species, sheath nematodes, Hemicycliophora species and Hemicriconemoides species; Hirshmanniella species; lance nematodes, Hoplolaimus columbus, Hoplolaimus galeatus and other Hoplolaimus species, false root-knot nematodes, Nacobbus aberrans and other Nacobbus species; needle nematodes, Longidorus elongates and other Longidorus species; pin nematodes, Paratylenchus species; lesion nematodes, Pratylenchus brachyurus, Pratylenchus coffeae, Pratylenchus curvitatus, Pratylenchus goodeyi, Pratylencus neglectus, Pratylenchus penetrans, Pratylenchus scribneri, Pratylenchus vulnus, Pratylenchus zeae and other Pratylenchus species; Radinaphelenchus cocophilus and other Radinaphelenchus species, burrowing nematodes, Radopholus similis and other Radopholus species; reniform nematodes, Rotylenchulus reniformis and other Rotylenchulus species; Scutellonema species; stubby root nematodes, Trichodorus primitivus and other Trichodorus species; Paratrichodorus minor and other Paratrichodorus species, stunt nematodes, Tylenchorhynchus claytoni, Tylenchorhynchus dubius and other Tylenchorhynchus species and Merlinius species; citrus nematodes, Tylenchulus semipenetrans and other Tylenchulus species; dagger nematodes, Xiphinema americanum, Xiphinema index, Xiphinema diversicaudatum and other Xiphinema species, and other plant parasitic nematode species

Plant propagation materials may be treated with the mixtures and compositions of the invention prophylactically either at or before planting or transplanting.

In particular, the present invention relates to a method for protection of plant propagation material from pests, wherein the plant propagation material is treated with an effective amount of an inventive mixture.

In a preferred embodiment, the present invention relates to a method for protection of plant propagation material from animal pests (insects, acarids or nematodes), wherein the plant propagation material are treated with an effective amount of an inventive mixture.

In an equally preferred embodiment, the present invention relates to a method for protection of plant propagation material from harmful fungi, wherein the plant propagation material is treated with an effective amount of an inventive mixture.

In general, “pesticidally effective amount” means the amount of the inventive mixtures or of compositions comprising the mixtures needed to achieve an observable effect on growth, including the effects of necrosis, death, retardation, prevention, and removal, destruction, or otherwise diminishing the occurrence and activity of the target organism. The pesticidally effective amount can vary for the various mixtures/compositions used in the invention. A pesticidally effective amount of the mixtures/compositions will also vary according to the prevailing conditions such as desired pesticidal effect and duration, weather, target species, locus, mode of application, and the like.

In an equally preferred embodiment, the present invention relates to a method for improving the nitrification-inhibiting effect, wherein the seeds, the plants or the soil are treated with a NI effective amount of an inventive mixture.

The term “NI effective amount” denotes an amount of the inventive mixtures, which is sufficient for achieving nitrification-inhibiting effects as defined herein below. More exemplary information about amounts, ways of application and suitable ratios to be used is given below. Anyway, the skilled artisan is well aware of the fact that such an amount can vary in a broad range and is dependent on various factors, e.g. weather, target species, locus, mode of application, soil type, the treated cultivated plant or material and the climatic conditions.

According to the present invention, the nitrification-inhibiting effect is increased by at least 2%, more preferably by at least 4%, most preferably at least 7%, particularly preferably at least 10%, more particularly preferably by at least 15%, most particularly preferably by at least 20%, particularly more preferably by at least 25%, particularly most preferably by at least 30%, particularly by at least 35%, especially more preferably by at least 40%, especially most preferably by at least 45%, especially by at least 50%, in particular preferably by at least 55%, in particular more preferably by at least 60%, in particular most preferably by at least 65%, in particular by at least 70%, for example by at least 75%. In general, the increase of the nitrification-inhibiting effect may be for example 5 to 10%, more preferably 10 to 20%, most preferably 20 to 30%. The nitrification-inhibiting effect can be measured according to Example 1 and 2 as shown below:

### EXAMPLE 1

The compositions and mixtures of the invention have been tested as follows in terms of the inhibition of nitrification:

Soil was sampled fresh from a field (e.g. Limburgerhof), dried and sieved through a 500 μm sieve. Approximately 200 mg of soil were placed into each well of a 48 well plate. The compositions or mixtures of the invention, or DMSO alone, were added at a concentration of 10 ppm, dissolved in 1% DMSO. 6 μmol ammonium sulfate was added per well as well as 4.8 mg NaClO₃.

Subsequently, the samples were incubated at room temperature for up to 72 hrs. After the incubation period 64 mg KCl were added and mixed. 25 μl of the supernatant were placed into a fresh plate and 260 μl of a color reaction solution (from Merck Nr 1.11799.0100) were added.

Measurements were taken with a Tecan plate Reader at 540 nm wavelength.

### EXAMPLE 2: (FOR THOSE RESULTS WITH A % INHIBITION AND NOT RESULTS IN PPM)

100 g soil is filled into 500 ml plastic bottles (e.g. soil sampled from the field) and is moistened to 50% water holding capacity. The soil is incubated at 20° C. for two weeks to activate the microbial biomass. 1 ml test solution, containing the compositions and mixtures of the invention in the appropriate concentration (usually 0.3 or 1% of nitrogen N), or DMSO and 10 mg nitrogen in the form of ammoniumsulfate-N is added to the soil and everything mixed well. Bottles are capped but loosely to allow air exchange. The bottles are then incubated at 20° C. for 0 and 14 days.

For analysis, 300 ml of a 1% K2SO4-solution is added to the bottle containing the soil and shaken for 2 hrs in a horizontal shaker at 150 rpm. Then the whole solution is filtered through a Macherey-Nagel Filter MN 807 ¼. Ammonium and nitrate content is then analyzed in the filtrate in an autoanalyzer at 550 nm (Merck, AA11).

### Calculations:

$$inhibition in \% = \frac{\begin{matrix}( NO 3 — {N}_{without NI at end of incubation} - \\ NO 3 — {N}_{with NI at end of incubation} )\end{matrix}}{\begin{matrix}( NO 3 — {N}_{without NI at end of incubation} - \\ NO 3 — {N}_{at beginning} )\end{matrix}} \times 100$$

In an equally preferred embodiment, the present invention relates to a method for improving the health of plants, wherein the plants are treated with a plant health effective amount of an inventive mixture.

The term “plant health effective amount” denotes an amount of the inventive mixtures, which is sufficient for achieving plant health effects as defined herein below. More exemplary information about amounts, ways of application and suitable ratios to be used is given below. Anyway, the skilled artisan is well aware of the fact that such an amount can vary in a broad range and is dependent on various factors, e.g. the treated cultivated plant or material and the climatic conditions.

Healthier plants are desirable since they result among others in better yields and/or a better quality of the plants or crops, specifically better quality of the harvested plant parts. Healthier plants also better resist to biotic and/or abiotic stress. A high resistance against biotic stresses in turn allows the person skilled in the art to reduce the quantity of pesticides applied and consequently to slow down the development of resistances against the respective pesticides.

It has to be emphasized that the above mentioned effects of the inventive mixtures, i.e. enhanced health of the plant, are also present when the plant is not under biotic stress and in particular when the plant is not under pest pressure.

For example, for seed treatment and soil applications, it is evident that a plant suffering from fungal or insecticidal attack shows reduced germination and emergence leading to poorer plant or crop establishment and vigor, and consequently, to a reduced yield as compared to a plant propagation material which has been subjected to curative or preventive treatment against the relevant pest and which can grow without the damage caused by the biotic stress factor.

However, the methods according to the invention lead to an enhanced plant health even in the absence of any biotic stress. This means that the positive effects of the mixtures of the invention cannot be explained just by the pesticidal activities of the compounds I and compounds II, but are based on further activity profiles. Accordingly, the application of the inventive mixtures can also be carried out in the absence of pest pressure.

In an equally preferred embodiment, the present invention relates to a method for improving the health of plants grown from said plant propagation material, wherein the plant propagation material is treated with an effective amount of an inventive mixture.

Each plant health indicator listed below, which is selected from the groups consisting of yield, plant vigor, quality and tolerance of the plant to abiotic and/or biotic stress, is to be understood as a preferred embodiment of the present invention either each on its own or preferably in combination with each other.

According to the present invention, “increased yield” of a plant means that the yield of a product of the respective plant is increased by a measurable amount over the yield of the same product of the plant produced under the same conditions, but without the application of the inventive mixture.

For seed treatment e.g. as inoculant and/or foliar application forms, increased yield can be characterized, among others, by the following improved properties of the plant: increased plant weight; and/or increased plant height; and/or increased biomass such as higher overall fresh weight (FW) or dry weight (DW); and/or increased number of flowers per plant; and/or higher grain and/or fruit yield; and/or more tillers or side shoots (branches); and/or larger leaves; and/or increased shoot growth; and/or increased protein content; and/or increased oil content; and/or increased starch content; and/or increased pigment content; and/or increased chlorophyll content (chlorophyll content has a positive correlation with the plant's photosynthesis rate and accordingly, the higher the chlorophyll content the higher the yield of a plant) and/or increased quality of a plant; and/or better nitrogen uptake (N uptake).

“Grain” and “fruit” are to be understood as any plant product which is further utilized after harvesting, e.g. fruits in the proper sense, vegetables, nuts, grains, seeds, wood (e.g. in the case of silviculture plants), flowers (e.g. in the case of gardening plants, ornamentals) etc., that is anything of economic value that is produced by the plant.

According to the present invention, the yield is increased by at least 2%, more preferably by at least 4%, most preferably at least 7%, particularly preferably at least 10%, more particularly preferably by at least 15%, most particularly preferably by at least 20%, particularly more preferably by at least 25%, particularly most preferably by at least 30%, particularly by at least 35%, especially more preferably by at least 40%, especially most preferably by at least 45%, especially by at least 50%, in particular preferably by at least 55%, in particular more preferably by at least 60%, in particular most preferably by at least 65%, in particular by at least 70%, for example by at least 75%.

According to the present invention, the yield—if measured in the absence of pest pressure—is increased by at least 2%, more preferably by at least 4%, most preferably at least 7%, particularly preferably at least 10%, more particularly preferably by at least 15%, most particularly preferably by at least 20%, particularly more preferably by at least 25%, particularly most preferably by at least 30%, particularly by at least 35%, especially more preferably by at least 40%, especially most preferably by at least 45%, especially by at least 50%, in particular preferably by at least 55%, in particular more preferably by at least 60%, in particular most preferably by at least 65%, in particular by at least 70%, for example by at least 75%.

Another indicator for the condition of the plant is the plant vigor. The plant vigor becomes manifest in several aspects such as the general visual appearance.

For foliar applications, improved plant vigor can be characterized, among others, by the following improved properties of the plant: improved vitality of the plant; and/or improved plant growth; and/or improved plant development; and/or improved visual appearance; and/or improved plant stand (less plant verse/lodging and/or bigger leaf blade; and/or bigger size; and/or increased plant height; and/or increased tiller number; and/or increased number of side shoots; and/or increased number of flowers per plant; and/or increased shoot growth; and/or enhanced photosynthetic activity (e.g. based on increased stomatal conductance and/or increased CO₂ assimilation rate)); and/or earlier flowering; and/or earlier fruiting; and/or earlier grain maturity; and/or less non-productive tillers; and/or less dead basal leaves; and/or less input needed (such as fertilizers or water); and/or greener leaves; and/or complete maturation under shortened vegetation periods; and/or easier harvesting; and/or faster and more uniform ripening; and/or longer shelf-life; and/or longer panicles; and/or delay of senescence; and/or stronger and/or more productive tillers; and/or better extractability of ingredients; and/or improved quality of seeds (for being seeded in the following seasons for seed production); and/or reduced production of ethylene and/or the inhibition of its reception by the plant.

Another indicator for the condition of the plant is the “quality” of a plant and/or its products. According to the present invention, enhanced quality means that certain plant characteristics such as the content or composition of certain ingredients are increased or improved by a measurable or noticeable amount over the same factor of the plant produced under the same conditions, but without the application of the mixtures of the present invention. Enhanced quality can be characterized, among others, by following improved properties of the plant or its product: increased nutrient content; and/or increased protein content; and/or increased oil content; and/or increased starch content; and/or increased content of fatty acids; and/or increased metabolite content; and/or increased carotenoid content; and/or increased sugar content; and/or increased amount of essential amino acids; and/or improved nutrient composition; and/or improved protein composition; and/or improved composition of fatty acids; and/or improved metabolite composition; and/or improved carotenoid composition; and/or improved sugar composition; and/or improved amino acids composition; and/or improved or optimal fruit color; and/or improved leaf color; and/or higher storage capacity; and/or better processability of the harvested products.

Another indicator for the condition of the plant is the plant's tolerance or resistance to biotic and/or abiotic stress factors. Biotic and abiotic stress, especially over longer terms, can have harmful effects on plants.

Biotic stress is caused by living organisms while abiotic stress is caused for example by environmental extremes. According to the present invention, “enhanced tolerance or resistance to biotic and/or abiotic stress factors” means (1.) that certain negative factors caused by biotic and/or abiotic stress are diminished in a measurable or noticeable amount as compared to plants exposed to the same conditions, but without being treated with an inventive mixture and (2.) that the negative effects are not diminished by a direct action of the inventive mixture on the stress factors, e.g. by its fungicidal or insecticidal action which directly destroys the microorganisms or pests, but rather by a stimulation of the plants' own defensive reactions against said stress factors.

Negative factors caused by biotic stress such as pathogens and pests are widely known and are caused by living organisms, such as competing plants (for example weeds), microorganisms (such as phytopathogenic fungi and/or bacteria) and/or viruses.

Negative factors caused by abiotic stress are also well-known and can often be observed as reduced plant vigor (see above), for example:

less yield and/or less vigor, for both effects examples can be burned leaves, less flowers, premature ripening, later crop maturity, reduced nutritional value amongst others.

Abiotic stress can be caused for example by: extremes in temperature such as heat or cold (heat stress/cold stress); and/or strong variations in temperature; and/or temperatures unusual for the specific season; and/or drought (drought stress); and/or extreme wetness; and/or high salinity (salt stress); and/or radiation (for example by increased UV radiation due to the decreasing ozone layer); and/or increased ozone levels (ozone stress); and/or organic pollution (for example by phytotoxic amounts of pesticides); and/or inorganic pollution (for example by heavy metal contaminants).

As a result of biotic and/or abiotic stress factors, the quantity and the quality of the stressed plants decrease. As far as quality (as defined above) is concerned, reproductive development is usually severely affected with consequences on the crops which are important for fruits or seeds. Synthesis, accumulation and storage of proteins are mostly affected by temperature; growth is slowed by almost all types of stress; polysaccharide synthesis, both structural and storage is reduced or modified: these effects result in a decrease in biomass (yield) and in changes in the nutritional value of the product.

As pointed out above, the above identified indicators for the health condition of a plant may be interdependent and may result from each other. For example, an increased resistance to biotic and/or abiotic stress may lead to a better plant vigor, e.g. to better and bigger crops, and thus to an increased yield. Inversely, a more developed root system may result in an increased resistance to biotic and/or abiotic stress. However, these interdependencies and interactions are neither all known nor fully understood and therefore the different indicators are described separately.

In one embodiment the inventive mixtures effectuate an increased yield of a plant or its product. In another embodiment the inventive mixtures effectuate an increased vigor of a plant or its product. In another embodiment the inventive mixtures effectuate in an increased quality of a plant or its product. In yet another embodiment the inventive mixtures effectuate an increased tolerance and/or resistance of a plant or its product against biotic stress. In yet another embodiment the inventive mixtures effectuate an increased tolerance and/or resistance of a plant or its product against abiotic stress.

The invention also relates to agrochemical compositions comprising an auxiliary and at least one compound I and at least one compound II, or a cell-free extract of compound II or at least one metabolite thereof having pesticidal activity, and/or a mutant of compound II having pesticidal activity and producing at least one pesticidal metabolite as defined herein, or a pesticidal metabolite or extract of the mutant, and at least one pesticide II according to the invention.

An agrochemical composition comprises a NI effective amount or plant health effective amount of compound I. Such an amount can vary in a broad range and is dependent on various factors, e.g. weather, target species, locus, mode of application, soil type, the treated cultivated plant or material and the climatic conditions.

An agrochemical composition comprises a fungicidally or insecticidally or plant health effective amount of compound II, or a cell-free extract thereof or at least one metabolite thereof having pesticidal activity, and/or a mutant of compound II having pesticidal activity and producing at least one pesticidal metabolite as defined herein, or a pesticidal metabolite or extract of the mutant, and at least one pesticide II. Such an amount can vary in a broad range and is dependent on various factors, such as the fungal or pest species to be controlled, the treated cultivated plant or material, the climatic conditions.

In the case of mixtures comprising microbial pesticides II selected from groups L1), L3) and L5), the microorganisms as used according to the invention can be cultivated continuously or discontinuously in the batch process or in the fed batch or repeated fed batch process. A review of known methods of cultivation will be found in the textbook by Chmiel (Bioprozesstechnik 1. Einführung in die Bioverfahrenstechnik (Gustav Fischer Verlag, Stuttgart, 1991)) or in the textbook by Storhas (Bioreaktoren and periphere Einrichtungen (Vieweg Verlag, Braunschweig/Wiesbaden, 1994)). The culture medium that is to be used must satisfy the requirements of the particular strains in an appropriate manner. Descriptions of culture media for various microorganisms are given in the handbook “Manual of Methods for General Bacteriology” of the American Society for Bacteriology (Washington D. C., USA, 1981). These culture media that can be used according to the invention generally comprise one or more sources of carbon, sources of nitrogen, inorganic salts, vitamins and/or trace elements. Preferred sources of carbon are sugars, such as mono-, di- or polysaccharides. Very good sources of carbon are for example glucose, fructose, mannose, galactose, ribose, sorbose, ribulose, lactose, maltose, sucrose, raffinose, starch or cellulose. Sugars can also be added to the media via complex compounds, such as molasses, or other by-products from sugar refining. It may also be advantageous to add mixtures of various sources of carbon. Other possible sources of carbon are oils and fats such as soybean oil, sunflower oil, peanut oil and coconut oil, fatty acids such as palmitic acid, stearic acid or linoleic acid, alcohols such as glycerol, methanol or ethanol and organic acids such as acetic acid or lactic acid. Sources of nitrogen are usually organic or inorganic nitrogen compounds or materials containing these compounds. Examples of sources of nitrogen include ammonia gas or ammonium salts, such as ammonium sulfate, ammonium chloride, ammonium phosphate, ammonium carbonate or ammonium nitrate, nitrates, urea, amino acids or complex sources of nitrogen, such as corn-steep liquor, soybean flour, soybean protein, yeast extract, meat extract and others. The sources of nitrogen can be used separately or as a mixture. Inorganic salt compounds that may be present in the media comprise the chloride, phosphate or sulfate salts of calcium, magnesium, sodium, cobalt, molybdenum, potassium, manganese, zinc, copper and iron. Inorganic sulfur-containing compounds, for example sulfates, sulfites, dithionites, tetrathionates, thiosulfates, sulfides, but also organic sulfur compounds, such as mercaptans and thiols, can be used as sources of sulfur. Phosphoric acid, potassium dihydrogenphosphate or dipotassium hydrogenphosphate or the corresponding sodium-containing salts can be used as sources of phosphorus. Chelating agents can be added to the medium, in order to keep the metal ions in solution. Especially suitable chelating agents comprise dihydroxyphenols, such as catechol or protocatechuate, or organic acids, such as citric acid. The culture media used may also contain other growth factors, such as vitamins or growth promoters, which include for example biotin, riboflavin, thiamine, folic acid, nicotinic acid, pantothenate and pyridoxine. Growth factors and salts often come from complex components of the media, such as yeast extract, molasses, corn-steep liquor and the like. In addition, suitable precursors can be added to the culture medium. The precise composition of the compounds in the medium is strongly dependent on the particular experiment and must be decided individually for each specific case. Information on media optimization can be found in the textbook “Applied Microbiol. Physiology, A Practical Approach” (Publ. P. M. Rhodes, P. F. Stanbury, IRL Press (1997) p. 53-73, ISBN 0 19 963577 3). Growing media can also be obtained from commercial suppliers, such as Standard 1 (Merck) or BHI (Brain heart infusion, DIFCO) etc. All components of the medium are sterilized, either by heating (20 min at 2.0 bar and 121° C.) or by sterile filtration. The components can be sterilized either together, or if necessary separately. All the components of the medium can be present at the start of growing, or optionally can be added continuously or by batch feed. The temperature of the culture of the respective microorganism is normally between 15° C. and 45° C., preferably 25° C. to 40° C. and can be kept constant or can be varied during the experiment. The pH value of the medium should be in the range from 5 to 8.5, preferably around 7.0. The pH value for growing can be controlled during growing by adding basic compounds such as sodium hydroxide, potassium hydroxide, ammonia or ammonia water or acid compounds such as phosphoric acid or sulfuric acid. Antifoaming agents, e.g. fatty acid polyglycol esters, can be used for controlling foaming. To maintain the stability of plasmids, suitable substances with selective action, e.g. antibiotics, can be added to the medium. Oxygen or oxygen-containing gas mixtures, e.g. the ambient air, are fed into the culture in order to maintain aerobic conditions. The temperature of the culture is normally from 20° C. to 45° C. Culture is continued until a maximum of the desired product has formed. This is normally achieved within 10 hours to 160 hours. To obtain cell-free extracts, the cells can be disrupted optionally by high-frequency ultrasound, by high pressure, e.g. in a French pressure cell, by osmolysis, by the action of detergents, lytic enzymes or organic solvents, by means of homogenizers or by a combination of several of the methods listed. The methodology of the present invention can further include a step of recovering individual compositions such as cell-free extracts, supernatants, metabolites or alike. The term “recovering” includes extracting, harvesting, isolating or purifying of an extract, supernatant or metabolite e.g. from whole culture broth. Recovering can be performed according to any conventional isolation or purification methodology known in the art including, but not limited to, treatment with a conventional resin (e.g., anion or cation exchange resin, nonionic adsorption resin, etc.), treatment with a conventional adsorbent (e.g., activated charcoal, silicic acid, silica gel, cellulose, alumina, etc.), alteration of pH, solvent extraction (e.g., with a conventional solvent such as an alcohol, ethyl acetate, hexane and the like), distillation, dialysis, filtration, concentration, crystallization, recrystallization, pH adjustment, lyophilization and the like. For example the agent can be recovered from culture media by first removing the microorganisms. The remaining broth is then passed through or over a cation exchange resin to remove unwanted cations and then through or over an anion exchange resin to remove unwanted inorganic anions and organic acids.

According to one embodiment, individual components of the composition according to the invention such as parts of a kit or parts of a binary or ternary mixture may be mixed by the user himself in a spray tank or any other kind of vessel used for applications (e.g seed treater drums, seed pelleting machinery, knapsack sprayer) and further auxiliaries may be added, if appropriate. When living microorganisms, such as compounds II from groups L1), L3) and L5), form part of such kit, it must be taken care that choice and amounts of the other parts of the kit (e.g. chemical pesticidal agents) and of the further auxiliaries should not influence the viability of the microbial pesticides in the composition mixed by the user. Especially for bactericides and solvents, compatibility with the respective microbial pesticide has to be taken into account.

Consequently, one embodiment of the invention is a kit for preparing a usable pesticidal composition, the kit comprising a) a composition comprising compound I as defined herein and at least one auxiliary; and b) a composition comprising compound II as defined herein and at least one auxiliary; and optionally c) a composition comprising at least one auxiliary and optionally a further active component III as defined herein.

The compounds according to the invention can be converted into customary types of agrochemical compositions, e.g. solutions, emulsions, suspensions, dusts, powders, pastes, granules, pressings, capsules, and mixtures thereof. Examples for composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further compositions types are defined in the “Catalogue of pesticide formulation types and international coding system”, Technical Monograph No. 2, 6th Ed. May 2008, CropLife International.

The compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e.g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinyl pyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B—C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the compound I on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones and benzisothiazolinones. Suitable anti-freezing agents are ethylene glycol, propylene glycol, urea and glycerin. Suitable anti-foaming agents are silicones, long chain alcohols, and salts of fatty acids. Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants). Suitable tackifiers or binders are polyvinylpyrrolidons, polyvinylacetates, polyvinyl alcohols, polyacrylates, biological or synthetic waxes, and cellulose ethers.

When living microorganisms, such as biopesticides from groups L1), L3) and L5), form part of the compositions, such compositions can be prepared as compositions comprising besides the active ingredients at least one auxiliary (inert ingredient) by usual means (see e.g. H. D. Burges: Formulation of Micobial Biopestcides, Springer, 1998). Suitable customary types of such compositions are suspensions, dusts, powders, pastes, granules, pressings, capsules, and mixtures thereof. Examples for composition types are suspensions (e.g. SC, OD, FS), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). Herein, it has to be taken into account that each formulation type or choice of auxiliary should not influence the viability of the microorganism during storage of the composition and when finally applied to the soil, plant or plant propagation material. Suitable formulations are e.g. mentioned in WO2008/002371, U.S. Pat. Nos. 6,955,912, 5,422,107.

Examples for suitable auxiliaries are those mentioned earlier herein, wherein it must be taken care that choice and amounts of such auxiliaries should not influence the viability of the microbial pesticides in the composition. Especially for bactericides and solvents, compatibility with the respective microorganism of the respective microbial pesticide has to be taken into account. In addition, compositions with microbial pesticides may further contain stabilizers or nutrients and UV protectants. Suitable stabilizers or nutrients are e.g. alpha-tocopherol, trehalose, glutamate, potassium sorbate, various sugars like glucose, sucrose, lactose and maltodextrine (H. D. Burges: Formulation of Micobial Biopestcides, Springer, 1998). Suitable UV protectants are e.g. inorganic compounds like titan dioxide, zinc oxide and iron oxide pigments or organic compounds like benzophenones, benzotriazoles and phenyltriazines. The compositions may in addition to auxiliaries mentioned for compositions comprising compounds I herein optionally comprise 0.1-80% stabilizers or nutrients and 0.1-10% UV protectants.

Examples for composition types and their preparation are:

i) Water-soluble concentrates (SL, LS)

10-60 wt % of a compound I and 5-15 wt % wetting agent (e.g. alcohol alkoxylates) are dissolved in water and/or in a water-soluble solvent (e.g. alcohols) ad 100 wt %. The active substance dissolves upon dilution with water.

ii) Dispersible concentrates (DC)

5-25 wt % of a compound I and 1-10 wt % dispersant (e.g. polyvinylpyrrolidone) are dissolved in organic solvent (e.g. cyclohexanone) ad 100 wt %. Dilution with water gives a dispersion.

iii) Emulsifiable concentrates (EC)

15-70 wt % of a compound I and 5-10 wt % emulsifiers (e.g. calcium dodecylbenzenesulfonate and castor oil ethoxylate) are dissolved in water-insoluble organic solvent (e.g. aromatic hydrocarbon) ad 100 wt %. Dilution with water gives an emulsion.

### iv) Emulsions (EW, EO, ES)

5-40 wt % of a compound I and 1-10 wt % emulsifiers (e.g. calcium dodecylbenzenesulfonate and castor oil ethoxylate) are dissolved in 20-40 wt % water-insoluble organic solvent (e.g. aromatic hydrocarbon). This mixture is introduced into water ad 100 wt % by means of an emulsifying machine and made into a homogeneous emulsion. Dilution with water gives an emulsion.

### v) Suspensions (SC, OD, FS)

In an agitated ball mill, 20-60 wt % of a compound I are comminuted with addition of 2-10 wt % dispersants and wetting agents (e.g. sodium lignosulfonate and alcohol ethoxylate), 0.1-2 wt % thickener (e.g. xanthan gum) and water ad 100 wt % to give a fine active substance suspension. Dilution with water gives a stable suspension of the active substance. For FS type composition up to 40 wt % binder (e.g. polyvinylalcohol) is added.

vi) Water-dispersible granules and water-soluble granules (WG, SG)

50-80 wt % of a compound I are ground finely with addition of dispersants and wetting agents (e.g. sodium lignosulfonate and alcohol ethoxylate) ad 100 wt % and prepared as water-dispersible or water-soluble granules by means of technical appliances (e.g. extrusion, spray tower, fluidized bed). Dilution with water gives a stable dispersion or solution of the active substance.

vii) Water-dispersible powders and water-soluble powders (WP, SP, WS)

50-80 wt % of a compound I are ground in a rotor-stator mill with addition of 1-5 wt % dispersants (e.g. sodium lignosulfonate), 1-3 wt % wetting agents (e.g. alcohol ethoxylate) and solid carrier (e.g. silica gel) ad 100 wt %. Dilution with water gives a stable dispersion or solution of the active substance.

viii) Gel (GW, GF)

In an agitated ball mill, 5-25 wt % of a compound I are comminuted with addition of 3-10 wt % dispersants (e.g. sodium lignosulfonate), 1-5 wt % thickener (e.g. carboxymethylcellulose) and water ad 100 wt % to give a fine suspension of the active substance. Dilution with water gives a stable suspension of the active substance.

### ix) Microemulsion (ME)

5-20 wt % of a compound I are added to 5-30 wt % organic solvent blend (e.g. fatty acid dimethylamide and cyclohexanone), 10-25 wt % surfactant blend (e.g. alcohol ethoxylate and arylphenol ethoxylate), and water ad 100%. This mixture is stirred for 1 h to produce spontaneously a thermodynamically stable microemulsion.

### x) Microcapsules (CS)

An oil phase comprising 5-50 wt % of a compound I, 0-40 wt % water insoluble organic solvent (e.g. aromatic hydrocarbon), 2-15 wt % acrylic monomers (e.g. methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50 wt % of a compound I according to the invention, 0-40 wt % water insoluble organic solvent (e.g. aromatic hydrocarbon), and an isocyanate monomer (e.g. diphenylmethene-4,4′-diisocyanatae) are dispersed into an aqueous solution of a protective colloid (e.g. polyvinyl alcohol). The addition of a polyamine (e.g. hexamethylenediamine) results in the formation of polyurea microcapsules. The monomers amount to 1-10 wt %. The wt % relate to the total CS composition.

xi) Dustable powders (DP, DS)

1-10 wt % of a compound I are ground finely and mixed intimately with solid carrier (e.g. finely divided kaolin) ad 100 wt %.

xii) Granules (GR, FG)

0.5-30 wt % of a compound I is ground finely and associated with solid carrier (e.g. silicate) ad 100 wt %. Granulation is achieved by extrusion, spray-drying or fluidized bed.

xiii) Ultra-low volume liquids (UL)

1-50 wt % of a compound I are dissolved in organic solvent (e.g. aromatic hydrocarbon) ad 100 wt %.

The compositions types i) to xiii) may optionally comprise further auxiliaries, such as 0.1-1 wt % bactericides, 5-15 wt % anti-freezing agents, 0.1-1 wt % anti-foaming agents, and 0.1-1 wt % colorants.

The compositions types i) to vii) may optionally comprise further auxiliaries, such as 0.1-1 wt % bactericides, 5-15 wt % anti-freezing agents, 0.1-1 wt % anti-foaming agents, 0.1-80% stabilizers or nutrients, 0.1-10% UV protectants and 0.1-1 wt % colorants.

The compositions types i) to xi) may optionally comprise further auxiliaries, such as 0.1-1 wt % bactericides, 5-15 wt % anti-freezing agents, 0.1-1 wt % anti-foaming agents, and 0.1-1 wt % colorants.

The agrochemical compositions generally are characterized in that they contain an effective quantity of the active components as defined above. Generally, they contain between 0.01 and 95%, preferably between 0.1 and 90%, and in particular between 0.5 and 75%, by weight of active components, in particular active substances.

According to one embodiment, the compositions contain biopesticides from groups L1), L3) and L5) in an amount from 1×10⁵ to 1×10¹² CFU, preferably from 1×10⁷ CFU to 1×10¹² CFU, more preferably from 1×10⁹ CFU to 1×10¹² CFU per gram total weight of the composition.

Solutions for seed treatment (LS), suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds.

Preferred examples of seed treatment formulation types or soil application for pre-mix compositions are of WS, LS, ES, FS, WG or CS-type.

The compositions in question give, after two-to-tenfold dilution, active components concentrations of from 0.01 to 60% by weight, preferably from 0.1 to 40%, in the ready-to-use preparations. Application can be carried out before or during sowing. Methods for applying or treating compound I and compound II and compositions thereof, respectively, on to plant propagation material, especially seeds include dressing, coating, pelleting, dusting, soaking and in-furrow application methods of the propagation material. Preferably, compound I and compound II or the compositions thereof, respectively, are applied on to the plant propagation material by a method such that germination is not induced, e.g. by seed dressing, pelleting, coating and dusting.

Typically, a pre-mix formulation for seed treatment application comprises 0.5 to 99.9 percent, especially 1 to 95 percent, of the desired ingredients, and 99.5 to 0.1 percent, especially 99 to 5 percent, of a solid or liquid adjuvant (including, for example, a solvent such as water), where the auxiliaries can be a surfactant in an amount of 0 to 50 percent, especially 0.5 to 40 percent, based on the pre-mix formulation. Whereas commercial products will preferably be formulated as concentrates (e.g., pre-mix composition (formulation)), the end user will normally employ dilute formulations (e.g., tank mix composition).

Seed treatment methods for applying or treating inventive mixtures and compositions thereof to plant propagation material, especially seeds, are known in the art, and include dressing, coating, filmcoating, pelleting and soaking application methods of the propagation material. Such methods are also applicable to the combinations according to the invention. In a preferred embodiment, the inventive mixture is applied or treated on to the plant propagation material by a method such that the germination is not negatively impacted. Accordingly, examples of suitable methods for applying (or treating) a plant propagation material, such as a seed, is seed dressing, seed coating or seed pelleting and alike.

It is preferred that the plant propagation material is a seed, seed piece (i.e. stalk) or seed bulb.

Although it is believed that the present method can be applied to a seed in any physiological state, it is preferred that the seed be in a sufficiently durable state that it incurs no damage during the treatment process. Typically, the seed would be a seed that had been harvested from the field; removed from the plant; and separated from any cob, stalk, outer husk, and surrounding pulp or other non-seed plant material. The seed would preferably also be biologically stable to the extent that the treatment would cause no biological damage to the seed. It is believed that the treatment can be applied to the seed at any time between harvest of the seed and sowing of the seed or during the sowing process (seed directed applications). The seed may also be primed either before or after the treatment.

Even distribution of the ingredients in inventive mixtures and adherence thereof to the seeds is desired during propagation material treatment. Treatment could vary from a thin film (dressing) of the formulation containing the combination, for example, a mixture of active ingredient(s), on a plant propagation material, such as a seed, where the original size and/or shape are recognizable to an intermediary state (such as a coating) and then to a thicker film (such as pelleting with many layers of different materials (such as carriers, for example, clays; different formulations, such as of other active ingredients; polymers; and colourants) where the original shape and/or size of the seed is no longer recognizable.

An aspect of the present invention includes application of the inventive mixtures onto the plant propagation material in a targeted fashion, including positioning the ingredients in the combination onto the entire plant propagation material or on only parts thereof, including on only a single side or a portion of a single side. One of ordinary skill in the art would understand these application methods from the description provided in EP954213B1 and WO06/112700.

The inventive mixtures can also be used in form of a “pill” or “pellet” or a suitable substrate and placing, or sowing, the treated pill, or substrate, next to a plant propagation material. Such techniques are known in the art, particularly in EP1124414, WO07/67042, and WO07/67044. Application of the combinations described herein onto plant propagation material also includes protecting the plant propagation material treated with the combination of the present invention by placing one or more pesticide-containing particles next to a pesticide-treated seed, wherein the amount of pesticide is such that the pesticide-treated seed and the pesticide-containing particles together contain an Effective Dose of the pesticide and the pesticide dose contained in the pesticide-treated seed is less than or equal to the Maximal Non-Phytotoxic Dose of the pesticide. Such techniques are known in the art, particularly in WO2005/120226.

Application of the combinations onto the seed also includes controlled release coatings on the seeds, wherein the ingredients of the combinations are incorporated into materials that release the ingredients over time. Examples of controlled release seed treatment technologies are generally known in the art and include polymer films, waxes, or other seed coatings, wherein the ingredients may be incorporated into the controlled release material or applied between layers of materials, or both.

Seed can be treated by applying thereto the compound s present in the inventive mixtures in any desired sequence or simultaneously.

The seed treatment occurs to an unsown seed, and the term “unsown seed” is meant to include seed at any period between the harvest of the seed and the sowing of the seed in the ground for the purpose of germination and growth of the plant.

Treatment to an unsown seed is not meant to include those practices in which the active ingredient is applied to the soil but would include any application practice that would target the seed during the planting process.

Preferably, the treatment occurs before sowing of the seed so that the sown seed has been pre-treated with the combination. In particular, seed coating or seed pelleting are preferred in the treatment of the combinations according to the invention. As a result of the treatment, the ingredients in each combination are adhered on to the seed and therefore available for pest control.

The treated seeds can be stored, handled, sowed and tilled in the same manner as any other active ingredient treated seed.

In particular, the present invention relates to a method for protection of plant propagation material from pests and/or improving the health of plants grown from said plant propagation material, wherein the soil, wherein plant propagation material is sown, is treated with an effective amount of an inventive mixture.

In particular, the present invention relates to a method for protection of plant propagation material from pests, wherein the soil, wherein plant propagation material is sown, is treated with an effective amount of an inventive mixture.

In particular, the present invention relates to a method for protection of plant propagation material from harmful fungi, wherein the soil, wherein plant propagation material is sown, is treated with an effective amount of an inventive mixture.

In particular, the present invention relates to a method for protection of plant propagation material from animal pests (insects, acarids or nematodes), wherein the soil, wherein plant propagation material is sown, is treated with an effective amount of an inventive mixture.

In one embodiment, the treatment(s) are carried out as foliar application.

In another embodiment, the treatment(s) are carried out as soil application.

In one embodiment, the treatment(s) are carried out as seed treatment.

When employed in plant protection, the total amounts of active components applied are, depending on the kind of effect desired, from 0.001 to 10 kg per ha, preferably from 0.005 to 2 kg per ha, more preferably from 0.05 to 0.9 kg per ha, in particular from 0.1 to 0.75 kg per ha. In the case of compounds II, the application rates preferably range from about 1×10⁶ to 5×10¹⁵ (or more) CFU/ha. Preferably, the spore concentration is about 1×10⁷ to about 1×10¹² CFU/ha. In the case of (entomopathogenic) nematodes as microbial pesticides (e.g. Steinernema feltiae), the application rates preferably range inform about 1×10⁵ to 1×10¹² (or more), more preferably from 1×10⁸ to 1×10¹¹, even more preferably from 5×10⁸ to 1×10¹⁰ individuals (e.g. in the form of eggs, juvenile or any other live stages, preferably in an infective juvenile stage) per ha.

When employed in plant protection by seed treatment, the amount of the inventive mixtures (based on total weight of active components) is in the range from 0.01-10 kg, preferably from 0.1-1000 g, more preferably from 1-100 g per 100 kg of plant propagation material (preferably seeds). In the case of compounds II, the application rates with respect to plant propagation material preferably range from about 1×10⁶ to 1×10¹² (or more) CFU/seed. Preferably, the concentration is about 1×10⁶ to about 1×10⁹ CFU/seed. In the case of compounds II, the application rates with respect to plant propagation material also preferably range from about 1×10⁷ to 1×10¹⁴ (or more) CFU per 100 kg of seed, preferably from 1×10⁹ to about 1×10¹² CFU per 100 kg of seed.

When used in the protection of materials or stored products, the amount of active components applied depends on the kind of application area and on the desired effect. Amounts customarily applied in the protection of materials are 0.001 g to 2 kg, preferably 0.005 g to 1 kg, of active components per cubic meter of treated material.

Various types of oils, wetters, adjuvants, fertilizer, or micronutrients, and further pesticides (e.g. herbicides, insecticides, fungicides, growth regulators, safeners, biopesticides) may be added to the mictures or the compositions comprising them as premix or, if appropriate not until immediately prior to use (tank mix). These agents can be admixed with the mixtures or compositions according to the invention in a weight ratio of 1:100 to 100:1, preferably 1:10 to 10:1.

These further useful active compounds can be fertilizers or micronutrient donors (such as Mo, Zn and/or Co), especially when applied to plant propagation materials.

According to one embodiment, a polyether polymethylsiloxane copolymer may be added to the mixture or composition according to the invention, preferably in a weight ratio of 1:100 to 100:1, more preferably in a weight ratio of 1:10 to 10:1, in particular in a weight ratio of 1:5 to 5:1 based on the total weight of the compound I and compound II.

According to a further embodiment, a mineral oil or a vegetable oil may be added to the mixture or composition according to the invention, preferably in a weight ratio of 1:100 to 100:1, more preferably in a weight ratio of 1:10 to 10:1, in particular in a weight ratio of 1:5 to 5:1 based on the total weight of compound I and compound II.

The user applies the mixture or composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

In one embodiment, the at least one compound I and the at least one compound II are applied simultaneously, either as a mixture or separately, or subsequently to the soil, the plant or the plant propagules.

Moreover, we have found that simultaneous, that is joint or separate, application of at least one active compound I and at least one active compound II or the successive application of at least one active compound I and at least one active compound II synergistically increase the efficacy for controlling pests or for improving the health of a plant or for inhibiting nitrification compared to the application of the individual components alone.

In one embodiment, compound I and compound II are present in a synergistically effective amount.

When applying at least one compound I and at least one compound II sequentially the time between both applications may vary e.g. between 2 hours to 7 days. Also a broader range is possible ranging from 0.25 hour to 30 days, preferably from 0.5 hour to 14 days, particularly from 1 hour to 7 days or from 1.5 hours to 5 days, even more preferred from 2 hours to 1 day.

In the mixtures and compositions, the compound ratios are advantageously chosen so as to produce a synergistic effect.

The term “synergstic effect” is understood to refer in particular to that defined by Colby's formula (Colby, S. R., “Calculating synergistic and antagonistic responses of herbicide combinations”, Weeds, 15, pp. 20-22, 1967).

The term “synergistic effect” is also understood to refer to that defined by application of the Tammes method, (Tammes, P. M. L., “Isoboles, a graphic representation of synergism in pesticides”, Netherl. J. Plant Pathol. 70, 1964).

According to the invention, the solid material (dry matter) of the biopesticides (with the exception of oils such as Neem oil, Tagetes oil, etc.) are considered as active components (e.g. to be obtained after drying or evaporation of the extraction medium or the suspension medium in case of liquid formulations of the microbial pesticides).

In accordance with the present invention, the weight ratios and percentages used herein for a biological extract such as Quillay extract are based on the total weight of the dry content (solid material) of the respective extract(s).

The total weight ratios of compositions comprising at least one microbial pesticide in the form of viable microbial cells including dormant forms, can be determined using the amount of CFU of the respective microorganism to calculate the total weight of the respective active component with the following equation that 1×10¹⁰ CFU equals one gram of total weight of the respective active component. Colony forming unit is measure of viable microbial cells, in particular fungal and bacterial cells. In addition, here “CFU” may also be understood as the number of (juvenile) individual nematodes in case of (entomopathogenic) nematode biopesticides, such as Steinernema feltiae.

For mixtures according to the invention comprising compound I (nitrification inhibitor) and compound II (biopesticide), the weight ratio of compound I and compound II generally depends from the properties of the active substances used, usually it is in the range of from 1:1000 to 1000:1, regularly in the range of from 1:500 to 500:1, preferably in the range of from 1:250 to 250:1, more preferably in the range of from 1:100 to 100:1, most preferably in the range of from 1:70 to 70:1, particularly preferably in the range of from 1:50 to 50:1, particularly more preferably in the range of from 1:30 to 30:1, particularly most preferably in the range from 1:20 to 20:1, particularly in the range of from 1:15 to 15:1, especially preferably in the range of from 1:10 to 10:1, especially more preferably in the range of from 1:8 to 8:1, especially most preferably in the range of from 1:6.5 to 6.5:1, especially in the range of from 1:5 to 5:1, in particular preferably in the range of 1:4 to 4:1, in particular more preferably in the range of from 1:3 to 3:1, in particular most preferably in the range of from 2.5:1 to 1:2.5, in particular in the range of from 1:2 to 2:1, for example in the range of from 1:1.5 to 1.5:1. For mixtures according to the invention, the weight ratio of compound I and compound II generally depends from the properties of the active substances used, usually it is not more than 1000:1, regularly not more than 250:1, preferably not more than 100:1, more preferably not more than 50:1, most preferably not more than 30:1, particularly preferably not more than 15:1, particularly more preferably not more than 8:1, particularly most preferably not more than 4:1, particularly not more than 2:1, especially preferably not more than 1:1, especially more preferably not more than 1:2, especially most preferably not more than 1:4, especially not more than 1:8, in particular preferably not more than 1:15, in particular more preferably not more than 1:30, in particular most preferably not more than 1:50, in particular not more than 1:100, for example preferably not more than 1:250, for example not more than 1:1000. For mixtures according to the invention, the weight ratio of compound I and compound II generally depends from the properties of the active substances used, usually it is at least 1000:1, regularly at least 250:1, preferably at least 100:1, more preferably at least 50:1, most preferably at least 30:1, particularly preferably at least 15:1, particularly more preferably at least 8:1, particularly most preferably at least 4:1, particularly at least 2:1, especially preferably at least 1:1, especially more preferably at least 1:2, especially most preferably at least 1:4, especially at least 1:8, in particular preferably at least 1:15, in particular more preferably at least 1:30, in particular most preferably at least 1:50, in particular at least 1:100, for example preferably at least 1:250, for example at least 1:1000.

In another preferred embodiment, compound I and compound II are present in a weight ratio of from 250:1 to 1:250, preferably in a weight ratio of from 100:1 to 1:100, more preferably in a weight ratio of from 50:1 to 1:50, more preferably in a weight ratio of from 30:1 to 1:30, most preferably in a weight ratio of from 15:1 to 1:15, particularly in a weight ratio of from 8:1 to 1:8, particularly preferably in a weight ratio of from 4:1 to 1:4, particularly more preferably in a weight ratio of from 2:1 to 1:2, particularly most preferably in a weight ratio of from 1.5:1 to 1:1.5.

In another preferred embodiment, compound I and compound II are present in a weight ratio of from 250:1 to 1:250, preferably in a weight ratio of from 100:1 to 1:100, more preferably in a weight ratio of from 50:1 to 1:50, more preferably in a weight ratio of from 30:1 to 1:30, most preferably in a weight ratio of from 15:1 to 1:15, particularly in a weight ratio of from 8:1 to 1:8, particularly preferably in a weight ratio of from 4:1 to 1:4, particularly more preferably in a weight ratio of from 2:1 to 1:2, particularly most preferably in a weight ratio of from 1.5:1 to 1:1.5, wherein the total weight of compound II is based on the amount of the solid material (dry matter) of compound II.

In another preferred embodiment, compound I and compound II are present in a weight ratio of from 250:1 to 1:250, preferably in a weight ratio of from 100:1 to 1:100, more preferably in a weight ratio of from 50:1 to 1:50, more preferably in a weight ratio of from 30:1 to 1:30, most preferably in a weight ratio of from 15:1 to 1:15, particularly in a weight ratio of from 8:1 to 1:8, particularly preferably in a weight ratio of from 4:1 to 1:4, particularly more preferably in a weight ratio of from 2:1 to 1:2, particularly most preferably in a weight ratio of from 1.5:1 to 1:1.5, wherein the total weight of compound II is calculated on the basis of the amount of CFU of compound II, wherein 1×10⁹ CFU equals one gram of total weight of compound II.

In another preferred embodiment, compound I and compound II are present in a weight ratio of from 1000:1 to 1:1000, preferably in a weight ratio of from 500:1 to 1:500, more preferably in a weight ratio of from 300:1 to 1:300, more preferably in a weight ratio of from 150:1 to 1:80, most preferably in a weight ratio of from 100:1 to 1:30, particularly in a weight ratio of from 70:1 to 1:10, particularly preferably in a weight ratio of from 50:1 to 1:1, particularly more preferably in a weight ratio of from 25:1 to 1.5:1, particularly most preferably in a weight ratio of from 15:1 to 2:1, for example in a weight ratio of either from 12:1 to 8:1 or from 5:1 to 2.5:1, wherein the total weight of compound II is calculated on the basis of the amount of CFU of compound II, wherein 1×10⁹ CFU equals one gram of total weight of compound II.

In another preferred embodiment, compound I and compound II are present in a weight ratio of from 100:1 to 1:1000, preferably in a weight ratio of from 50:1 to 1:500, more preferably in a weight ratio of from 30:1 to 1:300, more preferably in a weight ratio of from 15:1 to 1:100, most preferably in a weight ratio of from 10:1 to 1:70, particularly in a weight ratio of from 7:1 to 1:40, particularly preferably in a weight ratio of from 3:1 to 1:25, particularly more preferably in a weight ratio of from 1:1 to 1:15, particularly most preferably in a weight ratio of from 1:2 to 1:10, for example in a weight ratio of either from 1:4 to 1:7.

In another preferred embodiment, the mixture or composition according to the invention contains

a) DMPSA1 and/or DMPSA2, and/or a derivative thereof, and/or a salt thereof, as compound I, and
b) Bradyrhizobium japonicum, preferably Bradyrhizobium japonicum 532c, as compound II,
wherein the compound I and compound II are present in a weight ratio of from 1000:1 to 1:1000, preferably in a weight ratio of from 500:1 to 1:500, more preferably in a weight ratio of from 300:1 to 1:300, more preferably in a weight ratio of from 150:1 to 1:80, most preferably in a weight ratio of from 100:1 to 1:30, particularly in a weight ratio of from 70:1 to 1:10, particularly preferably in a weight ratio of from 50:1 to 1:1, particularly more preferably in a weight ratio of from 25:1 to 1.5:1, particularly most preferably in a weight ratio of from 15:1 to 2:1, for example in a weight ratio of either from 12:1 to 8:1 or from 5:1 to 2.5:1, wherein the total weight of compound II is calculated on the basis of the amount of CFU of compound II, wherein 1×10⁹ CFU equals one gram of total weight of compound II.

In another preferred embodiment, the mixture or composition according to the invention contains

a) DMPSA1 and/or DMPSA2, and/or a derivative thereof, and/or a salt thereof, as compound I (nitrication inhibitor),
b) grape seed extract (L.6.18) as compound II,
wherein the compound I and compound II are present in a weight ratio of from 100:1 to 1:1000, preferably in a weight ratio of from 50:1 to 1:500, more preferably in a weight ratio of from 30:1 to 1:300, more preferably in a weight ratio of from 15:1 to 1:100, most preferably in a weight ratio of from 10:1 to 1:70, particularly in a weight ratio of from 7:1 to 1:40, particularly preferably in a weight ratio of from 3:1 to 1:25, particularly more preferably in a weight ratio of from 1:1 to 1:15, particularly most preferably in a weight ratio of from 1:2 to 1:10, for example in a weight ratio of either from 1:4 to 1:7.

According to further embodiments of the binary mixtures and compositions, the weight ratio of the compound I and the compound II usually is in the range of from 1000:1 to 1:1, often in the range of from 100:1 to 1:1, regularly in the range of from 50:1 to 1:1, preferably in the range of from 20:1 to 1:1, more preferably in the range of from 10:1 to 1:1, even more preferably in the range of from 4:1 to 1:1 and in particular in the range of from 2:1 to 1:1.

According to a further embodiments of the binary mixtures and compositions, the weight ratio of the compound I and the compound II usually is in the range of from 1:1 to 1:1000, often in the range of from 1:1 to 1:100, regularly in the range of from 1:1 to 1:50, preferably in the range of from 1:1 to 1:20, more preferably in the range of from 1:1 to 1:10, even more preferably in the range of from 1:1 to 1:4 and in particular in the range of from 1:1 to 1:2.

According to further embodiments of the mixtures and compositions, the weight ratio of the compound I and the compound II generally depends from the properties of the active components used, usually it is in the range of from 1:10,000 to 10,000:1, regularly in the range of from 1:100 to 10,000:1, preferably in the range of from 1:100 to 5,000:1, more preferably in the range of from 1:1 to 1,000:1, even more preferably in the range of from 1:1 to 500:1 and in particular in the range of from 10:1 to 300:1.

According to further embodiments of the mixtures and compositions, the weight ratio of the compound I and the compound II usually is in the range of from 20,000:1 to 1:10, often in the range of from 10,000:1 to 1:1, regularly in the range of from 5,000:1 to 5:1, preferably in the range of from 5,000:1 to 10:1, more preferably in the range of from 2,000:1 to 30:1, even more preferably in the range of from 2,000:1 to 100:1 and in particular in the range of from 1,000:1 to 100:1.

According to further embodiments of the mixtures and compositions, the weight ratio of the compound I and the compound II usually is in the range of from 1:20,000 to 10:1, often in the range of from 1:10,000 to 1:1, regularly in the range of from 1:5,000 to 1:5, preferably in the range of from 1:5,000 to 1:10, more preferably in the range of from 1:2,000 to 1:30, even more preferably in the range of from 1:2,000 to 1:100 and in particular in the range of from 1:1,000 to 1 100.

According to further embodiments of the mixtures and compositions, the weight ratio of the compound I and the compound II usually is in the range of from 500:1 to 1:500, often in the range of from 250:1 to 1:250, regularly in the range of from 100:1 to 1:100, preferably in the range of from 50:1 to 1:30, more preferably in the range of from 25:1 to 1:10, even more preferably in the range of from 18:1 to 1:5, particularly preferably in the range of 12:1 to 1:1 and in particular in the range of from 8:1 to 2:1.

In the ternary mixtures, i.e. compositions according to the invention comprising the compound I and compound II and a compound III, the weight ratio of compound I and compound II depends from the properties of the active substances used, usually it is in the range of from 1:100 to 100:1, regularly in the range of from 1:50 to 50:1, preferably in the range of from 1:20 to 20:1, more preferably in the range of from 1:10 to 10:1 and in particular in the range of from 1:4 to 4:1, and the weight ratio of compound I and compound III usually it is in the range of from 1:100 to 100:1, regularly in the range of from 1:50 to 50:1, preferably in the range of from 1:20 to 20:1, more preferably in the range of from 1:10 to 10:1 and in particular in the range of from 1:4 to 4:1.

Any further active compounds are, if desired, added in a ratio of from 20:1 to 1:20 to the compound I.

These ratios are also suitable for inventive mixtures applied by seed treatment.

In further specific embodiments, the mixture or composition or kit-of-parts according to the present invention may additionally comprise a fertilizer. In case the mixture or kit-or-parts comprising compound I (nitrification inhibitor) and compound II (biopesticides) is used together with a fertilizer, or when a mixture is provided in combination with a fertilizer, such mixtures may be provided or used as agrochemical mixtures.

In the terms of the present invention “agrochemical mixture” means a combination of at least three or more compounds. The term is, however, not restricted to a physical mixture comprising three or more compounds, but refers to any preparation form of said compounds, the use of which many be time- and/or locus-related.

The agrochemical mixtures may, for example, be formulated separately but applied in a temporal relationship, i.e. simultaneously or subsequently, the subsequent application having a time interval which allows a combined action of the compounds.

Furthermore, the individual compounds of the agrochemical mixtures according to the invention such as parts of a kit or parts of the mixture may be mixed by the user himself in a suitable mixing device. In specific embodiments further auxiliaries may be added, if appropriate.

The term “fertilizers” is to be understood as chemical compounds applied to promote plant and fruit growth. Fertilizers are typically applied either through the soil (for uptake by plant roots), through soil substituents (also for uptake by plant roots), or by foliar feeding (for uptake through leaves). The term also includes mixtures of one or more different types of fertilizers as mentioned below.

The term “fertilizers” can be subdivided into several categories including: a) organic fertilizers (composed of plant/animal matter), b) inorganic fertilizers (composed of chemicals and minerals) and c) urea-containing fertilizers.

Organic fertilizers include manure, e.g. liquid manure, semi-liquid manure, biogas manure, stable manure or straw manure, slurry, liquid dungwater, sewage sludge, worm castings, peat, seaweed, compost, sewage, and guano. Green manure crops (cover crops) are also regularly grown to add nutrients (especially nitrogen) to the soil. Manufactured organic fertilizers include e.g. compost, blood meal, bone meal and seaweed extracts. Further examples are enzyme digested proteins, fish meal, and feather meal. The decomposing crop residue from prior years is another source of fertility.

Inorganic fertilizers are usually manufactured through chemical processes (such as e.g. the Haber-Bosch process), also using naturally occurring deposits, while chemically altering them (e.g. concentrated triple superphosphate). Naturally occurring inorganic fertilizers include Chilean sodium nitrate, mine rock phosphate, limestone, sulfate of potash, muriate of potash, and raw potash fertilizers.

Typical solid fertilizers are in a crystalline, prilled or granulated form. Typical nitrogen containing inorganic fertilizers are ammonium nitrate, calcium ammonium nitrate, ammonium sulfate, ammonium sulfate nitrate, calcium nitrate, diammonium phosphate, monoammonium phosphate, ammonium thio sulfate and calcium cyanamide.

The inorganic fertilizer may be an NPK fertilizer. “NPK fertilizers” are inorganic fertilizers formulated in appropriate concentrations and combinations comprising the three main nutrients nitrogen (N), phosphorus (P) and potassium (K) as well as typically S, Mg, Ca, and trace elements. “NK fertilizers” comprise the two main nutrients nitrogen (N) and potassium (K) as well as typically S, Mg, Ca, and trace elements. “NP fertilizers” comprise the two main nutrients nitrogen (N) and phosphorus (P) as well as typically S, Mg, Ca, and trace elements.

Urea-containing fertilizer may, in specific embodiments, be formaldehyde urea, UAN, urea sulfur, stabilized urea, urea based NPK-fertilizers, or urea ammonium sulfate. Also envisaged is the use of urea as fertilizer. In case urea-containing fertilizers or urea are used or provided, it is particularly preferred that urease inhibitors as defined herein above may be added or additionally be present, or be used at the same time or in connection with the urea-containing fertilizers.

Fertilizers may be provided in any suitable form, e.g. as coated or uncoated granules, in liquid or semi-liquid form, as sprayable fertilizer, or via fertigation etc.

Coated fertilizers may be provided with a wide range of materials. Coatings may, for example, be applied to granular or prilled nitrogen (N) fertilizer or to multi-nutrient fertilizers. Typically, urea is used as base material for most coated fertilizers. The present invention, however, also envisages the use of other base materials for coated fertilizers, any one of the fertilizer materials defined herein. In certain embodiments, elemental sulfur may be used as fertilizer coating. The coating may be performed by spraying molten S over urea granules, followed by an application of sealant wax to close fissures in the coating. In a further embodiment, the S layer may be covered with a layer of organic polymers, preferably a thin layer of organic polymers. In another embodiment, the coated fertilizers are preferably physical mixtures of coated and non-coated fertilizers.

Further envisaged coated fertilizers may be provided by reacting resin-based polymers on the surface of the fertilizer granule. A further example of providing coated fertilizers includes the use of low permeability polyethylene polymers in combination with high permeability coatings.

In specific embodiments the composition and/or thickness of the fertilizer coating may be adjusted to control, for example, the nutrient release rate for specific applications. The duration of nutrient release from specific fertilizers may vary, e.g. from several weeks to many months. The presence of nitrification inhibitors and biopesticides in a mixture with coated fertilizers may accordingly be adapted. It is, in particular, envisaged that the nutrient release involves or is accompanied by the release of an nitrification inhibitor and biopesticides according to the present invention.

Coated fertilizers may be provided as controlled release fertilizers (CRFs). In specific embodiments these controlled release fertilizers are fully coated N—P-K fertilizers, which are homogeneous and which typically show a pre-defined longevity of release. In further embodiments, the CRFs may be provided as blended controlled release fertilizer products which may contain coated, uncoated and/or slow release components. In certain embodiments, these coated fertilizers may additionally comprise micronutrients. In specific embodiments these fertilizers may show a pre-defined longevity, e.g. in case of N—P-K fertilizers.

Additionally envisaged examples of CRFs include patterned release fertilizers. These fertilizers typically show a pre-defined release patterns (e.g. hi/standard/lo) and a pre-defined longevity. In exemplary embodiments fully coated N—P—K, Mg and micronutrients may be delivered in a patterned release manner.

Also envisaged are double coating approaches or coated fertilizers based on a programmed release.

In further embodiments the fertilizer mixture may be provided as, or may comprise or contain a slow release fertilizer. The fertilizer may, for example, be released over any suitable period of time, e.g. over a period of 1 to 5 months, preferably up to 3 months. Typical examples of ingredients of slow release fertilizers are IBDU (isobutylidenediurea), e.g. containing about 31-32% nitrogen, of which 90% is water insoluble; or UF, i.e. an urea-formaldehyde product which contains about 38% nitrogen of which about 70% may be provided as water insoluble nitrogen; or CDU (crotonylidene diurea) containing about 32% nitrogen; or MU (methylene urea) containing about 38 to 40% nitrogen, of which 25-60% is typically cold water insoluble nitrogen; or MDU (methylene diurea) containing about 40% nitrogen, of which less than 25% is cold water insoluble nitrogen; or MO (methylol urea) containing about 30% nitrogen, which may typically be used in solutions; or DMTU (diimethylene triurea) containing about 40% nitrogen, of which less than 25% is cold water insoluble nitrogen; or TMTU (tri methylene tetraurea), which may be provided as component of UF products; or TMPU (tri methylene pentaurea), which may also be provided as component of UF products; or UT (urea triazone solution) which typically contains about 28% nitrogen. The fertilizer mixture may also be long-term nitrogen-bearing fertiliser containing a mixture of acetylene diurea and at least one other organic nitrogen-bearing fertiliser selected from methylene urea, isobutylidene diurea, crotonylidene diurea, substituted triazones, triuret or mixtures thereof.

Any of the above mentioned fertilizers or fertilizer forms may suitably be combined. For instance, slow release fertilizers may be provided as coated fertilizers. They may also be combined with other fertilizers or fertilizer types. The same applies to the presence of a nitrification inhibitor or biopesticide according to the present invention, which may be adapted to the form and chemical nature of the fertilizer and accordingly be provided such that its release accompanies the release of the fertilizer, e.g. is released at the same time or with the same frequency. The present invention further envisages fertilizer or fertilizer forms as defined herein above in combination with nitrification inhibitors as defined herein above and biopesticides and further in combination with urease inhibitors as defined herein above. Such combinations may be provided as coated or uncoated forms and/or as slow or fast release forms. Preferred are combinations with slow release fertilizers including a coating. In further embodiments, also different release schemes are envisaged, e.g. a slower or a faster release.

The term “fertigation” as used herein refers to the application of fertilizers, optionally soil amendments, and optionally other water-soluble products together with water through an irrigation system to a plant or to the locus where a plant is growing or is intended to grow, or to a soil substituent as defined herein below. For example, liquid fertilizers or dissolved fertilizers may be provided via fertigation directly to a plant or a locus where a plant is growing or is intended to grow. Likewise, nitrification inhibitors according to the present invention, or in combination with additional nitrification inhibitors, may be provided via fertigation to plants or to a locus where a plant is growing or is intended to grow. Fertilizers and nitrification inhibitors according to the present invention, or in combination with additional nitrification inhibitors, may be provided together, e.g. dissolved in the same charge or load of material (typically water) to be irrigated. In further embodiments, fertilizers and nitrification inhibitors may be provided at different points in time. For example, the fertilizer may be fertigated first, followed by the nitrification inhibitor, or preferably, the nitrification inhibitor may be fertigated first, followed by the fertilizer. The time intervals for these activities follow the herein above outlined time intervals for the application of fertilizers and nitrification inhibitors. Also envisaged is a repeated fertigation of fertilizers and nitrification inhibitors according to the present invention, either together or intermittently, e.g. every 2 hours, 6 hours, 12 hours, 24 hours, 2 days, 3 days, 4 days, 5 days, 6 days or more.

In particularly preferred embodiments, the fertilizer is an ammonium-containing fertilizer.

The agrochemical mixture according to the present invention may comprise one fertilizer as defined herein above and one nitrification inhibitor as defined herein above and one biopesticide as defined herein above. In further embodiments, the agrochemical mixture according to the present invention may comprise at least one or more than one fertilizer as defined herein above, e.g. 2, 3, 4, 5, 6, 6, 7, 8, 9, 10 or more different fertilizers (including inorganic, organic and urea-containing fertilizers) and at least one nitrification inhibitor as defined above and at least one biopesticide as defined herein above, preferably a combination as defined in the Tables 1 to 49.

In another group of embodiments the agrochemical mixture according to the present invention may comprise at least one or more than one nitrification inhibitor as defined herein above, preferably more than one nitrification inhibitor as defined above and at least one fertilizer as defined herein above and at least one biopesticide as defined herein above.

The term “at least one” is to be understood as 1, 2, 3 or more of the respective compound selected from the group consisting of fertilizers as defined herein above, and nitrification inhibitors as defined herein above (also designated as compound I), and biopesticides (also designated as compound II).

In addition to at least one fertilizer and at least one nitrification inhibitor as defined herein above and at least one biopesticide, an agrochemical mixture may comprise further ingredients, compounds, active compounds or compositions or the like. For example, the agrochemical mixture may additionally comprise or composed with or on the basis of a carrier, e.g. an agrochemical carrier, preferably as defined herein. In further embodiments, the agrochemical mixture may further comprise at least one additional pesticidal compound. For example, the agrochemical mixture may additionally comprise at least one further compound selected from herbicides, insecticides, fungicides, growth regulators, biopesticides, urease inhibitors, nitrification inhibitors, and denitrification inhibitors.

In specific embodiments, the treatment may be carried out during all suitable growth stages of a plant as defined herein. For example, the treatment may be carried out during the BBCH principle growth stages.

The term “BBCH principal growth stage” refers to the extended BBCH-scale which is a system for a uniform coding of phenologically similar growth stages of all mono- and dicotyledonous plant species in which the entire developmental cycle of the plants is subdivided into clearly recognizable and distinguishable longer-lasting developmental phases. The BBCH-scale uses a decimal code system, which is divided into principal and secondary growth stages. The abbreviation BBCH derives from the Federal Biological Research Centre for Agriculture and Forestry (Germany), the Bundessortenamt (Germany) and the chemical industry.

In one embodiment the invention relates to a method for reducing nitrification comprising treating a plant growing on soil or soil substituents and/or the locus where the plant is growing or is intended to grow with a mixture or composition of the invention at a growth stage (GS) between GS 00 and GS >BBCH 99 of the plant (e.g. when fertilizing in fall after harvesting apples) and preferably between GS 00 and GS 65 BBCH of the plant.

In one embodiment the invention relates to a method for reducing nitrification comprising treating a plant growing on soil or soil substituents and/or the locus where the plant is growing or is intended to grow with a mixture or composition of the invention (referred to as mixture (Q) in the following) at a growth stage (GS) between GS 00 to GS 45, preferably between GS 00 and GS 40 BBCH of the plant.

In a preferred embodiment the invention relates to a method for reducing nitrification comprising treating a plant growing on soil or soil substituents and/or the locus where the plant is growing or is intended to grow with a mixture or composition of the invention at an early growth stage (GS), in particular a GS 00 to GS 05, or GS 00 to GS 10, or GS 00 to GS 15, or GS 00 to GS 20, or GS 00 to GS 25 or GS 00 to GS 33 BBCH of the plant. In particularly preferred embodiments, the method for reducing nitrification comprises treating a plant growing on soil or soil substituents and/or the locus where the plant is growing or is intended to grow with a mixture or composition of the invention during growth stages including GS 00.

In a further, specific embodiment of the invention, a mixture or composition of the invention is applied to a plant growing on soil or soil substituents and/or the locus where the plant is growing or is intended to grow at a growth stage between GS 00 and GS 55 BBCH, or of the plant.

In a further embodiment of the invention, a mixture or composition of the invention is applied to a plant growing on soil or soil substituents and/or the locus where the plant is growing or is intended to grow at the growth stage between GS 00 and GS 47 BBCH of the plant.

In one embodiment of the invention, a mixture or composition of the invention is applied to a plant growing on soil or soil substituents and/or the locus where the plant is growing or is intended to grow before and at sowing, before emergence, and until harvest (GS 00 to GS 89 BBCH), or at a growth stage (GS) between GS 00 and GS 65 BBCH of the plant.

### Experimental Details

Regarding the isomer ratio of DMPSA, the DMPSA used in the experiments was the free acid of DMPSA containing 70 to 90 wt.-% 2-(3,4-dimethyl-1H-pyrazol-1-yl)succinic acid (“DMPSA1”) and 10 to 30 wt.-% 2-(4,5-dimethyl-1H-pyrazol-1-yl)succinic acid (“DMPSA2”). “Wt.-%” means “percent by weight”.

### Plant Growth Conditions

Plants were generally grown under standard green house conditions (20° C. and 60% humidity) using standard greenhouse soil (mixture of peat, loam and sand). Therefore, 0.4 g of ryegrass seeds (Lolium perennes ‘Chagall’), 1 soybean seed (Glycine max ‘Sultana’) or 1 grape vine live stack (Vitis vinifer ssp. ‘Sativa’) were grown per pot (8.4 cm for ryegrass, soybean; 13 cm for grape vine) in a completely randomized set-up. Following a growth period of ten days (ryegrass), 14 days (soybean) or approx. 21 days, until the main shoot reached a length of 20 cm (grape vine), plants were designated for experimental usage.

### Greenhouse Experiment

### Detection of Nitrous Oxide Losses:

On application day (DATO), each pot (with/without plants) was set onto a plant saucer designed with an inner compartment for the pot and an outer ring that is filled with water. At time 0, water holding capacity of the soil was set to 60-70% prior to application with/without fertilizer and active ingredient. Subsequently, a gas sampling chamber was placed over the plant saucer such that the rim fit into the ring filled with water to create a gas-tight chamber and 25 cc air from the chamber were drawn into a syringe and immediately emptied in to a Vacutainer (Labco, 12 ml volume). This equals the Time 0 measurement for each pot. The same procedure was performed with all pots in the experiment. After two hour incubation time, again 25 cc air samples were taken from the gas chambers and emptied into Vacutainers as described above. Plants were then returned to their positions in the climate chamber. The procedure was repeated at precisely the same time of day for up to 19 days.

Samples were analyzed in a Shimadzu 2014 GC equipped with an ECD system.

### Detection of Plant Biomass/Shoot Elongation:

Detection of ryegrass and soybean biomass (fresh weight) was determined gravitometricallly. Therefore, plants were cut using a hand held lawn cutter (ryegrass) or garden shears (soybean) 1 cm above the soil. Given ryegrass data represent the mean value of respective replicates summed up for 3 cuttings. For experiments using ryegrass, evaluations were conducted 5, 12 and 17 days after start of the experiment. For experiments using soybean, biomass evaluation was conducted 17 days after experimental start.

For experiments using grape vine, elongation of the main shoot was measured metrically 17 days after experimental start.

The experimental details regarding the detection of nitrous oxide losses and of biomass are shown in Table N1 to N5.

In Table N1, the weight ratio between DMPSA and Histick Super is 3.65:1, the weight ratio between DMPSA and Hicoat is 10.43:1.

In Table N2, the weight ratio between DMPSA and VitoVin is 1:5.6.

TABLE N1
Application rates of the different compounds for N2O emission tests (crop: soybean)

| | Active ingredient | application rate | a.i. application rate | | |
|---|---|---|---|---|---|
| Compound | (a.i.) | [g/ha] | [% of NH4—N] | Crop | Parameter |
| AS liquid | DMPP | 219000 (NH4—N) | | Soybean | N₂O, |
| DMPSA | DMPSA | | 1.0 | | biomass |
| Histick Super | Bradyrhizobium japonicum | 0.4 kg Histick + | | | |
| | 532c | 0.8 kg water/ | | | |
| | | 100 kg soybean seeds | | | |
| Hicoat Super | Bradyrhizobium japonicum | 6.4 L Hicoat Super + | | | |
| | 532c | 6.4 L Extender Polymer/ | | | |
| | | 4500 kg soybean seeds | | | |

(AS = ammonium sulfate, Compounds were provided by BASF SE)

TABLE N2
Application rates of the different compounds for N2O emission teste (crop: soybean)

| | Active ingredient | application rate | a.i. application rate | | |
|---|---|---|---|---|---|
| Compound | (a.i.) | [g/ha] | [% of NH4—N] | Crop | Parameter |
| AS liquid | — | 219000 (NH4—N) | | Grape vine | |
| DMPSA | DMPSA | | 1.0 | | Shoot |
| VitoVin | Grape seed extract | 12481 | | | elongation |

(AS = ammonium sulfate, Compounds werde provided by BASF SE, VitoVin was obtained from Raiffeisen)

TABLE N3
N2O loss detection data of the mixtures comprising Hicoat Super

| | | | | Colby |
|---|---|---|---|---|
| | | N2O | | Calculated |
| | N2O | emission | | value |
| | emission | ppb net | % | (A + B) − |
| | ppb | emission | inhibition | (A*B/100) |
| Water | 1 | | | |
| Soybean untreated + AS | 47 | 47 | 0 | |
| liquid | | | | |
| Soybean untreated + AS | 38 | 38 | 19 | |
| liquid + 1% DMPSA | | | | |
| Soybean coated (Hicoat | 66 | 66 | −40 | |
| Super) + H2O | | | | |
| Soybean coated (Hicoat | 55 | 55 | −17 | |
| Super) + AS liquid | | | | |
| Soybean coated (Hicoat | 45 | 45 | 4 | |
| Super) + H2O + | | | | |
| 1% DMPSA | | | | |
| Soybean coated (Hicoat | 34 | 34 | 28 | 21 |
| Super) + AS liquid + | | | | |
| 1% DMPSA | | | | |

TABLE N4
Biomass data of the mixtures comprising Histick

| | net | Biomass | Colby |
|---|---|---|---|
| | Biomass | increase [% of | Calculated |
| | increase | fertilized | value |
| | [g] | control] | (A*B)/100 |
| Water | | | |
| Soybean untreated + AS liquid | 0 | 100 | |
| Soybean untreated + AS liquid + | −2.47 | 83 | |
| 1% DMPSA | | | |
| Soybean coated (Histick) + H2O | −2.97 | 80 | |
| Soybean coated (Histick) + AS | 2.20 | 115 | |
| liquid | | | |
| Soybean coated (Histick) + | −1.87 | 87 | |
| H2O + 1% DMPSA | | | |
| Soybean coated (Histick) + | 0.11 | 101 | 96 |
| AS liquid + 1% DMPSA | | | |

TABLE N5
Biomass data of the mixtures comprising grape seed extract

| | | Colby |
|---|---|---|
| | relative | Calculated |
| | Growth increase | value |
| | [% of control] | (A*B)/100 |
| Water | 100 | |
| VitoVin (contains grape | 99 | |
| seed extract) | | |
| 1% DMPSA | 104 | |
| VitoVin + 1% DMPSA | 116 | 103 |

The experimental data as described in the Table N1 to N5 show that the mixtures comprising DMPSA and the biopesticides as shown in the Table N1 to N5 have a synergistic effect in reducing the N20 emissions from soils, or a synergistic effect regarding the growth increase (biomass).

1. A mixture comprising as active components
1) at least one active compound I (nitrification inhibitor) selected from the group consisting of:
a) 2-(3,4-dimethyl-1H-pyrazol-1-yl)succinic acid and/or 2-(4,5-dimethyl-1H-pyrazol-1-yl)succinic acid, and/or a derivative thereof, and/or a salt thereof,
b) glycolic acid addition salt of 3,4-dimethyl pyrazole (3,4-dimethyl pyrazolium glycolate), and/or an isomer thereof, and/or a derivative thereof,
c) citric acid addition salt of 3,4-dimethyl pyrazole (3,4-dimethyl pyrazolium citrate), and/or an isomer thereof, and/or a derivative thereof,
d) lactic acid addition salt of 3,4-dimethyl pyrazole (3,4-dimethyl pyrazolium lactate), and/or an isomer thereof, and/or a derivative thereof,
e) mandelic acid addition salt of 3,4-dimethyl pyrazole (3,4-dimethyl pyrazolium mandelate), and/or an isomer thereof, and/or a derivative thereof,
f) 1,2,4-triazole, and/or a derivative thereof, and/or a salt thereof,
g) 4-Chloro-3-methylpyrazole, and/or an isomer thereof, and/or a derivative thereof, and/or a salt thereof,
h) N-((3(5)-methyl-1H-pyrazole-1-yl)methyl)acetamide, and/or an isomer thereof, and/or a derivative thereof, and/or a salt thereof,
i) N-((3(5)-methyl-1H-pyrazole-1-yl)methyl)formamide, and/or an isomer thereof, and/or a derivative thereof, and/or a salt thereof,
j) N-((3(5),4-dimethylpyrazole-1-yl)methyl)formamide, and/or an isomer thereof, and/or a derivative thereof, and/or a salt thereof,
k) N-((4-chloro-3(5)-methyl-pyrazole-1-yl)methyl)formamide, and/or an isomer thereof, and/or a derivative thereof, and/or a salt thereof,
l) a reaction adduct of dicyandiamide, urea and formaldehyde, or a triazonyl-formaldehyde-dicyandiamide adduct
m) 2-cyano-1-(4-oxo-1,3,5-triazinan-1-yl)methyl)guanidine,
n) 1-((2-cyanoguanidino)methyl)urea, and
o) 2-cyano-1-((2-cyanoguanidino)methyl)guanidine,
p) 2-chloro-6-(trichloromethyl)-pyridine (nitrapyrin or N-serve),
q) dicyandiamide (DCD, DIDIN),
r) 3,4-dimethyl pyrazole phosphate, and/or 4,5-dimethyl pyrazole phosphate (DMPP, ENTEC), and/or an isomer thereof, and/or a derivative thereof,
s) 3,4-dimethylpyrazole, and/or 4,5-dimethylpyrazole (DMP), and/or an isomer thereof, and/or a derivative thereof, and/or a salt thereof, and/or an acid addition salt thereof,
t) ammoniumthiosulfate (ATU),
u) neem, and/or products based on ingredients of neem,
v) linoleic acid,
w) alpha-linolenic acid,
x) methyl p-coumarate,
y) methyl ferulate,
z) methyl 3-(4-hydroxyphenyl) propionate (MHPP),
aa) Karanjin,
bb) brachialacton,
cc) p-benzoquinone sorgoleone,
dd) 4-amino-1,2,4-triazole hydrochloride (ATC),
ee) 1-amido-2-thiourea (ASU),
ff) 2-amino-4-chloro-6-methylpyrimidine (AM),
gg) 2-mercapto-benzothiazole (MBT),
hh) 5-ethoxy-3-trichloromethyl-1,2,4-thiodiazole (terrazole, etridiazole),
ii) 2-sulfanilamidothiazole (ST),
jj) 3-methylpyrazol (3-MP),
kk) 1,2,4-triazol thiourea (TU),
ll) cyan amide,
mm) melamine,
nn) zeolite powder,
oo) catechol,
pp) benzoquinone,
qq) sodium tetra borate,
rr) allylthiourea,
ss) chlorate salts, and
tt) zinc sulfate;
and
2) at least one active compound II (biopesticide) selected from groups L1) to L6):
L1) Microbial pesticides with fungicidal, bactericidal, viricidal and/or plant defense activator activity: Ampelomyces quisqualis, Aspergillus flavus, Aureobasidium pullulans, Bacillus altitudinis, Bacillus amyloliquefaciens, Bacillus licheniformis, Bacillus megaterium, Bacillus mojavensis, Bacillus mycoides, Bacillus pumilus, Bacillus simplex, Bacillus solisalsi, Bacillus subtilis, Bacillus subtilis var. amyloliquefaciens, Candida oleophila, Candida saitoana, Clavibacter michiganensis (bacteriophages), Coniothyrium minitans, Cryphonectria parasitica, Cryptococcus albidus, Dilophosphora alopecuri, Fusarium oxysporum, Clonostachys rosea f. catenulata (also named Gliocladium catenulatum), Gliocladium roseum, Lysobacter antibioticus, Lysobacter enzymogenes, Metschnikowia fructicola, Microdochium dimerum, Microsphaeropsis ochracea, Muscodor albus, Paenibacillus alvei, Paenibacillus epiphyticus, Paenibacillus polymyxa, Paenibacillus agglomerans, Pantoea vagans, Penicillium bilaiae, Phlebiopsis gigantea, Pseudomonas chlororaphis, Pseudomonas fluorescens, Pseudomonas putida, Pseudozyma flocculosa, Pichia anomala, Pythium oligandrum, Sphaerodes mycoparasitica, Streptomyces griseoviridis, Streptomyces lydicus, Streptomyces violaceusniger, Talaromyces flavus, Trichoderma asperellum, Trichoderma atroviride, Trichoderma asperelloides, Trichoderma fertile, Trichoderma gamsii, Trichoderma harmatum, Trichoderma harzianum, Trichoderma polysporum, Trichoderma stromaticum, Trichoderma vixens, Trichoderma viride, Typhula phacorrhiza, Ulocladium oudemansii, Verticillium dahlia, zucchini yellow mosaic virus (avirulent strain);
L2) Biochemical pesticides with fungicidal, bactericidal, viricidal and/or plant defense activator activity: chitosan (hydrolysate), fusaricidins, paeniserines, paeniprolixines, harpin protein, laminarin, Menhaden fish oil, natamycin, Plum pox virus coat protein, potassium or sodium bicarbonate, Reynoutria sachalinensis extract, salicylic acid, tea tree oil (Melaleuca alternifolia extract);
L3) Microbial pesticides with insecticidal, acaricidal, molluscidal and/or nematicidal activity: Agrobacterium radiobacter, Bacillus cereus, Bacillus firmus, Bacillus subtilis, Bacillus licheniformis, Bacillus thuringiensis, Bacillus thuringiensis ssp. aizawai, Bacillus thuringiensis ssp. israelensis, Bacillus thuringiensis ssp. galleriae, Bacillus thuringiensis ssp. kurstaki, Bacillus thuringiensis ssp. tenebrionis, Beauveria bassiana, Beauveria brongniartii, Burkholderia rinojensis, Chromobacterium subtsugae, Cydia pomonella granulovirus (CpGV), Cryptophlebia leucotreta granulovirus (CrleGV), Flavobacterium spp., Helicoverpa armigera nucleopolyhedrovirus (HearNPV), Heterorhabditis bacteriophora, Isaria fumosorosea, Lecanicillium longisporum, Lecanicillium muscarium, Metarhizium anisopliae, Metarhizium anisopliae var. anisopliae, Metarhizium anisopliae var. acridum, Nomuraea rileyi, Paecilomyces lilacinus, Paenibacillus popilliae, Pasteuria nishizawae, Pasteuria penetrans, Pasteuria ramosa, Pasteuria thornea, Pasteuria usgae, Phasmarhabditis hermaphrodita, Pseudomonas fluorescens, Spodoptera littoralis nucleopolyhedrovirus (SpliNPV), Steinernema carpocapsae, Steinernema feltiae, Steinernema kraussei, Steinernema riobrave, Streptomyces galbus, Streptomyces microflavus, Paecilomyces lilacinus;
L4) Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl butyrate, isopropyl myristate, lavanulyl senecioate, cis-jasmone, 2-methyl 1-butanol, methyl eugenol, methyl jasmonate, (E,Z)-2,13-octadecadien-1-ol, (E,Z)-2,13-octadecadien-1-ol acetate, (E,Z)-3,13-octadecadien-1-ol, R-1-octen-3-ol, pentatermanone, potassium silicate, sorbitol actanoate, (E,Z,Z)-3,8,11-tetradecatrienyl acetate, (Z,E)-9,12-tetradecadien-1-yl acetate, Z-7-tetradecen-2-one, Z-9-tetradecen-1-yl acetate, Z-11-tetradecenal, Z-11-tetradecen-1-ol, Acacia negra extract, extract of grapefruit seeds and pulp, Chenopodium ambrosioides extract, Catnip oil, Neem oil, Quillay extract, Tagetes oil;
L5) Microbial pesticides with plant stress reducing, plant growth regulator, plant growth promoting and/or yield enhancing activity: Azospirillum amazonense, Azospirillum brasilense, Azospirillum lipoferum, Azospirillum irakense, Azospirillum halopraeferens, Bradyrhizobium elkanii, Bradyrhizobium japonicum, Bradyrhizobium spp., Bradyrhizobium liaoningense, Bradyrhizobium lupini, Delftia acidovorans, Glomus intraradices, Mesorhizobium spp., Mesorhizobium ciceri, Rhizobium leguminosarum bv. phaseoli, Rhizobium leguminosarum bv. trifolii, Rhizobium leguminosarum bv. viciae, Rhizobium tropici, Sinorhizobium meliloti, Sinorhizobium medicae; and
L6) Biochemical pesticides with plant stress reducing, plant growth regulator and/or plant yield enhancing activity: abscisic acid, aluminium silicate (kaolin), 3-decen-2-one, formononectin, genistein, hesperetin, homobrassinolide, humates, methyl jasmonate, cis-jasmone, lysophosphatidyl ethanlamine, naringenin, polymeric polyhydroxy acid, salicylic acid, Ascophyllum nodosum (Norwegian kelp, Brown kelp) extract and Ecklonia maxima (kelp) extract, zeolite (aluminosilicate), grape seed extract.

2. The mixture according to claim 1, wherein compound I is selected from the group consisting of compounds LA to I.Z:
I.A: 2-(3,4-dimethyl-1H-pyrazol-1-yl)succinic acid and/or 2-(4,5-dimethyl-1H-pyrazol-1-yl)succinic acid,
I.B: a salt of 2-(3,4-dimethyl-1H-pyrazol-1-yl)succinic acid and/or 2-(4,5-dimethyl-1H-pyrazol-1-yl)succinic acid,
I.C: a potassium salt of 2-(3,4-dimethyl-1H-pyrazol-1-yl)succinic acid and/or 2-(4,5-dimethyl-1H-pyrazol-1-yl)succinic acid,
I.D: an ammonium salt of 2-(3,4-dimethyl-1H-pyrazol-1-yl)succinic acid and/or 2-(4,5-dimethyl-1H-pyrazol-1-yl)succinic acid,
I.E: a sodium salt of 2-(3,4-dimethyl-1H-pyrazol-1-yl)succinic acid and/or 2-(4,5-dimethyl-1H-pyrazol-1-yl)succinic acid,
I.F: 3,4-dimethyl pyrazolium glycolate (DMPG),
I.G: 3,4-dimethyl pyrazolium citrate (DMPC),
I.H: 3,4-dimethyl pyrazolium lactate (DMPL),
I.J: 3,4-dimethyl pyrazolium lactate (DMPM),
I.K: 1,2,4-triazole (TZ),
I.L: 4-Chloro-3-methylpyrazole (C1MP),
I.M: N-((3(5)-methyl-1H-pyrazole-1-yl)methyl)acetamide,
I.N: N-((3(5)-methyl-1H-pyrazole-1-yl)methyl)formamide,
I.O: N-((3(5),4-dimethylpyrazole-1-yl)methyl)formamide,
I.P: N-((4-chloro-3(5)-methyl-pyrazole-1-yl)methyl)formamide,
I.Q: reaction adduct of dicyandiamide, urea and formaldehyde, or a triazonyl-formaldehyde-dicyandiamide adduct
I.R: 2-cyano-1-((4-oxo-1,3,5-triazinan-1-yl)methyl)guanidine,
I. S: 1-((2-cyanoguanidino)methyl)urea,
I.T: 2-cyano-1-((2-cyanoguanidino)methyl)guanidine,
I.U: 2-chloro-6-(trichloromethyl)-pyridine (nitrapyrin or N-serve),
I.V: dicyandiamide (DCD, DIDIN),
I.W: 3,4-dimethyl pyrazole phosphate, and/or 4,5-dimethyl pyrazole phosphate (DMPP, ENTEC), and/or an isomer thereof, and/or a derivative thereof,
I.X: 3,4-dimethylpyrazole, and/or 4,5-dimethylpyrazole (DMP), and/or an isomer thereof, and/or a derivative thereof, and/or a salt thereof, and/or an acid addition salt thereof,
I.Y: ammoniumthiosulfate (ATU), and
I.Z: neem.

3. The mixture according to claim 1, wherein compound I is 2-(3,4-dimethyl-1H-pyrazol-1-yl)succinic acid and/or 2-(4,5-dimethyl-1H-pyrazol-1-yl)succinic acid.

4. The mixture according to claim 1, wherein compound II is selected from the group consisting of Bacillus amyloliquefaciens, Bacillus firmus, Bacillus pumilus, Bacillus subtilis, Bacillus licheniformis, Paenibacillus polymyxa, Paenibacillus epiphyticus, Pasteuria nishizawae, Penicillium bilaiae, fusaricidins and cis-jasmone.

5. The mixture according to claim 1, wherein compound II is selected from:
L1) Microbial pesticides with fungicidal, bactericidal, viricidal and/or plant defense activator activity: Ampelomyces quisqualis M-10 (L.1.1), Aspergillus flavus NRRL 21882 (L.1.2), Aureobasidium pullulans DSM 14940 (L1.3), Aureobasidium pullulans DSM 14941 (L.1.4), Bacillus altitudinis 41KF2b (L.1.5), Bacillus amyloliquefaciens AP-136 (L.1.6), Bacillus amyloliquefaciens AP-188 (L.1.7), Bacillus amyloliquefaciens AP-218 (L.1.8), Bacillus amyloliquefaciens AP-219 (L.1.9), Bacillus amyloliquefaciens AP-295 (L.1.10), Bacillus amyloliquefaciens IN937a (L.1.11), Bacillus amyloliquefaciens IT-45 (L.1.12), Bacillus amyloliquefaciens ssp. plantarum D747 (L.1.13), Bacillus amyloliquefaciens ssp. plantarum FZB24 (L.1.14), Bacillus amyloliquefaciens ssp. plantarum FZB42 (L.1.15), Bacillus amyloliquefaciens ssp. plantarum GB03 (=Bacillus subtilis GB03) (L.1.16), Bacillus amyloliquefaciens ssp. plantarum MBI600 (NRRL B-50595) (L.1.17), Bacillus amyloliquefaciens ssp. plantarum QST-713 (L.1.18), Bacillus amyloliquefaciens ssp. plantarum TJ1000 (L.1.19), Bacillus mojavensis AP-209 (L.1.20), Bacillus mycoides AQ726 (L.1.21), Bacillus mycoides strain J (L.1.22), Bacillus pumilus INR-7 (L.1.23), B. pumilus KFP9F (L.1.24), Bacillus pumilus QST 2808 (L.1.25), Bacillus pumilus GHA 180 (L.1.26), Bacillus solisalsi AP-217 (L.1.28), Bacillus subtilis CX-9060 (L.1.29), Bacillus subtilis FB17 (L.1.30), Bacillus subtilis GB07 (L.1.31), Candida oleophila 1-82 (L.1.32), Candida oleophila 0 (L.1.33), Candida saitoana (L.1.34), Clavibacter michiganensis (bacteriophages) (L.1.35), Coniothyrium minitans CON/M/91-08 (L.1.36), Cryphonectria parasitica (L.1.37), Cryptococcus albidus (L.1.38), Dilophosphora alopecuri (L.1.39), Fusarium oxysporum (L.1.40), Clonostachys rosea f. catenulata J1446 (L.1.41), Gliocladium roseum 321U (L.1.42), Metschnikowia fructicola NRRL Y-30752 (L.1.43), Microdochium dimerum (L.1.44), Microsphaeropsis ochracea P130A (L.1.45), Muscodor albus QST 20799 (L.1.46), Muscodor albus SA-13 (L.1.47), Paenibacillus alvei NAS6G6 (L.1.48), Paenibacillus polymyxa PKB1 (L.1.49), Pantoea agglomerans E325 (L.1.90), Pantoea vagans C9-1 (L.1.50), Penicillium bilaiae ATCC 22348 (L.1.51), P. bilaiae ATCC 20851 (L.1.52), Penicillium bilaiae ATCC 18309 (L.1.53), Phlebiopsis gigantea (L.1.54), Pichia anomala WRL-76 (L.1.55), Pseudomonas sp. Proradix (L.1.56), Pseudomonas chlororaphis MA 342 (L.1.57), P. fluorescens A506 (L.1.58), P. fluorescens CL 145A (L.1.91), P. fluorescens NCIB 12089 (L.1.92), P. fluorescens Pf-5 (L.1.93), P. fluorescens WCS 374 (L.1.94), P. fluorescens ATCC 13525 (L.1.95), P. fluorescens CHAO (L.1.96), P. putida ATCC 202153 (L.1.97), Pseudozyma flocculosa PF-A22 UL (L.1.59), Pythium oligandrum DV 74 (L.1.60), Sphaerodes mycoparasitica SMCD2220 (L.1.61), Streptomyces griseoviridis K61 (L.1.62), Streptomyces lydicus WYEC 108 (L.1.63), Streptomyces violaceusniger XL-2 (L.1.64), Streptomyces violaceusniger YCED-9 (L.1.65), Talaromyces flavus V117b (L.1.66), Trichoderma asperellum T34 (L.1.67), Trichoderma asperellum SKT-1 (L.1.68), Trichoderma asperellum ICC 012 (L.1.69), Trichoderma atroviride LC52 (L.1.70), Trichoderma atroviride CNCM I-1237 (L.1.71), Trichoderma asperelloides JM41R (=Trichoderma fertile) (L.1.72), Trichoderma gamsii ICC 080 (L.1.73), Trichoderma harmatum TH 382 (L.1.74), Trichoderma harzianum T-35 (L.1.75), Trichoderma harzianum T-22 (L.1.76), Trichoderma harzianum T-39 (L.1.77); mixture of Trichoderma harzianum ICC012 and Trichoderma viride ICC080 (L.1.78); Trichoderma polysporum (L.1.79); Trichoderma stromaticum (L.1.80), Trichoderma virens GI-3 (L.1.81), Trichoderma virens G-41 (L.1.82), Trichoderma virens GL-21 (=Gliocladium virens GL-21) (L.1.83), Trichoderma. virens G-41 (L.1.84), Trichoderma viride TV1 (L.1.85), Typhula phacorrhiza 94671 (L.1.86), Ulocladium oudemansii HRU3 (L.1.87), Verticillium dahlia (L.1.88), zucchini yellow mosaic virus (avirulent strain) (L.1.89), Bacillus licheniformis SB3086 (L.1.90), Paenibacillus polymyxa Lu16774 (L.1.91), Paenibacillus polymyxa Lu17007 (L.1.92), Paenibacillus epiphyticus Lu17015 (L.1.93), Paenibacillus sp. NRRL B-50972 (L.1.94), Paenibacillus sp. strain NRRL B-67129 (L.1.95), Bacillus pumilus strain GB34 (L.1.96);
L2) Biochemical pesticides with fungicidal, bactericidal, viricidal and/or plant defense activator activity: chitosan (hydrolysate) (L.2.1), harpin protein (L.2.2), laminarin (L.2.3), Menhaden fish oil (L.2.4), natamycin (L.2.5), Plum pox virus coat protein (L.2.6), potassium bicarbonate (L.2.7), Reynoutria sachalinensis extract (L.2.8), salicylic acid (L.2.9), potassium or sodium bicarbonate (L.2.10), tea tree oil (Melaleuca alternifolia extract) (L.2.11), fusaricidin A (L.2.12), fusaricidin B (L.2.13), fusaricidin C (L.2.14), fusaricidin D (L.2.15), fusaricidin LI F03 (L.2.16), fusaricidin LI F04 (L.2.17), fusaricidin LI-F05 (L.2.18), fusaricidin LI-F06 (L.2.18), fusaricidin LI-F07 (L.2.19), fusaricidin LI-F08 (L.2.20), fusaricidin 1A (L.2.21), fusaricidin 1B (L.2.22), paeniserine A (L.2.23), paeniserine B (L.2.24) paeniserine C (L.2.25), paeniserine D (L.2.26) paeniprolixine A (L.2.27), paeniprolixine B (L.2.28), paeniprolixine C (L.2.29), paeniprolixine D (L.2.30), paeniprolixine E (L.2.31), paeniprolixine F (L.2.32), paeniprolixine G (L.2.33);
L3) Microbial pesticides with insecticidal, acaricidal, molluscidal and/or nematicidal activity: Agrobacterium radiobacter K1026 (L.3.1), A. radiobacter K84 (L.3.2), Bacillus firmus I-1582 (L.3.3); B. thuringiensis ssp. aizawai strains: ABTS-1857 (L.3.4), SAN 401 I (L.3.5), ABG-6305 (L.3.6) and ABG-6346 (L.3.7); B. t. ssp. israelensis AM65-52 (L.3.8), B. t. ssp. israelensis SUM-6218 (L.3.9), B. t. ssp. galleriae SDS-502 (L.3.10), B. t. ssp. kurstaki EG2348 (L.3.11), B. t. ssp. kurstaki SB4 (L.3.12), B. t. ssp. kurstaki ABTS-351 (HD-1) (L.3.13), Beauveria bassiana ATCC 74040 (L.3.14), Beauveria bassiana GHA (L.3.15), Beauveria bassiana H123 (L.3.16), Beauveria bassiana DSM 12256 (L.3.17), Beauveria bassiana PPM 5339 (L.3.18), B. brongniartii (L.3.19), Burkholderia rinojensis A396 (L.3.20), Chromobacterium subtsugae PRAA4-1^{T} (L.3.21), Cydia pomonella granulosis virus V22 (L.3.22), Cydia pomonella granulosis virus V1 (L.3.23), Cryptophlebia leucotreta granulovirus (CrleGV) (L.3.57), Flavobacterium sp. H492 (L.3.60), Helicoverpa armigera nucleopolyhedrovirus (HearNPV) (L.3.58), Isaria fumosorosea Apopka-97 (L.3.24), Lecanicillium longisporum KV42 (L.3.25), Lecanicillium longisporum KV71 (L.3.26), Lecanicillium muscarium KV01 (L.3.27), Metarhizium anisopliae FI-985 (L.3.28), Metarhizium anisopliae FI-1045 (L.3.29), Metarhizium anisopliae F52 (L.3.30), Metarhizium anisopliae ICIPE 69 (L.3.31), Metarhizium anisopliae var. acridum IMI 330189 (L.3.32); Nomuraea rileyi strains: SA86101 (L.3.33), GU87401 (L.3.34), SR 86151 (L.3.35), CG128 (L.3.36) and VA9101 (L.3.37); Paecilomyces fumosoroseus FE 9901 (L.3.38), Paecilomyces lilacinus 251 (L.3.39), Paecilomyces lilacinus DSM 15169 (L.3.40), Paecilomyces lilacinus BCP2 (L.3.41), Paenibacillus popilliae Dutky-1940 (NRRL B-2309=ATCC 14706) (L.3.42), Paenibacillus popilliae Dutky 1 (L.3.43), Paenibacillus popilliae KLN 3 (L.3.56), Pasteuria sp. Ph3 (L.3.44), Pasteuria sp. ATCC PTA-9643 (L.3.45), Pasteuria sp. ATCC SD-5832 (L.3.46), P. nishizawae Pn1 (L.3.46), P. penetrans (L.3.47), P. ramosa (L.3.48), P. sp. Pr-3 (L.3.49), P. thornea (L.3.50), P. usgae (L.3.51), Pseudomonas fluorescens CL 145A (L.3.52), Spodoptera littoralis nucleopolyhedrovirus (SpliNPV) (L.3.59), Steinernema carpocapsae (L.3.53), Steinernema feltiae UK76 (L.3.54), Steinernema kraussei L137 (L.3.55), Beauveria bassiana 147 (L.3.56), Beauveria bassiana NPP111B005 (L.3.57); Bacillus subtilis linhagem QST 713 (L.3.58), Bacillus licheniformis RTI184 (L.3.59), Paecilomyces lilacinus (L.3.60), Steinernema riobrave 355 (L.3.61), Phasmarhabditis hermaphrodita DMG 0001 (L.3.62), Heterorhabditis bacteriophora GPS11 (L.3.63);
L4) Biochemical pesticides with insecticidal, acaricidal, molluscidal, pheromone and/or nematicidal activity: L-carvone (L.4.1), citral (L.4.2), (E,Z)-7,9-dodecadien-1-yl acetate (L.4.3), ethyl formate (L.4.4), (E,Z)-2,4-ethyl decadienoate (pear ester) (L.4.5), (Z,Z,E)-7,11,13-hexadecatrienal (L.4.6), heptyl butyrate (L.4.7), isopropyl myristate (L.4.8), cis-jasmone (L.4.9), lavanulyl senecioate (L.4.10), 2-methyl 1-butanol (L.4.11), methyl eugenol (L.4.12), methyl jasmonate (L.4.13), (E,Z)-2,13-octadecadien-1-ol (L.4.14), (E,Z)-2,13-octadecadien-1-ol acetate (L.4.15), (E,Z)-3,13-octadecadien-1-ol (L.4.16), R-1-octen-3-ol (L.4.17), pentatermanone (L.4.18), potassium silicate (L.4.19), sorbitol actanoate (L.4.20), (E,Z,Z)-3,8,11-tetradecatrienyl acetate (L.4.21), (Z,E)-9,12-tetradecadien-1-yl acetate (L.4.22), Z-7-tetradecen-2-one (L.4.23), Z-9-tetradecen-1-yl acetate (L.4.24), Z-11-tetradecenal (L.4.25), Z-11-tetradecen-1-ol (L.4.26), Acacia negra extract (L.4.27), extract of grapefruit seeds and pulp (L.4.28), Chenopodium ambrosioides extract (L.4.29), Catnip oil (L.4.30), Neem oil (L.4.31), Quillay extract (L.4.32), Tagetes oil (L.4.33);
L5) Microbial pesticides with plant stress reducing, plant growth regulator, plant growth promoting and/or yield enhancing activity: Azospirillum amazonense BR 11140 (SpY2) (L.5.1), A. brasilense Ab-V5 (L.5.74), A. brasilense Ab-V6 (L.5.75), A. brasilense AZ39 (L.5.2), A. brasilense XOH (L.5.3), A. brasilense Sp245 (BR 11005) (L.5.4), A. brasilense BR 11002 (L.5.5), A. lipoferum BR 11646 (Sp31) (L.5.6), A. irakense (L.5.7), A. halopraeferens (L.5.8), Bradyrhizobium sp. PNL01 (L.5.9), Bradyrhizobium sp. (Arachis) CB1015 (L.5.10), Bradyrhizobium sp. (Arachis) USDA 3446 (L.5.11), Bradyrhizobium sp. (Arachis) SEMIA 6144 (L.5.12), Bradyrhizobium sp. (Arachis) SEMIA 6462 (L.5.13), Bradyrhizobium sp. (Arachis) SEMIA 6464 (L.5.14), Bradyrhizobium sp. (Vigna) (L.5.15), Bradyrhizobium elkanii SEMIA 587 (L.5.16), Bradyrhizobium elkanii SEMIA 5019 (L.5.17), Bradyrhizobium elkanii U-1301 (L.5.18), Bradyrhizobium elkanii U-1302 (L.5.19), Bradyrhizobium elkanii USDA 74 (L.5.20), Bradyrhizobium elkanii USDA 76 (L.5.21), Bradyrhizobium elkanii USDA 94 (L.5.22), B. elkanii USDA 3254 (L.5.23), Bradyrhizobium japonicum 532c (L.5.24), Bradyrhizobium japonicum CPAC 15 (L.5.25), Bradyrhizobium japonicum E-109 (L.5.26), Bradyrhizobium japonicum G49 (L.5.27), Bradyrhizobium japonicum TA-11 (L.5.28), Bradyrhizobium japonicum USDA 3 (L.5.29), Bradyrhizobium japonicum USDA 31 (L.5.30), Bradyrhizobium japonicum USDA 76 (L.5.31), Bradyrhizobium japonicum USDA 110 (L.5.32), Bradyrhizobium japonicum USDA 121 (L.5.33), Bradyrhizobium japonicum USDA 123 (L.5.34), Bradyrhizobium japonicum USDA 136 (L.5.35), Bradyrhizobium japonicum SEMIA 566 (L.5.36), Bradyrhizobium japonicum SEMIA 5079 (L.5.37), Bradyrhizobium japonicum SEMIA 5080 (L.5.38), Bradyrhizobium japonicum WB74 (L.5.39), Bradyrhizobium liaoningense (L.5.40), Bradyrhizobium lupini LL13 (L.5.41), Bradyrhizobium lupini WU425 (L.5.42), Bradyrhizobium lupini WSM471 (L.5.43), Bradyrhizobium lupini WSM4024 (L.5.44), Glomus intraradices RTI-801 (L.5.45), Mesorhizobium sp. WSM1271 (L.5.46), Mesorhizobium sp. WSM1497 (L.5.47), Mesorhizobium ciceri CC1192 (L.5.48), Mesorhizobium huakii (L.5.49), Mesorhizobium loti CC829 (L.5.50), Mesorhizobium loti SU343 (L.5.51), Rhizobium leguminosarum bv. phaseoli RG-B10 (L.5.52), R. I. bv. trifolii RP113-7 (L.5.53), R. I. bv. trifolii 095 (L.5.57), R. I. bv. trifolii TA1 (L.5.58), R. I. bv. trifolii CC283b (L.5.59), R. I. bv. trifolii CC275e (L.5.60), R. I. bv. trifolii CB782 (L.5.61), R. I. bv. trifolii CC1099 (L.5.62), R. I. bv. trifolii WSM1325 (L.5.63), R. I. bv. viciae SU303 (L.5.64), R. I. bv. viciae WSM1455 (L.5.65), R. I. bv. viciae P1NP3Cst (=1435) (L.5.66), R. I. bv. viciae RG-P2 (L.5.67), R. tropici PRF81 (L.5.68), R. tropici SEMIA 4077 (L.5.69), R. tropici CC511(L.5.70), Sinorhizobium meliloti RCR2011 (L.5.71), S. meliloti NRG185 (L.5.72), S. meliloti RRI128 (L.5.73), Bacillus licheniformis RTI184 (L.5.74), Bacillus licheniformis CH200 (L.5.75), Bacillus simplex ABU 288 (L.5.76), Bradyrhizobium lupini LL13 (L.5.77), Mesorhizobium ciceri CC1653 (L.5.78), Sinorhizobium medicae WSM1115 (L.5.79), Bradyrhizobium japonicum CB1809 (L.5.80), Bradyrhizobium japonicum 3407 (L.5.81), Rhizobium tropici SEMIA 4088 (L.5.82), Bradyrhizobium NC92 (L.5.83), Bradyrhizobium CB1024 (L.5.84);
L6) Biochemical pesticides with plant stress reducing, plant growth regulator and/or plant yield enhancing activity: abscisic acid (L.6.1), aluminium silicate (kaolin) (L.6.2), 3-decen-2-one (L.6.3), formononectin (L.6.4), genistein (L.6.5), hesperetin (L.6.6), homobrassinolide (L.6.7), humates (L.6.8), methyl jasmonate (L.6.9), cis-jasmone (L.6.10), lysophosphatidyl ethanlamine (L.6.11), naringenin (L.6.12), polymeric polyhydroxy acid (L.6.13), salicylic acid (L.6.14), Ascophyllum nodosum (Norwegian kelp, Brown kelp) extract (L.6.15) and Ecklonia maxima (kelp) extract (L.6.16), zeolite (aluminosilicate) (L.6.17), grape seed extract (L.6.18).

6. The mixture according to claim 1, wherein compound II is selected from the group consisting of Bacillus firmus CNCM I-1582 (L.3.3), Bacillus amyloliquefaciens ssp. plantarum MBI600 (NRRL B-50595) (L.1.17), Bacillus subtilis linhagem QST 713 (L.3.58), Bacillus licheniformis RTI184 (L.3.59), Paenibacillus polymyxa Lu16774 (L.1.91), Paenibacillus polymyxa Lu17007 (L.1.92), Paenibacillus epiphyticus Lu17015 (L.1.93), Pasteuria nishizawae Pn1 (L.3.46), Penicillium bilaiae ATCC 22348 (L.1.51), Penicillium bilaiae ATCC 20851 (L.1.52) and Penicillium bilaiae ATCC 18309 (L.1.53).

7. The mixture according to claim 1, wherein compound II is selected from the group consisting of Bacillus firmus CNCM I-1582 (L.3.3), Bacillus amyloliquefaciens ssp. plantarum MBI600 (NRRL B-50595) (L.1.17), Bacillus subtilis linhagem QST 713 (L.3.58), Bacillus licheniformis RTI184 (L.3.59), Paenibacillus polymyxa Lu16774 (L.1.91), Paenibacillus polymyxa Lu17007 (L.1.92), Paenibacillus epiphyticus Lu17015 (L.1.93), Pasteuria nishizawae Pn1 (L.3.46), Penicillium bilaiae ATCC 22348 (L.1.51), Penicillium bilaiae ATCC 20851 (L.1.52) and Penicillium bilaiae ATCC 18309 (L.1.53).

8. The mixture according to claim 1, wherein compound II is Bradyrhizobium japonicum.

9. The mixture according to claim 1, wherein compound II is Bradyrhizobium japonicum 532c (L.5.24).

10. The mixture according to claim 1, wherein compound II is grape seed extract (L.6.18).

11. The mixture according to claim 1, wherein compound I and compound II are present in a synergistically effective amount, and/or in a synergistically nitrification inhibitor (NI) effective amount, and/or in a synergistically pesticidally effective amount, and/or in a synergistically plant health effective amount.

12. The mixture according to claim 1, wherein compound I and compound II are present in a weight ratio of from 100:1 to 1:100, wherein a total weight of compound II is based on an amount of the solid material (dry matter) of compound II, or wherein the total weight of compound II is calculated on a basis of an amount of CFU of compound II, wherein 1×10⁹ CFU equals one gram of total weight of compound II.

13. The mixture according to claim 1, further comprising a fertilizer.

14. An agrochemical composition, comprising an auxiliary and a mixture according to claim 1.

15. A method of using the mixture as defined in claim 1 for nitrification inhibition, for controlling phytopathogenic harmful fungi or for increasing health of a plant.

16. A method for controlling phytopathogenic harmful fungi, comprising treating the fungi, their habitat or seed, soil or plants to be protected against fungal attack with an effective amount of the mixture as defined in claim 1.

17. A method for increasing health of a plant, comprising treating the plant or plant propagation material or soil where the plants are to grow with an effective amount of the mixture as defined in claim 1.

18. The methods as claimed in claim 16, wherein the at least one compound I and the at least one compound II are applied simultaneously, either as a mixture or separately, or subsequently to plant propagules.

19. Plant propagation material, the material comprising a mixture as defined in claim 1, in an amount of from 0.1 to 10 kg active substances per 100 kg of seed.
